(19) United States
(12) Patent Application Publication
(10) Pub. No.: US 2009/0177301 A1
(43) Pub. Date: Jul. 9, 2009

(54) SCALABLE SYSTEM AND METHOD FOR AN INTEGRATED DIGITAL MEDIA CATALOG, MANAGEMENT AND REPRODUCTION SYSTEM

(75) Inventor: Thomas J. HAYES, Westmont, IL (US)

Correspondence Address: Momkus McCluskey, LLC, 1001 Warrenville Road, Suite 500, Lisle, IL, 60532, US

(73) Assignee: CODENTITY, LLC, Westmont, IL (US)

(21) Appl. No.: 12/327,523

(22) Filed: Dec. 3, 2008

Related U.S. Application Data
(60) Provisional application No. 60/992,097, filed on Dec. 3, 2007.

(51) Int. Cl. G06F 17/00; G06F 3/048; G06F 17/30

(52) U.S. Cl. 700/94; 715/716; 707/5; 707/E17.045; 707/E17.101

(57) ABSTRACT

A system and method for creating an integrated digital media management and reproduction device comprised of a database with key data values for a plurality of records, and a module with search controls that include sets of compound parallel attribute queries that can execute instructions for a data category, and concurrently retrieve and display records across a plurality of related categories—thereby revealing the associations between discrete records. The invention also has a plurality of software instantiated media players which, through instructions managed by a “master container” design, function as if they were dynamically aware of user actions and the quantifiable states of each other player object—and respond according to logic rules, visually guiding event workflow. The system has a memory module for storing query information, a processor configured to retrieve data, a display unit for retrieved data and a digital-to-analog converter for providing capability for connection to loudspeakers.

### RELATED APPLICATIONS

This application claims priority under 35 U.S.C. § 119(e)(1) to U.S. Provisional Patent Application No. 60/992,097 filed Dec. 3, 2007, the specification and drawings of which are fully incorporated by reference herein.

### BACKGROUND OF THE INVENTION

The digital media revolution began quietly in the early 1980s with the arrival of the compact disc (CD). While ubiquitous today, as late as 1985 most consumers in the United States had not yet heard of optical media CD storage, and could not know that the compact disc would eventually replace the vinyl phonograph record album and analog tape cassette as the medium of choice for their personal music collections.

Before the digital music era, professional sound engineers and audio producers used the long-standing tools of the trade such as analog tape recorders and vinyl record turntables to reproduce audio in the studio and on location. The consumer market became accustomed to easy portability with the introduction of Sony® Walkman® units which were designed to play analog tape cassettes.

In 2007, the Apple® iPod® portable digital music player, with sales of more than 100 million units, is leading the charge for the personal music revolution. Other small-format music and video players, such as the Microsoft® Zune™, are attempting to compete with Apple's domination of the consumer digital device market.

In the professional audio arena, sound reproduction for a broad range of applications such as satellite and radio broadcasting, live sporting events, theatrical presentations, mobile DJ parties and house-of-worship activities is typically realized with some form of digital media software or hardware. These “pro-audio” solutions are a mix of computer-based implementations and dedicated electronic hardware devices which are sold and supported by many different companies.

The transformation from analog formats to digital domains has brought many changes. The consumer market has benefited from the convenience of instant music access, and the professional audio market has gained increased productivity through the time-saving technique of digital audio manipulation. For live audio reproduction, with the capability to mix or blend multiple audio streams, many users rely on computer-based audio reproduction management software. While the present state-of-the-art for live sound and portable audio is considered advanced when compared with the heavy hardware and unsophisticated software of years past, the digital media solutions market still has much room for improvement.

To understand the objectives of the invention disclosed in this specification, one should know that the field of live audio reproduction can be broadly classified in two areas: “discrete-reproduction” (DR) and “blended-reproduction” (BR). Discrete-reproduction (where one music track is generally played from start to finish before the next music track plays) is what occurs millions of times every hour on consumer devices like the iPod®. Blended-reproduction (where a plurality of music tracks can be played in co-incidental synchronization, or cross-mixed, from a plurality of integrated player devices) is the method preferred by professional audio users who want the ability to merge multiple audio sources on demand, and in any sequential order they desire. The invention disclosed in this specification provides significant operational improvements for both markets—consumer and professional audio.

After the inventor identified areas of deficiency in the prior art, the system and methods of the invention were developed to provide beneficial solutions in four important digital media management components: Catalog (database) Design, Search Collaboration, Workflow Automation and Visual Interface Enhancement. Working together, the invention's developments in these areas provide a demonstrable improvement in digital media asset management and execution performance.

To explain the recognized deficiencies in many digital audio systems now available in the marketplace, this specification will briefly examine two common environments for digital audio deployment: professional applications where a user, such as a mobile DJ (disc-jockey), requires blended-reproduction to mix a series of music recordings (stored, for example, as digital media files on his computer); and consumer applications where a user, such as the owner of a small-format digital media player, desires the ability to locate music recordings stored on his personal device and listen to them in a spontaneous or semi-ordered sequence. Before highlighting the potential deficiencies prevalent in consumer format media players, a discussion of the operational constraints inherent in many professional and “prosumer” devices may be helpful.

Tens of thousands of mobile DJs (and live sound producers for venues such as marketing conferences, sporting events, house-of-worship assemblies, etc.) have switched from older analog technology (vinyl phonograph records and magnetic tape) to digital tools (like computer-based media players). The vast majority of blended-reproduction digital media players currently deployed typically offer the ability for the operator to play (reproduce) audio files through a system of two (2) media players implemented in adjacent proximity in the user interface display. These designs allow the user to alternate or blend music sources from player A and player B.

The search capabilities for most of these BR products range from requiring the user to locate a target audio file within a known music folder (media storage container) or subfolder on the computer hard drive, to finding songs (recordings) based on variations of an alpha-numeric display of songs stored in a special subfolder, to offering a search mechanism designed to locate a target audio file by searching for a criteria match on a limited set of key data values such as song Title, Artist name, Music genre (music type) or Title of album (collection). While these techniques can produce acceptable results, they are not as efficient as the robust methods disclosed for this invention.

There is another limitation with much of the existing art in the world of blended-reproduction audio. Having only two (2) players (such as player A and player B) restricts the user's ability to work ahead by pre-loading extended sequences, and it makes last-second file changes impractical because of the time it can take to locate and load (insert) a new selection. The time spent locating and loading a file is crucial because with only two (2) players, the process of loading a new file would require removing a digital media file (track) from a previously loaded player, thereby temporarily creating a situation where no new audio file was ready to play. Adding more players increases audio source flexibility, but also complicates matters because the operator has to know which player, from among a plurality of players, is intended to be activated next. An integrated media player design that offered concurrent access to three, six or nine players would greatly increase the risk of an operator error because, with the interface design currently common to many established systems, the operator may not be able to remember or quickly distinguish which specific player should logically be the next player object to receive the play (execute file reproduction) command.

The methods revealed in this specification resolve problems in the prior art associated with search method deficiencies, workflow calculations, interface display constraints and other operational issues.

One disclosed embodiment is comprised of six (6) integrated media players, each capable of reproducing a discrete audio recording (music track), where the interaction of the players can be directed by a method of situational awareness (SA) logic that can control the appropriate properties (such as start, stop, mute, playback rate, audio level, fade rate, content-oriented behavior) for each player, determine the preferred sequence timing of player events (workflow), and visually communicate that recommendation to the user. This capability is important in blended-reproduction systems.

One method of collaborative interoperability for a plurality of digital media player assets is managed by a “Master Container Object” (program instruction control and management entity). The Master Container Object—or master module—may be comprised of programming objects created for the invention and programming objects which are native to the development environment, and it may implement a practical level of situational awareness logic.

The specification discloses “media player object sets” (MPOS) that function as part of the situational awareness logic to extend the capabilities of the core media player objects (such as the Microsoft® ActiveX® Windows Media® player control version 6.4) which, without the methods disclosed in this invention, have no innate awareness of other media player objects, media player object states, or user actions within the programming environment. The MPOS design allows the core media player objects to interact with the programming environment, user actions, and other media player object sets and function as if each discrete media player object within each MPOS does have an innate awareness of each other media player object (and its various event states). For the user, the advantages provided by the creation of a programming environment where media player objects can intelligently collaborate are numerous and useful—and will be made obvious by the methods described in this specification.

This specification also discloses information about other special programming objects such as sets of query search controls, match filter commands and accessible play lists (in the form of pre-designated music groups or imported biographical profiles) that effectively collaborate with the user to produce a broad array of pre-defined and user-improvised queries, where each query is capable of retrieving record summaries that display the natural connections between a plurality of key data values (such as Artist, Music Type, Decade of Release, Tempo, Track Producer, Energy Level, etc.) for a plurality of records in a concise and easy-to-navigate selection screen.

Rather than rely on the inefficient query searches employed by many products in the prior art, the new methods in this invention provide a dramatic increase in query search productivity. Because one embodiment is implemented by adding a flexible audio object (media player) control interface to a relational database search engine, the invention delivers an extreme level of indexed record and query search precision—especially when implemented in collaboration with a specially-designed media catalog comprised of key data value attributes (and their natural sub classifications) for a plurality of music recordings.

One embodiment of the invention provides a method of query search controls that can retrieve and concurrently display records based on the match value for a primary search category (field) and up to six (6) additional key data value attributes, and then permit the user to rearrange (reorder) the results for those retrieved records based on his choice of a different primary match value for the anchor record (database bookmark record), or any record, in that result summary. This method allows the user to identify a digital media file (record) of interest using a primary key data value, view that record in relationship with other records, and then—without instigating a completely new search—see that record in context with similar or dissimilar records based on the match values, applied filters, and executed sort order for a commonly shared secondary category (key data value) attribute. It is this spontaneously-branching query capability that allows the user to retrieve and evaluate the natural connections (associations) between similar records, and to simultaneously retrieve and evaluate the natural connections between dissimilar records, even when those connections may not be immediately obvious.

A new type of “dual-mode” compound parallel attribute query search system has been envisioned for this invention. It is a method that creates alternating sets of Key Data Value Command Query Controls (as part of a user modifiable query search system) where each Key Data Value Command Query Control (KDVCQC) has a name corresponding to its primary match category (such as search by Title, search by Artist, search by Music Type, search by Music Code, search by Decade, search by Tempo, search by Producer, search by Energy Level, search by Gender of Lead Vocalist, and so on).

In the program's default passive mode, a query search is activated when the user clicks a database category (key data value command query control) attribute button (icon) and the program executes a pre-defined SQL instruction attached to the button. The passive mode requires no instruction from the user.

In the active mode, the user clicks a database category (key data value command query control) attribute button (icon), and then submits a new fixed-string or keyword phrase instruction of his choosing in a text input box. The user's instruction is used to modify the execution of the pre-defined SQL instruction attached to the previously activated database category (key data value command query control) attribute button (icon). The active mode requires an instruction (in the form of alpha-numeric character data) from the user.

In the invention, a “parent-child attribute” design in its associated media catalog (database) can help facilitate query search results (executed with the Key Data Value Command Query Controls) that retrieve record summaries that display connections between similar and dissimilar tracks because the catalog provides a richer level of cross-indexed key data values. When this detail is manipulated by alternating sets of specially-constructed query search controls, the information displayed to the user simplifies the task of distinguishing and understanding the finer points of record (music recording) attribute relationships.

Some interesting query search implementations found in the prior art create a “visual display connection” (VDC) interface that allows the user to search, for example, a dictionary or thesaurus database for the definition of a word or phrase, and then see a depiction of associated words displayed in a series of linear and non-linear branching result sets. While useful, this design does not permit the level of query search manipulation embodied in the KDVCQC system disclosed in the invention specified in this document.

The VDC method as commonly implemented in prior art does not allow the user to specify precisely which key data value match information is used to organize the retrieved display. Also, it does not generally allow the user to prioritize the match categories, regulate exclusions, or specify match filters within query results. Most visual display connection query methods in the prior art do not allow the user to import or incorporate unique biographical profile information (shaped for an individual's music preferences, for example) and use that data in the execution of query searches. All of these capabilities are found within the KDVCQC system disclosed in the invention which means that the KDVCQC system can permit the user to achieve greater control over the outcome of a search.

To further explain the value of the KDVCQC system, this specification will recite the enhancements provided by the invention that improve on prior art, including VDC systems, in at least three critical areas: query formulation, hyper-contemplation, and user access to retrieved records.

The method and system of this invention provides alternating sets of Key Data Value Command Query Controls where each Key Data Value Command Query Control (KDVCQC) is capable of facilitating the concurrent display of a plurality of key data values for a plurality of related key data value categories (database fields) retrieved from a plurality of catalog (database) records. At the same time, each KDVCQC can permit the user to accept its unique default SQL (structured query language) instruction, or to modify its default instruction with a user-improvised instruction or user-applied filters and exclusions. Additionally, in an embodiment, each KDVCQC can be randomly accessed by the user in sets of complementary controls that can (if desired) maintain the user's original query anchor record (database bookmark pointer record) while new query results are retrieved from within a previously retrieved record summary, or new query results are retrieved to include one or more records from a previously retrieved summary and a plurality of new records. This is significant because with the KDVCQC system, a user can execute one query and choose to continuously generate successive queries where all retrieved records can be traced back to the user's original query results.

While other methods such as those found in visual display connection (VDC) implementations can achieve branching in order to reveal associated records (for example, word or phrase results), they generally present the linked records as two or more word/phrases connected by a line which can branch to additional lines representing extended results. In contrast, the KDVCQC system concisely displays multiple attribute values in query-specific order and accessible by a user-navigable list. The KDVCQC system allows the user to choose to immediately reorganize his connections and assert query formulation control by specifying the key data value match categories.

In one embodiment, the Key Data Value Command Query Control (KDVCQC) system is comprised of four (4) complimentary sets of Key Data Value Command Query Controls, each KDVCQC set having five (5) discrete KDVCQC buttons (icons); each KDVCQC button facilitating display of seven (7) attributes (key data values) for each record retrieved by execution of the key data value match on the primary field of the designated KDVCQC; where the display of all key data values is organized by a priority rule which groups related categories (such as music genre and music sub genre, or decade of popularity and year of release, etc.).

The degree of user-observable/user-configurable connection data in the invention is available in a magnitude that is many times that of any other known system. An embodiment can be envisioned that implements the Key Data Value Command Query Control (KDVCQC) system with a plurality of four (4) complementary KDVCQC sets, each KDVCQC set having five (5) key data value match controls, each KDVCQC retrieving and concurrently displaying a plurality of seven (7) attributes (key data values) for each record, and each KDVCQC facilitating the initial concurrent display of eight (8) record summaries (as part of a navigable list). While the default summary display of records retrieved by a Key Data Value Command Query Control for an embodiment is presented in a Microsoft® combo box (dynamic list) object that is limited to eight (8) concurrent records in order to achieve a concise and manageable view, the user's ability to browse (navigate) through a much larger set of retrieved records within the combo box reveals the broader capabilities of this query and display method.

For example, depending on the query criteria, a KDVCQC-initiated search of an integrated media catalog might return a retrieved record count summary of ten (10), one-hundred (100), two-hundred (200), five-hundred (500) or more discrete records—where each record may be displayed with seven (7) key data values (attributes) which can be arranged (sorted) and then rearranged by the user in five (five) different combinations per KDVCQC set. An embodiment that provided four (4) KDVCQC sets, each set displaying a summary of eight (8) concurrent cross-indexed records, would then initially offer approximately one-thousand one-hundred twenty (1,120) key data value combinations based on the same anchor record (assuming the query retrieved at least eight records).

Multiplying the one-thousand one-hundred twenty (1,120) combinations by a summary that displays, for example, five-hundred (500) matching records (as the user navigates the combo box list) produces a potential key data value combination on the order of five-hundred sixty-thousand (560,000) variations. For a human user, the task of viewing and comparing five-hundred sixty-thousand (560,000) data value combinations in a short period of time represents an impossible challenge. The assignment of viewing such an assortment of records can be efficiently managed by using a summary display that clearly identifies the cross-indexed attributes (key data values) of associated records in segments of eight (8) concurrent records sorted by key data match priority, where each retrieved record can serve as the starting point for a more refined record set query.

The effect of this Key Data Value Command Query Control switching system is to provide a level of “hyper-contemplation” (or random comparative analysis) unmatched in other systems because the KDVCQC system (when implemented, for example, as part of an integrated digital media management scheme) allows the user to easily determine whether he wants to directly locate (and mark for immediate or delayed playback) a known target track (record), or whether he wants to permit the numerous query search configuration options to guide him in his quest for the best selection at a given moment—even when the user is not sure what he should play, what he might want to play, or what he can play next.

To demonstrate the beneficial effects of the enhanced search power in the Key Data Value Command Query Control switching system, it might be helpful to use real-world examples. Imagine a media catalog where a key data value primary field such as Music Type (genre), the “parent” category, also has a key data value secondary field such as Music Code (sub genre), the “child” category. To visualize this method using media catalog data values, assume the Music Type is “Soul” and its associated Music Code sub classifications include “Funky”, “Motown”, “R&B”, “Doo Wop”, etc. This form of delineation can define a master music genre in the database, and populate it with various flavors of related musical sub genres.

In such an implementation, the user could query search the Music Type key data value for all “Soul” tracks in the catalog, and then further define the query search by choosing one track (record) from among the retrieved records where that track was a member, for example, of the “Motown” Music Code sub genre.

Depending on the user's decision, the query could be reshaped by applying a match filter that showed only “Motown” Music Code (sub genre) tracks, or it could be re-executed to sort and display all “Soul” tracks arranged by sub genres and beginning, for example, with all “Motown” recordings. An alpha-numeric ordered query executed in this manner might produce results such as: “7 Rooms Of Gloom” by The Four Tops, “A Place In The Sun” by Stevie Wonder, “ABC” by The Jackson 5, “Ain't No Woman (Like The One I've Got)” by The Four Tops, “Ain't Nothing Like The Real Thing” by Marvin Gaye and Tammi Terrell, and so on, where the Music Type key data value for each retrieved record is “Soul” but the Music Code key data value for each retrieved record is “Motown”—and the display summary was organized to group results by Music Code value.

Using this parent-child association query as described, other records with a Music Type key data value of “Soul”, but having a different Music Code key data value such as “R&B”, would not be visible or would not be grouped with “Motown” sub genre records. Examples of “Soul” Music Type tracks with “R&B” Music Code sub genres might include: “1-2-3” by Len Barry and “A Rockin'Good Way To Mess Around (And Fall In Love)” by Brook Benton and Dinah Washington and “After The Love Is Gone” by Earth Wind and Fire and “Baby I'm Yours” by Barbara Lewis, and so on.

Furthermore, using this parent-child association query as described, other records with a Music Code child key data value of “R&B”, but having a different Music Type parent key data value such as “Pop Vocal”, would not be visible or would not be grouped with “Motown” sub genre records. Examples of “R&B” sub genre Music Code tracks with “Pop Vocal” Music Type values might include: “Alfie” by Dionne Warwick and “Born to Lose” by Ray Charles and “Broken Hearted Melody” by Sarah Vaughn and “Easy” by The Commodores, and so on.

A common connection between all the cited recordings in these examples may be deduced. While the artist in each case can be broadly classified as a “Soul” artist, each recording is not necessarily a “Soul” music recording. “Alfie” by Dionne Warwick is a recording that, in substance and style, has more in common with “Pop Vocal” genre tunes like “All Alone Am I” by Brenda Lee or “Can't Get Used To Losing You” by Andy Williams than it does with the hit record “Brickhouse” by The Commodores (classified as “Soul”/“Funk”) or “Duke Of Earl” by Gene Chandler (“Soul”/“Doo Wop”) or “Honeychile” by Martha and the Vandellas (“Soul”/“Motown”)—recordings that exemplify three (3) different types of “Soul” music.

Another common connection between all of the cited recordings is that each record is classified with either a “Motown” or “R&B” Music Code sub genre value, and both of these sub genre child values are related to the “Soul” parent value genre. Using this system, when the DJ begins looking for “Soul” music, he can browse a broad parent category and then further refine his choices with a more precise distinction by means of a media catalog (database) key data value stored in a child category that is derived from the parent category.

Conversely, when the user views displays of records grouped by a child key data value category such as “R&B”, using the invention's disclosed Key Data Value Command Query Control (KDVCQC) system, he can instantly broaden the scope of his query search by observing the associated parent key data value “Soul” and choose to resort his summary display organized by all “Soul” records. Using the KDVCQC system, these tasks can be accomplished without executing a completely new query search. The user can decide on a music track he wants to play and immediately move that track into the play process for integrated media player objects because the display summary for the KDVCQC system permits the user to observe and select records.

One implementation of the invention uses a database engine to store records where indexed field values in relational data tables can facilitate fast and efficient record retrieval. With this system design, a user could choose from among a plurality of pre-defined primary category (key data value) command query controls, execute specific queries, rapidly retrieve summaries, reorder summaries by associated child category values or new primary category values, and even apply match filters to further shape the results—all with the click of one or two command buttons (or icons). And, any Key Data Value Command Query Control can also facilitate user-improvised query instructions in the form of whole phrase or keyword phrase search strings.

Another operational area of significant improvement provided by the invention is file insertion—e.g. loading the player and making it ready for digital file reproduction. In cases where a user is in blended-reproduction mode, he may wish to query search, select and load a plurality of media player objects. An embodiment discloses a method of achieving a very fast load of up to five (5) media players with as little as one (1) or two (2) mouse clicks. This can be accomplished using a “Speed Load Event” (SLE) system which maintains a separate list of record data and uses a plurality of place-holder program variables to rapidly move music tracks (records) on the SLE list into a group or groups of integrated media players. This method reduces the steps required to identify, specify, and transfer five (5) media assets (digital audio files, for example) into five (5) players from a range of fifteen (15) to twenty (20) steps to a range of two (2) to three (3) steps. The Speed Load system could be envisioned for use on blended-reproduction (BR) systems or discrete-reproduction (DR) devices.

Another improvement over prior art is the disclosure of a Resident Attribute Key Data Match (RAKDM) system. This design allows the user to pre-determine one specific key data value category (such as Artist name or Music Type or Year Of Release, etc.) and to use that category as a starting point for a match filter that displays all records (music tracks, for example) that may have a key data value match for the designated category. Other methods may allow the user to apply filters when searching for music tracks, however, no known system allows the user to implement the query search immediately based on the key data value of a music track (record) that is loaded in an available media player object. With the RAKDM system in the invention, the user can load a song by an artist such as Madonna in Player 1 and then, with a double mouse-click, instantly apply a key data value match filter that shows a summary of retrieved records for every Madonna song, and permit the user to load (insert) any one of those Madonna tracks into any available player. This saves time because it does not require any extra query formulations or executions by the user. The user can select a Madonna track, or using the flexibility of the KDVCQC system, decide to expand the instant query search for tracks that have a Music Type value that matches any of the Madonna tracks. For example, a user by pointing and clicking will see all Madonna tracks in the summary. This technology represents a major improvement for both professional grade and consumer grade audio devices.

The invention also improves on what had been observed as a common theme in the world of blended-reproduction audio (and video) systems; too often, the user is required to make most of his decisions based on data that is presented in a relatively small screen area. When implemented with media player object designs that only permit a small and difficult to read typeface, it can be difficult for the user to know what the program is telling him, especially if the user is attempting to operate the system on a small-format display screen. The methods disclosed in this specification provide a system for creating a plurality of media player objects that can be rendered in “over-size” (larger than common) dimensions, and yet automatically self-align in player object groups above and below an “artificial horizon” (line of demarcation) so that the user can enjoy the benefits of large display characteristics in a screen field of view that allows the key operational controls and data for six (6) players, for example, to fit into the space normally reserved for three (3) players of those dimensions. This technology is called Auto-Adjusting Field of View (AAFOV) and is disclosed in this specification.

Widespread adoption and the evolutionary refinement of portable digital music players reveals consistent evidence of operational inefficiencies. Three areas where these weaknesses can be observed are the search, load, and visual interface functions; therefore, creating a system and method to improve the user experience for these portable music devices, and to enhance the entire category of digital media asset management and reproduction, would be a highly-desired objective.

The invention disclosed in this specification comprises an intuitive switching system of pre-defined and user-modifiable query searches that can offer measurable performance benefits when compared, for example, with music player embodiments in the prior art that ask the operator to use a “thumb-wheel” design to navigate through a tedious chain of multiple branching folders (media storage containers) in search of a single music track (recording) or a list of recordings grouped by artist or genre. The thumb-wheel method found on millions of portable players can be slow, inefficient, and fatiguing for the person executing the search. In an embodiment of the invention detailed here, the Key Data Value Command Query Controls can execute a pre-determined or user-improvised query search of a linked media catalog containing a plurality of records, e.g. many thousands of records, and retrieve a summary of records, grouped by five cross-indexed key data value categories (fields) in as little as one (1) second. After viewing his original retrieved record summary, the user could then almost instantly (in about one second) choose to reorder the summary view based on a different key data value match instruction by simply activating an alternative Key Data Value Command Query Control (KDVCQC). Using the KDVCQC system on a portable player device like the Apple® iPod® or Microsoft® Zune™ would free users from the limitations of query search methods in the prior art—and that newly-realized freedom would make their search process much more intuitive and efficient.

It can also be envisioned that the KDVCQC system can be implemented without a pre-defined media catalog (database) and can work instead with Meta tag (category) information that may be associated with the user's stored digital media files. A skilled programmer could choose to work with tools in a number of object-oriented or event-driven programming environments (as well as other programming environments) to adapt the concepts of the KDVCQC switching system, and apply them to any number of consumer or professional grade media player devices.

To make the search process even more effective, with an embodiment of the invention, users can retrieve their record summaries and then choose to instantly apply an assortment of key data value match filters to further shape the results view with one mouse click (or with the touch of a stylus pen or some other pointing device or bio-feedback method). And, in a new method of executing query searches, the user can view a summary of retrieved records profiling a plurality of associated key data value categories for a plurality of records sorted by one primary category (such as Artist), and then immediately execute a query search of a new category (such as Year of Release) while choosing to maintain the database bookmark on the current anchor record—which would retrieve corresponding records that share common attributes for the new query search category, but maintain the connection with the anchor record of the original query.

Alternatively, with this invention the user can immediately execute a query search of a new category (such as Music Type) while choosing to migrate the database bookmark from the current anchor record to a new anchor record, but basing the query search on at least one common key data value of the current anchor record which would retrieve corresponding records that share common attributes for the new query search category, but expand the connection from the original anchor record to a chosen attribute (key data value) of the new or migrated anchor record.

These techniques, which are implemented in an easily-accessible series of alternating query switches, can effectively produce a summary of records that allows the user to retrieve and compare data values for many records in a parallel-branching frame of reference; this means that the user can see the natural connections between shared key data value categories of similar and dissimilar records. The user can recognize these inherent, though not always obvious connections, by viewing the summary in a hyper-contemplation mode and making record selections based not on one or two data attributes for a record, but instead based on the concurrent analysis of a plurality of key data value attributes for a plurality of records at the point where some data attributes intersect. This form of intuitive record summary analysis is not possible with previous designs in the prior art which often limit the user to a method that requires a new search each time the user wants to identify and play a new recording.

The user is free to instigate and refine query searches in either a linear or non-linear manner because the sets of KDVCQC buttons (icons) permit the user to randomly select his original and subsequent key data value match categories in any order. The KDVCQC system leverages the user's investment in each query instruction because it allows the results of each query instruction to be carried forward as part of the next query search where that query search can retrieve records based on a default (pre-defined) SQL (structured query language) instruction, or based on a combination of instructions including a pre-defined SQL instruction and additional key data match search criteria, modifications, and limitations submitted by the user.

The consumer market and its wide range of hand-held portable music players might also benefit from the methods disclosed for situational awareness logic and workflow manipulation and display techniques. An iPod®-like device can be envisioned that presents a plurality of media players in adjacent proximity on one screen. With such a device, a system of visual cues that notify the operator, for example, that Player 1 is not ready to play, but Player 2 and Player 3 are ready to play, and further enables Player 2 for one-click start, would improve productivity and reduce the opportunity for operator error. Such a multi-player system could also benefit from the situational awareness (SA) logic functions disclosed in this specification, such as workflow automation for programmed player level fade out, or a system of an auto-aligning field of view to synchronize display of key operational controls and data displays (for a plurality of media player objects) simultaneously rendered in a small display area.

When compared with the current known methods available to the professional audio enthusiast or the casual music consumer, an embodiment providing the systems and methods referenced in this specification could deliver a new benchmark for flexible, intuitive, and powerful query search methods, plus intelligent workflow and enhanced display cues. The net effect of these improvements creates a digital media asset search, load, and execution system that is more intuitively responsive, more operationally-balanced, and more speed performance-optimized than any other system in the known prior art.

### SUMMARY OF THE INVENTION

According to one aspect of the invention, a plan is provided for devising an integrated digital media catalog, management and reproduction device implemented in computer software, hardware, a combination of computer software and hardware, or on a flash memory device; or, additionally, accessed through a public or private network system such as: the Internet, an individual or entity-owned computer network, an entity-owned or managed broadcast network, or a telephone, cable, wireless transmission, or satellite system that may provide local, regional, national, international or global access. It can also be embodied as a unified electronic device incorporating one or more methods in a consumer or professional grade apparatus, where the apparatus may include a design that is able to interpret computer readable code from any computer readable medium; or the apparatus may include a functionality that deciphers instructions embedded in circuits, mechanisms, memory or other systems that may comprise the apparatus, or a system which might facilitate a connection to, or interaction with, the apparatus.

One embodiment of the invention provides a system capable of creating an intelligent “Master Container Object” that uses situational awareness (SA) logic to effectively manage program initiated or user-improvised workflow (e.g., sequential event execution) and collaborative interoperability for a plurality of digital media player assets. The Master Container Object can be referred to as a master module having instructions that are implemented in computer software, hardware or a combination of computer software and hardware.

In one embodiment, for example an implementation created using tools provided by the Microsoft® Access™ development environment, the method and system of the Master Container Object comprises a “program instruction control and management entity” that is one element of a larger program application.

An embodiment of the invention provides a system and method for creating individualized query searches of a specialized Media Catalog (e.g., a database) based a number of different user-determined multi-function search modes, activated by alternating complementary sets of Key Data Value Command Query Controls where such Key Data Value Command Query Controls can implement execution of passive (e.g., pre-defined) SQL instruction query searches, or active (e.g., user-improvised) instruction query searches, or a combination of passive and active instruction query searches.

Provided in one embodiment of the invention is a method for the creation of an Auto-Adjusting Field of View that can control the concurrent alignment display margins for groups of media player objects and their key operational elements as they are presented in equal proportions above and below a program alterable line of demarcation (or “artificial horizon”)—according to a workflow optimized pattern.

An embodiment of the invention provides a system and method to concurrently load (“Speed Load”) a plurality of digital media assets (associated with the summary of retrieved records) into a plurality of integrated media player objects with as few as one or two execution commands. In one embodiment, this system reduces the total steps (commands) required to simultaneously load five (5) discrete media players from fifteen (15) chronological commands to two (2) chronological commands.

In one embodiment, a method of creating a collection of dynamic, one-click, Resident Attribute Key Data Match (e.g., key data value) filters is provided. The Resident Attribute Key Data Match system gives the user the ability to instantly retrieve, display and access media catalog summaries (and thereby associated execution hyperlinks) for all records in a database that have a corresponding matching attribute (e.g., key data value) for a record (e.g., media file) loaded in a media player.

An embodiment of the present invention provides a media catalog which is essentially a highly cross-indexed database of hit-music recordings which has been optimized for implementation with this invention. The media catalog, in combination with the embodiment's query structure and retrieved record display summaries (managed by the Microsoft® Access™ database engine that controls an embodiment of this invention), can supply information which reveals the natural connections between dissimilar recordings.

An embodiment of the present invention provides query searches of a media catalog (database) where at least one processor is configured to execute program instructions to perform the operations of finding data in a database based upon a program or user-supplied search value, the database having a plurality of records that can be queried or match-filtered based on key values, the instructions having the capability to: retrieve at least one music data that may be of interest to the user; display retrieved music data; link corresponding digital media files associated with the retrieved data for transfer to a plurality of discrete software instantiated multi-channel media player objects.

An embodiment of the present invention provides a method of supplementing media catalog query searches with data from an individualized “music preference list”, constructed in part from an individual's pre-determined biographical information profile—where the profile can be comprised of multiple query resource threads to include delineation of record attributes such as: Title and its corresponding “universal personal music profile” (UPMP) number (a unique commercially identifiable number) for a specific record or records on user's personal profile list, or Artist value(s) of record(s) on user's personal profile list, or Music Type value(s) of record(s) on user's personal profile list, or Theme Content value(s) of record(s) on user's personal profile list, or groups of records that can be marked as excluded from user's personal profile list, and so on.

An individualized “music preference list” of an embodiment may also comprise data sources such as catalog statistics, attribute matching, editor suggestions, profile baseline, and declared preferences.

The individualized “music preference list” of an embodiment may further comprise a system and method of: creating a window based on the user's age, wherein the window corresponds to a predetermined time frame associated with a period in the user's life when he is most likely to hear, absorb, and develop an emotional connection with popular music; retrieving a plurality of music data within the window; providing the plurality of music data to the user; receiving a rating from the user for a plurality of genres, wherein the plurality of sample music data is a member of one or more the plurality of genres; and retrieving the plurality of music data based on the user's ratings for the plurality of genres.

An embodiment of the present invention provides the capability to filter query results based on a plurality of matching key data values that can be identified and retrieved for summary display by match filter command buttons implemented in the user interface and presented in adjacent proximity to the operational controls for a media player object or a plurality of media player objects.

An improved understanding of the invention can be assisted by further elaboration for some of its key methods and systems such as: the Master Container Object, the Key Data Value Command Query Control switching system, the Auto-Adjusting Field of View, the Speed Load system, the Resident Attribute Key Data Match system and its specialized Media Catalog (database).

The intelligent “Master Container Object”, in one embodiment of the invention, provides a system that uses situational awareness logic to effectively manage program initiated or user-improvised workflow (e.g., sequential event execution) and collaborative interoperability for a plurality of digital media player assets through a rules-based decision structure formulated, in part, on information from a strategic network of data points (implemented, in one embodiment, as stored data values, persistent and temporary variables, assigned or inherited properties, the product of a mathematical calculation or result of a conditional statement, program environment constants, quantifiable object properties, interpretations of user actions, and/or the aggregate relationships as may exist from time to time between various data points and program objects). In such a system, each data point can serve to facilitate the execution of certain corresponding conditional program instructions where, simply stated, the objective is to create an actionable (computer or machine readable) program that can execute task-specific functions on demand in a predictable pattern, according to a reasonable schedule, with practical, efficient, discernable results for the purpose of recommending (guiding) user actions, advancing a program procedure, blocking an unwanted action, implementing a mechanical consequence or achieving a desired effect.

A new type of compound parallel attribute query searches have been created for one embodiment of the invention. A system and method provides for creating individualized query searches of a Media Catalog (e.g., a database) based a number of different user-determined multi-function search modes, activated by alternating complementary sets of Key Data Value Command Query Controls, each individual Key Data Value Command Query Control (KDVCQC) having a name that indicates a direct association with the particular primary category (database field) used for an improvisational query search or a pre-defined query search as may be permitted or specified in the instructions attached to each discrete KDVCQC.

In one embodiment, a method is provided for creating a user interface control system comprising program or user-accessible master switching control(s) that can alternate display of, and regulate access to, a plurality of Key Data Value Command Query Control sets where each control set contains a plurality of discrete Key Data Value Command Query Controls, each individual Key Data Value Command Query Control (KDVCQC) having a name that indicates a direct association with the particular primary category (database field) used for the query search specified in the instructions attached to each discrete KDVCQC; and each Key Data Value Command Query Control is directly associated with information collected and/or stored for a specific key data value category such as Title, Artist, Music Type, Decade, Tempo, Music Code, Set Name, Playlist Name, Year of Release, Chart Position, Dance Rating, Energy Level, Content Theme, Gender of Lead Vocalist, Publisher, Catalog Number, Producer Name, etc.

One method that embodies the invention includes creating an Auto-Adjusting Field of View (e.g., practical inclusive display region boundaries) for a plurality of media player objects (including, but not limited to, instantiated media player object groups of two, three, four, five, six or more discrete players) where key command control buttons, data indicators and visual elements corresponding to the operation of each media player object can be rendered in over-sized (large) dimensions, yet remain easy for the user to comprehend and access, through the implementation of situational awareness (SA) programming logic that can control the concurrent alignment display margins for groups of media player objects as they are presented incrementally above and below a program alterable line of demarcation (or “artificial horizon”)—according to a workflow optimized pattern and within screen resolution dimensions normally reserved for a maximum of, for example, three comparably-sized media player objects. The term Auto-Adjusting Field of View (AAFOV) may be used throughout this specification to describe such a self-regulating visual object boundary system.

One method embodying the invention involves creating a compound digital media file insertion device (or “Speed Loader”) permitting the user to conduct one individualized query search, view a summary of retrieved records as may be contained in a media catalog (database) and identified by the query search—and consequently, directly proceed to concurrently load a plurality of digital media assets (associated with the summary of retrieved records) into a plurality of integrated media player objects with as few as one or two execution commands based on an individual media catalog record's designated association with a named “Speed Load” set (reproduction event list).

One embodiment of the invention provides a method of creating a collection of dynamic, one-click, Resident Attribute Key Data Match (e.g., key data value) filters which are executable by a user action on or within an instantiated media player object; each key data value filter having the ability to permit the user to instantly retrieve, display and access media catalog summaries (and thereby associated hyperlinks) for all records in a database with corresponding matching attribute (key data) values for filter-controlled categories (data fields) such as Artist, Music Type, Year of Release, and so on—for any digital media file then loaded in a specific instantiated media player. The term Resident Attribute Key Data Match (RAKDM) system may be used throughout this specification to describe such a dynamic, media player object-enabled record retrieval and filter capability. The term key data value may be used throughout this specification to mean a value, code or representation identifying an attribute or a category of media or music data.

In one embodiment, the computer software has Microsoft® Visual Basic® programming instructions combined with the Microsoft Access™ programming environment and augmented by certain SQL (Structured Query Language) commands that enable the user to identify database records associated with music recordings that may be of interest to the user, and then link to a plurality of digital media files associated with those recordings for purpose of reproduction through a system of software instantiated media players or dedicated hardware players with the required video displays and sound ports for connection to audio loudspeakers.

One embodiment of the invention provides for the implementation of integrated media player objects that are based on Microsoft® ActiveX® technology, however, an embodiment can also be envisioned where media player objects may be implemented by different types of technology from Microsoft® Corporation or other vendors including applications based on Adobe® Flash®, or open source Linux programming, or an Apple® operating system, etc. An embodiment can be envisioned where the application and interface, and possibly the media player objects, are created in an object-oriented programming language that may or may not be compatible with the Microsoft® Windows® operating system. Additionally, hardware embodiments can also be envisioned that include an implementation of this specification in a consumer or professional grade electronic appliance (apparatus).

One embodiment utilizing Microsoft® ActiveX® technology permits users to reproduce digitally stored (and possibly compressed) media assets in a variety of diverse file formats commonly associated with file extensions such as: WAV, MP3, WMA, AVI, WMV, etc. An embodiment can be envisioned that allows, by way of programming “plug-ins” (supplements) or future format developments, even more digital file formats such as AAC, Vorbis®, MP2, AIFF, MPEG-4, MOV and others including various lossless formats that may or may not be controlled or developed by Microsoft® Corporation and formats that may prove to be improvements on existing technology. An embodiment can also be envisioned which implements media players (or media player objects) that can interact with media assets that may be protected by a form of DRM (digital rights management).

It is also easy to imagine an embodiment that incorporates major concepts of this invention in a system that integrates with, or seeks to manage, a plurality of audio or video sources including analog reproduction devices. After reading about the workflow process that is controlled in part by situational awareness (SA) logic and the multi-mode query switching, the reviewer might understand that SA logic and search queries in this invention might be adapted and extended to automated or semi-automated mixing consoles (used for blending audio or video sources) that can determine and signal, for example, an anticipated audio event to the operator, and further facilitate programmed or spontaneous user actions, and accept or assist audio or video reproduction from a combination of digital or analog sources.

It would not be difficult to imagine an embodiment where certain query methods, and a delineated system of situational awareness logic, as detailed in this specification could be adapted to assist the operator of a lighting management console (or program) within an application that might include tasks such as querying a database to identify pre-defined (and database-named) effects patterns (descriptions of light appliances and their applied voltage levels and timing), and visually guiding the operator through a series of various lighting effect events as he executes commands to implement such effects according to a beneficial schedule.

Other embodiments are certainly possible in situations where software application developers for markets outside the scope of digital media asset management might wish to construct new programs or improve existing programs using one or more technology designs that are detailed in this specification. One can envision, for example, that the unified query control switching mechanism, visual workflow indicators, or method of the master container object (with situational awareness logic) might be beneficial to developers and designers of applications such as: CRM, contact, calendar, desktop and Web search products; also, medical records, drug interaction tables and news digest database programs; and job search, automobile search, OEM parts replacement, human resource, match-maker, real estate database, and computer learning programs; also, warehouse operations, data-mining, retail inventory control, and applications for online auction sites (such as EBay.com) or Internet-based retailers (such as Amazon.com) that dynamically assess customer browsing in order to direct customer attention to a list of commodities based on individualized queries; and so on. This invention can also be envisioned as key component of applications or systems that perform intelligence analysis, military assessments, weather system analysis and historical climate modeling, law enforcement profiling, and aviation communications. For any of these cited applications, and a foreseeable number of others, it can be vital, for example, to have the ability to quickly execute individualized query searches that retrieve and display a summary of records in a manner that allows the user to distinguish the natural associations (connections) made apparent by comparing the retrieved key data values (attributes) for a plurality of records; especially in cases where, without the methods set forth in this invention, the natural associations that may exist between—what can initially appear as superficially dissimilar—database records may not always be plainly obvious and available to the skilled or unskilled user in a concise display and practical time frame.

For the sake of brevity, this specification and accompanying drawings may sometimes refer to “key data value controls” or “command query controls”. These terms are shortened names for “Key Data Value Command Query Controls”. The terms “key data value control sets” or “command query control sets” are concise ways of expressing the term “Key Data Value Command Query Control sets”.

One search method embodied in the invention is pre-defined queries (assigned to Key Data Value Command Query Control buttons or icons which can be accessed in complementary sets by an interface activation switch) where the pre-defined queries are structured to retrieve records (in a passive mode without user intervention) that match a key data value for a record in a database and then, while optionally maintaining the database record pointer on the anchor record associated with one set of query results, quickly retrieve a descendant result set from a new query which is derived by matching at least one key data value from the original anchor record of the preceding query with at least one key data value that matches a record or a plurality of records from the subsequent query. With this method the original anchor can be maintained through subsequent queries unless the user instructs the program to bookmark a new anchor record, and the user can submit the “allow change in anchor record” instructions by means of an interface control object such as a command button, check box or icon.

Another search method embodied in the invention is user-improvised queries (assigned to Key Data Value Command Query Control buttons or icons which can be accessed in complementary sets by an interface activation switch) where the user-improvised queries are structured to accept ad hoc (spontaneous) instructions in the form of a text string, and then to retrieve records (in active mode with user intervention) that match a key data value for the (field) category (such as Title, Artist, Music Type, etc.) associated with the user's submitted instruction; and then setting the database pointer to a new anchor record in the new summary list, or optionally maintaining the database record pointer on an anchor record associated with the results of a preceding query in cases where that same record is also retrieved by instructions submitted in the user's improvised descendant query.

Yet another search method embodied in the invention is pre-defined queries or user-improvised queries (assigned to, and sharing, the same Key Data Value Command Query Control buttons or icons which can be accessed in complementary sets by an interface activation switch) where the pre-defined queries are structured (without user intervention) to retrieve records that match a key data value for a record in a database and then, while optionally maintaining the database record pointer on the anchor record associated with one set of query results, quickly retrieve a descendant result set which is derived by matching at least one key data value from the original anchor record of the preceding query with at least one key data value that matches a record or a plurality of records from the subsequent query; additionally, one embodiment may provide for cases where a user chooses to submit an improvised fixed-string (whole) value or improvised keyword phrase (partial) value character query instruction (both types actively supplementing the default operation for the associated Key Data Value Command Query Control), where the executed query can retrieve records based on a combination of the pre-defined instructions (for example, implemented with a SQL query statement) which can execute first, followed by search parameters dictated by the composition of the user's ad hoc (spontaneous) instruction; and further, in some cases, either method of pre-defined queries, or user-improvised queries (both initiated by the same command query control button), the difference determined by the user's decision to submit a text string instruction thereby changing a pre-defined passive query to an active query, can offer the user the ability to shape query results by applied filters and other modifications (engaged via interface commands) including the capability to filter query results based on a plurality of matching key data values and whether or not a record or plurality of records are contained in (or excluded from) an individual's pre-determined (stored or imported) biographical information profile—where the profile can be comprised of multiple query resource threads to include delineation of record attributes like: Title and its acknowledged “universal personal music profile” (UPMP) number (a unique commercially identifiable number) for a specific record or records on user's personal profile list, or Music Type value(s) of record(s) on user's personal profile list, or Theme Content value(s) of record(s) on user's personal profile list, or groups of records that can be marked as excluded from user's personal profile list, and so on.

One embodiment of the invention also provides software instantiation (creation) of groups of, for example, two, three, four, five, six (or more) media player objects (commonly referred to as “media players” in many applications), which are directly integrated with the passive-active multi-mode Key Data Value Command Query Controls used to provide individualized on-demand query searches of a Media Catalog (database), which may include data referencing music, video and film recordings. In one embodiment, the Media Catalog may be stored on a local computer, networked computer, external hard drive, flash memory device, Internet-enabled telephone, small-format computing device, retail music “kiosk” apparatus or Internet data server, or other device; and the catalog may be accessed from a local computer, networked computer, external hard drive, flash memory device, Internet-enabled telephone or other telephone network-enabled device, small-format computing device, retail music “kiosk” apparatus, wireless device, Internet data server, or other device.

One embodiment of the invention also stipulates that each discrete media player object (in each media player object group) shall be capable of providing digital media file reproduction as an independent sound and video source (for an extemporized selection of imported digital media files, but primarily for digital media files as may be associated with a linked Media Catalog), or capable of providing digital media file reproduction as an independent member of a plurality of media player objects which can be manipulated to collaborate in order to achieve a beneficial degree of partially coincidental (cross-layered) content presentation, often referred to in music or audio presentations as a “segue” and in video and film presentations as a “cross fade”.

Additionally, one embodiment of the invention also makes available a plurality of independent software instantiated media player objects collectively managed in a Master Container Object (MCO) for the purpose of effectively producing “situational awareness” (SA) logic, where the term situational awareness logic is defined, for this invention, as a system that programmatically creates an artificial intelligence design structure that can be characterized as an elaborate context-sensitive compilation of data points (implemented, in one embodiment, as stored data values, persistent and temporary variables, assigned or inherited properties, the product of a mathematical calculation, program environment constants, quantifiable object properties, and/or the aggregate relationships as may exist from time to time between various data points); each data point facilitating the execution of certain corresponding conditional program instructions that measure and evaluate a plurality of data points, object properties, and event states—according to a standard of application-specific rules based on each objects' relationship to and interaction with other objects, properties and events, and each objects' relationship to and interaction with data points maintained within the Master Container Object itself, and also each objects' relationship to and interaction with a quantifiable certainty of procedure timing, programming environment constants and variables, third-party code libraries (such as Microsoft® Scripting Runtime and Microsoft ActiveX® controls), properties, methods and requirements of the operating system, and finally, each objects' relationship to and interaction with and interpretations of user (operator) actions—where the objective of such a SA system is to create an actionable (computer or machine readable) program that can execute task-specific functions on demand in a predictable pattern, according to a reasonable schedule, with practical, efficient, discernable results for the purpose of recommending (guiding) user actions, advancing a program procedure, blocking an unwanted action, implementing a mechanical consequence or achieving a desired effect.

In one embodiment, the media player objects instantiated in the Master Container Object may, individually: have no programmed or innate awareness of other media player objects and other media player object states; have no programmed or innate awareness of any useful elements that comprise a collection of media player object sets that facilitate, in part, a network of logic waypoints (comprised of data points and other object and event properties as described in this specification); have no native awareness of programmed routines in the Master Container Object; have no programmed or innate awareness of any other entity, event or property state, but, in the invention, can be manipulated by situational awareness (SA) logic in the Master Container Object to block or execute task-specific functions in a collaborative and predictable pattern with practical discernable results that can appear and imply (from the perspective of the user and the actions of the application) as if the media player objects do have a program actionable awareness of other player object states and player object sets, other entities and event states, user actions—and further, a program actionable awareness of the potential effect and interaction of those states and associated events, properties and entities on program workflow (event execution) and other objects instantiated within, or accessed by, the Master Container Object.

It should further be noted that, according to an embodiment of the invention, the Master Container Object is in large part comprised of computer instructions (composed for this invention and formulated from the acceptable conventions of universally adopted programming language environments such as Microsoft® Visual Basic® for Applications, Microsoft Access™, SQL, or other object-oriented systems) which by deliberate design, enable the Master Container Object to perform functions with a degree of situational awareness logic as may be outlined in the following paragraphs.

In one embodiment, the Master Container Object is connected to, and controls the presentation of, the user interface with specific regard to the visual display of the media player objects, Key Data Value Command Query Controls and all associated command buttons, icons, visual guide elements and data indicators.

In one embodiment, the Master Container Object may be programmed (with or without user interaction) to prevent certain behaviors such as: load player, start player, stop player, pause player, alter speed, mute sound output, load pre-determined audio level and fade audio level, etc.—based on a set of programming rules which will seek to block the program or the user from executing a detrimental action during a presentation.

In one embodiment, the Master Container Object is programmed (with or without user interaction) to execute certain behaviors such as: load player, start player, stop player, pause player, alter speed, mute sound output, load pre-determined audio level and fade audio level, etc.—based on a set of programming rules which will seek to advance desired workflow (event execution) sequence and insure the coherent interoperability of media player objects for a practical audio or video presentation.

In one embodiment, the Master Container Object has the ability to instantiate and systematically define a plurality of objects such as Key Data Value Command Query Controls, other command objects, switches and buttons, visual guide elements, message labels, data displays and conditional behavior procedures, where each of these objects is capable of functioning in at least one role as a data assessment entity, or as a referential placeholder, or as a dynamic variable, or as a data indicator, or as a command button with such objects collectively comprising, in correlation with the program measurable properties and event states of instantiated media player objects—a network of logic waypoints—or data points—e.g., carefully delineated and systematically plotted objects and object states for which a programming procedure can evaluate, calculate, and then execute, or recommend the user execute, at least one, and potentially many, programmatic or material operations in a practical and efficient manner for the purpose of advancing a program procedure, blocking an unwanted action or achieving a desired effect.

In one embodiment, the Master Container Object has the ability to ascertain, monitor in real time, and keep a record of, the natural states of each discrete player in relation to the state and behaviors of a plurality of other independent, collaborating or merged player objects (and other elements as may comprise a media player object set).

In one embodiment, the Master Container Object has the ability—in a dynamic ever-changing presentation environment—to programmatically determine and visually differentiate various player states and thereby suggest (e.g. guide by means of visual cues) a practical and orderly execution of sequential event actions (workflow) to the user.

### BRIEF DESCRIPTION OF THE DRAWINGS

Further aspects of the invention and their advantages can be discerned in the following detailed description, in which like characters denote like parts and in which:

FIGS. 1A-1 through 1A-5, when viewed together, constitute a high-level diagram depicting the key elements of the present invention according to one embodiment.

FIG. 1A-1 depicts the Media Catalog which can be queried by the invention's programming instructions.

FIG. 1A-2 depicts the Master Container Object which is illustrated with its internal objects in one embodiment: the Key Data Value Command Query Control Set Switching System, Auto-Adjusting Field of View System, the Media Player Object Sets, and the Resident Attribute Key Data Match System.

FIG. 1A-3 depicts the Speed Load Set Names Data Table.

FIG. 1A-4 depicts the Individual's Biographical Profile Data Table.

FIG. 1A-5 depicts the Speed Load Event Manager.

FIG. 1B is a flowchart depicting a method for retrieving database records and passing their associated digital media files to a media player object, according to one embodiment of the present invention.

FIG. 1C is a flowchart depicting a method of query execution as determined by the user's actions (or lack of actions) in the Text Input Control activated by the Key Data Value Command Query Control.

FIG. 1D depicts hardware and software for one embodiment comprised of a computer-readable storage medium having at least one memory with program instructions, at least one processor configured to execute the program instructions to perform the operations of finding data in a database based upon a user-supplied search value, a keyboard configured to input user instructions to the processor, a display unit, a Master Container Object residing on a computer hard drive, a USB Flash reader device and a Media Catalog residing on a Flash memory stick (device).

FIG. 2 is an organizational flowchart depicting a method of enabling unified sets of Key Data Value Command Query Controls, which are part of the Key Data Value Command Query Control Sets, and each Key Data Value Command Query Control Set has been created as part of the Key Data Value Command Query Control Set Switching System.

FIG. 3 is an organizational flowchart depicting a method of enabling unified sets of command query controls grouped by fixed-string queries.

FIG. 4 is an organizational flowchart depicting a method of enabling unified sets of command query controls grouped by keyword queries.

FIG. 5A is an organizational flowchart, for a plurality of media player objects, depicting a method for moving digital media file load (insertion) instructions (a required prerequisite for file reproduction) through a system of logic waypoints (designed to perform the functions of data assessment, referential placeholders and command buttons) culminating in a designated media player object.

FIG. 5B-1 is an organizational diagram that illustrates, in one embodiment, the various elements that may comprise an enhanced standard-order construction “media player object set” (MPOS) design where a discrete Microsoft® ActiveX® Media Player Control object—which has no innate awareness (knowledge) of, or intrinsic collaborative capability with, other discrete media player objects—is augmented by a plurality of media player object set elements which can be manipulated by program instructions to assist in the facilitation of a dependable degree of situational awareness (SA) logic for the purpose of a creating a practical collaboration between discrete media player objects.

FIG. 5B-2 is an organizational diagram that depicts a more detailed view of a media player object element known as the Track Timing Display (TTD) which is part of the MPOS in FIG. 5B-1.

FIG. 5C-1 is an organizational diagram that illustrates, in one embodiment, the various elements that may comprise an enhanced inverted-order construction “media player object set” (MPOS) design where a discrete Microsoft® ActiveX® Media Player Control object—which has no innate awareness (knowledge) of, or intrinsic collaborative capability with, other discrete media player objects—is augmented by a plurality of media player object set elements which can be manipulated by program instructions to assist in the facilitation of a dependable degree of situational awareness (SA) logic for the purpose of a creating a practical collaboration between discrete media player objects.

FIG. 5C-2 is an organizational diagram that depicts a more detailed view of a media player object element known as the Track Timing Display (TTD) which is part of the MPOS in FIG. 5C-1.

FIG. 5D is an organizational diagram that illustrates in greater detail the various elements that may comprise an enhanced “media player object set” design where such components, according to one embodiment, can be used to visually guide the user, or to manipulate player performance, or to serve as reference points for data assessments performed during the execution of a programming procedure.

FIGS. 5E1 through 5E6 are organizational diagrams that illustrate in expanded detail the various elements that may comprise a Microsoft® ActiveX® Control—or Microsoft® ActiveX® Windows Media® Player control object version 6.4—which is used in an embodiment as the core media player object.

FIG. 5E-1 depicts the key components that in one embodiment may comprise a Microsoft® ActiveX® Windows Media® Player control object version 6.4 for digital player 1.

FIG. 5E-2 depicts the key components that in one embodiment may comprise a Microsoft® ActiveX® Windows Media® Player control object version 6.4 for digital player 2.

FIG. 5E-3 depicts the key components that in one embodiment may comprise a Microsoft® ActiveX® Windows Media® Player control object version 6.4 for digital player 3.

FIG. 5E-4 depicts the key components that in one embodiment may comprise a Microsoft® ActiveX® Windows Media® Player control object version 6.4 for digital player 4.

FIG. 5E-5 depicts the key components that in one embodiment may comprise a Microsoft® ActiveX® Windows Media® Player control object version 6.4 for digital player 5.

FIG. 5E-6 depicts the key components that in one embodiment may comprise a Microsoft® ActiveX® Windows Media® Player control object version 6.4 for digital player 6.

FIG. 6A is an organizational chart illustrating a plurality of query modification controls, query filter controls, command query control set objects, data points, media player object set elements and waypoint value displays contained in a Master Container Object.

FIG. 6B is an organizational chart illustrating a plurality of query filter controls contained in a Master Container Object.

FIG. 7A is a flowchart depicting a method for retrieving database records and passing their associated digital media files to a specific media player object, according to one embodiment of the present invention. FIG. 7A illustrates the same process as FIG. 1B, however, FIG. 7A depicts the process using character numbers that correspond with a specific media player object set, unlike FIG. 1B which is a generic illustration for all media player object sets in an embodiment of the invention.

FIG. 7B through 7D are companions to the FIG. 7A flowchart. Using screen captures from an embodiment, FIG. 7B is a flowchart that uses software screen captures to depict the first four steps of the search and load process that begins by opening the Master Container Object to its default search by Title Key Data Value Command Query Control.

FIG. 7C picks up where FIG. 7B ends and FIG. 7C is a flowchart that uses software screen captures to depict steps five through seven of the search and load process.

FIG. 7D picks up where FIG. 7C ends and FIG. 7D is a flowchart that uses software screen captures to depict step eight of the search and load process.

FIG. 8A is a flowchart that uses computer program screen images to illustrate the linear process of retrieving records and summary views based on a sustained anchor record that is used as a baseline to generate descendant queries.

FIG. 8B is a flowchart that uses computer program screen images to illustrate the linear process of retrieving records and summary views based on a sustained anchor record that is used as a baseline to generate descendant queries. FIG. 8B flows from the point where FIG. 8A concluded.

FIG. 9A is a flowchart that (begins at the point where FIG. 8B concluded and) uses computer program screen images to illustrate the linear and non-linear process of retrieving records and summary views based on a sustained anchor record that is used as a baseline to generate descendant queries.

FIG. 9B is a flowchart that uses computer program screen images to illustrate the linear process of retrieving records and summary views based on a sustained anchor record that is used as a baseline to generate descendant queries. FIG. 9B flows from the point where FIG. 9A concluded.

FIG. 10A is a flowchart that (begins at the point where FIG. 9B concluded and) uses computer program screen images to illustrate the linear and non-linear process of retrieving records and summary views based on a sustained anchor record that is used as a baseline to generate descendant queries, or records and summary views based on a migrated (new) anchor record derived from an improvised user query instruction.

FIG. 10B is a flowchart that (begins at the point where FIG. 10A concluded and) uses computer program screen images to illustrate the linear and non-linear process of retrieving records and summary views based on a sustained anchor record that is used as a baseline to generate descendant queries, or records and summary views based on a migrated (new) anchor record derived from an improvised user query instruction.

FIG. 11A is a flowchart that (begins at the point where FIG. 10B concluded and) uses computer program screen images to illustrate the linear and non-linear process of retrieving records and summary views based on a sustained anchor record that is used as a baseline to generate descendant queries, or records and summary views based on a migrated (new) anchor record derived from an improvised user keyword query instruction.

FIG. 11B is a flowchart that (begins at the point where FIG. 11A concluded and) uses computer program screen images to illustrate the linear and non-linear process of retrieving records and summary views based on a sustained anchor record that is used as a baseline to generate descendant queries, or records and summary views based on a migrated (new) anchor record derived from an improvised user keyword query instruction.

FIG. 12A illustrates one exemplary embodiment of a Master Container Object (MCO) interface with three instantiated media player objects, each having a plurality of controls and associated display objects.

FIG. 12B continues the MCO illustration started with FIG. 12A; i.e. FIG. 12B further depicts one exemplary embodiment of a Master Container Object interface with three instantiated media player objects (displayed in adjacent proximity), each having a plurality of controls and associated display objects.

FIG. 13A illustrates one exemplary embodiment of a Master Container Object interface with three instantiated media player objects, each having a plurality of controls and associated display objects.

FIG. 13B illustrates one exemplary embodiment of a Master Container Object interface with three instantiated media player objects, each having a plurality of controls and associated display objects.

FIG. 14A illustrates one exemplary embodiment of a Master Container Object interface with six instantiated media player objects, each media player object comprising part of a media player object group concurrently displayed in a self-adjusting variable field of view that optimizes the screen alignment of key commands and their associated data indicators within limited dimensions to facilitate efficient event workflow.

FIG. 14B illustrates one exemplary embodiment of a Master Container Object interface with six instantiated media player objects, each media player object comprising part of a media player object group concurrently displayed in a self-adjusting variable field of view that optimizes the screen alignment of key commands and their associated data indicators within limited dimensions to facilitate efficient event workflow.

FIG. 15 illustrates an exemplary programming query instruction in one embodiment which can be attached to the click event of a Key Data Value Command Query Control where the queries are designed to execute in a default manner without user modification and thereby permit retrieval of a summary of records based on a propagated (sustained) anchor record used as a baseline for subsequent queries.

FIG. 16 illustrates an exemplary programming query instruction in one embodiment which can be attached to the click event of a Key Data Value Command Query Control where the queries are designed to execute first in a default manner without user modification, and then in a manner that accepts a user-improvised instruction, and thereby permit retrieval of a summary of records based on a propagated (sustained) anchor record, or a summary of records based on a new (migrated) anchor record which may consequently be used as a baseline for subsequent queries.

FIG. 17 is a flowchart depicting a method for choosing between various sets of complementary key data value command query category (field) controls, according to one embodiment of the present invention.

FIG. 18 is a flowchart depicting a method for choosing between three operational modes of one key data value command query category (field) control, according to one embodiment of the present invention.

FIG. 19 is a flowchart depicting a method for selecting from a plurality of key data value command query category (field) controls and then choosing between two operational modes which can produce different summary views, according to one embodiment of the present invention.

FIG. 20 is a flowchart depicting a method for selecting from a plurality of key data value command query category (field) controls and then choosing between two operational modes which can produce different summary views, according to one embodiment of the present invention.

FIG. 21 is a flowchart (that begins a series of descendant queries) depicting a method for selecting from a plurality of key data value command query category (field) controls and then choosing between two operational modes which can produce different summary views, according to one embodiment of the present invention.

FIG. 22 is a flowchart (that begins at the point where FIG. 21 concluded) depicting a method for selecting from a plurality of key data value command query category (field) controls and then choosing between two operational modes which can produce different summary views and different anchor records, according to one embodiment of the present invention.

FIG. 23 is a flowchart (that begins at the point where FIG. 22 concluded) depicting a method for selecting from a plurality of key data value command query category (field) controls and then choosing between two operational modes which can produce different summary views and different anchor records, according to one embodiment of the present invention.

FIG. 24 is a flowchart (that begins at the point where FIG. 23 concluded) depicting a method for selecting from a plurality of key data value command query category (field) controls and then choosing between two operational modes which can produce different summary views and different anchor records, according to one embodiment of the present invention.

FIG. 25 is a flowchart (that begins at the point where FIG. 24 concluded) depicting a method for selecting from a plurality of key data value command query category (field) controls and then choosing between two operational modes which can produce different summary views and different anchor records, according to one embodiment of the present invention.

FIG. 26 is a flowchart (that begins at the point where FIG. 25 concluded) depicting a method for selecting from a plurality of key data value command query category (field) controls and then choosing between two operational modes which can produce different summary views and different anchor records, according to one embodiment of the present invention.

FIG. 27 is a flowchart (that begins at the point where FIG. 26 concluded) depicting a method for selecting from a plurality of key data value command query category (field) controls and then choosing between three operational modes which can produce different summary views and different anchor records, according to one embodiment of the present invention.

FIG. 28 is a flowchart (that begins at the point where FIG. 26 concluded) depicting a method for selecting from a plurality of key data value command query category (field) controls and then choosing between three operational modes which can produce different summary views and different anchor records, according to one embodiment of the present invention.

FIG. 29 illustrates different views of summary lists (delineating specific record sets) that have been retrieved from the music catalog (database) as a result of using various combinations of default (pre-programmed) and user-improvised query instructions.

FIG. 30 illustrates different views of summary lists (delineating specific record sets) that have been retrieved from the music catalog (database) as a result of using various combinations of default (pre-programmed) and user-improvised query instructions.

FIG. 31 illustrates different views of summary lists (delineating specific record sets) that have been retrieved from the music catalog (database) as a result of using various combinations of default (pre-programmed), user-improvised, and filter modified query instructions.

FIG. 32 illustrates different views of summary lists (delineating specific record sets) that have been retrieved from the music catalog (database) as a result of using various combinations of default (pre-programmed), user-improvised, and filter modified query instructions.

FIG. 33 illustrates different views of key data values (associated with specific anchor records) that have been retrieved from the music catalog (database) as a result of using various combinations of default (pre-programmed based on command query control buttons), user-improvised, and filter modified query instructions.

FIG. 34A illustrates how an event state known as “focus” can be used to determine how a specific object can be directed to be the subject of attention during the execution of a programming procedure, and defines the concept of focus according to one embodiment.

FIG. 34B illustrates how an event state known as “focus” can be used to manipulate various object states and properties during the execution of a programming procedure, and further defines the concept of focus according to one embodiment.

FIG. 35 is a flowchart depicting two visual methods the user may invoke to determine the availability of a plurality of media player objects (for purpose of loading a digital media file), according to one embodiment of the present invention.

FIG. 36 is a flowchart (that begins at the point where FIG. 35 concluded) depicting the process of loading a digital file into a specific media player object when the user click-activates the requisite series of file load waypoint commands where, in turn, each command advances the process and changes the color and caption properties for associated objects.

FIG. 37 is a flowchart depicting a method for querying and retrieving a specific database record from a media catalog (database) and passing its associated attribute information to the Speed Load Manager, and from there into a separate database table that catalogs named Speed Load sets; once a title is associated with a Speed Load Set Name (unique list), it can be readied for further transfer to a Speed Load Set Name staging control, which will next serve the title to the appropriate Speed Load Set Name variable position—which will eventually facilitate the transfer of the title (record) to a holding variable known as the Media Player Speed Load value.

FIG. 38 is a flowchart that begins where FIG. 37 ended and follows the designated record (title) associated with the Speed Load Set Name staging control through a process that assigns the record to a specific Speed Load Set Name variable position.

FIG. 39A is a flowchart that begins a more detailed explanation of the process used to place a retrieved media catalog record (title) into the Speed Load Set Name staging control and through a process that assigns the record to a specific Speed Load Set Name variable position so that, eventually, the stored record can be loaded into a media player object as part of one batch load process command.

FIG. 39B-1 is a flowchart that continues a detailed explanation of the process used to convert database information for a retrieved media catalog record, that is on a specific Speed Load Set Name event list, into a hyperlink value that can be identified by the system, loaded, and then made ready to play in a media player object, through the use of a system of variable data value placeholder exchanges.

FIG. 39B-2 is a diagram of Media Player Object Sets as used in a calculation for variable transfer programming. FIG. 39B-2 is a companion to FIG. 39B-1.

FIG. 39C is a flowchart that illustrates in greater detail the (Speed Load) Transfer Set Event command introduced in FIG. 39B-1. FIG. 39C examines the step by step process in the first part of a nested procedure that converts a Media Catalog stored hyperlink file path to a load command for a specific media player object.

FIG. 40 is a flowchart depicting the process of concurrently loading a plurality of digital files into a plurality of media player objects with one command when the user elects to bypass the default file load process and choose from a summary of pre-defined “speed load” record sets; it also shows the resolution of the speed load process initiated in FIG. 37 and further explained in FIGS. 38, 39A, 39B-1 and 39B-2.

FIG. 41 is a software screen image depicting the Resident Attribute Key Data Match control section accessible from the user interface.

FIG. 42 is a flowchart depicting the process of selecting a Resident Attribute Key Data Match filter button and its consequences.

FIG. 43A-1 is a software screen image depicting the process of selecting the Resident Attribute Key Data Match filter Artist button in the interface.

FIG. 43A-2 is a software screen image depicting the process of applying the Resident Attribute Key Data Match filter by double-clicking the Resident Attribute Key Data Match indicator from within the media player object.

FIG. 43B is a software screen image depicting the summary of retrieved records after the user has applied a specific Resident Attribute Key Data Match filter button.

FIG. 44 is a software screen image depicting the start of a situational awareness Master Container Object workflow sequence where three instantiated media player objects are ready to play with “focus” set on Player 1.

FIG. 45 is a software screen image depicting the step by step continuation of a situational awareness Master Container Object workflow sequence with “focus” set on Player 2.

FIG. 46 is a software screen image depicting the step by step continuation of a situational awareness Master Container Object workflow sequence with “focus” set on Player 3.

FIG. 47 is a software screen image depicting the step by step continuation of a situational awareness Master Container Object workflow sequence where Player 3 is playing and no other players are loaded.

FIG. 48 is a software screen image depicting the step by step continuation of a situational awareness Master Container Object workflow sequence where the user has selected a different Key Data Value Command Query Control (KDVCQC) button and opened the summary of records.

FIG. 49A is a software screen image depicting the step by step continuation of a situational awareness Master Container Object workflow sequence where Player 3 is playing and the user has received an error message on a blocked attempt to overwrite a media file in Player 3.

FIG. 49B is a software screen image depicting the step by step continuation of a situational awareness Master Container Object workflow sequence where Player 3 is playing and the user has successfully loaded a media file in Player 2.

FIG. 50A is an illustration depicting the dimensions of a typical Master Container Object (MCO) interface implemented in a computer resolution of 1024×768.

FIG. 50B is an illustration depicting the dimensions of two media player object groups provided to indicate their size in relation to the MCO.

FIG. 51A is an illustration depicting the dimensions of one media player object group as aligned within the Master Container Object “field of view” where Media Player Object Group 1 is shown above the “artificial horizon” line and the operational elements of Media Player Object Group 2 are out of view below the “artificial horizon” line.

FIG. 51B is an illustration depicting the dimensions of two media player object groups as aligned within the Master Container Object “field of view” where Media Player Object Group 1 is shown above the “artificial horizon” line and Media Player Object Group 2 is shown below the “artificial horizon” line.

FIG. 52 is a companion illustration to FIG. 51A and FIG. 52 depicts the dimensions of two media player object groups within the Master Container Object “field of view” where Media Player Object Group 1 is shown above the “artificial horizon” line and parts of Media Player Object Group 2 are shown below the “artificial horizon” line and continue in a background layer view below the outside dimensions of the MCO.

FIG. 53 is a companion illustration to FIG. 51B and FIG. 53 depicts the dimensions of two media player object groups within the Master Container Object “field of view” where parts of Media Player Object Group 1 are shown above the “artificial horizon” line and parts of Media Player Object Group 2 (as aligned by the hidden Alignment Tab 2 program object) are shown below the “artificial horizon” line.

FIG. 54 is a companion illustration to FIG. 52 and FIG. 54 depicts the dimensions of one media player object group (as aligned by the hidden Alignment Tab 1 program object) within the Master Container Object “field of view” where Media Player Object Group 1 is shown above the “artificial horizon” line and other command elements of the MCO such as the KDVCQC switches and the match attribute filter buttons are visible above and below the field of view.

FIG. 55 is a companion illustration to FIG. 53 and FIG. 55 depicts the dimensions of two media player object groups within the Master Container Object “field of view” where parts of Media Player Object Group 1 are shown above the “artificial horizon” line and parts of Media Player Object Group 2 are shown below the “artificial horizon” line while at the same time other command elements of the MCO (such as the KDVCQC switches and the match attribute filter buttons) are visible above and below the field of view.

### DETAILED DESCRIPTION

Before beginning an in-depth inspection of flowchart depictions and other drawings, it must be noted that the expression “focus”, as used throughout this specification, represents an important concept, and is informally defined as a programming event or object state that, in simple terms, can be described as a method to specify that a certain program instantiated object is the entity that has been stipulated, at a given moment, as the subject of program attention (as opposed to other program instantiated entities that are not the subject of program attention at that given moment). The concept of focus was not created by this invention, but instead by a program development environment (such as Microsoft® Access) used to construct one embodiment of this invention.

Why is the concept of focus significant? In the world of a computer programmer, it can be most vital have the ability to inform a program procedure that you want to perform a function or operation on a certain object (entity), and focus allows the programmer to instruct the program precisely which object (from among a plurality of objects) that he wants to work with at a given moment in time. That means focus can be an important data point (reference marker) used to measure values, set coordinates and enable the computation of program instructions.

For example, a simple programming procedure might be constructed with a phrase (expressed here in non-technical terms) such as: IF Object X is the subject of focus, THEN Object A is visible AND Object B is not visible AND Object C is not visible AND the caption for Object A equals “Play Now” ELSE (however) IF Object Y is the subject of focus, THEN Object A is not visible AND Object B is visible AND Object C is not visible AND the caption for Object B equals “Play Now”, etc. Because focus plays a role in this invention, especially with respect to a method of devising situational awareness logic, focus is explained in greater detail later in this specification.

The invention provides individualized query searches of a Media Catalog (database) based on a number of different user-determined multi-function search modes, activated by alternating complementary sets of Key Data Value Command Query Controls, each individual Key Data Value Command Query Control (KDVCQC) having a name that indicates a direct association with the particular primary category (database field) used for the query search specified in the instructions attached to each discrete KDVCQC. For example, KDVCQC names such as Title, Artist, Music Type, Decade, Tempo, Set Name, Chart Rank, Theme Content, Publisher, Gender of Lead Vocalist, etc. will activate a query (and facilitate a summary display of retrieved records) based on a primary data evaluation of corresponding categories such as Title, Artist, Music Type, Decade, Tempo, Set Name, Chart Rank, Theme Content, Publisher, Gender of Lead Vocalist, etc. in a queried database. The query instructions associated with each KDVCQC will also retrieve record summaries that concurrently present key data values for a plurality of categories (associated with each retrieved record) which the programmer specifies as may be statistically or historically relevant to the primary data evaluation category with the objective of demonstrating the natural connections between similar and dissimilar database records.

Each Key Data Value Command Query Control can order (and thereby facilitate display of) retrieved record summaries in a manner that gives sorting priority to its primary data category while also showing key data values for additional categories in a manner that will allow the user to easily compare retrieved values (in horizontal and vertical planes). In one embodiment, the horizontal display may be offered from screen left to screen right with a plurality of key data values, for each discrete retrieved record, observed in a list presented beneath key data value column headings; and the vertical presentation may allow a user-adjustable view of an extended list, permitting the user to observe a plurality of key data values associated with each retrieved record while at the same time viewing a plurality of those retrieved records in a larger context, resulting in a summary view that presents concise organized portions of those retrieved records.

Each Key Data Value Command Query Control (KDVCQC) can be a member of a KDVCQC set (collection) comprised of a plurality of Key Data Value Command Query Controls. According to one embodiment, all such KDVCQC objects are designed with pre-defined default query search instructions, but each control can also facilitate a method that allows the user to submit improvised (meaning ad hoc or spontaneous) query instructions whether formulated as fixed-string (whole word value) or keyword (partial value) instructions, according to the user's direction. Using these KDVCQC objects—which in some cases are designed to permit the query to be further shaped by the application of data filters, exclusionary statements, importation and incorporation of parameters stored in individualized biographical query profiles, importation and incorporation of parameters stored in music publisher, vendor sales or historical record databases, and other query modifications—an embodiment of the invention can offer the user ease of manipulation and a certainty of action by including query search variations such as those detailed in the following paragraphs.

In one embodiment, the computer software has Microsoft® Visual Basic® programming instructions combined with the Microsoft® Access programming environment and augmented by certain SQL (Structured Query Language) commands that enable the user to identify database records associated with music recordings that may be of interest to the user, and then link to a plurality of digital media files associated with those recordings for the purpose of reproduction through a system of software instantiated media players or dedicated hardware players with the required video displays and sound ports (and required digital to analog converters) for connection to audio loudspeakers.

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

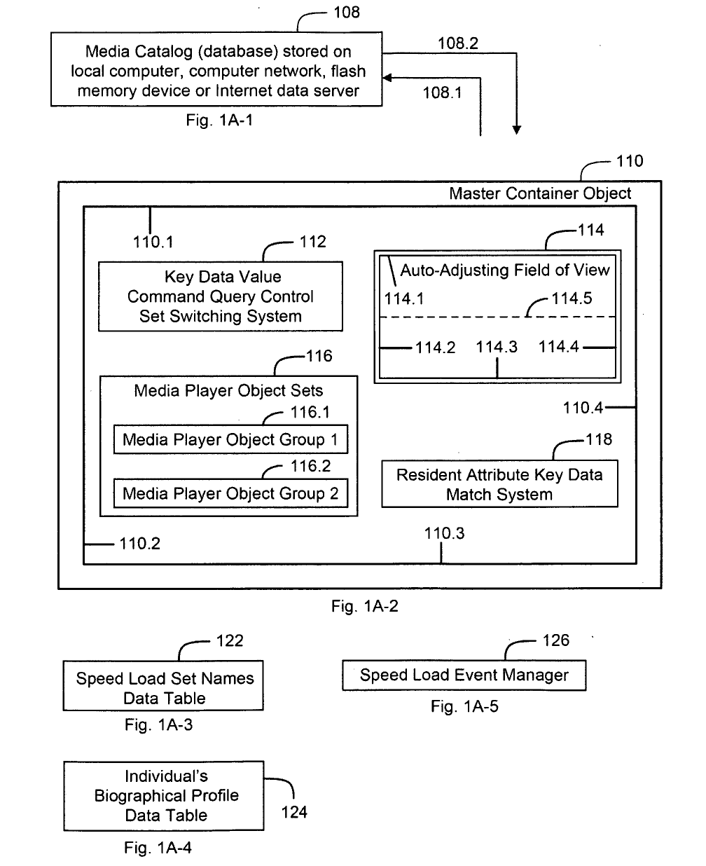

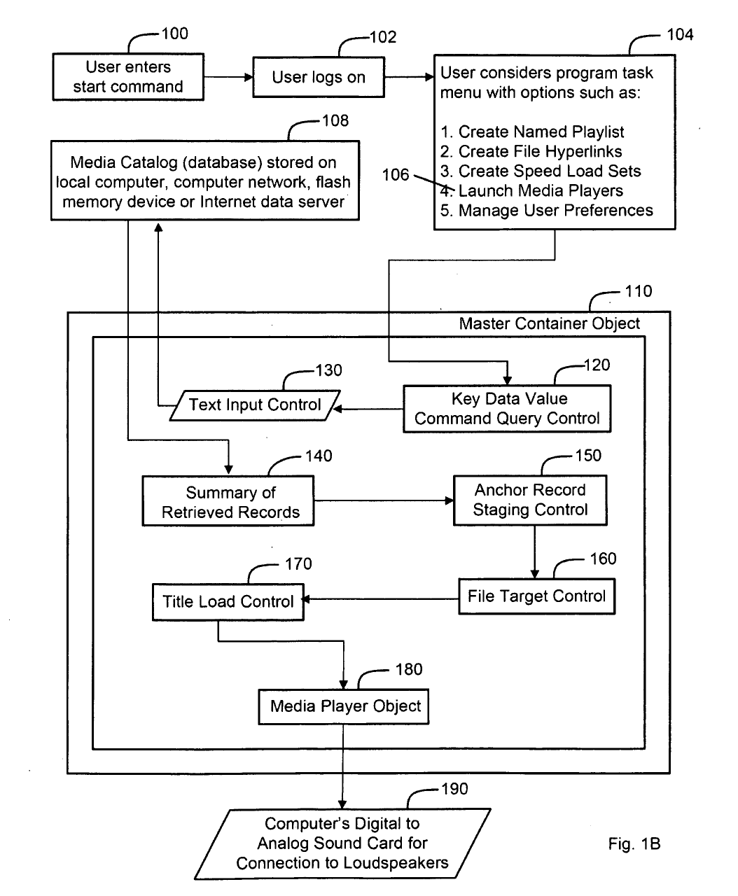

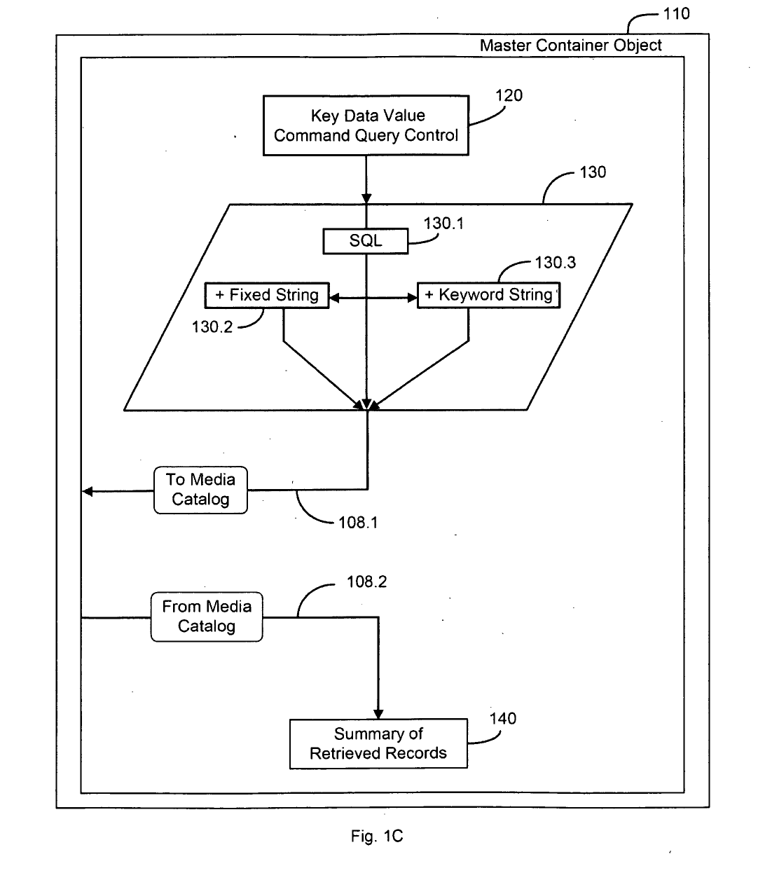

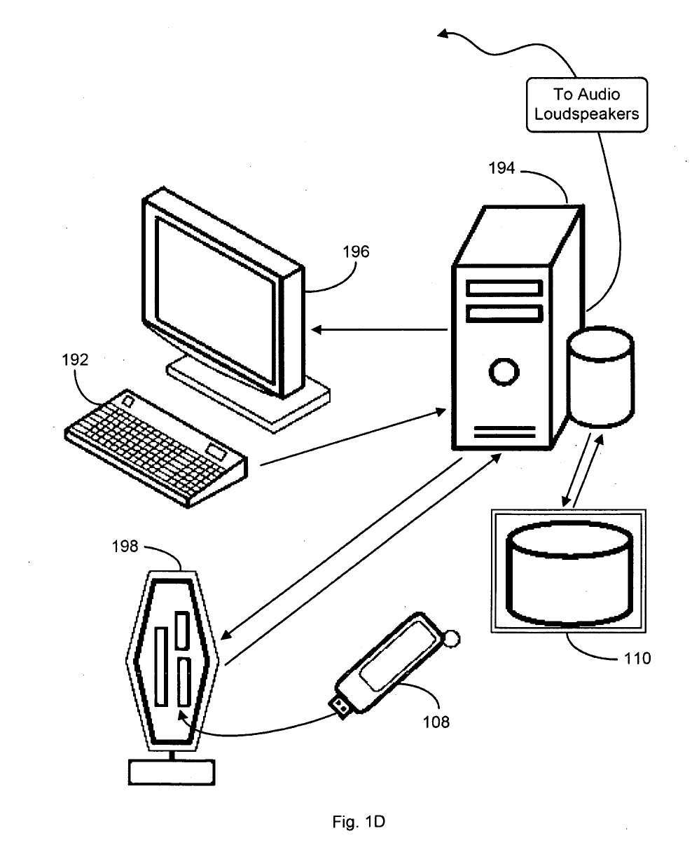

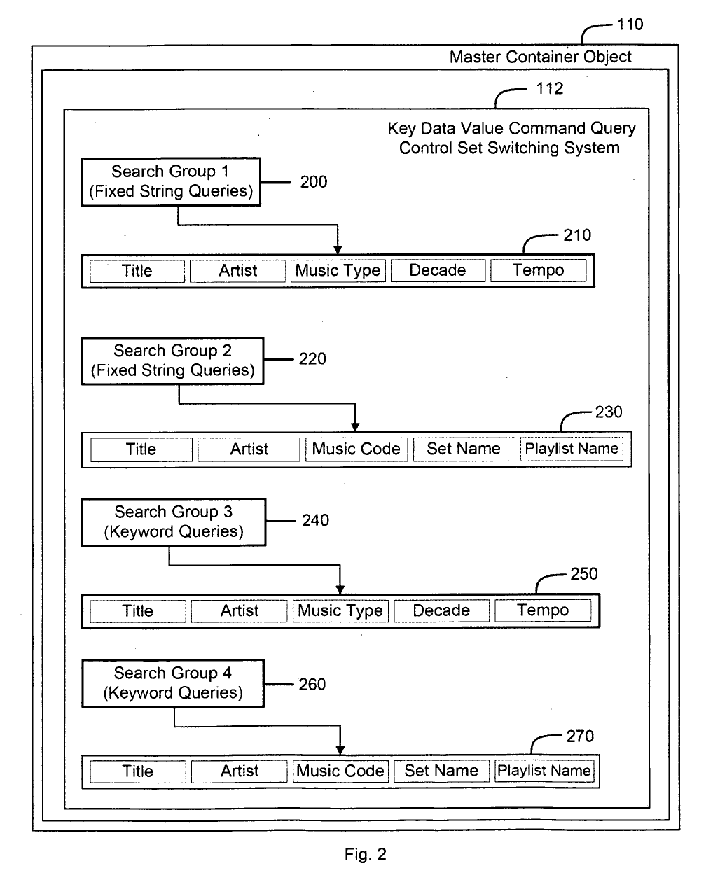

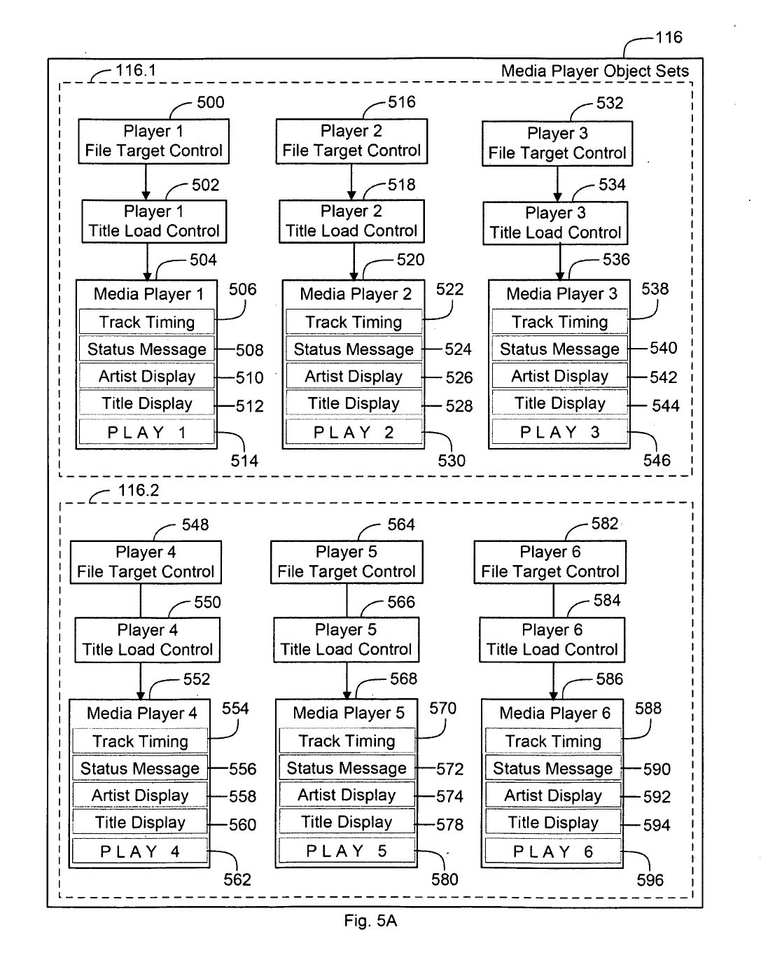

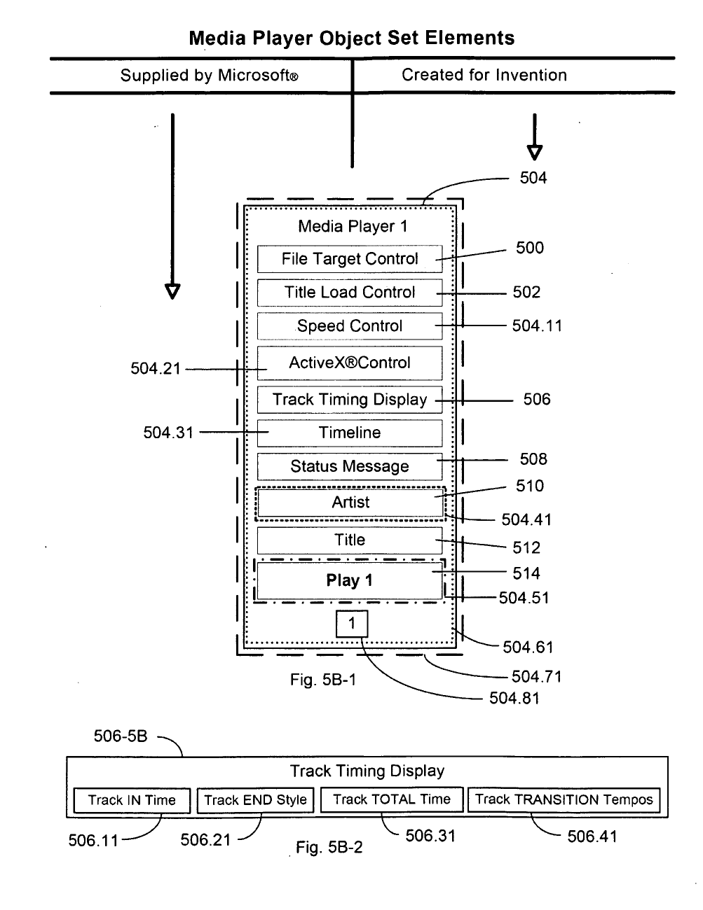

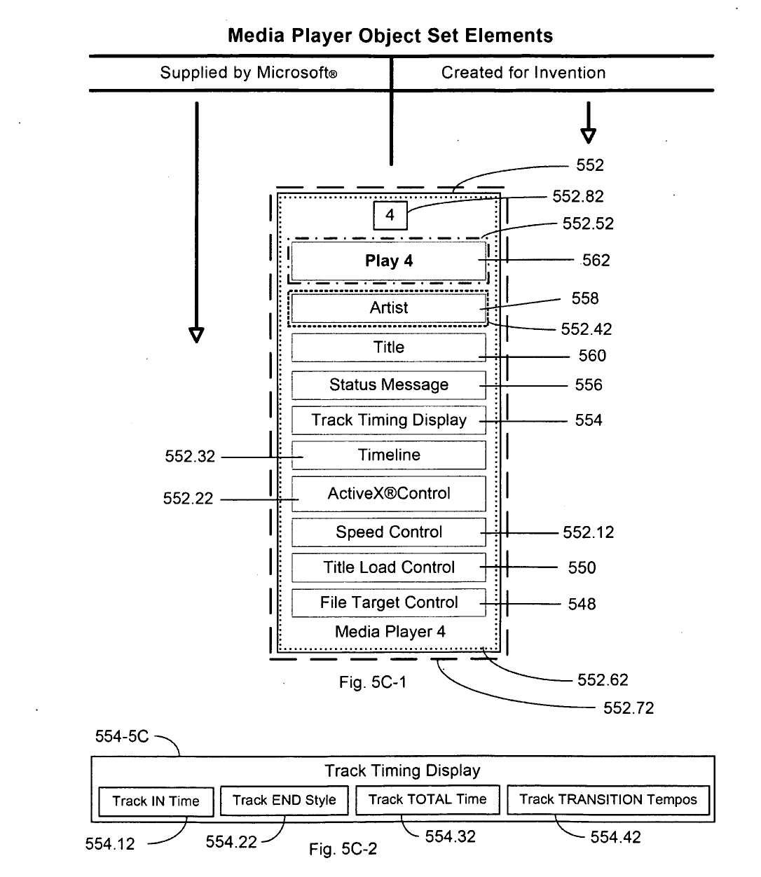

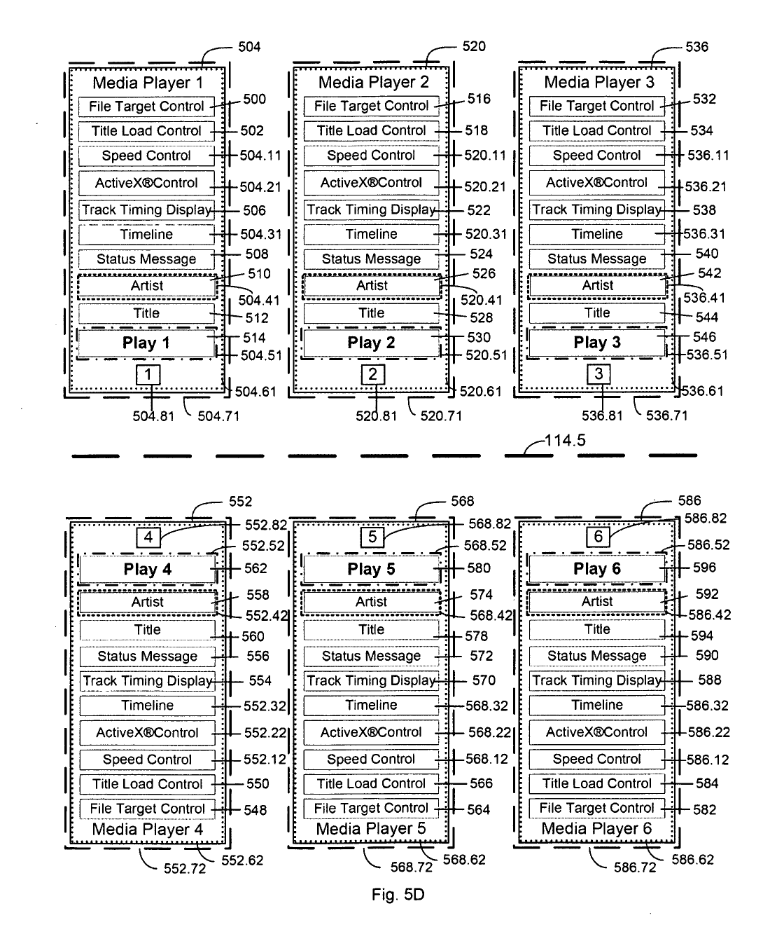

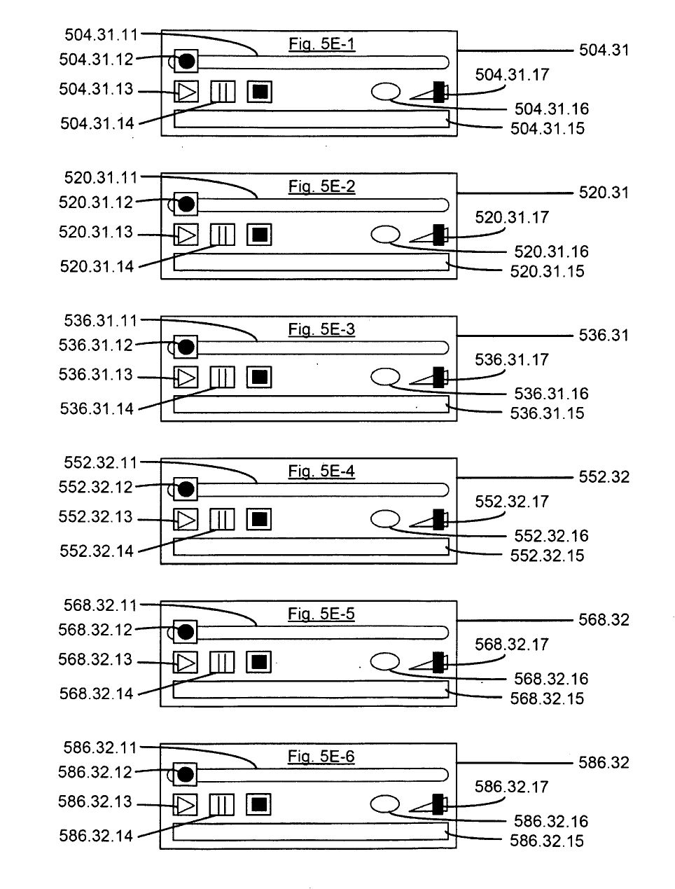

In the disclosure, the different parts in figures are specified by reference numbers. The specification generally refers to such reference numbers by the term “character”. Occasionally, the terms “element” and “illustration” may also be used. For example, the phrase “see FIG. 1B, element 110” refers to the character reference number 110 on FIG. 1B. The phrase “see illustration 110 in FIG. 1B” has the same meaning. Also, in many cases the term “elements” may be used to refer to the various components that may be included, for example, in a logic process or a software interface embodiment. E.g. the phrase “ . . . an organizational diagram that illustrates, in one embodiment, the various elements that may comprise an enhanced inverted-order construction ‘media player object set’” can also be understood to have the same meaning as the phrase “ . . . an organizational diagram that illustrates, in one embodiment, the various components that may comprise an enhanced inverted-order construction ‘media player object set’”. Throughout the drawings, reference numbers are re-used to indicate correspondence between referenced characters. In addition, the first digit (or in cases where the figure is characterized by a two-digit number, the first two digits) of each reference number indicates the figure in which the character first appears. Additionally, some drawings contain reference numbers associated with illustrations that present a different iteration (version) of a previously described character (to show, for example, a changing value or to illustrate the evolution of a programming procedure), and reference numbers such as these may be expressed as hyphenated numbers that indicate correspondence between a previously referenced character and the new character. Some figures display whole numbers followed by a decimal point and additional numbers. This is generally intended to differentiate the individual elements of a process as seen in FIG. 1C where character 130 corresponds with a text input control and characters 130.1, 130.2 and 130.3 indicate one of three processes managed by the control; or the parts of a larger object (such as seen in FIG. 1A-2 where the number 110 represents a Master Container Object and 110.1 represents the upper vertical boundary of the object, while 110.2 represents the left horizontal boundary of the object, and so on). On several drawing sheets, one or more related figures are depicted using a hyphenated derivative method such as can be seen in with FIGS. 5E-1, 5E-2, 5E-3, etc. Finally, in several drawings, the whole number-decimal-additional number system allows the inclusion of a greater amount of delineated reference points (such as seen in FIG. 5D where object 552 is exploded to show its individual elements such as 552.12, 552.22, 552.32, etc.) than would be possible without a decimal delimiter.

FIGS. 1A-1 through 1A-5, when viewed together, constitute a high-level diagram depicting the key elements of the present invention according to one embodiment.

FIG. 1A-1 illustrates the Media Catalog (108) which is essentially a highly cross-indexed database of hit-music recordings which has been optimized for implementation with this invention. As a database, the Media Catalog may store records outside the Master Container Object (see FIG. 1A-2). It is also possible to envision an embodiment where the Media Catalog is integrated with the programming environment used to create and manage the Master Container Object. In either case, the data records in the Media Catalog may be understood to be accessed by a query input path (108.1) from the Master Container Object, and the query results returned along a data output path (108.2) which permits the controls in the Master Container Object to format and display record summaries in the user interface. Operational details of the Media Catalog are beyond the scope of this section; however, a portion of the catalog's finely-tuned organizational capabilities can be explained by its native “parent-child” categorization design. By virtue of a series of elaborate queries managed by the database engine that controls an embodiment of this invention (Microsoft® Access™ for example), the Media Catalog, in combination with the embodiment's query structure, can retrieve and offer display summaries to the user which reveal the natural connections between similar and dissimilar recordings.

Now referring to FIG. 1A-2, an illustration which depicts a high-level view of an implementation of the Master Container Object (110) and its key elements according to one embodiment. As the reader will understand upon closer examination of this specification, the Master Container Object (MCO) is a programming object created to manage a plurality of objects under its direction by means of deliberate program instruction execution created for this invention and classified as a situational awareness (SA) method and system. The MCO (110) has four defined boundaries: character 110.1 represents the upper vertical boundary of the object, while 110.2 represents the left horizontal boundary of the object, 110.3 the lower vertical boundary, and 110.4 represents right horizontal boundary.

In FIG. 1A-2, the MCO is illustrated with its internal components: the Key Data Value Command Query Control Set Switching Module or System (112), Auto-Adjusting Field of View Module or System (114), the Media Player Object Sets (116), and the Resident Attribute Key Data Match Module or System (118).

Continuing with FIG. 1A-2, the Key Data Value Command Query Control Set Switching System (112) is a method creating a user interface control system comprising program or user-accessible master switching control(s) that can alternate display of, and regulate access to, a plurality of Key Data Value Command Query Control Sets where each control set contains a plurality of discrete Key Data Value Command Query Controls, each individual Key Data Value Command Query Control (KDVCQC) having a name that indicates a direct association with the particular primary category (database field) used for the query search specified in the instructions attached to each discrete KDVCQC; and each Key Data Value Command Query Control is directly associated with information collected and/or stored for a specific key data value category. The Key Data Value Command Query Controls are the primary means of executing query searches in the invention. (FIG. 2 clearly identifies various Key Data Value Command Query Control Sets and their associated data categories.)

Also depicted in FIG. 1A-2 is an Auto-Adjusting Field of View Module or System (114)—or the AAFOV. The AAFOV reveals a method embodied in the invention that involves program instructions which evaluate a series of data point statistics (such as a procedure's execution of a workflow cycle) in order to determine how best to automatically align the screen display for a plurality of instantiated media player objects (media players) when those media player objects can be discrete members of collaborating Media Player Object Groups, where each of those media players in each group is rendered (provided) in relatively large dimensions. The Auto-Adjusting Field of View Module or System (114) has defined boundaries (114.1, 114.2, 114.3, 114.4) and an “artificial horizon” (114.5) that will be explained later in the specification.

FIG. 1A-2 also depicts the Media Player Object Sets (116) which represents a utilitarian collection of media player object set “elements” (such as data indicators, command controls and data point reference markers) which have been created with the objective of enabling media player objects, such as the Microsoft® ActiveX® Media Player Control object in one embodiment, to be manipulated by a program structure which demonstrates a form of situational awareness logic. (The term data point as used here has a much broader definition and is described at length elsewhere in this specification). In one embodiment, at least two Media Player Object Groups can be envisioned as part of the Media Player Object Sets: Media Player Object Group 1 (116.1) and Media Player Object Group 2 (116.2).

FIG. 1A-2 also introduces the Resident Attribute Key Data Match Module or System (118), a method of creating a collection of dynamic, one-click, Resident Attribute Key Data Match (key data value) filters which may be simply described as user-applied filters that can immediately retrieve a summary of records from a media catalog (database), in one embodiment, where the records in the summary have a key data value, for example an artist value, that matches a corresponding value for the record (file) loaded in an instantiated media player. In other words, observe a media player with a recording by artist Garth Brooks loaded in that player, double-click the player artist label, in one embodiment, and immediately reveal, and obtain digital media file access to, a summary list with every Garth Brooks recording available on the computer's music hard drive. This method has been named the Resident Attribute Key Data Match (RAKDM) system because it allows the user to focus on one key data value attribute of a loaded media file, and instantly identify every file with that matching attribute-without a new query search. In an embodiment, the user simply sets an interface option declaring which attribute he wants to use as the basis for the RAKDM event. And since this can be accomplished from, for example, an artist label target area on the media player object itself, there is not even a requirement for the user to move his eyes off the workflow stage.

Now referring to FIG. 1A-3, the Speed Load Set Names Data Table (122). It is depicted as a separate relational database object, in one embodiment, where a user-determined list of specific “Speed Load” events, each event comprised of a plurality of designated records (media files), is stored.

Now referring to FIG. 1A-4, the Individual's Biographical Profile Data Table (124). It is depicted as a separate relational database object, in one embodiment, where an individualized music preference profile (identifiable by a universal music profile) is maintained. The preference profile (described in more detail later in this specification) is comprised of a plurality of records and their associated key data value attributes and can be used, in one embodiment, to supplement or modify the Key Data Value Command Query Control (KDVCQC) searches executed in this invention.

Now referring to FIG. 1A-5, the Speed Load Event Manager or Module (126) which, in one embodiment, can generate a user interface window that permits the operator to perform a number of functions related to constructing and enabling named sets of Speed Load events. Specifying a named Speed Load set can, for example, allow the user to quickly load a plurality of instantiated media player objects with a pre-determined record list in a matter of seconds.

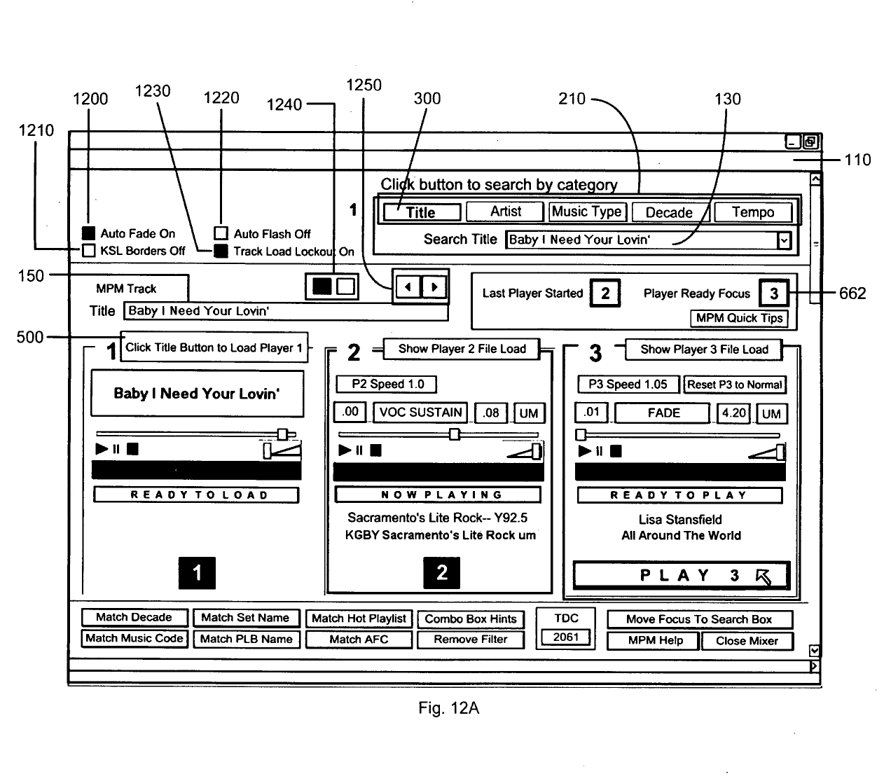

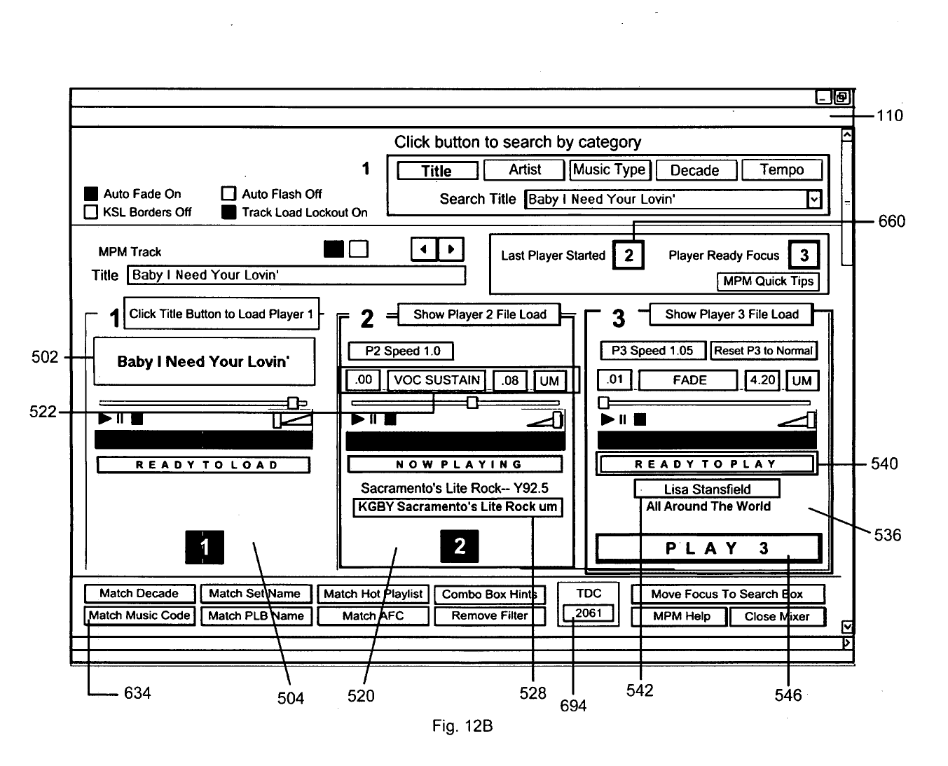

Now referring to FIG. 1B where most elements are generic representations illustrating the basic design of the program data flow structure. When an embodiment is examined more closely, the specific elements (identified by definitive labels in subsequent figures) will be shown in their logical position, replacing the generic elements. For example, to place the elements in FIG. 1B in perspective with the larger context of the invention, it should be noted that the Key Data Value Command Query Control (120) depicted in FIG. 1B is a generic representation for any one specific Key Data Value Command Query Control such as search by Title, search by Artist, search by Music Type, etc. as may be available in an embodiment. (See FIG. 12A illustration 300 for an embodiment screen image showing the default Title Key Data Value Command Query Control.)

FIG. 1B is a flowchart depicting a method for retrieving database records and passing their associated digital media files to a media player object, according to one embodiment of the invention. This high-level overview takes the user from program start, to query execution, to record summary display, to user's decision to target a media player and load (insert) the title (file) in the selected player, and finally shows how the file may be routed for audio reproduction.

Initially, a user enters a start command (100). If the user is using a computer program, the start command will open or start the program. If the user is using an Internet-based system, the start command will retrieve or open the relevant Web site. If the embodiment was implemented as a hardware device, the start command might start the program or open a task selection panel (display). In any case, the user may be required to enter login information (102) such as a username and/or password. It can be envisioned that the system automatically identifies the user, for instance, by logging on to Windows® operating system, or is stored for future access by the computer program or hardware device.

Continuation in the system depends on the user's selection from a menu of program tasks (104) where the user can choose the start command associated with option 4 (106), “Launch Media Players”.

In one embodiment, the “Master Container Object” interface (110) opens with a default Key Data Value Command Query Control (120) visible near the top of the display screen and the Text Input Control (130) situated beneath the Key Data Value Command Query Control.

The same action that reveals the Key Data Value Command Query Control (120) automatically directs program focus to the Text Input Control (130) where a default text string (such as the title of a hit-music recording, name of an artist, music genre label, etc. as determined by the database key data value category associated with the activated Key Data Value Command Query Control) is presented in white letters (typeface) on a black background (as can be typical in many Windows® applications) when the contrast of white on black, as opposed to the usual black characters on white background, is intended to visually indicate the text string, and its associated database record, is the subject of focus.

Continuing with a discussion of the flowchart depicted in FIG. 1B, when the user observes that focus is on the Text Input Control (130), he has a simple decision to make regarding query results. In one embodiment, he can accept the default (passive) mode of the Key Data Value Command Query Control (KDVCQC) (120) which may, in the absence of any user intervention, automatically bypass instruction from the Text Input Control (130) and retrieve a summary of records from a digital assets Media Catalog (108). The Media Catalog is stored outside of the Master Container Object, but integrated with the invention application program and stored on a local or networked computer with the Master Container Object. It can also be envisioned that an alternative embodiment may store the digital assets Media Catalog on a remote server, on an external hard drive, on a “flash” memory drive, on an Internet-enabled telephone, on an Internet data server, on a small-format computing device, on a retail music “kiosk” apparatus, or some other device.

The summary obtained by the default passive query search may be retrieved and ordered by a pre-defined SQL (structured query language) routine (programming statement) attached to the KDVCQC (120), and it may set an “anchor record”; e.g. the database bookmark pointer (internal record marker) may be synchronized to correspond with the first ordered record in the retrieved summary. However, if a user elects to submit an (active mode) improvised character string instruction in the Text Input Control (130), the Summary of Records (140) retrieved from the digital assets Media Catalog (108) may be different from the default summary and the anchor record may be different from that marked in the default summary.

Once a summary has been retrieved from the Media Catalog (108), it is automatically brought into the summary display (140) which is an extension of the Text Input Control (130) and also managed by instructions within the Master Container Object (110).

Therefore, the Summary of Retrieved Records (140) in an embodiment may be calculated (in part) by the user's decision to use a passive or active mode query as determined by his actions or non-actions in the Text Input Control (130).

Each Key Data Value Command Query Control, such as Title, Artist, Music Type, Decade, Tempo, etc. (see FIG. 2, for an expanded illustration of available KDVCQC objects), is directly associated with stored values for the category (field) depicted its control name, and since each Key Data Value Command Query Control (KDVCQC) is capable of generating an instant query based on its default SQL instruction and modifying that default query by facilitating direct instructions from the user in an improvisational manner, each KDVCQC is implemented as a multi-mode control; e.g. capable of executing default SQL-based queries, or capable of executing user-improvised fixed-string queries, or capable of executing user-improvised keyword queries, or combinations of these variations. (There are other query modifications that may be imposed in this invention and they will be addressed in subsequent sections of this specification.)

Continuing with a discussion of the flowchart depicted in FIG. 1B, programming instructions assigned to monitor anchor record values, as displayed in the Summary of Retrieved Records (140), simultaneously transfer the value of the summary anchor record (as marked by database bookmark) to the Anchor Record Staging Control (150) which serves as a value place holder and, as such, the first “logic waypoint” in the file load process, and therefore the Anchor Record Staging Control may be characterized as file load process waypoint 1.

The user, having automatically transferred the value of the anchor record in the summary view (140) to the anchor record staging control (150), should next identify an available media player. The user interface, implemented in one embodiment as the display screen of the Master Container Object (110), allows the user to observe which media player object (from among a plurality of, for example, two, three, six, or more depending on the embodiment) is ready to load—e.g. accept insertion (by program instruction assignment) of a digital file.

Once the user visually determines the availability of a specific media player or players, he may mentally choose a target (destination) player, and then proceed to physically activate (for example, by mouse or keyboard action) the player's associated File Target Control (160)—which might be thought of as file load process waypoint 2. Activating the File Target Control (160) causes the Title Load Control (170) to immediately appear above the timeline of the selected media player. The title of the anchor record is then displayed on the face of the Title Load Control button.

Next, the flowchart in FIG. 1B depicts a sequence where the user (after confirming the name of the intended title as visible on the Title Load Control button), may then activate the Title Load Control button (170) or icon as the final waypoint to be crossed when loading a digital media file. Activating (for example, by mouse or keyboard action) the Title Load Control button or icon causes immediate loading of the file stored in the Anchor Record Staging Control (150) into the selected media player object (180) by a means that associates a catalog hyperlink stored for a specific record with the load command for the instantiated media player object. (In cases where the situational awareness logic program instructions in Master Container Object detect that the targeted player is already playing a media file, the file load process can be automatically blocked and an error message can direct the user to select a different player.)

Finally, in FIG. 1B, selecting the Play button on the successfully loaded Media Player Object (180), which is now technically evaluated by Master Container Object logic as “ready to play”, starts reproduction of the media file which may be routed to the computer's Sound Card (190) which the user may connect to headphones or an external loudspeaker system. (FIGS. 5A and 5D illustrate an embodiment with a plurality of media player objects and their assorted controls including the Play button.)

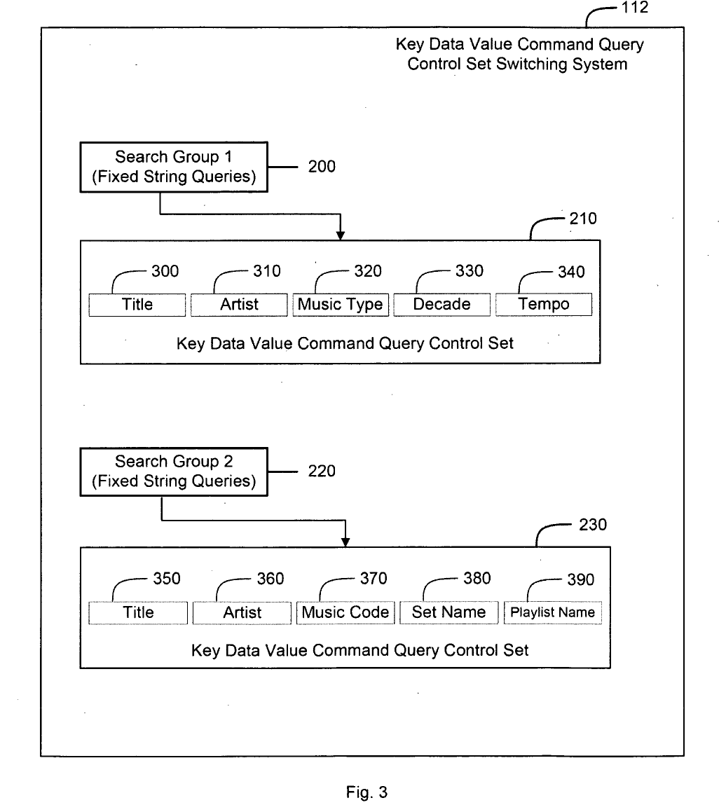

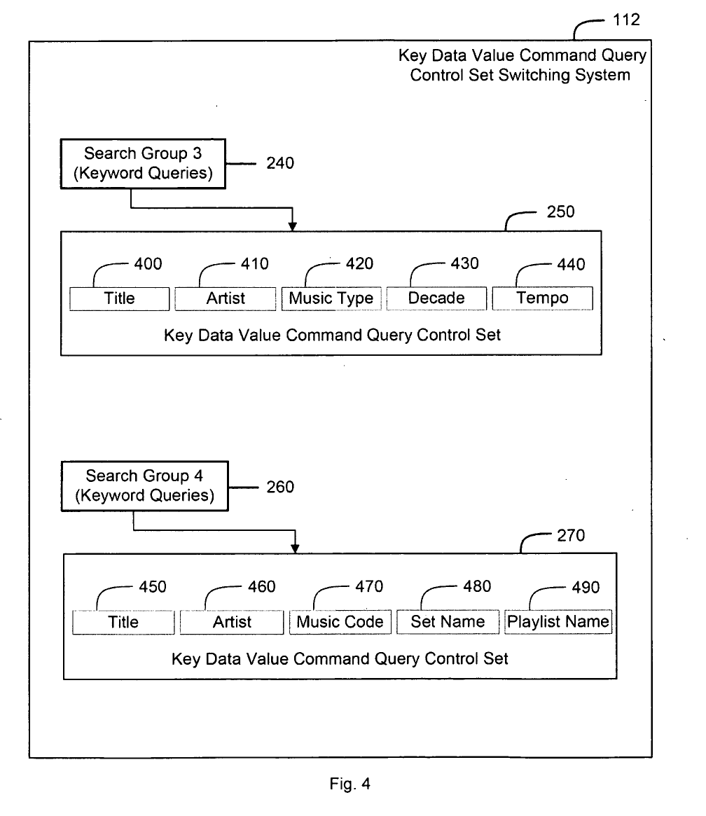

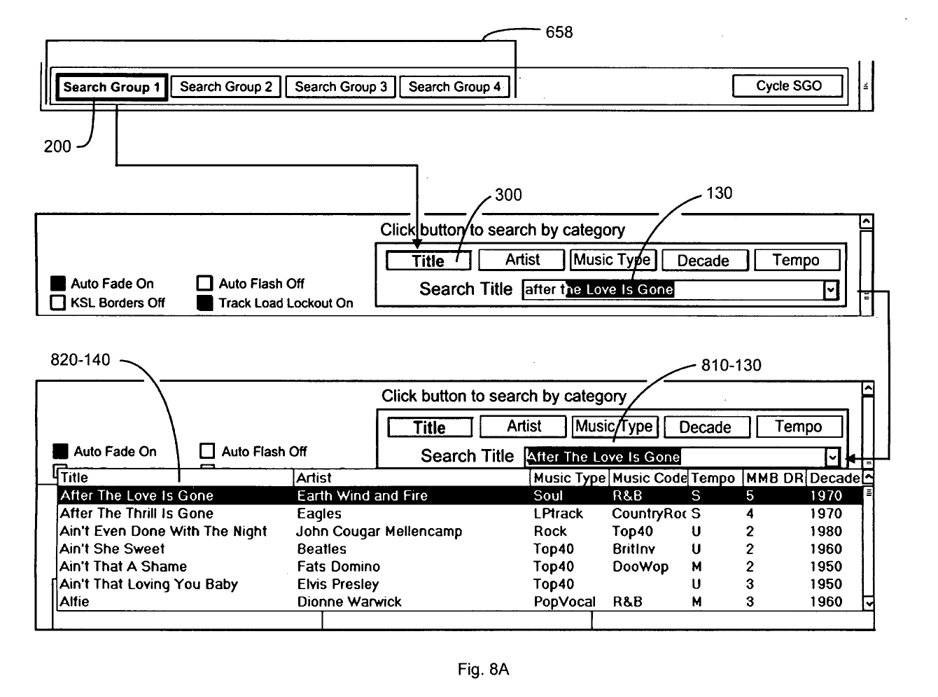

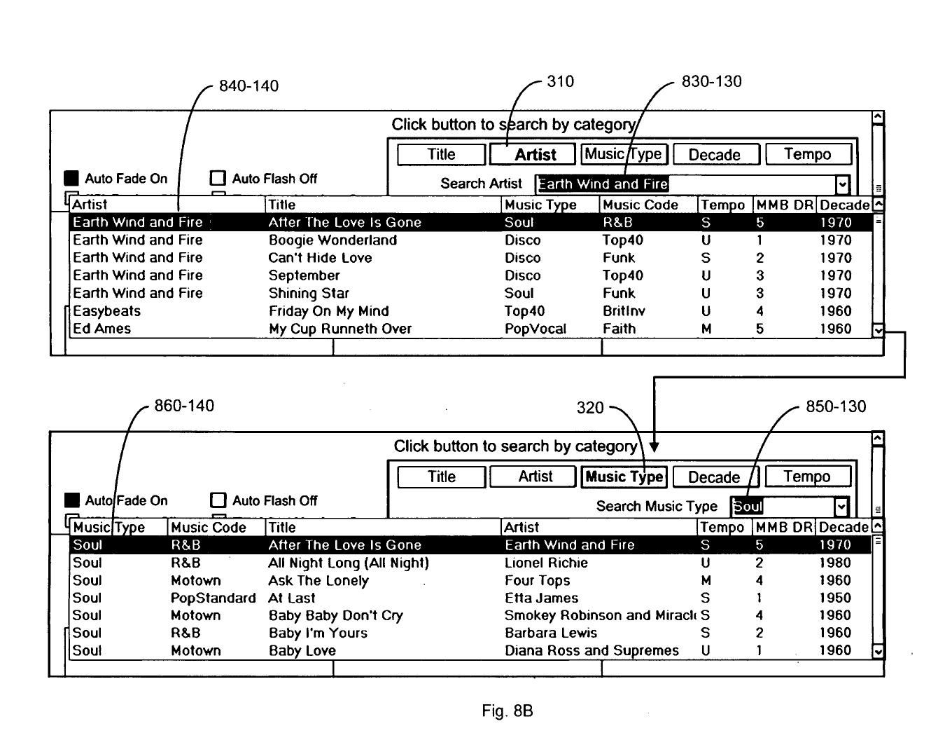

As a point of clarification, the combo box/Text Input Control (130) with its attached summary display window (140) in FIG. 1B is a common element in most Microsoft® Windows® applications. It can be easily created using Microsoft® development tools. The reader, however, will understand after reviewing additional explanations in this specification, that while the implementation of a Microsoft combo box/Text Input Control is a routine matter to programmers, the method of its implementation in this invention, where it is connected to alternating sets of Key Data Value Command Query Controls in a layered system capable of quickly initiating a diverse array of relational compound queries, makes an embodiment using this technology novel and extremely useful. (See FIG. 8A, characters 810-130 and 820-140 for an embodiment display screen capture image that illustrates the summary view as connected with the Text Input Control. For an object diagram of the various complimentary sets of Key Data Value Command Query Controls, refer to FIGS. 3 and 4.)

Now referring to FIG. 1C which is a flowchart depicting a method of query execution as determined by the user's actions (or lack of actions) in the Text Input Control (TIC) activated by the Key Data Value Command Query Control (KDVCQC). FIG. 1C provides a deeper exploration of the switching method connected with the KDVCQC and the TIC. As previously illustrated (in FIG. 1B), the same action performed within the Master Container Object (110) that reveals the Key Data Value Command Query Control (120), automatically directs program focus to the Text Input Control (130). The Text Input Control, in connection with a programming statement (formulated as a SQL command in one embodiment) attached to the KDVCQC, permits the TIC to function in one of three different modes—thereby allowing the user's actions to resolve the final effect of the query. The user can decide to accept the default SQL instructions as devised for each specific type KDVCQC (such as the search by Title KDVCQC, or the search by Artist KDVCQC, or the search by Music Type KDVCQC, etc.), or the user can choose to submit further query instructions via the Text Input Control (130). All modes pass the search query to the Media Catalog (database) (see FIG. 1A-1, character 108) and then the retrieved records are available for manipulation and viewing in the Summary of Retrieved Records (140) combo box. Record manipulation methods may include mouse click or drag, keyboard commands, bio-feedback interpreted instructions, etc.

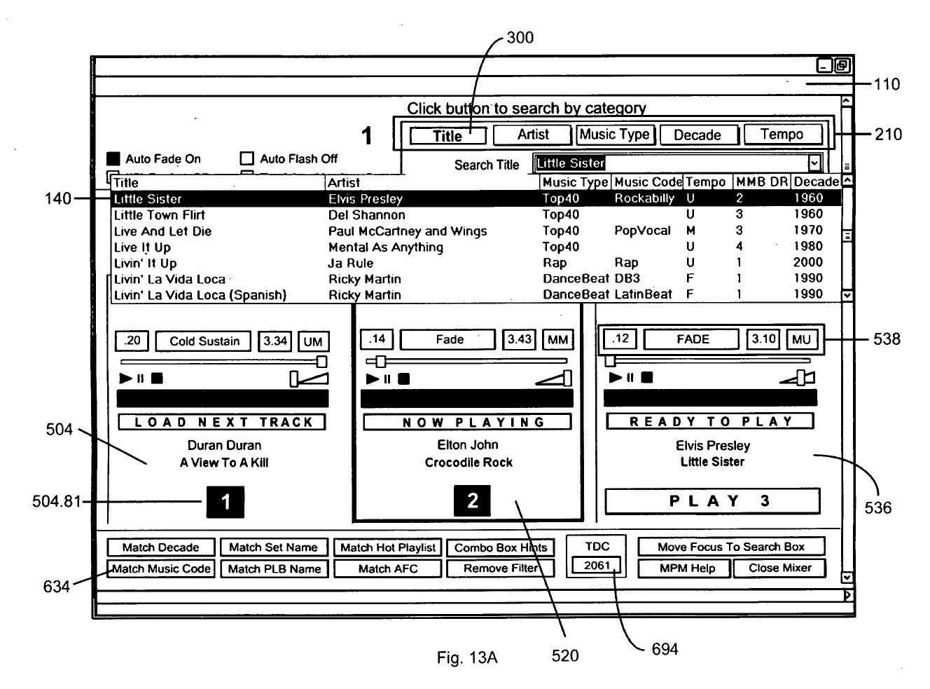

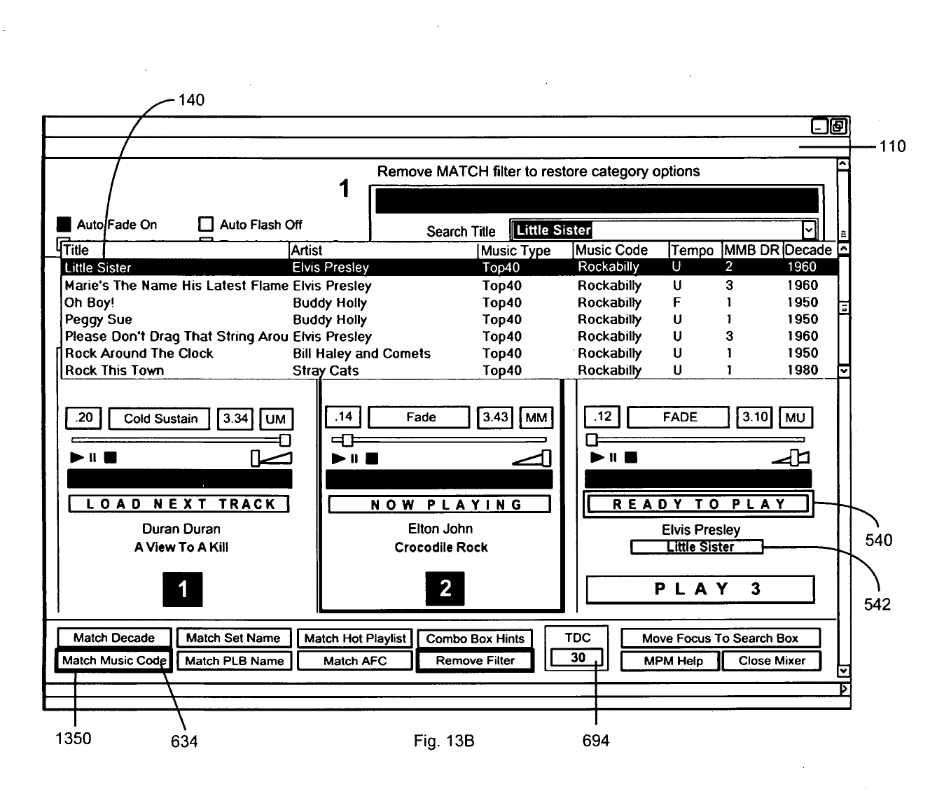

It should be noted that the Text Input Control (commonly referred to as a “combo box” in this invention and many desktop software applications such as those developed by Microsoft® Corporation) is an object made available by the programming environment and was not created by the invention described in this specification. The Summary of Retrieved Records, in one embodiment, appears as a visual extension of the combo box in what is termed a “drop-down” window situated beneath the Text Input Control. The Summary of Retrieved Records (140) can be implemented as a user navigable list of all retrieved records with the current anchor record (as maintained by the database bookmark pointer) at the top of the drop-down window in the Text Input Control (130). (FIG. 13A, illustration 140 provides an example of this design in one embodiment.)

The illustrations in FIG. 1C are helpful to explain the available modes (query iterations) of the Key Data Value Command Query Control (KDVCQC) and its connection with the Text Input Control (TIC). Referring to the flowchart that begins at the top of FIG. 1C, the Key Data Value Command Query Control (120) has activated the Text Input Control (130) where the user's actions, or non-actions, determine the query execution mode as passed to the Summary of Retrieved Records (140).

The Text Input Control can function in a manner similar to a 3-position “toggle” switch found on common household appliances. Like a light switch that may offer OFF, LO and HI positions, each discrete KDVCQC permits the user a choice of three different query formulation modes.

When the TIC is used with only its default SQL instruction (130.1), it passes that query instruction to the database via the embodiment's query path (108.1). This “SQL only” path is illustrated as an operational logic process within the TIC. Therefore 130.1 represents a “Passive mode” process where the user does not submit an instruction in the TIC and the query executes with default SQL statement. Query results are returned along a data output path (108.2) which permits the controls in the Master Container Object to format and display record summaries in the user interface.

However, if the user elects to submit a fixed-string in the TIC, the fixed-string instruction (130.2) is added to the default SQL instruction assigned to that KDVCQC, and that query formulation is prepared for the embodiment's query path (108.1). This “SQL+Fixed String” path is illustrated as an operational logic process within the TIC. Therefore 130.2 represents an “Active mode” process where the user submits an improvised fixed-string (whole value) instruction in the TIC and the query executes with user instruction added to default SQL statement.

Continuing with FIG. 1C, alternatively, once he has activated the TIC, the user may decide to submit an improvised keyword-string instruction (130.3). This keyword-string is added to the default SQL instruction assigned to that KDVCQC, and that query formulation is prepared for the embodiment's query path (108.1). This “SQL+Keyword String” path is illustrated as an operational logic process within the TIC. Therefore 130.3 represents an “Active keyword mode” process where the user submits an improvised keyword-string (partial value) instruction in the TIC and the query executes with user instruction added to default SQL statement.

For example, assume the Key Data Value Command Query Control has been activated in the default circumstance—in other words, the manner in which the program first opens—of the search by Title KDVCQC. Accepting the (pre-defined) SQL query instructions attached to the search by Title KDVCQC requires no further action on the part of the user, and in this case, the pre-defined query instruction may bypass any modification from the Text Input Control (130) because there may be no modification. Therefore, submitting no additional user-improvised instructions, and applying no filters or other modifications, a user can expect the system to retrieve a summary of records from the Media Catalog where the list is sorted alpha-numerically by title—and starts with such titles as: “10th Avenue Freezeout” by Bruce Springsteen, “1-2-3” by Gloria Estefan and the Miami Sound Machine, “1-2-3” by Len Barry, “16 Candles” by The Crests”, “19th Nervous Breakdown” by The Rolling Stones, and so on, continuing in alpha-numeric progression through the entire alphabet and possibly ending with a titles such as “Yummy, Yummy, Yummy” by the Ohio Express, “Zoot Suit Riot” by the Cherry Poppin' Daddies and “Zorba The Greek” by Herb Alpert and the Tijuana Brass. This is an example of an embodiment that constructs and then executes a passive mode query by means of instructions attached to the Key Data Value Command Query Control used in combination with process 130.1 in the TIC.

To demonstrate the inherent versatility of this invention's multi-mode design, the next example from FIG. 1C examines what occurs when the user decides to input an improvised fixed-string query instruction (130.2) in a Key Data Value Command Query Control—this time a different command query control—the search by Artist KDVCQC; and the example assumes the user submits an improvised (active mode) instruction such as “Elton John”.

By typing the fixed-string (whole value) phrase “Elton John” (without the quotes) in the Text Input Control (130) associated with the search by Artist KDVCQC (which may be viewed in relationship to other Key Data Value Command Query Controls in FIG. 3, illustration 310), the Text Input Control Module retrieves from the Media Catalog a plurality of records where the artist value was equal to Elton John. In one embodiment, the user viewing the Summary of Records (140) would observe records displayed from left to right across a horizontal plane with the summary organized by Artist value, then Title value, then Music Type value, then Music Code value, then Tempo value, then Dance Rating Value, then Decade value, and so on. Therefore, an unmodified summary of retrieved records from the Media Catalog based on a user-improvised instruction of “Elton John” in the search by Artist KDVCQC would include such Elton John titles as “Daniel”, “Goodbye Yellow Brick Road”, “Harmony”, “Island Girl”, and “Tiny Dancer”. This explains the 130.2 process in the TIC as illustrated in FIG. 1C.

However, continuing with an explanation of the KDVCQC and its multiple-mode functions as shown in FIG. 1C, entering a user-improvised keyword instruction (e.g. partial value construct) such as “john” or “turn” or “19” in the Text Input Control (130), a user can achieve a much broader effect and see a different Summary of Records (140) in the “drop-down” window of the combo box. For example, in one embodiment, entering the letters “john” in the search by keyword Artist KDVCQC (which may be viewed in FIG. 4, character 410), the command query control associated with the artist key data value category (field), can retrieve a plurality of records from the digital assets Media Catalog including music titles by such artists as “Elton John”, “Olivia Newton-John”, “John Travolta” and “Johnny Cash”. This occurs because a keyword query is generally constructed to retrieve all records that contain the submitted phrase, and therefore find all records with the phrase, including records that have additional characters before or after the phrase. This explains the 130.3 process in the TIC as illustrated in FIG. 1C.

FIG. 1D depicts hardware and software for one embodiment comprised of a computer-readable storage medium having at least one memory with program instructions, at least one processor configured to execute the program instructions to perform the operations of finding data in a database based upon a user-supplied search value, a keyboard configured to input user instructions to the processor, a display unit, a Master Container Object residing on a computer hard drive, a Flash memory reader device, a Media Catalog residing on a Flash memory stick (device) and a digital to analog sound card for connection to loudspeakers.

FIG. 1D shows a keyboard (192) that connects with a desktop computer containing a processor, memory, a computer-readable storage medium (hard drive), and a digital to analog signal conversion sound card (194). A display unit (196) is connected to the computer. In an embodiment, a Master Container Object (110), such as a Microsoft® Access™ relational database and programming environment, is stored on the computer hard drive. Also, a Media Catalog (database) (108) is stored on a Flash memory device which is connected to a Flash reader device (198) which connects to the computer with processor, memory and hard drive (194).

FIG. 1D depicts one embodiment of the invention. Other embodiments can be envisioned such as a self-contained portable embodiment like a Microsoft® Windows® laptop computer with processor, memory, hard drive, digital to analog sound card and audio speakers—having a Master Container Object and Media Catalog stored as a computer readable database(s) on the laptop computer.

FIG. 2 is an organizational flowchart depicting a method of enabling unified sets of Key Data Value Command Query Controls, which are part of the Key Data Value Command Query Control Sets, and each Key Data Value Command Query Control Set has been created as part of the Key Data Value Command Query Control Set Switching System (112).

Initially, a user having already opened the display interface connected with the Master Container Object (MCO) (110), activates the Search Group 1 switching control (200), which is further contained in the Key Data Value Command Query Control Set Switching System (112). This action reveals a specific Key Data Value Command Query Control (KDVCQC) set—namely Search Group 1 (210) which is comprised of a plurality of complementary KDVCQC objects (buttons or icons); the user observes the search by Title KDVCQC button, the search by Artist KDVCQC button, the search by Music Type KDVCQC button, the search by Decade KDVCQC button and the search by Tempo KDVCQC button. As previously noted, each KDVCQC button controls access to individualized query searches of a Media Catalog and each individual Key Data Value Command Query Control has a name that corresponds with the particular primary category (database field) used for the query search specified in the instructions attached to each discrete KDVCQC. (Please refer to FIG. 3 for a more detailed diagram of the KDVCQC button controls in FIG. 2, character 210).

If, however, as shown in FIG. 2, the user having already opened the display interface connected with the Master Container Object (MCO) (110), chooses to activate the Search Group 2 switching control (220), this action would reveal a specific Key Data Value Command Query Control (KDVCQC) set—namely Search Group 2 (230) which is comprised of a plurality of complementary KDVCQC objects (buttons or icons); the user observes the search by Title KDVCQC button, the search by Artist KDVCQC button, the search by Music Code KDVCQC button, the search by Set Name KDVCQC button and the search by Playlist KDVCQC button. (Please refer to FIG. 3 for a more detailed diagram of the KDVCQC button controls in FIG. 2, character 230).

If, however, as shown in FIG. 2, the user having already opened the display interface connected with the Master Container Object (MCO) (110), chooses to activate the Search Group 3 switching control (240), this action would reveal a specific Key Data Value Command Query Control (KDVCQC) set—namely Search Group 3 (250) which is comprised of a plurality of complementary KDVCQC objects (buttons); the user observes the search by keyword Title KDVCQC button, the search by keyword Artist KDVCQC button, the search by keyword Music Type KDVCQC button, the search by keyword Decade KDVCQC button and the search by keyword Tempo KDVCQC button. (Please refer to FIG. 4 for a more detailed diagram of the KDVCQC button controls in FIG. 2, character 250).

If, however, as shown in FIG. 2, the user having already opened the display interface connected with the Master Container Object (MCO) (110), chooses to activate the Search Group 4 switching control (260), this action would reveal a specific Key Data Value Command Query Control (KDVCQC) set—namely Search Group 4 (270) which is comprised of a plurality of complementary KDVCQC objects (buttons or icons); the user observes the search by keyword Title KDVCQC button, the search by keyword Artist KDVCQC button, the search by keyword Music Code KDVCQC button, the search by keyword Set Name KDVCQC button and the search by keyword Playlist Name KDVCQC button. (Please refer to FIG. 4 for a more detailed diagram of the KDVCQC button controls in FIG. 2, character 270).

FIG. 3 is an organizational flowchart depicting a method of enabling unified sets of command query controls grouped by fixed-string queries. FIG. 3 is present to show in greater detail a switch selector where each Key Data Value Command Query Control (KDVCQC) in the fixed-string sets has been assigned a character number. The Key Data Value Command Query Control Set Switching System (112) contains the Search Group 1 switching control (200) which, when activated, reveals the KDVCQC set known as Search Group 1 (210). Search Group 1 is comprised of the search by Title KDVCQC button (300), the search by Artist KDVCQC button (310), the search by Music Type KDVCQC button (320), the search by Decade KDVCQC button (330) and the search by Tempo KDVCQC button (340). As previously noted, each KDVCQC button controls access to individualized query searches of a Media Catalog and each individual Key Data Value Command Query Control has a name that corresponds with the particular primary category (database field) used for the query search specified in the instructions attached to each discrete KDVCQC.

Continuing with FIG. 3, the reader may see in greater detail a switch selector where each Key Data Value Command Query Control (KDVCQC) in the fixed-string sets has been assigned a character number. The Key Data Value Command Query Control Set Switching System (112) contains the Search Group 2 switching control (220) which, when activated, reveals the KDVCQC set known as Search Group 2 (230). Search Group 2 is comprised of the search by Title KDVCQC button (350), the search by Artist KDVCQC button (360), the search by Music Code KDVCQC button (370), the search by Set Name KDVCQC button (380) and the search by Playlist Name KDVCQC button (390).

It should be noted that, in one embodiment, the functions of certain Key Data Value Command Query Controls are identical; but the switches are re-used to form different complementary KDVCQC sets in cases where it can be beneficial to have core data values such as Title and Artist available in summary presentations with other key data values. For example, the search by Title KDVCQC (FIG. 3, character 300) performs an identical function as the search by Title KDVCQC (FIG. 3, character 350), but if the search by Title KDVCQC (FIG. 3, character 350) was not included in the Search Group 2 (FIG. 3, character 230) KDVCQC set, the record summary as displayed might confuse the viewer because he would not be able to visually attach a title and artist value to retrieved record summaries that included key data values such as Set Name and Playlist Name.

FIG. 4 is an organizational flowchart depicting a method of enabling unified sets of command query controls grouped by keyword queries. FIG. 4 is present to show in greater detail a switch selector where each Key Data Value Command Query Control (KDVCQC) in the keyword sets has been assigned a character number. The Key Data Value Command Query Control Set Switching System (112) contains the Search Group 3 switching control (240) which, when activated, reveals the KDVCQC set known as Search Group 3 (250). Search Group 3 is comprised of the search by keyword Title KDVCQC button (400), the search by keyword Artist KDVCQC button (410), the search by keyword Music Type KDVCQC button (420), the search by keyword Decade KDVCQC button (430) and the search by keyword Tempo KDVCQC button (440). As previously noted, each KDVCQC button controls access to individualized query searches of a Media Catalog and each individual Key Data Value Command Query Control has a name that corresponds with the particular primary category (database field) used for the query search specified in the instructions attached to each discrete KDVCQC.

Continuing with FIG. 4, the reader may see in greater detail a switch selector where each Key Data Value Command Query Control (KDVCQC) in the keyword sets has been assigned a character number. The Key Data Value Command Query Control Set Switching System (112) contains the Search Group 4 switching control (260) which, when activated, reveals the KDVCQC set known as Search Group 4 (270). Search Group 4 is comprised of the search by keyword Title KDVCQC button (450), the search by keyword Artist KDVCQC button (460), the search by keyword Music Code KDVCQC button (470), the search by keyword Set Name KDVCQC button (480) and the search by keyword Playlist Name KDVCQC button (490).

FIG. 5A is an organizational flowchart, for a plurality of media player objects, depicting a method for moving digital media file load (insertion) instructions (a required prerequisite for file reproduction) through a system of logic waypoints (designed to perform the functions of data assessment, referential placeholders and command buttons) culminating in a designated media player object. To put it simply, FIG. 5A shows the data flow for each media player object by delineating assigned character numbers which illustrate the progression of file (record title) acquisition by a specific player's file target control, and then demonstrates how that record is passed to the player's file load control and finally to a specific player.

FIG. 5A depicts the Media Player Object Sets (116) which are instantiated (created) within the Master Container Object in one embodiment. The Media Player Object Sets are comprised of a plurality of Media Player Object Groups (two, three or more) and in the embodiment depicted in FIG. 5A there are two Media Player Object Groups. Media Player Object Group 1 (116.1) is comprised of three media player objects (and object sets): Media Player Object 1 (504), Media Player Object 2 (520) and Media Player Object 3 (536). Media Player Object Group 2 (116.2) is comprised of three media player objects (and object sets): Media Player Object 4 (552), Media Player Object 5 (568) and Media Player Object 6 (586).

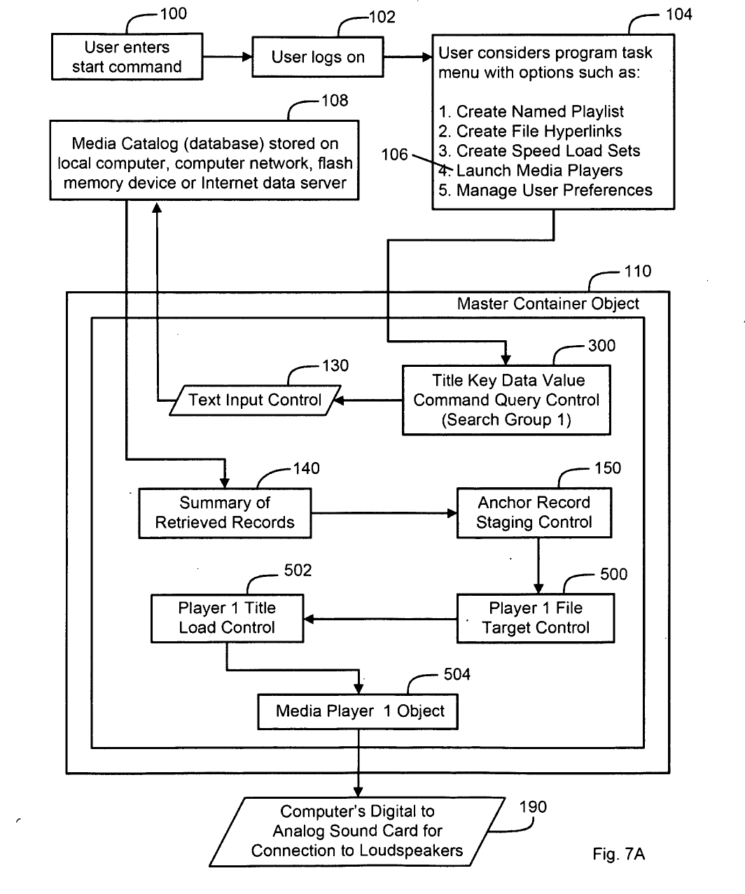

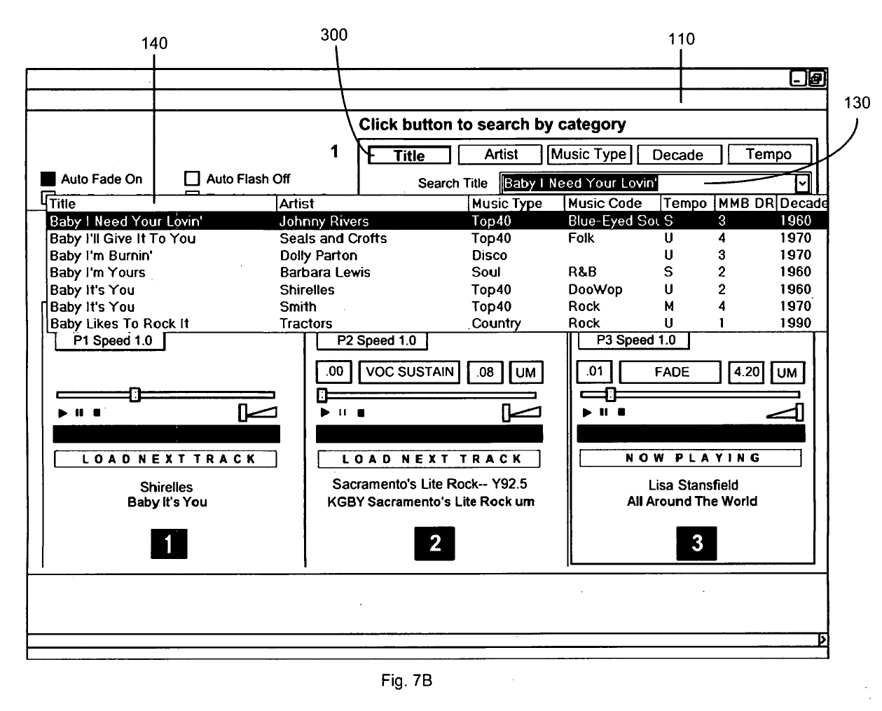

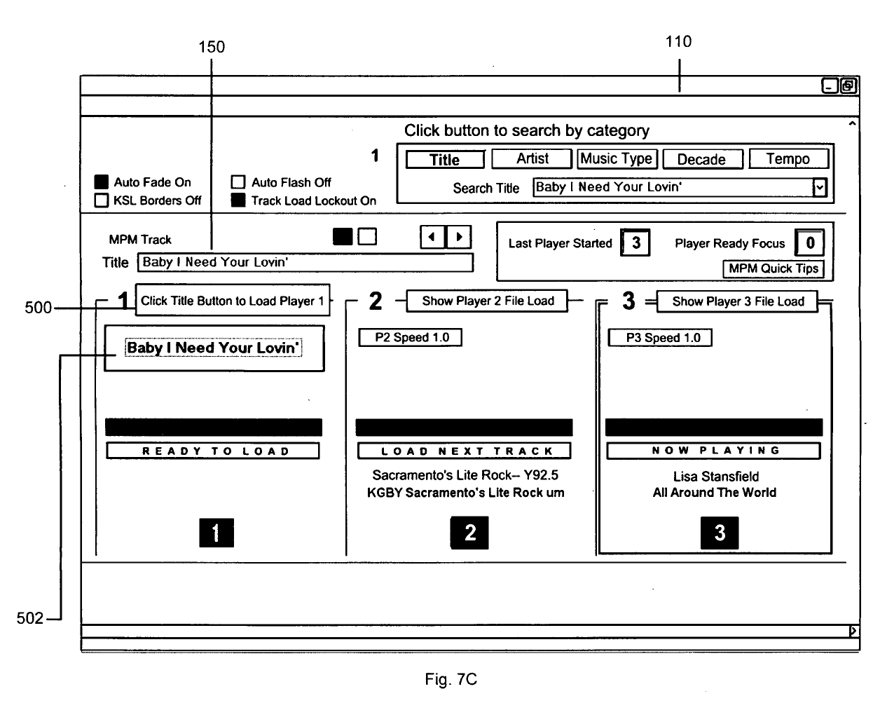

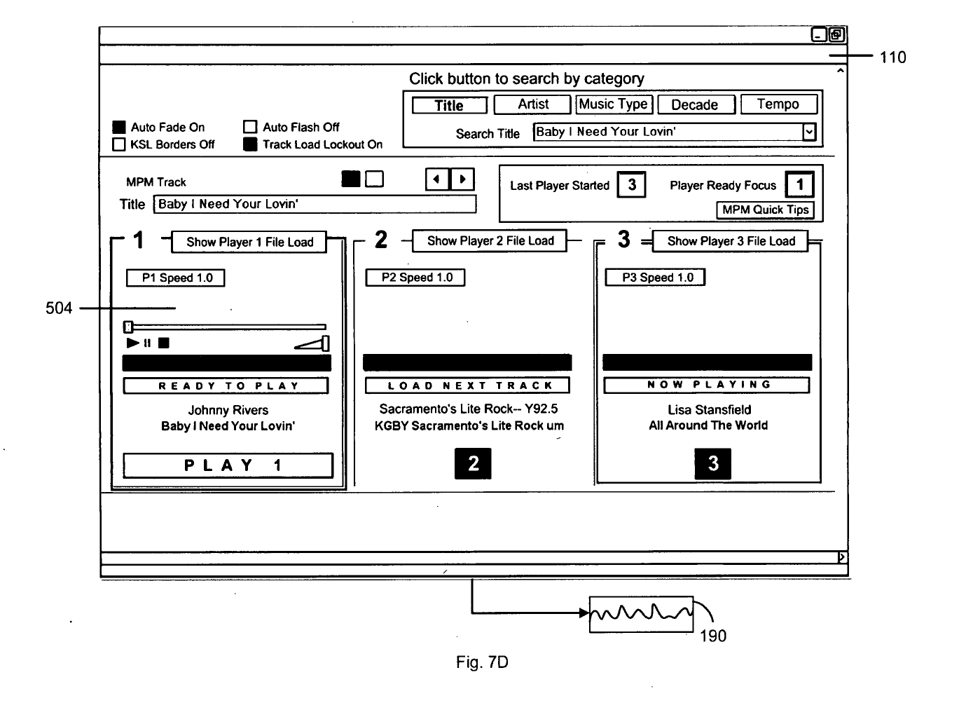

As shown in FIG. 5A, the user activates the Player 1 File Target Control button (500) followed by activation of the Player 1 File Load Control button (502) which directs the anchor record currently stored in the Anchor Record Staging Control (not shown on FIG. 5A but visible in FIG. 1B as character 150) to be loaded into Media Player Object 1 (504). When Player 1 is loaded and ready to play, the Player 1 Status Message (508) light (data label) will display a “Ready To Play” caption; also, the user may then read the name of the artist and title in the Artist Display (510) and Title Display (512). Observe the Track Timing display (506) located above the status message. Next, the user may activate the Play 1 control (514) to begin reproduction of the loaded digital media file. The file load process is the same for all media player objects depicted in FIG. 5A. (Note: the Particulars of this Process are Described in Great Detail in FIG. 1B and FIG. 7A.)

Continuing with the media player object sets depicted in FIG. 5A: the user activates the Player 2 File Target Control button (516) followed by activation of the Player 2 File Load Control button (518) which directs the anchor record currently stored in the Anchor Record Staging Control (not shown on FIG. 5A but visible in FIG. 1B as character 150) to be loaded into Media Player Object 2 (520). When Player 2 is loaded and ready to play, the Player 2 Status Message (524) light (data label) will display a “Ready To Play” caption; also, the user may then read the name of the artist and title in the Artist Display (526) and Title Display (528). Observe the Track Timing display (522) located above the status message. Next, the user may activate the Play 2 control (530) to begin reproduction of the loaded digital media file.

Continuing further with the media player object sets depicted in FIG. 5A: the user activates the Player 3 File Target Control button (532) followed by activation of the Player 3 File Load Control button (534) which directs the anchor record currently stored in the Anchor Record Staging Control (not shown on FIG. 5A but visible in FIG. 1B as character 150) to be loaded into Media Player Object 2 (536). When Player 3 is loaded and ready to play, the Player 3 Status Message (540) light (data label) will display a “Ready To Play” caption; also, the user may then read the name of the artist and title in the Artist Display (542) and Title Display (544). Observe the Track Timing display (538) located above the status message. Next, the user may activate the Play 3 control (546) to begin reproduction of the loaded digital media file. This completes a description of the characters within the Media Player Object Group 1 (116.1) in FIG. 5A.

Now referring to the media player object sets in Media Player Object Group 2 (116.2) as shown in FIG. 5A where, in this depicted embodiment, the media player object sets are seen in the invention's standard-order construction like those in Media Player Object Group 1 (116.1). The user activates the Player 4 File Target Control button (548) followed by activation of the Player 4 File Load Control button (550) which directs the anchor record currently stored in the Anchor Record Staging Control (not shown on FIG. 5A but visible in FIG. 1B as character 150) to be loaded into Media Player Object 4 (552). When Player 4 is loaded and ready to play, the Player 4 Status Message (556) light (data label) will display a “Ready To Play” caption; also, the user may then read the name of the artist and title in the Artist Display (558) and Title Display (560). Observe the Track Timing display (554) located above the status message. Next, the user may activate the Play 4 control (562) to begin reproduction of the loaded digital media file.

Continuing with a description of FIG. 5A: the user activates the Player 5 File Target Control button (564) followed by activation of the Player 5 File Load Control button (566) which directs the anchor record currently stored in the Anchor Record Staging Control (not shown on FIG. 5A but visible in FIG. 1B as character 150) to be loaded into Media Player Object 5 (568). When Player 5 is loaded and ready to play, the Player 5 Status Message (572) light (data label) will display a “Ready To Play” caption; also, the user may then read the name of the artist and title in the Artist Display (574) and Title Display (578). Observe the Track Timing display (570) located above the status message. Next, the user may activate the Play 5 control (580) to begin reproduction of the loaded digital media file.

Now concluding FIG. 5A: the user activates the Player 6 File Target Control button (582) followed by activation of the Player 6 File Load Control button (584) which directs the anchor record currently stored in the Anchor Record Staging Control (not shown on FIG. 5A but visible in FIG. 1B as character 150) to be loaded into Media Player Object 6 (586). When Player 6 is loaded and ready to play, the Player 6 Status Message (590) light (data label) will display a “Ready To Play” caption; also, the user may then read the name of the artist and title in the Artist Display (592) and Title Display (594). Observe the Track Timing display (588) located above the status message. Next, the user may activate the Play 6 control (596) to begin reproduction of the loaded digital media file.

Now referring to FIG. 5B-1. In an embodiment of the invention depicted in FIG. 5B-1, a “media player object set” (MPOS) has been created to enhance the inherent capabilities of the Microsoft® ActiveX® Media Player Control object—which functions as the core media player object; e.g., the Microsoft® ActiveX® Media Player Control object performs the role of decoding and reproducing audio, video and messages from digital media files, while the other elements in a media player object set perform roles related to workflow guidance and facilitation of situational awareness logic in the invention's Master Container Object (MCO). In an embodiment, the MPOS is instantiated (created) with tools available in an integrated development environment (Microsoft® Access™), and the MPOS is stored within the MCO which is also created in the same integrated development environment. The entirety of the Media Player 1 object set as illustrated in FIG. 5B-1 is comprised of more than sixteen elements. Two of those elements, the Microsoft® ActiveX® Media Player Control object and its connected timeline control (which incorporates elapsed time/total time displays, plus pause, stop, mute and audio level controls) are created and distributed by Microsoft® Corporation, and the remaining fourteen elements have been created specifically for the invention.

Therefore, FIG. 5B-1 is an organizational diagram that illustrates, in one embodiment, the various elements that may comprise an enhanced standard-order construction “media player object set” (MPOS) design where a discrete Microsoft® ActiveX® Media Player Control object—which has no innate awareness (knowledge) of, or intrinsic collaborative capability with, other discrete media player objects—is augmented by a plurality of media player object set elements which can be manipulated by program instructions to assist in the facilitation of a dependable degree of situational awareness (SA) logic for the purpose of a creating a practical collaboration between discrete media player objects.

In one embodiment, the SA logic includes ordered workflow (sequential event execution), with corresponding visual guidance cues for the user, that effectively confers an articulate standard of collaborative interoperability between discrete media player objects; i.e. a level of consistent collaboration to include scheduled timing for media player object event execution(s) based on a programmed decision structure that can assess the natural states (such as not loaded, ready to load, ready to play, now playing, audio level, elapsed time, etc.) of each media player object—and evaluate the effect of media player object state changes on a plurality of other objects in the program environment. Using this method of SA logic, the elements (components) in the invention's media player object set function as part of a greater system of data points, conditional calculations and rules-based instructions that compliment and extend the capabilities of each discrete Microsoft® ActiveX® Media Player Control object so it can be directed to accept and execute instructions as part of a MPOS, and according to a master plan. The effect of this design causes each discrete media player object set—instantiated as one member of a plurality of media player object sets, each set to include, in one embodiment, a core media player object and the invention's additional media player object set elements—to interact with the programming environment, user actions, and other media player object sets as if each discrete media player object within each MPOS does have an innate awareness of each other media player object (and its various event states).

For the user, the advantages provided by the creation of a programming world where media player objects can intelligently collaborate are numerous and useful—and will be made obvious by the methods described in this specification.

The delineation order for each media player object set element (component) in FIG. 5B-1 will now be described along with brief comment on each element's designated role as a part of the Master Container Object (MCO) in one embodiment.

From top to bottom, the characters delineated for the Media Player 1 object set components in FIG. 5B-1 include:

the Media Player Object set (504) framework which is a collection of objects used to enhance the capabilities of the core MPO, the Microsoft® ActiveX® Media Player Control;

the File Target Control (500) which is primarily a command switch used to designate a specific media player object (MPO) as the intended (standby) recipient of a compatible digital media file which will be transferred from the Anchor Record Staging Control (which can be viewed in FIG. 1B, character 150);

the Title Load Control (502) which is a data indicator because it will display the title of a targeted file in large typeface, but it is also a command switch used to initiate the load instruction for its targeted MPO;

the Speed Control (504.11) which is a data indicator because it will display the current play rate (speed) on its face, and also a command switch because it can cycle (change) the current reproduction speed for its corresponding MPO when that player has a loaded or playing file;

the ActiveX® Control (504.21) which is a Microsoft® ActiveX® Media Player Control and the core MPO which performs the role of decoding and reproducing audio, video and messages from digital media files;

the Track Timing Display (506) which is a data indicator because it will display the timing values, end styles and transition tempos as associated with a specific track (file) loaded in the MPO; and it is also a “data point” (or stored reference) used to calculate record attributes (such as the Time IN to first vocal for a particular music track) which can be used by the rules-based programming in the invention's situational awareness (SA) logic to initiate display behaviors (such as showing the Time IN value with a bright magenta background color when a music track is loaded where the Time IN value is equal to :00);

the Timeline (504.31) which is a part of the Microsoft® ActiveX® Media Player Control and both a data indicator (showing elapsed/total time) and a command control that incorporates several functions such as: stop, pause, mute audio, change audio level, and advance or reverse the progression (start to finish timing) of the digital media file along its linear display bar;

the Status Message Light (508) which is a data indicator because it will display in (variable color caption typeface, depending on the deduced state) the status message for a player's current tangible (natural) state (such as not loaded, load next track, ready to load, now playing, etc.); and it is also a data point (or stored reference) used, for example, to assess the availability of a specific player for track the load process, or to allow the Master Container Object (MCO) to evaluate a decision to advance program focus (program attention at a given moment) to a specific player;

the Artist Display (510) which is a visual display cue for the user because it identifies the name of the artist associated with the specific record (such as a music track digital media file) loaded in a specific player, and it is also a data point used in the decision to apply, for example, an instant match artist filter based on the artist attribute (key data value) of the specific file loaded in the player;

the Resident Attribute Key Data Match Indicator (RAKDMI) (504.41) which is both a command control and a visual display cue for the user because when the RAKDMI is visible (shown, for example, in bright purple around the edge of the Artist label in the media player object), it tells the user that by double-clicking the RAKDMI, he can apply an instant “match filter” that will mask or hide all records that do not share the same Artist attribute (key data value as stored in an associated database field) as the record (such as a music track) that is currently loaded in the player—and thereby show only those records, from a plurality of query search retrieved records, that do share the same value (artist name) as the record that is currently loaded in the player;

the Title Display (512) which is a visual display cue for the user because it identifies the name of the title associated with the specific record (such as a music track digital media file) loaded in a specific player;

the large (as in “easy-to-read” and “hard-to-miss”) Play 1 Button (514) serves in three roles, first as a command control allowing the user to start play of its respective player, then as a visual display cue where the color of its caption changes to let the user know its respective player is the subject of focus and ready for instant start, and thirdly as a data point for the SA in the MCO which evaluates the caption of the play button to facilitate its workflow sequencing;

the play button color Proximity Light (504.51) which is displayed around the edges of the large Play 1 button and therefore serves as a data indicator letting the user know his mouse is hovering over the large play command control;

the Now Playing Inside Border Light (504.61) which is a data indicator designed to offer a bold visual cue around the inside edges of the MPO framework when a specific player is in both the now playing and last started modes;

the Player Ready Focus Border Light (504.71) which is also a data indicator designed to offer a bold visual cue when visible as a large color border around the outside edges of the media player object that is the current subject of program focus;

the post-event Player ID Label (504.81) which is actually located behind the Play 1 Button (514) and not visible until the Play 1 button is hidden; this is a data indicator that displays the number of the media player object which has executed a play event, and a command control that when double-clicked by the user offers a shortcut in the file load process; it is also a data point used to assess the play back state of its respective player.

For one embodiment, the media player object set elements arranged in this manner described for media player object set (MPOS) 1 in FIG. 5B-1 may be referenced as the “standard-order” construction.

In one embodiment, the command associated with the key data value label corresponding to the Resident Attribute Key Data Match Indicator (504.41) can alternately implement filters for other key data value fields such as Music Type, Year of Release and Theme (message) Content and is therefore the Resident Attribute Key Data Match Indicator is not limited to indicating a filter for the Artist field only. An embodiment may also feature additional visual and data elements in the media player object set (MPOS) which may not be shown in FIG. 5B-1.

For the record, one embodiment implements the MPOS elements for Media Player 2 and 3 in exactly the same order as the arrangement for Media Player 1. Media Player 2 and 3 are referenced in greater detail in FIG. 5D.

In order to better understand the useful benefits of implementing this invention's MPOS design (as illustrated in FIG. 5B-1) that can enhance the basic capabilities of an instantiated media player object, the following paragraphs are provided to explain a relatively simple decision structure. This example is not an actual computer instruction from the invention, but is arranged instead as a series of given facts and logic statements that demonstrate how a computer instruction (which can be formulated in different programming languages according to an embodiment) can assess facts (as may be stored in the invention's data point objects) and deduce a conclusion; and then, based on that conclusion (evaluation), proceed to manipulate the co-coordinated behaviors for a plurality of core media player objects such as, in one embodiment, Microsoft® ActiveX® Media Player Control objects, where the elements of the invention's media player object set comprise a portion of the invention's situational awareness logic capabilities. For example:

IF a discrete media player object (MPO), identified as “MPO-A”, can be understood by the programmed environment—or the “Master Container Object” (MCO) in this invention—to be in a busy state (as in now playing);

AND IF it can also be understood that, in a plurality of integrated media player objects, “MPO-A” was the most recent MPO that executed a play (start) command;

AND IF, at the same time, “MPO-B”, also a discrete media player object, can be understood to be not ready to play (because it may not be loaded with a valid digital media file);

AND IF, at the same time, a third discrete media player object, “MPO-C”, can be understood to be ready to play (because it is loaded with a valid digital media file);

AND IF, at the same time, a fourth discrete media player object, “MPO-D”, can be understood to be ready to play (because it is loaded with a valid digital media file);

THEN the situational awareness logic in the Master Container Object, in one embodiment, can be programmed to execute a plurality of functions such as:

transfer program FOCUS (the subject of attention within a given moment and procedure) to what is sequentially identified as the next ready to play media player object, “MPO-C”;

visually mark (indicate internally to a procedure, and externally via computer display) “MPO-C” for NEXT event execution;

evaluate the audio output level of “MPO-C” before it is started and ALTER its level according to a pre-defined standard so that the level is consistent with an acceptable range at the moment “MPO-C” is started;

calculate or deduce the IN time (measured in seconds or milliseconds increments) that may exist between the moment that “MPO-C” begins playing a loaded digital media file (such as a “:00 music track”) where the file producer has synchronized the first vocal of the song to start coincidentally with the song's instrumentation—and then visually NOTIFY the user (via data indicators or contrasting border lights) when certain music tracks are mastered with a zero-second IN time, in order to prevent user timing errors;

deduce from stored data point values, such as the assigned designation of a specific media file content-type (as in music with vocal, promotional announcement, sound effect, etc.), and NOTIFY the user (via data indicators or varying color captions) and change data indicator labels when a certain media file content-type is loaded in a specific media player object like “MPO-C”, so the user may visually differentiate between dissimilar forms of content;

begin a three-second FADE to zero of the audio level output from “MPO-A” (the preceding media player object) at the moment the user (or the program) gives the play (start) command for the next event “MPO-C”;

add the title of the digital media file as contained in the now playing media player object, “MPO-C”, to a dynamically generated list (summary) of executed media files; which may later be used to print a report of executed files including informative data such as play order and a time/date stamp;

seek and identify the next ready media player object in order to transfer program FOCUS (the subject of attention within a given moment and procedure) for the purpose of preparing the program (or the user) to execute what is sequentially identified as the next ready to play media player object, (in this example) “MPO-D”.

This concludes an example of how logic statements attached to, or reacting to, various states in media player object set components in FIG. 5B-1 might be used to assess facts and deduce a conclusion.

Now referring to FIG. 5B-2 where character 506-5B depicts a more detailed view of a media player object element known as the Track Timing Display (TTD) which is part of the Media Player 1 object set (seen in FIG. 5B-1, character 506). The TTD (506-5B) is comprised of these functional components: the Track In Time (506.11), the Track End Style (506.21), the Track Total Time (506.31) and Track Transition Tempos (506.41).

In FIG. 5B-2: the Track IN Time data indicator (506.11) is used to inform the user of the length of the time from start of first audio to start of first vocal; it is also used as a data point for the situational awareness logic which can change display behaviors and workflow sequencing based, in part, on the value of the Time IN data indicator;

the Track END Style data indicator (506.21) holds a stored value that tells the user the manner in which the loaded track (such as a music track with vocal) may be concluded; i.e. a visual indication as to whether, for example, the audio for a digital media file ends cold (abruptly), fades out, is capped with a musical sting, etc;

the Track TOTAL Time data indicator (506.31) holds a stored value that informs the user of the approximate length (time) of the loaded track; it is also a data point because the total length of the track (file) can be used by the situational awareness (SA) logic in the Master Container Object (MCO) to execute decision structures that, for example, affect the disposition of the screen display;

the Track TRANSITION Tempos data indicator (506.41) tells the user how a loaded track may begin and end with regard to different tempos (rate of speed for a musical piece or passage); e.g. a track that starts with an up-tempo feel and ends with a slow tempo sound may be displayed at “US” (up/slow). This concludes a description of FIG. 5B-2.

Now referring to FIG. 5C-1: in an embodiment of the invention, as shown in FIG. 5C-1, a “media player object set” (MPOS) has been created to enhance the inherent capabilities of the Microsoft® ActiveX® Media Player Control object—which functions as the core media player object; i.e., the Microsoft® ActiveX® Media Player Control object performs the role of decoding and reproducing audio, video and messages from digital media files, while the other elements in a media player object set perform roles related to workflow guidance and facilitation of situational awareness logic in the invention's Master Container Object (MCO).

The MPOS is instantiated (created), in one embodiment, with tools available in an integrated development environment (Microsoft® Access™), and the MPOS is stored within the MCO which is also created in the same integrated development environment. The entirety of the Media Player 4 object set as illustrated in FIG. 5C-1 is comprised of more than sixteen elements. Two of those elements, the Microsoft® ActiveX® Media Player Control object and its connected timeline control (which incorporates elapsed time/total time displays, plus pause, stop, mute and audio level controls) are created and distributed by Microsoft® Corporation, and the remaining fourteen elements have been created specifically for the invention.

Therefore, FIG. 5C-1 is an organizational diagram that illustrates, in one embodiment, the various elements (components) that may comprise an enhanced inverted-order construction “media player object set” (MPOS) design where a discrete Microsoft® ActiveX® Media Player Control object—which has no innate awareness (knowledge) of, or intrinsic collaborative capability with, other discrete media player objects—is augmented by a plurality of media player object set elements which can be manipulated by program instructions to assist in the facilitation of a dependable degree of situational awareness (SA) logic for the purpose of a creating a practical collaboration between discrete media player objects.

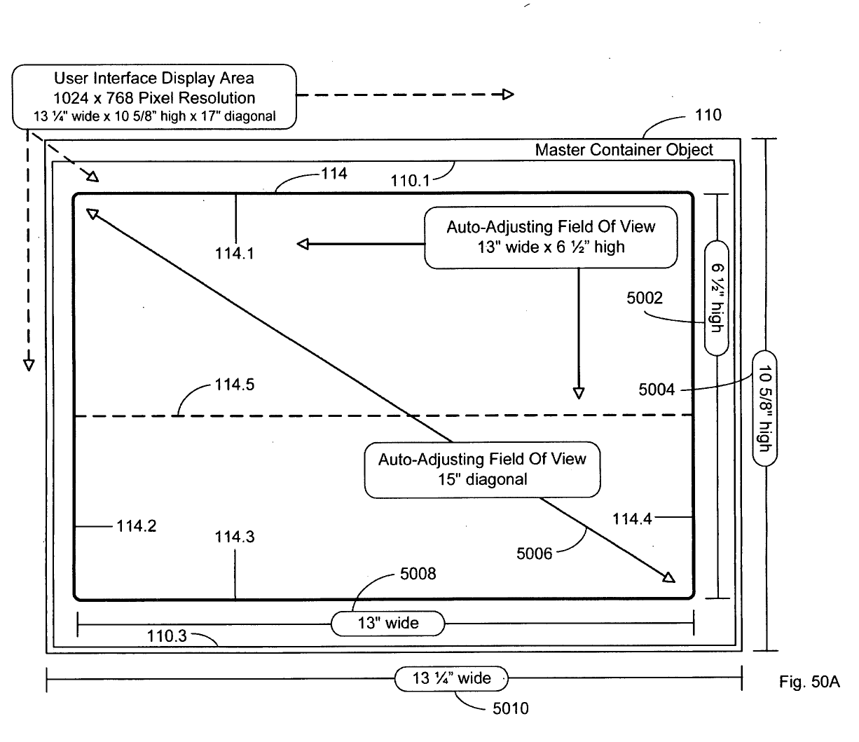

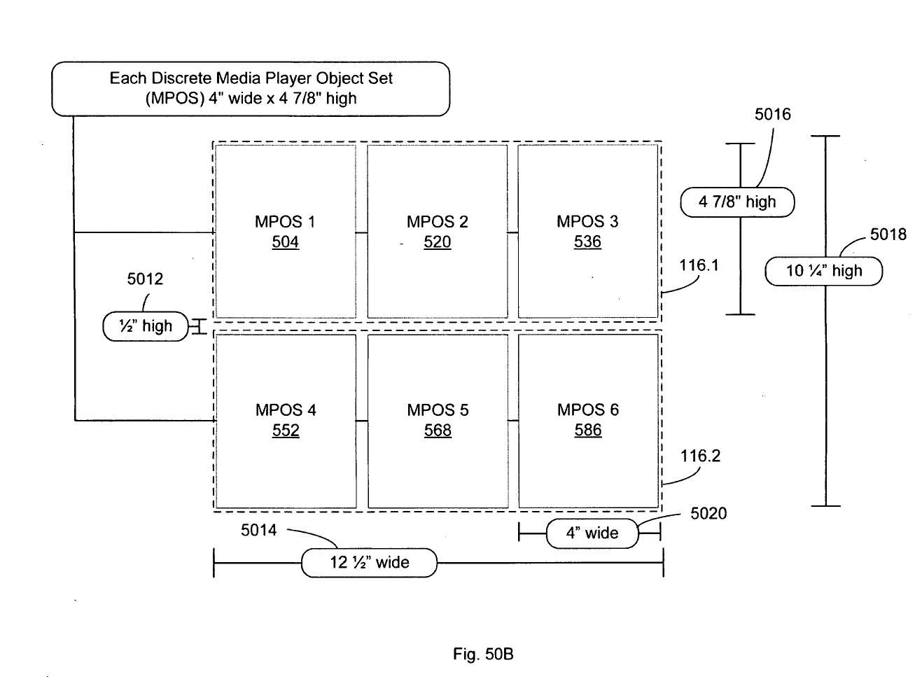

The delineation order for the media player object set elements in FIG. 5C-1 (illustrating the Media Player 4 Object Set) may be viewed in context with other media player object sets in FIG. 5D. It is noted here that the arrangement of elements (components) for the Media Player 4 Object Set is almost a mirror-image reversal when compared with the arrangement of elements for the Media Player 1 Object Set. This element reversal has been implemented in order to facilitate a more efficient alignment for the concurrent display of key elements from a plurality of media player objects. (This design is illustrated in relationship with the dimensions of a “field of view’ area on the display screen in FIGS. 50 through 55.)

Now the description turns to the inverted-order arrangement of the media player object set depicted in FIG. 5C-1. From top to bottom, the elements delineated for the Media Player 4 object set in FIG. 5C-1 include:

the Media Player Object set (552) framework which is a collection of objects used to enhance the capabilities of the core MPO, the Microsoft® ActiveX® Media Player Control;

the post-event Player ID Label (552.82) which is actually located behind the Play 4 Button (562) and not visible until the Play 4 button is hidden; this is a data indicator that displays the number of the media player object which has executed a play event, and a command control that when double-clicked by the user offers a shortcut in the file load process; it is also a data point used to assess the play back state of its respective player.

the play button color Proximity Light (552.52) which is displayed around the edges of the large Play 4 button and therefore serves as a data indicator letting the user know his mouse is hovering over the large play command control;

the large (as in “easy-to-read” and “hard-to-miss”) Play 4 Button (562) serves in three roles, first as a command control allowing the user to start play of its respective player, then as a visual display cue where the color of its caption changes to let the user know its respective player is the subject of focus and ready for instant start, and thirdly as a data point for the SA in the MCO which evaluates the caption of the play button to facilitate its workflow sequencing;

the Artist Display (558) which is a visual display cue for the user because it identifies the name of the artist associated with the specific record (such as a music track digital media file) loaded in a specific player, and it is also a data point used in the decision to apply, for example, an instant match artist filter based on the artist attribute (key data value) of the specific file loaded in the player;

the Resident Attribute Key Data Match Indicator (RAKDMI) (552.42) which is both a command control and a visual display cue for the user because when the RAKDMI is visible (shown, for example, in bright purple around the edge of the Artist label in the media player object), it tells the user that by double-clicking the RAKDMI, he can apply an instant “match filter” that will mask or hide all records that do not share the same Artist attribute (key data value as stored in an associated database field) as the record (such as a music track) that is currently loaded in the player—and thereby show only those records, from a plurality of query search retrieved records, that do share the same value (artist name) as the record that is currently loaded in the player;

the Title Display (560) which is a visual display cue for the user because it identifies the name of the title associated with the specific record (such as a music track digital media file) loaded in a specific player;

the Status Message Light (556) which is a data indicator because it will display in (variable color caption typeface, depending on the deduced state) the status message for a player's current tangible (natural) state (such as not loaded, load next track, ready to load, now playing, etc.); and it is also a data point (or stored reference) used, for example, to assess the availability of a specific player for track the load process, or to allow the Master Container Object (MCO) to evaluate a decision to advance program focus (program attention at a given moment) to a specific player;

the Track Timing Display (554) which is a data indicator because it will display the timing values, end styles and transition tempos as associated with a specific track (file) loaded in the MPO; and it is also a “data point” (or stored reference) used to calculate record attributes (such as the Time IN to first vocal for a particular music track) which can be used by the rules-based programming in the invention's situational awareness (SA) logic to initiate display behaviors (such as showing the Time IN value with a bright magenta background color when a music track is loaded where the Time IN value is equal to :00);

the Timeline (552.32) which is a part of the Microsoft® ActiveX® Media Player Control and both a data indicator (showing elapsed/total time) and a command control that incorporates several functions such as: stop, pause, mute audio, change audio level, and advance or reverse the progression (start to finish timing) of the digital media file along its linear display bar;

the ActiveX® Control (552.22) which is a Microsoft® ActiveX® Media Player Control and the core MPO which performs the role of decoding and reproducing audio, video and messages from digital media files;

the Speed Control (552.12) which is a data indicator because it will display the current play rate (speed) on its face, and also a command switch because it can cycle (change) the current reproduction speed for its corresponding MPO when that player has a loaded or playing file;

the Title Load Control (550) which is a data indicator because it will display the title of a targeted file in large typeface, but it is also a command switch used to initiate the load instruction for its targeted MPO;

the File Target Control (548) which is primarily a command switch used to designate a specific media player object (MPO) as the intended (standby) recipient of a compatible digital media file which will be transferred from the Anchor Record Staging Control (which can be viewed in FIG. 1B, character 150);

the Now Playing Inside Border Light (552.62) which is a data indicator designed to offer a bold visual cue around the inside edges of the MPO framework when a specific player is in both the now playing and last started modes;

and the Player Ready Focus Border Light (552.72) which is also a data indicator designed to offer a bold visual cue when visible as a large color border around the outside edges of the media player object that is the current subject of program focus.

For one embodiment, the media player object set elements arranged in the manner described for media player object set (MPOS) 4 in FIG. 5C-1 may be referenced as the “inverted-order” construction.

In one embodiment, the command associated with the key data value label corresponding to the Resident Attribute Key Data Match Indicator (552.42) can alternately implement filters for other key data value fields such as Music Type, Year of Release and Theme (message) Content and is therefore the Resident Attribute Key Data Match Indicator is not limited to indicating a filter for the Artist field only. An embodiment may also feature additional visual and data elements in the media player object set (MPOS) which may not be shown in FIG. 5C-1.

For the record, one embodiment implements the MPOS elements for Media Players 5 and 6 in exactly the same order as the arrangement for Media Player 4. Media Players 5 and 6 are referenced in greater detail in FIG. 5D

In order to better understand the useful benefits of implementing this invention's MPOS design (as illustrated in FIG. 5C-1), the reader is directed to review a section of paragraphs above which reference FIG. 5B-1, and explain how a relatively simple decision structure in the invention's situational awareness (SA) logic design can depend, in part, on the elements of the media player object set.

Now referring to FIG. 5C-2 where illustration 554-5C depicts a more detailed view of a media player object element known as the Track Timing Display (TTD) which is part of the Media Player 4 object set (seen in FIG. 5C-1, character 554). The TTD (554-5C) is comprised of these functional components: the Track In Time (554.12), the Track End Style (554.22), the Track Total Time (554.32) and Track Transition Tempos (554.42).

In FIG. 5C-2: the Track IN Time data indicator (554.12) is used to inform the user of the length of the time from start of first audio to start of first vocal; it is also used as a data point for the situational awareness logic which can change display behaviors and workflow sequencing based, in part, on the value of the Time IN data indicator;

the Track END Style data indicator (554.22) holds a stored value that tells the user the manner in which the loaded track (such as a music track with vocal) may be concluded; i.e. a visual indication as to whether, for example, the audio for a digital media file ends cold (abruptly), fades out, is capped with a musical sting, etc;

the Track TOTAL Time data indicator (554.32) holds a stored value that informs the user of the approximate length (time) of the loaded track; it is also a data point because the total length of the track (file) can be used by the situational awareness (SA) logic in the Master Container Object (MCO) to execute decision structures that, for example, affect the disposition of the screen display;

the Track TRANSITION Tempos data indicator (554.42) tells the user how a loaded track may begin and end with regard to different tempos (rate of speed for a musical piece or passage); e.g. a track that starts with an medium-tempo feel and ends with an up tempo sound may be displayed at “MU” (medium/up). This concludes a description of FIG. 5C-2.

FIG. 5D is an organizational diagram that illustrates in greater detail the various elements that may comprise an enhanced “media player object set” design where such components, according to one embodiment, can be data labels (such as the Track Timing Data Display), command control objects (such as the Speed Control) and can be used to visually guide the user, or to manipulate player performance, or to serve as reference points for data assessments performed during the execution of a programming procedure.

The reader should realize that, in an embodiment, the term “media player object set(s)” refers to many elements that comprise an instantiated media player object to include the core media player object (which in one embodiment is a Microsoft® ActiveX® Media Player Control) and associated message labels, data indicators, command and control buttons, etc. as detailed in this specification. Also, the term “media player object group(s)” refers to a collection (plurality) of discrete media player objects which can be manipulated by the invention's situational awareness (SA) logic. In this specification, all elements (components) that comprise a media player object set are creations developed for this invention—with one exception: the Microsoft® ActiveX® Media Player Control, as referenced in an embodiment, is a software object distributed by Microsoft® Corporation).

From top to bottom, the elements in the media player object set delineated for Media Player 1 object set in FIG. 5D include: the Media Player Object set (504) framework which is a collection of objects used to enhance the capabilities of the core MPO, the Microsoft® ActiveX® Media Player Control; the File Target Control (500); the Title Load Control (502); the Speed Control (504.11); the ActiveX® Control (504.21); the Track Timing Display (506); the Timeline (504.31); the Status Message Light (508); the Artist Display (510); the Resident Attribute Key Data Match Indicator (504.41); the Title Display (512); the large Play 1 Button (514); the play button color Proximity Light (504.51) which is displayed around the edges of the large Play 1 button; the Now Playing Inside Border Light (504.61); the Player Ready Focus Border Light (504.71) which is displayed as a large color border around the outside edges on the media player object; and the post-event Player ID Label (504.81) which is actually located behind the Play 1 Button and not visible until the Play 1 button is hidden. For one embodiment, the media player object set elements arranged in this manner may be referenced as the “standard-order” construction.

In one embodiment, the command associated with the key data value label corresponding to the Resident Attribute Key Data Match Indicator (504.41) can alternately implement filters for other key data value fields such as Music Type, Year of Release and Theme (message) Content and is therefore the Resident Attribute Key Data Match Indicator is not limited to indicating a filter for the Artist field only. An embodiment may also feature additional visual and data elements in the media player object set (MPOS) which may not be shown in FIG. 5D.

In one embodiment, it can be envisioned that a plurality of media player objects (two, three, or more) can be instantiated in a manner that deploys media player object set elements as described above in standard-order construction. However, it is possible to envision an alternative embodiment that offers an enhanced visual display method for a plurality of media player objects presented in concurrent groups.

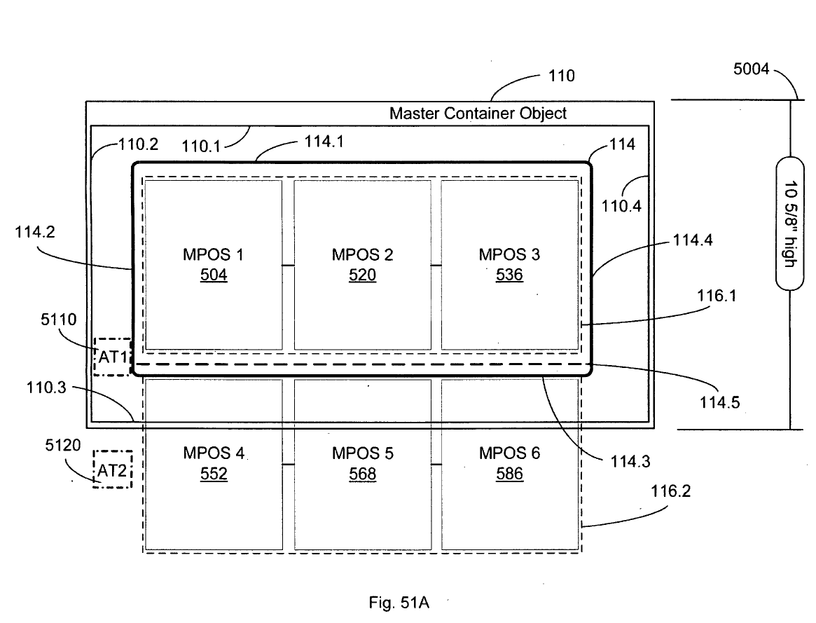

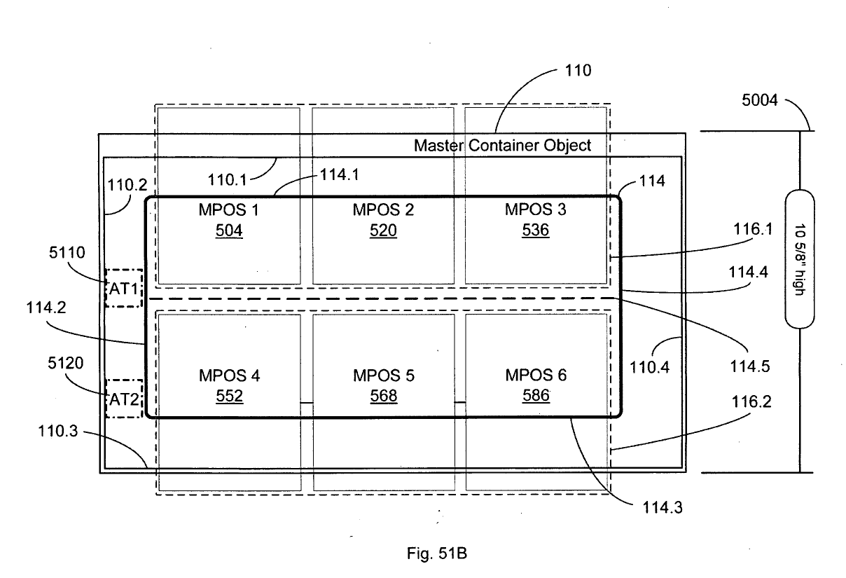

The challenge of devising a display that allows concurrent groups of media player objects to fit in one standard resolution window, without altering the purposeful large (easy-to-read) dimensions of any key design elements, has been solved by the introduction of “inverted order” construction. In FIG. 5D, Player 4, Player 5 and Player 6 are depicted as media player object sets created with inverted-order construction. A more detailed illustration of media player object group dimensions and how each media player object group fits within an aligned “field of view” can be seen depicted in FIGS. 50 through 55. (Note the Alignment Tabs—hidden program objects—in FIG. 51A and 51B that are used as data points to synchronize display of standard-order and inverted-order construction media player object set elements for each media player object group within field of view in the Master Container Object interface window.)

Now referring to the elements in the Media Player 2 object set in FIG. 5D which, from top to bottom, includes: the Media Player Object set (520) framework which is a collection of objects used to enhance the capabilities of the core MPO, the Microsoft® ActiveX® Media Player Control; the File Target Control (516); the Title Load Control (518); the Speed Control (520.11); the ActiveX® Control (520.21); the Track Timing Display (522); the Timeline (520.31); the Status Message Light (524); the Artist Display (526); the Resident Attribute Key Data Match Indicator (520.41); the Title Display (528); the large Play 2 Button (530); the play button color Proximity Light (520.51) which is displayed around the edges of the large Play 2 button; the Now Playing Inside Border Light (520.61); the Player Ready Focus Border Light (520.71) which is displayed as a large color border around the outside edges on the media player object; and the post-event Player ID Label (520.81) which is actually located behind the Play 2 Button and not visible until the Play 2 button is hidden. For one embodiment, the media player object set elements arranged in this manner may be referenced as the “standard-order” construction.

Now referring to the elements in the Media Player 3 object set in FIG. 5D which, from top to bottom, includes: the Media Player Object set (536) framework which is a collection of objects used to enhance the capabilities of the core MPO, the Microsoft® ActiveX® Media Player Control; the File Target Control (532); the Title Load Control (534); the Speed Control (536.11); the ActiveX® Control (536.21); the Track Timing Display (538); the Timeline (536.31); the Status Message Light (540); the Artist Display (542); the Resident Attribute Key Data Match Indicator (536.41); the Title Display (544); the large Play 3 Button (546); the play button color Proximity Light (536.51) which is displayed around the edges of the large Play 3 button; the Now Playing Inside Border Light (536.61); the Player Ready Focus Border Light (536.71) which is displayed as a large color border around the outside edges on the media player object; and the post-event Player ID Label (536.81) which is actually located behind the Play 3 Button and not visible until the Play 3 button is hidden. For one embodiment, the media player object set elements arranged in this manner may be referenced as the “standard-order” construction.

Continuing with an explanation of FIG. 5D: looking at the elements in the media player object set delineated for Media Player 4 object (552), from top to bottom: the post-event Player ID Label (552.82) which is actually located behind the Play 4 Button and not visible until the Play 4 button is hidden; the large play button color Proximity Light (552.52) which is displayed around the edges of the large Play 4 button; the Play 4 Button (562); the Artist Display (558); the Resident Artist Key Data Match Indicator (552.42); the Title Display (560); the Status Message Light (556); the Track Timing Display (554); the Timeline (552.32); the ActiveX® Control (552.22); the Speed Control (552.12); the Title Load Control (550); and the File Target Control (548); the Now Playing Inside Border Light (552.62); and the Player Ready Focus Border Light (552.72) which is displayed as a large color border around the outside edges on the media player object. For one embodiment, the media player object set elements arranged in this manner may be referenced as the “inverted-order” construction.

It can noted that the inverted-order construction of Media Player Object 4 (552) is essentially an almost mirror-image reversal of the Media Player Object 1 (504) in this embodiment. The specific advantage in using an embodiment with such a design—the standard-order/inverted-order construction implementation—will be discussed later in this specification.

In one embodiment, the command associated with the key data value label corresponding to the Resident Attribute Key Data Match Indicator (552.42) can alternately implement filters for other key data value fields such as Music Type, Year of Release and Theme (message) Content and is therefore the Resident Attribute Key Data Match Indicator is not limited to indicating a filter for the Artist field only. An embodiment may also feature additional visual and data elements in the media player object set (MPOS) which may not be shown in FIG. 5D.

Now a recitation of the elements in the media player object set delineated for Media Player 5 object (568), from top to bottom: the post-event Player ID Label (568.82) which is actually located behind the Play 5 Button and not visible until the Play 5 button is hidden; the large play button color Proximity Light (568.52) which is displayed around the edges of the large Play 5 button; the Play 5 Button (580); the Artist Display (574); the Resident Artist Key Data Match Indicator (568.42); the Title Display (578); the Status Message Light (572); the Track Timing Display (570); the Timeline (568.32); the ActiveX® Control (568.22); the Speed Control (568.12); the Title Load Control (566); and the File Target Control (564); the Now Playing Inside Border Light (568.62); and the Player Ready Focus Border Light (568.72) which is displayed as a large color border around the outside edges on the media player object.

Now a recitation of the elements in the media player object set delineated for Media Player 6 object (586), from top to bottom: the post-event Player ID Label (586.82) which is actually located behind the Play 6 Button and not visible until the Play 6 button is hidden; the large play button color Proximity Light (586.52) which is displayed around the edges of the large Play 6 button; the Play 6 Button (596); the Artist Display (592); the Resident Artist Key Data Match Indicator (586.42); the Title Display (594); the Status Message Light (590); the Track Timing Display (588); the Timeline (586.32); the ActiveX® Control (586.22); the Speed Control (586.12); the Title Load Control (584); and the File Target Control (582); the Now Playing Inside Border Light (586.62); and the Player Ready Focus Border Light (586.72) which is displayed as a large color border around the outside edges on the media player object.

On close inspection of FIG. 5D, the reader will count a total of sixteen delineated elements that comprise each media player object set, each media player object set comprising one core media player object (like, in one embodiment, the Microsoft® ActiveX® Media Player Control) and additional elements. Of the sixteen elements detailed for each media player object in the FIG. 5D diagram, fourteen were created as part of the situational awareness (SA) logic/visual display method and system of this invention. Only two elements, part of the core media player object for one embodiment, are programming objects not created for this invention: the Microsoft® ActiveX® Media Player Control and its connected timeline control. The media player object set elements as described for FIG. 5D do not represent every media player object set element that has been created for this invention. Other elements, including a closer look at the various components of the media player object Track Timing Display objects, will be described and illustrated later in this specification.

There is one additional element in FIG. 5D that that will play an important part in the implementation of the self-adjusting “field of view” that will be discussed in connection (later in this specification) with the standard-order/inverted-order construction for elements comprising media player object sets: a program alterable line of demarcation (or “artificial horizon”) which is fundamentally a media player object group divider line (114.5) is depicted below the PLAY button areas at the bottom of Player 1, Player 2 and Player 3 (media player object group 1)—and above the PLAY button areas at the top of Player 4, Player 5 and Player 5 (media player object group 2).

Now referring to FIGS. 5E-1 through 5E-6 which are organizational diagrams that illustrate, in expanded detail, the various elements that may comprise a Microsoft® ActiveX® Control—or Microsoft® ActiveX® Windows Media® Player control object version 6.4—which is used in an embodiment as the core media player object. (To gain a better understanding of where the timeline objects described in FIGS. 5E-1 through 5E-6 fit into an embodiment's Media Player Object set, see FIG. 5D.)

FIG. 5E-1 depicts a software timeline object for digital media player 1 in one embodiment. The Media Player 1 timeline object (504.31) is delineated with seven of its key elements: the elapsed time bar indicator (504.31.11), the timeline slider control (504.31.12), the native play button (504.31.13), the native pause button (504.31.14), the native track timing display (504.31.15), the native mute control (504.31.16) and the native audio level control (504.31.17).

The term “native” as used here (in the description for FIGS. 5E-1 through 5E-6) means that these features are supplied by Microsoft® Corporation with their ActiveX® control. In at least one embodiment of this invention, the Master Container Object has been used to upgrade the functionality of these timeline controls with respect to situational awareness logic and the controls' ability to function as part of a series of objects which can be responsive to program instructions from the MCO.

FIG. 5E-2 depicts a software timeline object for digital media player 2 in one embodiment. The Media Player 2 timeline object (520.31) is delineated with seven of its key elements: the elapsed time bar indicator (520.31.11), the timeline slider control (520.31.12), the native play button (520.31.13), the native pause button (520.31.14), the native track timing display (520.31.15), the native mute control (520.31.16) and the native audio level control (520.31.17).

FIG. 5E-3 depicts a software timeline object for digital media player 3 in one embodiment. The Media Player 3 timeline object (536.31) is delineated with seven of its key elements: the elapsed time bar indicator (536.31.11), the timeline slider control (536.31.12), the native play button (536.31.13), the native pause button (536.31.14), the native track timing display (536.31.15), the native mute control (536.31.16) and the native audio level control (536.31.17).

FIG. 5E-4 depicts a software timeline object for digital media player 4 in one embodiment. The Media Player 4 timeline object (552.32) is delineated with seven of its key elements: the elapsed time bar indicator (552.32.11), the timeline slider control (552.32.12), the native play button (552.32.13), the native pause button (552.32.14), the native track timing display (552.32.15), the native mute control (552.32.16) and the native audio level control (552.32.17).

FIG. 5E-5 depicts a software timeline object for digital media player 5 in one embodiment. The Media Player 5 timeline object (568.32) is delineated with seven of its key elements: the elapsed time bar indicator (568.32.11), the timeline slider control (568.32.12), the native play button (568.32.13), the native pause button (568.32.14), the native track timing display (568.32.15), the native mute control (568.32.16) and the native audio level control (568.32.17).

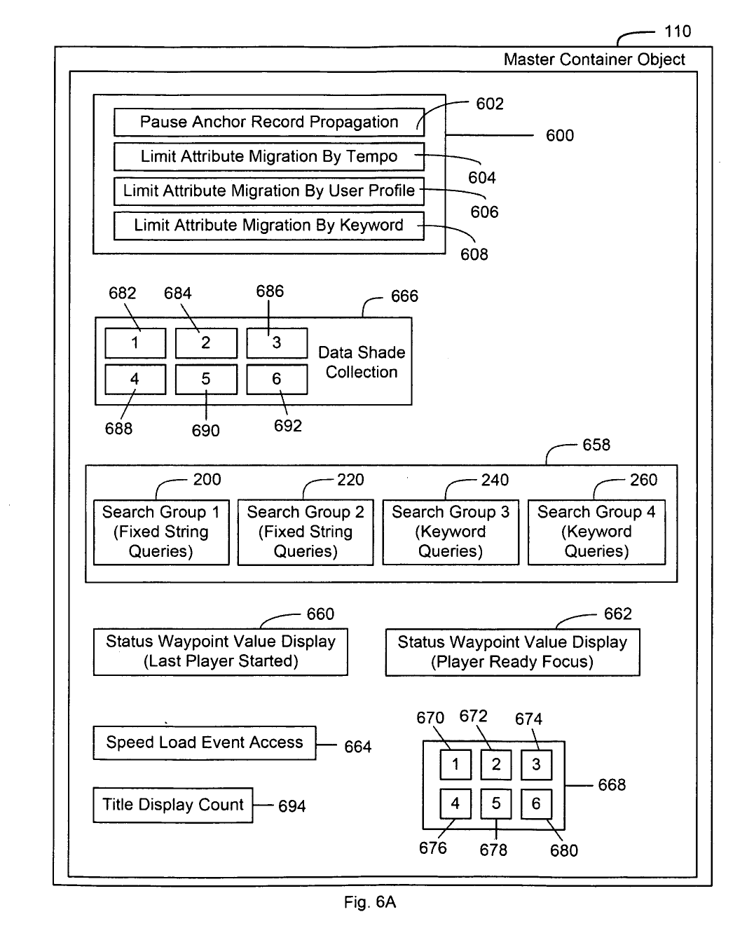

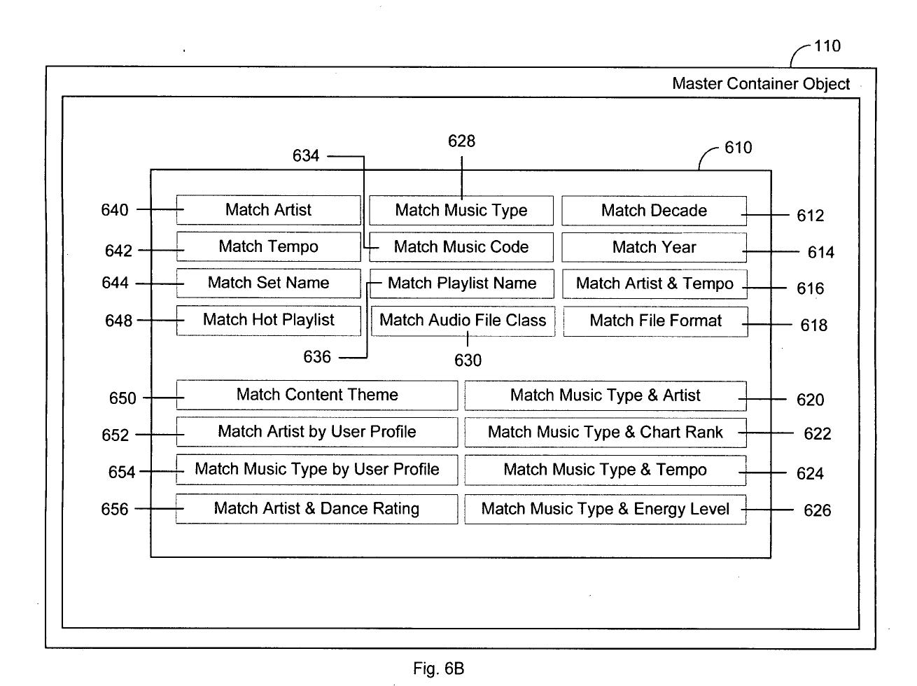

FIG. 5E-6 depicts a software timeline object for digital media player 6 in one embodiment. The Media Player 6 timeline object (586.32) is delineated with seven of its key elements: the elapsed time bar indicator (586.32.11), the timeline slider control (586.32.12), the native play button (586.32.13), the native pause button (586.32.14), the native track timing display (586.32.15), the native mute control (586.32.16) and the native audio level control (586.32.17).

Moving to FIG. 6A which is an organizational chart illustrating a plurality of query modification controls, query filter controls, command query control set objects, and waypoint value displays contained in a Master Container Object. FIG. 6A depicts elements or element groups such as: query search filter modification command buttons (600); data shade objects (666) where each data shade can be used to apply a “screened” transparency—engaging a level of a gray out effect—for media player object data when that player's data display is not required for priority assessment by the user; media player object load state tally lights (668); status waypoint value displays (660 and 662); the Speed Load access button (664); the Key Data Value Command Query Control set switching command buttons (658)—the so-called Search Group activation buttons; and the Title Display Count indicator (694). All the elements depicted in FIG. 6A are stored within the Master Container Object (110) in an embodiment.

Now a delineation of all elements depicted in FIG. 6A will be discussed for an embodiment. Present in FIG. 6A are the query search filter modification command buttons (600) which include: the Pause Anchor Record Propagation button (602), the Limit Attribute Migration By Tempo button (604); the Limit Attribute Migration By User Profile button (606); and the Limit Attribute Migration By Keyword button (608).

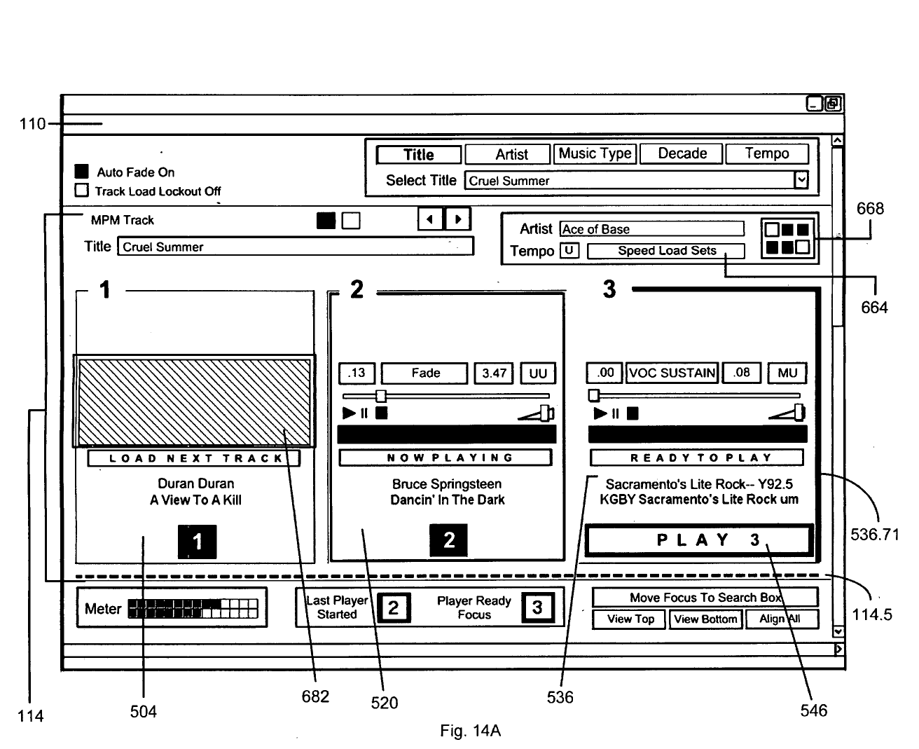

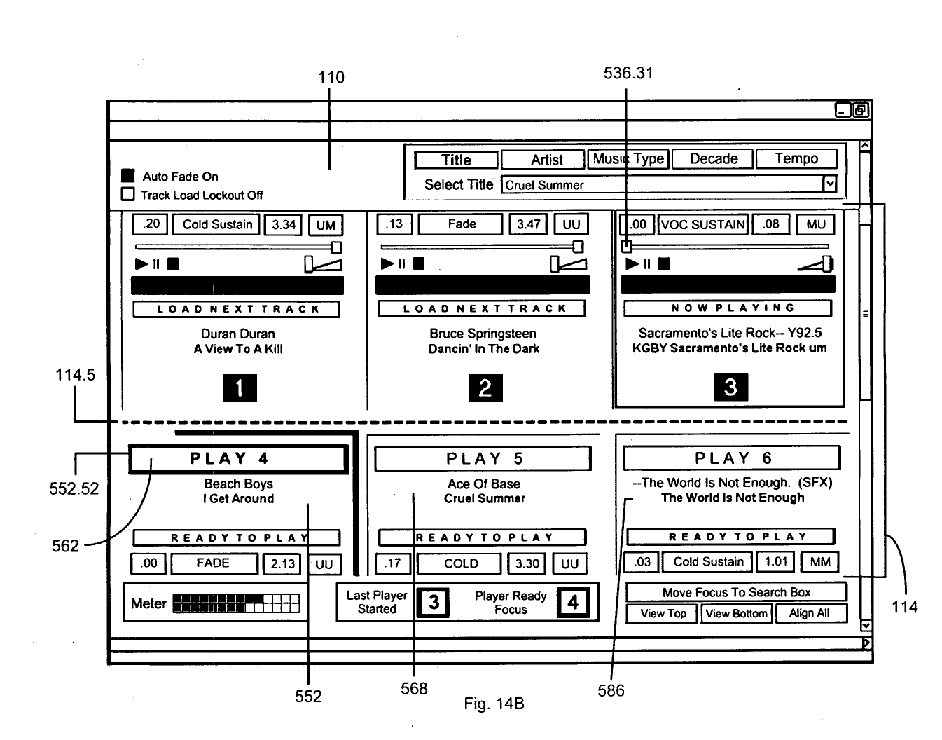

Also seen in FIG. 6A is the data shade object group (666) which includes: the Media Player 1 data shade (682); the Media Player 2 data shade (684); the Media Player 3 data shade (686); the Media Player 4 data shade (688); the Media Player 5 data shade (690); and the Media Player 6 data shade (692). (Note: FIG. 14A, illustration 682 depicts a data shade engaged in Media Player 1.)

FIG. 6A shows the Key Data Value Command Query Control set switching command buttons (658) which include: the Search Group 1 button (200); the Search Group 2 button (220); the Search Group 3 button (240); and the Search Group 4 button (260).

Continuing with FIG. 6A, the reader will observe the media player object load state tally lights (668) which include: the Media Player 1 tally light (670); the Media Player 2 tally light (672); the Media Player 3 tally light (674); the Media Player 4 tally light (676); the Media Player 5 tally light (678); and the Media Player 6 tally light (680).

Also visible in FIG. 6A are: the Last Player Started Status Waypoint Value Display (660); the Player Ready Focus Status Waypoint Value Display (662); the Speed Load Event Access button (664); and the Title Display Count (694).

Now referring to FIG. 6B which is an organizational chart illustrating a plurality (group) of query filter controls (610) that may be present within the Master Container Object (110), and which have been envisioned for an embodiment of the invention: the Match Decade button (612); the Match Year button (614); the Match Artist & Tempo button (616); the Match File Format button (618); the Match Music Type & Artist button (620); the Match Music Type & Chart Rank button (622); the Match Music Type & Tempo button (624); and the Match Music Type & Energy Level button (626).

Also depicted in FIG. 6B are these query filter controls in group 610: the Match Music Type button (628); the Match Music Code button (634); the Match Playlist Name button (636); the Match Audio File Class button (630); the Match Artist button (640); the Match Tempo button (642); the Match Set Name button (644); the Match Hot Playlist button (648); the Match Content Theme button (650); the Match Artist By User Profile button (652); the Match Music Type By User Profile button (654); and the Match Artist & Dance Rating button (656).

The functional intention of each button described above for group 610, which is to apply a record set filter, can be understood from the name assigned to each control button.

Now referring to FIG. 7A which is a flowchart depicting a method for retrieving database records and passing their associated digital media files to a specific media player object, according to one embodiment of the present invention. This high-level overview takes the user from program start, to query execution, to record summary display, to user's decision to target a media player and load (insert) the title (file) in the selected player, and finally shows how the file may be routed for audio reproduction. FIG. 7A illustrates the same process as FIG. 1B, however, FIG. 7A depicts the process using character numbers that correspond with a specific media player object set (such as illustration character 300 in FIG. 3), unlike FIG. 1B which is a generic illustration for all media player object sets in an embodiment of the invention.

Initially, in FIG. 7A, a user enters a start command (100). If the user is using a computer program, the start command will open or start the program. If the user is using an Internet-based system, the start command will retrieve or open the relevant Web site. If the embodiment was implemented as a hardware device, the start command might start the program or open a task selection panel (display). In any case, the user may be required to enter login information (102) such as a username and/or password. It can be envisioned that the system automatically identifies the user, for instance, by logging on to Windows® operating system, or is stored for future access by the computer program or hardware device.

Continuation in the system depends on the user's selection from a menu of program tasks (104) where the user can choose the start command associated with option 4 (106), “Launch Media Players”.

In one embodiment, the “Master Container Object” interface (110) opens with a default Title Key Data Value Command Query Control (300) visible near the top of the display screen and the Text Input Control (130) situated beneath the Key Data Value Command Query Control.

The same action that reveals the Title Key Data Value Command Query Control (300) automatically directs program focus to the Text Input Control (130) where a default text string (such as the title of a hit-music recording as determined by the database key data value category associated with the activated Title Key Data Value Command Query Control) is presented in white letters (typeface) on a black background (as can be typical in many Windows® applications) when the contrast of white on black, as opposed to the usual black characters on white background, is intended to visually indicate the text string, and its associated database record, is the subject of focus.

Continuing with a discussion of the flowchart depicted in FIG. 7A, when the user observes that focus is on the Text Input Control (130), he has a simple decision to make regarding query results. In one embodiment, he can accept the default (passive) mode of the Title Key Data Value Command Query Control (KDVCQC) (300) which may, in the absence of any user intervention, automatically bypass instruction from the Text Input Control (130) and retrieve a summary of records from a digital assets Media Catalog (108). The Media Catalog is stored outside of the Master Container Object, but integrated with the invention application program and stored on a local or networked computer with the Master Container Object. It can also be envisioned that an alternative embodiment may store the digital assets Media Catalog on a remote server, on an external hard drive, on a “flash” memory drive, on an Internet-enabled telephone, on an Internet data server, on a small-format computing device, on a retail music “kiosk” apparatus, or some other device.

The summary obtained by the default passive query search may be retrieved and ordered by a pre-defined SQL (structured query language) routine (programming statement) attached to the KDVCQC (300), and it may set an “anchor record”; e.g. the database bookmark pointer (internal record marker) may be synchronized to correspond with the first ordered record in the retrieved summary. However, if a user elects to submit an (active mode) improvised character string instruction in the Text Input Control (130), the Summary of Records retrieved (140) from the digital assets Media Catalog (108) may be different from the default summary and the anchor record may be different from that marked in the default summary.

Once a summary has been retrieved from the Media Catalog (108), it is automatically brought into the summary display (140) which is an extension of the Text Input Control (130) and also managed by instructions within the Master Container Object (110).

Therefore, the Summary of Retrieved Records (140) in an embodiment may be calculated (in part) by the user's decision to use a passive or active mode query as determined by his actions or non-actions in the Text Input Control (130).

For a more elaborate explanation the Text Input Control (130) and its function as a virtual switch in connection with the user's actions, refer the narrative for FIG. 1C character 130.1 (passive mode), character 130.2 (active mode) and character 130.3 (active keyword mode).

Each Key Data Value Command Query Control, such as Title, Artist, Music Type, Decade, Tempo, etc. (see FIG. 2, for an expanded illustration of available KDVCQC objects), is directly associated with stored values for the category (field) depicted by its control name, and since each Key Data Value Command Query Control (KDVCQC) is capable of generating an instant query based on its default SQL instruction and modifying that default query by facilitating direct instructions from the user in an improvisational manner, each KDVCQC is implemented as a multi-mode control; i.e. capable of executing default SQL-based queries, or capable of executing user-improvised fixed-string queries, or capable of executing user-improvised keyword queries, or combinations of these variations. (There are other query modifications that may be imposed in this invention and they will be addressed in subsequent sections of this specification.)

Continuing with a discussion of the flowchart depicted in FIG. 7A, programming instructions assigned to monitor anchor record values, as displayed in the Summary of Retrieved Records (140), simultaneously transfer the value of the summary anchor record (as marked by database bookmark) to the Anchor Record Staging Control (150) which serves as a value place holder and, as such, the first “logic waypoint” in the file load process, and therefore the Anchor Record Staging Control may be characterized as file load process waypoint 1.

The user, having automatically transferred the value of the anchor record in the summary view (140) to the anchor record staging control (150), should next identify an available media player. The user interface, implemented in one embodiment as the display screen of the Master Container Object (110), allows the user to observe which media player object (from among a plurality of, for example, two, three, six, or more depending on the embodiment) is ready to load—i.e. accept insertion (by program instruction assignment) of a digital file.

Once the user visually determines the availability of a specific media player or players, he may mentally choose a target (destination) player, and then proceed to physically activate (for example, by mouse or keyboard action) the associated Player 1 File Target Control (500)—which might be thought of as file load process waypoint 2. Activating the Player 1 File Target Control (500) causes the Player 1 Title Load Control (502) to immediately appear above the timeline of the selected media player. The title of the anchor record is then displayed on the face of the Player 1 Title Load Control button.

Next, the flowchart in FIG. 7A depicts a sequence where the user (after confirming the name of the intended title as visible on the Player 1 Title Load Control button), may then activate the Player 1 Title Load Control button (502) or icon as the final waypoint to be crossed when loading a digital media file. Activating (for example, by mouse or keyboard action) the Player 1 Title Load Control button causes immediate loading of the file stored in the Anchor Record Staging Control (150) into the selected Media Player 1 Object (504) by a means that associates a catalog hyperlink stored for a specific record with the load command for the instantiated media player object. (In cases where the situational awareness logic program instructions in Master Container Object detect that the targeted player is already playing a media file, the file load process can be automatically blocked and an error message can direct the user to select a different player.)

Finally, selecting the Play button on the successfully loaded Media Player 1 Object (504), which is now technically evaluated by Master Container Object logic as “ready to play”, starts reproduction of the media file which may be routed to the computer's Sound Card (190) which the user may connect to headphones or an external loudspeaker system. (FIGS. 5A and 5D illustrate an embodiment with a plurality of media player objects and their assorted controls including the Play button.)

As a point of clarification, in FIG. 7A, the combo box/Text Input Control (130) with its attached summary display window (140) is a common element in most Microsoft® Windows® applications. It can be easily created using Microsoft® development tools. The reader, however, will understand after reviewing additional explanations in this specification, that while the implementation of a Microsoft combo box/Text Input Control is a routine matter to programmers, the method of its implementation in this invention, where it is connected to alternating sets of Key Data Value Command Query Controls in a layered system capable of quickly initiating a diverse array of relational compound queries, makes an embodiment using this technology novel and extremely useful. (See FIG. 8A, illustration 820-140 for an embodiment display screen capture image that illustrates the summary view as connected with the Text Input Control. For an object diagram of the various complimentary sets of Key Data Value Command Query Controls, refer to FIGS. 3 and 4.)

Because the process depicted in FIG. 7A can be further clarified by FIG. 7B (which uses embodiment screen images), be sure to read the description of FIG. 7B in the following paragraphs.

FIGS. 7B through 7D are high-level overview companions to FIG. 7A because FIGS. 7B through 7D illustrate the same process as FIG. 7A, however FIGS. 7B through 7D substitute screen images from a software embodiment in place of the flowchart drawings depicted in FIG. 7A.

FIG. 7B starts where the user has decided to launch media players and has opened the Master Container Object (110) which by default, in one embodiment, enables the search by Title Key Data Value Command Query Control (KDVCQC) (300) which, when activated, sets program focus on the Text Input Control (130).

If the user decides to override the default (passive) mode of the search by Title Key Data Value Command Query Control (300) and enter an improvised text string, for example, “Baby I Need your Lovin'”, the Text Input Control (TIC) (130) will facilitate a query based on the combination of instructions attached to the default SQL query statement (assigned to the search by Title KDVCQC) and the user-submitted instruction (and also any user-applied modifications, exclusion orders or filters). Changes submitted in the TIC are updated in the Summary of Records (140) visible as a combo box (extended, multi-column, multi-row record list).

FIG. 7C starts where FIG. 7B ends. FIG. 7C shows the result of the update of the anchor record (database bookmark pointer) value in the summary which has automatically propagated (synchronized) in the Anchor Record Staging Control (150) depicted within the Master Container Object (110).

The reader should be aware that information retrieved for the summary is obtained, in one embodiment, from an associated Media Catalog (FIG. 7A, illustration 108) which is comprised of a plurality of records, each record having a plurality of key data values (attributes) and, for example, the Media Catalog contains an entry for a record title “Baby I Need your Lovin'” by artist “Johnny Rivers”.

Continuing with a discussion of the screen images depicted in FIG. 7C, if the user activates the Player 1 File Target Control (500), for Media Player Object 1, the Player 1 Title Load Control (502) button appears above the timeline in Player 1 and the title of the record as stored in the Anchor Record Staging Control (150) will be visible in large typeface on the Player 1 Title Load Control button (502).

FIG. 7D begins after the user has activated the Player 1 Title Load Control button (and therefore issued a command to cross the final waypoint in the load process) and the digital media file associated with the record title visible on the face of the Player 1 Title Load Control button has been loaded into Media Player Object 1 (504).

In an embodiment, if Media Player Object 1 (504) is already in use, e.g. can be evaluated by logic in the Master Container Object (110) to be in a busy (“now playing”) mode at the moment the load order is given, the Player 1 Title Load Control button (see FIG. 7C character 502) will trigger an error message informing the user that the load (insert) action is not possible due to the detrimental effect it would have on program operation; in other words, the invention will not allow the user to abruptly halt the audio output from Player 1 by overwriting a current music track with a new music track.

Finally, activating the Play 1 button (for example, by mouse or keyboard action) on Media Player Object 1 (504) when successfully loaded (as indicated by the Media Player 1 status message “ready to play”) will start reproduction of the media file which will be routed to the embodiment's digital to analog conversion circuit, such as a standard computer sound card (190), to facilitate audio reproduction through headphones or an external loudspeaker system.

The process of instructing a Master Container Object (MCO) (110), like that instantiated in the embodiment depicted in FIGS. 7B through 7D, to use a degree of situational awareness (SA) logic to manage a query and load sequence through a series of waypoints (such as program evaluated variables, property values, event conditions and the assessed states of other media player objects and media player object set elements) and to ultimately allow the Media Player 1 Object (FIG. 7D character 504) to load the digital media file corresponding to the value of the invention's Anchor Record Staging Control (FIG. 7C character 150) is a method and system created for this invention.

The method, for one embodiment example, also involves equating the filename property of the Media Player 1 ActiveX® control object (FIG. 5B-1, illustration 504.21) with the physical location (file path) of the target media file as maintained in the Media Catalog (database) (FIG. 7A, illustration 108) and stored on a designated hard drive where the physical location (address) can be expressed in a procedure as a valid hyperlink. The Media Catalog (FIG. 7A, illustration 108) title “Baby I Need your Lovin'”, as used in FIG. 7B, might be identified by a hyperlink path statement such as: “D:\Audio\Decades\1960s\Baby_I_Need_Your_Lovin'.mp3”, where the digital media file corresponding to the “Baby I Need your Lovin'” title was stored on an embodiment's “D” drive, in a “1960s” child subfolder created in a “Decades” parent subfolder created in a parent “Audio” subfolder created in the root folder of the D drive.

While the method of using a switching system to enable alternating sets of Key Data Value Command Query Controls (FIG. 1A, illustration 112) to query search a specialized Media Catalog (database) (FIG. 7A, illustration 108) in order to produce a parent-child, compound parallel attribute query display in the Summary of Retrieved Records (FIG. 7A, 140), and then concurrently propagate the value of the database anchor record as determined by the combo box records summary (FIG. 7A, 140) to a variable placeholder such as the Anchor Record Staging Control (FIG. 7A, 150) is a method created for one embodiment of this invention—the final step in the load process, the means of using a hyperlink value to load a media player object, is probably not unique to this invention.

As a further point of clarification, in FIG. 7B, the Text Input Control (130) with its attached summary combo box display (FIG. 7B, 140) is a common element in most Microsoft® Windows® applications. It can be easily created using Microsoft® development tools. The reader, however, will understand after reviewing additional explanations in this specification, that while the implementation of a Microsoft combo box/text input control is a routine matter to programmers, the method of its implementation in this invention, where it is connected to alternating sets of Key Data Value Command Query Controls in a layered system capable of quickly initiating a diverse array of relational compound queries, makes an embodiment using this design novel and extremely useful. (For an object diagram of the various complimentary sets of Key Data Value Command Query Controls, refer to FIGS. 3 and 4.)

FIGS. 7B through 7D represent one embodiment of this invention. Alternate embodiments can be envisioned that may not use a “Master Container Object” in the precise method as described in this specification but can, however, provide a means of rules-based procedures that effectively mimic or duplicate the functions of this invention's Master Container Object by implementing a design which may comprise a “program instruction control and management entity” that emulates the role of this invention's Master Container Object.

FIG. 8A is a flowchart that uses computer program screen images to illustrate the linear process of retrieving records and summary views based on a sustained anchor record that is used as a baseline to generate descendant queries. FIG. 8A begins where the user has selected the Key Data Value Command Query Control set: Search Group 1 button (200), one of the options in the Search Group activation buttons (658). This action enables the Key Data Value Command Query Control (KDVCQC) set with focus on the search by title button (300) which has been activated. The user has started typing an improvised query instruction in the Text Input Control (TIC) (130). The complete title of the record (music track) associated with the user instruction is visible in the TIC (810-130) and the same record (“After The Love Is Gone”) is also visible as the anchor record (database bookmark pointer) in the Summary of Records (820-140), shown in this software embodiment as a typical Microsoft® Access™ combo box. Note: In FIG. 8A, and in some other software image figures submitted with this specification, the lead line boundaries for character 658 (the Search Group activation buttons) do not completely enclose the entire button group because placing a four-border box around the button group would cause the border boundaries to cross or intersect with many other lead lines, and the effect might make it more difficult to understand the intent of the illustration. For a whole depiction of the Search Group activation buttons, please see character 658 in FIG. 6A.

FIG. 8B is a flowchart that uses computer program screen images to illustrate the linear process of retrieving records and summary views based on a sustained anchor record that is used as a baseline to generate descendant queries that began in FIG. 8A. In FIG. 8B, the user has click-activated the Artist key data value control (310) and, without a new user instruction, the default SQL query instruction assigned to the KDVCQC button (310) has retrieved records sorted by artist data that matches the propagated (sustaining) anchor record artist value, “Earth Wind and Fire”. Note that the Text Input Control label has changed to Search Artist (from Search Title as shown in FIG. 8A) and the artist value of the current anchor record is visible in the Text Input Control (830-130). Also, the summary list (840-140) has been reordered and grouped by artist name, then the associated titles are displayed in descending alpha-numeric order. With this design, one click of a different KDVCQC has produced a new set or records based on one record from the original query results.

Next, in FIG. 8B, the user has click-activated the Music Type key data value control (320) and, without a new user instruction, the default SQL query instruction assigned to the KDVCQC button (320) has retrieved records sorted by music type (genre) data that matches the propagated (sustaining) anchor record (which remains “After The Love Is Gone” by Earth Wind and Fire). The value of the Music Type attribute for the anchor record is “Soul”. Note that the Text Input Control (850-130) label has changed to Search Music Type (from Search Artist) and the summary list (860-140) has been reordered and grouped by music type name (a Media Catalog “parent” category), then the associated data is displayed as Music Code (a Media Catalog “child” category) values for each corresponding record in the summary; followed by Title, Artist, Tempo, MMB DR (Dance Rating) and Decade values. With this design, one click of a different KDVCQC has produced a new set or records based on one record from the original query results.

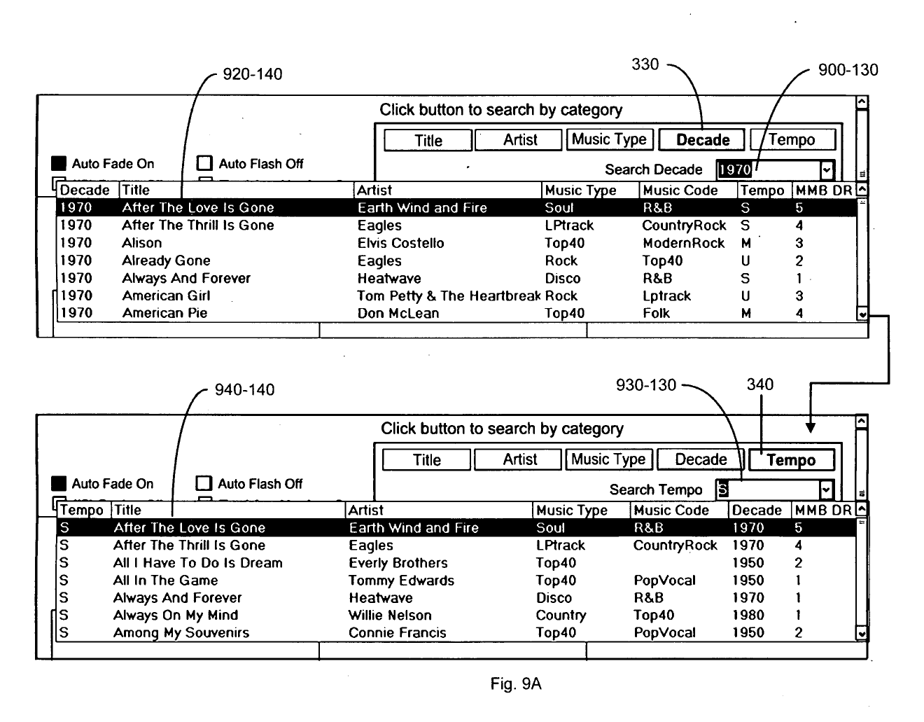

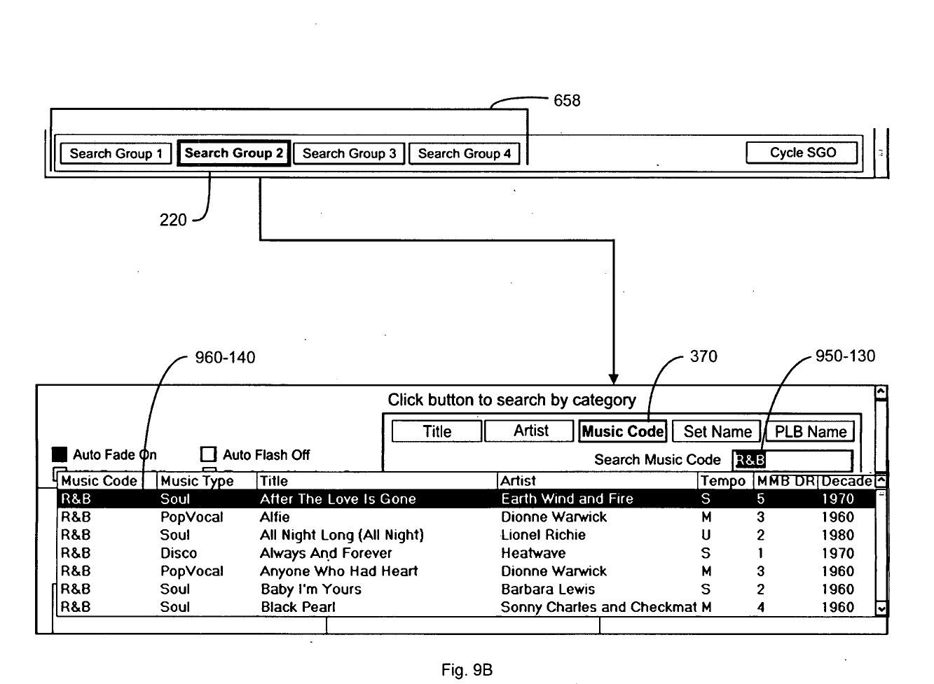

FIG. 9A is a flowchart that (begins at the point where FIG. 8B concluded and) uses computer program screen images to illustrate the linear and non-linear process of retrieving records and summary views based on a sustained anchor record that is used as a baseline to generate descendant queries. The user has decided to change primary query categories again and produce a new summary without changing the anchor record first used in the original query in FIG. 8A. Observe that the Key Data Value Command Query Control (KDVCQC) for Decade (330) is depressed (indicating selection) and the Text Input Control (900-130) shows a decade value of “1970”.

The Summary of Records (920-140) has been re-sorted to correspond with the stored decade value of the sustained anchor record and an alpha-numeric list of other titles that share the “1970” decade value appear under the anchor record title. For example, beneath “After The Love Is Gone”, the user can observe “After The Thrill Is Gone”, “Alison”, “Already Gone”, “Always And Forever”, etc. Note that the anchor record has been maintained and it is the same anchor record derived from the original query.

Also in FIG. 9A, the Text Input Control (900-130) label has changed to Search Decade (from Search Music Type) and the summary list (920-140) has been reordered and grouped by decade value with data for each corresponding record in the summary also displayed. The user can immediately see the Decade value for each record followed by Title, Artist, Music Type, Music Code, Tempo and MMB DR (Dance Rating) values. With this design, one click of a different KDVCQC has produced a new set or records based on one record from the original query results and, again, the user has not had to compose any query instruction.

While the user is viewing retrieved records in the summary (920-140), he can choose to use the navigation arrows on the right side of the summary combo box (920-140) to scroll down to view all records (currently sorted by decade value 1970). In this manner, the summary retrieved by the KDVCQC offers the user an opportunity to “hyper-contemplate” (e.g. freely associate attribute analysis and then jump to a new selection) from an assortment of similar and dissimilar records. For example, the user sees a 1970s era “Soul” track like “After The Love Is Gone” by Earth Wind and Fire and in the same view (920-140) he can also see a completely different type of “Rock” song “American Girl” by Tom Petty and the Heartbreakers. If he desires, the user can choose to radically alter the music flow by electing to choose a rock song as opposed to a soul song. Or, in the same summary view, the user can see and click access a “Top 40” “Folk” sub genre song like “American Pie” by Don Mclean. These records (music tracks) have no obvious similarity in style or substance; however they do have at least one natural connection: all three songs were hits during the 1970s.

Continuing with FIG. 9A, the user has click-activated the Search Tempo KDVCQC (340) and the “S” tempo value associated with the current anchor record (“After The Love Is Gone”) is visible in the Text Input Control (930-130). Note that the summary view (940-140) has been resorted to display a list of retrieved records that share a matching S (slow) tempo value.

Moving to FIG. 9B, which is a flowchart that uses computer program screen images to illustrate the linear process of retrieving records and summary views based on a sustained anchor record that is used as a baseline to generate descendant queries, we see depicted the KDVCQC switching control object (658) and the KDVCQC Search Group 2 button (220) which is depressed indicating the user has decided to change to a different set of Key Data Value Command Query Controls. This change has enabled some new Key Data Value category choices and the user has activated the Search Music Code (370) KDVCQC button. Note the Search Music Code label has replaced the Search Tempo label at the Text input Control (950-130) and that the summary (960-140) has been resorted to display records that have the same key data value in their Music Code field (category), “R&B”, as the current anchor record which remains “After The Love Is Gone”. Once again, in the absence of a user-submitted query instruction to alter the default SQL statement, the query search has retrieved and displayed a fresh summary (960-140) grouped according to the matching key data value of the anchor record.

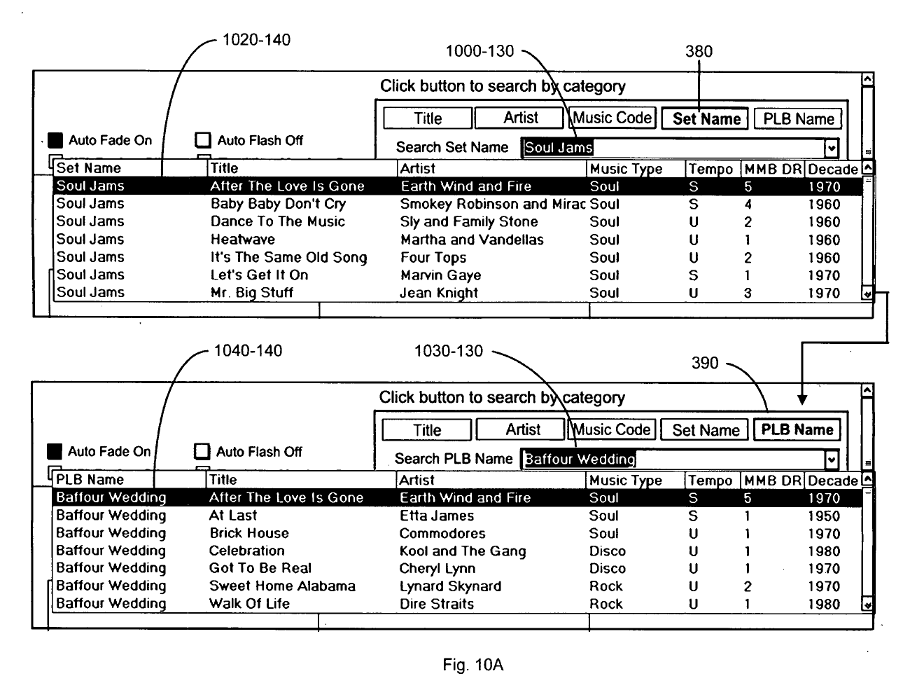

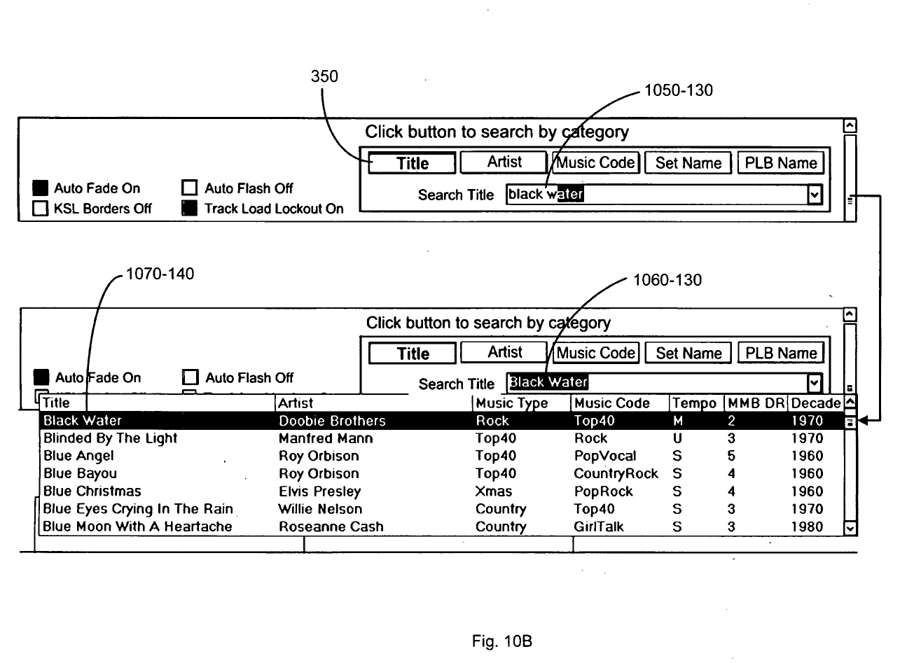

FIG. 10A is a flowchart that (begins at the point where FIG. 9B concluded and) uses computer program screen images to illustrate the linear and non-linear process of retrieving records and summary views based on a sustained anchor record that is used as a baseline to generate descendant queries. The user has decided to change primary query categories again and produce a new summary without changing the anchor record first used in the original query in FIG. 8A. Observe that the Key Data Value Command Query Control (KDVCQC) for Set Name (380) is depressed (indicating it is in a state of selection) and the Text Input Control (1000-130) shows a Set Name value of “Soul Jams”.

The Summary of Records (1020-140) has been re-sorted to correspond with the stored set name value of the sustained anchor record and a list of other titles that share the “Soul Jams” set name value appear under the anchor record title. For example, beneath “After The Love Is Gone”, the user can observe “Baby Bay Don't Cry”, “Dance To The Music”, “Heatwave”, “It's The Same Old Song”, etc. Note that the anchor record has been maintained and it is the same anchor record derived from the original query.

Also in FIG. 10A, the Text Input Control label has changed to Search Set Name (from Search Music Code) and the summary list (1020-140) has been reordered and grouped by set name value with data for each corresponding record in the summary also displayed. The user can immediately see the Set Name value for each record followed by Title, Artist, Music Type, Tempo and MMB DR (Dance Rating) and Decade values. With this design, one click of a different KDVCQC has produced a new set or records based on one record from the original query results and, again, the user has not had to compose any query instruction.

While the user is viewing retrieved records in the summary (1020-140), he can choose to use the navigation arrows on the right side of the combo box (1020-140) to scroll down to view all records (currently sorted by set name value “Soul Jams”). In this manner, the summary retrieved by the KDVCQC offers the user an opportunity to “hyper-contemplate” (freely associate attribute analysis, and then jump to a new selection) from an assortment of similar and dissimilar records. For example, the user sees a 1970s era “Soul” track like “After The Love Is Gone” by Earth Wind and Fire, and in the same view (1020-140) he can also see other soul songs from different eras such as the 1960s decade soul hit “Heatwave” by Martha and the Vandellas. If he desires, the user can choose to alter the music flow by electing to choose a slow tempo soul song from the same summary view such as “Baby Baby Don't Cry” by Smokey Robinson. The summary view concurrently displays soul songs in the “Soul Jams” set name, and also makes visible other natural connections such as up tempo soul songs and soul songs from the 1970s. In this manner, the design of the KDVCQC system allows users to freely switch between key data categories and allow the user to see a plurality of database results with tracks that have one or more natural attribute connections.

Continuing with FIG. 10A, the user has click-activated the Search PLB Name KDVCQC (390) and the “Baffour Wedding” PLB Name value associated with the current anchor record (“After The Love Is Gone”) is visible in the Text Input Control (1030-130). Note that the summary view (1040-140) has been resorted to display a list of retrieved records that share a matching PLB Name value (“Baffour Wedding”).

Moving to FIG. 10B, we see depicted the KDVCQC Search Title button (350) which is depressed indicating the user has decided to change to a different Key Data Value Command Query Control (while still in the Search Group 2 mode). To demonstrate the multi-mode capability of the Text Input Control (1050-130), the software image depicts the phrase “black water”, which in this case, has been input by the user in the so-called “active mode” (which is further illustrated by FIG. IC, character 130.2) of the Text Input Control (TIC) which demonstrates the effect produced when the user submits an improvised fixed-string (whole value) instruction in the TIC, and the query executes with user instruction added to default SQL statement.

Continuing in FIG. 10B, we can see a depiction of the result of this active mode query: the song “Black Water” by the Doobie Brothers is visible and has been selected as the new anchor record; and the database retrieved result “Black Water” is visible in the Text Input Control (1060-130). The summary (1070-140) has been resorted to display records that are stored in descending alphabetical order after “Black Water”. Unlike previous examples which demonstrated the “passive mode” (FIG. 1C, character 130.1) capability of the KDVCQC design (where the absence of a user-submitted query instruction allowed the KDVCQC to execute in its default SQL statement mode), FIG. 10B illustrates a query search that has retrieved and displayed a fresh summary (1070-140) grouped according to the corresponding key data value (Title) of the new user-improvised anchor record selection “Black Water”.

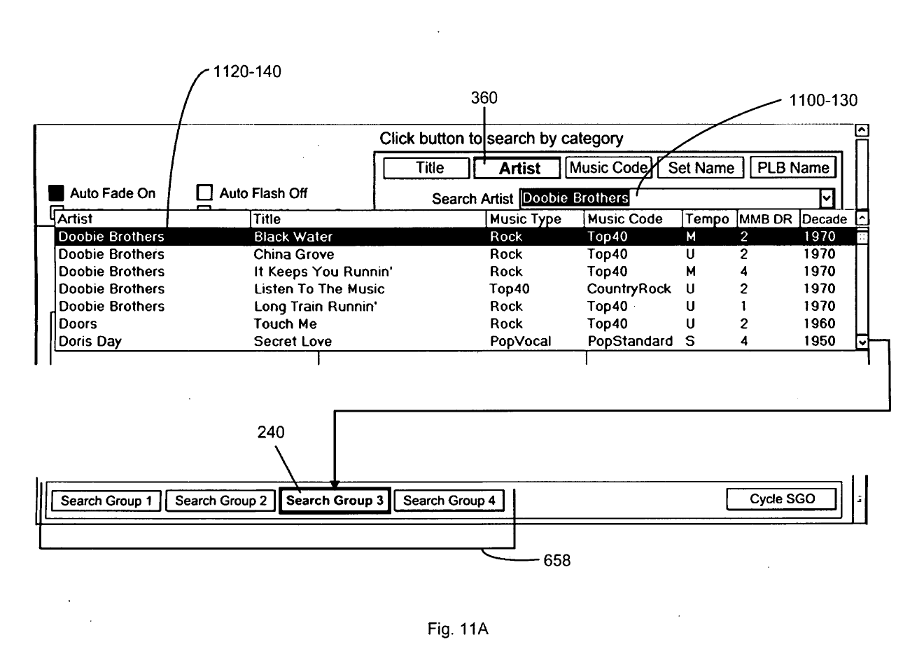

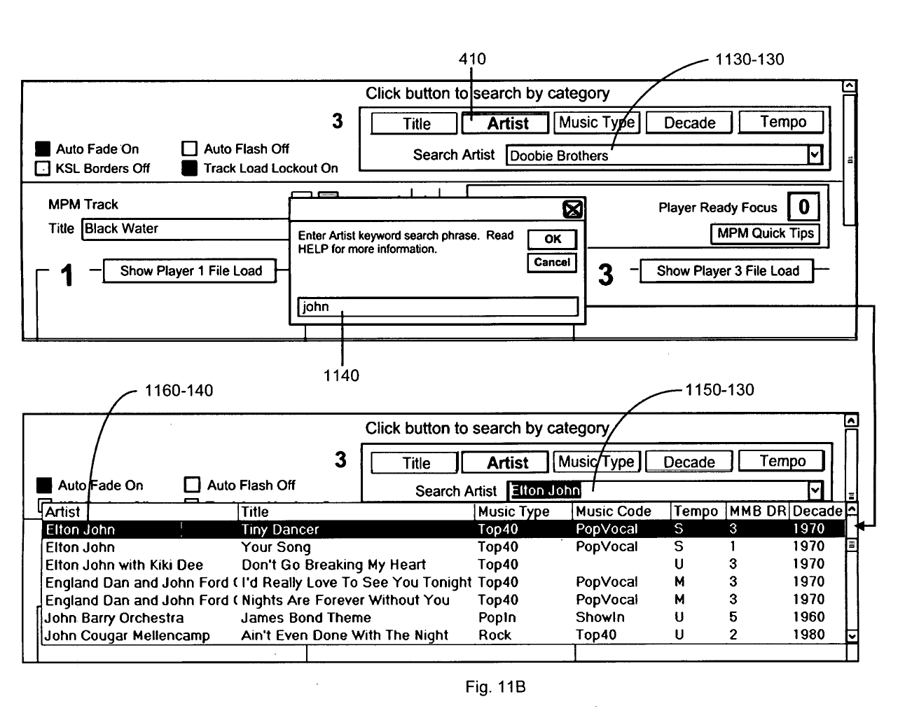

FIG. 11A is a flowchart that (begins at the point where FIG. 10B concluded and) uses computer program screen images to illustrate the linear and non-linear process of retrieving records and summary views based on a new sustained anchor record that is used as a baseline to generate descendant queries. The user has decided to change primary query categories and produce a new summary without changing the anchor record first used in the original query in FIG. 10B. (1070-140). Observe that the Key Data Value Command Query Control (KDVCQC) for Artist (360) is depressed and the Text Input Control (1100-130) shows an Artist value of “Doobie Brothers”.

The Summary of Records (1120-140) has been re-sorted to correspond with the stored artist name value of the sustained anchor record and a list of other titles that share the “Doobie Brothers” artist name value appear under the anchor record title. For example, beneath “Black Water”, the user can observe “China Grove”, “It Keeps You Runnin'”, “Listen to The Music”, “Long Train Runnin'”, etc. Note that the anchor record selected by the user-improvisational input in FIG. 10B has been maintained, and FIG. 11A illustrates that same anchor record as derived from the previous query.

Also in FIG. 11A, the Text Input Control (1100-130) label has changed to Search Artist (from Search Title) and the summary list (1120-140) has been reordered and grouped by artist name value with data for each corresponding record in the summary also displayed. The user can immediately see the artist value for each record followed by Title, Music Type, Music Code, Tempo, MMB DR (Dance Rating) and Decade values. With this design, one click of a different KDVCQC has automatically (passively) produced a new set of records based on one record from the previous query result and, again, the user has not had to compose any query instruction.

While the user is viewing retrieved records in the summary (1120-140), he can choose to use the navigation arrows on the right side of the combo box (1120-140) to scroll down to view all records (currently sorted by artist name value “Doobie Brothers”). In this manner, the summary retrieved by the KDVCQC offers the user an opportunity to “hyper-contemplate” (freely associate attribute analysis and then jump to a new selection) from an assortment of similar and dissimilar records.

Continuing with FIG. 11A, we see depicted the KDVCQC switching control object (658) and the KDVCQC Search Group 3 button (240) which is depressed indicating the user has decided to change to a different set of Key Data Value Command Query Controls. This change has enabled some new Key Data Value category choices and the next drawing will depict the user's selection of a “Keyword” query.

Moving to FIG. 11B, we see depicted the KDVCQC Search Artist keyword button (410) which is depressed indicating the user has decided to change to a different set of Key Data Value Command Query Control (in the Search Group 3 keyword mode). To demonstrate the multi-mode capability of the Text Input Control (1130-130), the software image depicts the phrase “john”, which in this case, has been input by the user in the so-called “active keyword mode” (which is further depicted in FIG. 1C, 130.3) of the Text Input Control (TIC) which demonstrates the effect produced when the user submits an improvised keyword (partial value) instruction in the TIC, and the query executes with user instruction added to default SQL statement.

In one embodiment (shown here), the selection of the Search Artist keyword button has triggered the Keyword Input dialog box (1140) which the program uses to collect and parse the user's improvised keyword value (in this example, “john”) and pass it on to the TIC Search Artist SQL statement.

Continuing in FIG. 11B, we can see a depiction of one result of this active mode keyword query: the song “Tiny Dancer” by Elton John is visible and has been selected as the new anchor record and is now depicted in the Search Artist Text Input Control (1150-130) box. The summary (1160-140) has been resorted to display records that are stored in descending alphabetical order after “Tiny Dancer”. Unlike previous examples which demonstrated the “passive mode” (FIG. 1C, 130.1) or “active mode (FIG. 1C, 130.2) capability of the KDVCQC, FIG. 11B illustrates a query search that has retrieved and displayed a fresh summary (1160-140) grouped according to the corresponding key data value (Artist which includes the keyword string “john”) of the new user-improvised anchor record selection “Tiny Dancer”.

Now referring to FIG. 12A, an illustration that depicts one exemplary embodiment of a Master Container Object interface with three instantiated media player objects (displayed in adjacent proximity), each having a plurality of controls and associated display objects.

For the purpose of understanding the various objects that comprise the Master Container Object (MCO) (110) and its Media Player Object Sets (which include, in an embodiment, Player 1, Player 2 and Player 3), it will be necessary to identify the key objects visible in the MCO (e.g. the software interface as presented to the user).

In FIG. 12A, illustration character numbers that begin with numbers other than “12” represent characters that are first displayed in earlier drawings that correspond with the character number designation. The numbers as used here in FIG. 12A allow the reader to understand how the objects represented by the character numbers can be implemented in at least one software embodiment.

The character recitation is generally described from top to bottom and left to right for FIG. 12A: Character 1250 refers to the large Record Browse Navigation Buttons (which permit the user to move forward or backward in incremental steps through a displayed summary list). Character 1240 depicts the Track Content/File Format Status Lights. Character 1200 depicts the Auto Fade On-Off Button/Light. Character 1210 depicts the KSL Borders On-Off Button/Light. Character 1230 depicts the Track Load Lockout On-Off Button/Light and character 1220 depicts the Auto Flash On-Off Button/Light.

Continuing with FIG. 12A: Character 210 refers to the Key Data Value Command Query Control Set with Discrete Buttons (Search Group 1 as shown); character 300 depicts the Search by Title Key Data Value Command Query Control; character 110 depicts the Master Container Object (Shown From User Interface Perspective); character 130 depicts the Text Input Control; and character 150 depicts the Anchor Record Staging Control.

Continuing further with FIG. 12A: Character 500 refers to the Player 1 File Target Control and character 662 depicts the Status Waypoint Value Display (PRF—Player Ready Focus) indicator.

FIG. 12B continues the MCO illustration begun with FIG. 12A; i.e. FIG. 12B further depicts one exemplary embodiment of a Master Container Object interface with three instantiated media player objects (displayed in adjacent proximity), each having a plurality of controls and associated display objects.

In FIG. 12B, illustration character numbers that represent characters that are first displayed in earlier drawings that correspond with the character number designation. The numbers as used here in FIG. 12B allow the reader to understand how the objects represented by the character numbers can be implemented in at least one software embodiment.

The character recitation is generally described from top to bottom and left to right for FIG. 12B: Character 110 depicts the Master Container Object (Shown From User Interface Perspective); Character 502 refers to the Player 1 Title Load Control; character 660 refers to the Status Waypoint Value Display (LPS—Last Player Started) indicator; character 522 refers to the Player 2 Track Timing Data Display; character 540 refers to the Player 3 Status Waypoint Physical State Message Light; character 634 refers to the Match Music Code Filter Command; and character 504 refers to the Media Player 1 Object.

Continuing further with FIG. 12B: Character 520 refers to the Media Player 2 Object; character 528 refers to the Player 2 Title Display; character 694 refers to the Title Display Count; character 542 refers to the Player 3 Artist Display; character 546 refers to the Player 3 large Start Button; and finally; character 536 refers to the Media Player 3 Object.

The illustration characters detailed in FIGS. 12A and 12B do not necessarily represent all the objects created for one embodiment, but instead serve as representations of some of the objects typically created for use in one embodiment's user interface. Additionally, there can be tens, hundreds, or thousands of additional common and/or proprietary programming objects that may be present as part of the operational infrastructure of the Master Container Object (110); yet in an embodiment, the programmer can elect to make these objects accessible by the program logic, yet invisible to the user.

Now referring to FIGS. 13A and 13B, illustrations depicting one exemplary embodiment of a Master Container Object software interface with three instantiated media player objects, each having a plurality of controls and associated display objects. In FIGS. 13A and 13B, illustration character numbers that begin with numbers other than “13” represent characters that are first displayed in earlier drawings that correspond with the character number designation. The numbers as used here in FIGS. 13A and 13B allow the reader to understand how the objects represented by the character numbers can be implemented in at least one software embodiment.

The character recitation is generally described from top to bottom and left to right for FIG. 13A: Character 300 refers to the Search by Title Key Data Value Command Query Control; character 110 refers to the Master Container Object (implemented as 3 Player embodiment); character 140 refers to the Summary of Retrieved Records and displays “Little Sister” by Elvis Presley as the current anchor record; character 210 refers to the Search Group 1 KDVCQC set; character 504 refers to the Media Player 1 Object set; and character 538 refers to the Media Player 3 Track Timing Display.

Continuing with FIG. 13A: Character 504.81 refers to the Post-Event Player 1 ID Label; character 536 refers to the Media Player 3 Object; character 634 refers to the Match Music Code filter; character 520 refers to the Media Player 2 Object; character 694 refers to the TDC (Title Display Count) which reveals number of available tracks (records) in current summary view.

Next, the character recitation is generally described from top to bottom and left to right for FIG. 13B: Character 140 refers to the Summary of Retrieved Records where the anchor record can remain the same as before any applied filter (however the background color of the summary view changes to indicate an active filter); character 110 refers to the Master Container Object (implemented as 3 Player embodiment and showing “Little Sister” as the sustained anchor record in filtered summary view). Note that, since the Match Music Code filter button has been pressed, the Summary of Retrieved Records (140) shows a record list where all the titles have a Music Code attribute equal to “Rockabilly”; character 540 refers to the Player 3 Status Message Display (which displays “Ready To Play” indicating to the user that the player is loaded and ready for audio reproduction); and character 1350 refers to the Command Border Light surrounding the Match Music Code button, which indicates an applied filter.

Continuing with FIG. 13B: Character 542 refers to the Player 3 Artist Display; character 634 refers to the Match Music Code filter button (where when activated, the modified query retrieves, and the summary view displays, only records that match the Music Code key data value “Rockabilly” stored for “Little Sister”); character 694 refers to the TDC value which changes when filter modifies summary view (Note the TDC value is FIG. 13A is “2061” and with a filter applied in FIG. 13B, the TDC value is “30”).

Now referring to FIGS. 14A and 14B, illustrations depicting one exemplary embodiment of a Master Container Object software interface with six instantiated media player objects, each media player object comprising part of a media player object group concurrently displayed in a self-adjusting variable field of view that optimizes the screen alignment of key commands and their associated data indicators within limited dimensions to facilitate efficient event workflow.

In FIGS. 14A and 14B, illustration character numbers that begin with numbers other than “14” represent characters that are first displayed in earlier drawings that correspond with the character number designation. The numbers as used here in FIGS. 14A and 14B allow the reader to understand how the objects represented by the character numbers can be implemented in at least one software embodiment.

The character recitation is generally described from top to bottom and left to right for FIG. 14A: Character 110 refers to the Master Container Object Implemented as 6 Player Embodiment (but showing 3 discrete players with auto focus set on Player 3); the other 3 players are present but are parked below the artificial horizon line (114.5) and therefore not visible in the Field of View; character 114 refers to the Field of View with three player objects visible above the horizon. Note that the vertical boundaries for the player object Field of View extend from a point above the “MPM Track” label to a point just below the “artificial horizon” dotted line (114.5), and the horizontal boundaries for the Field of View extend across the display screen from a point left of Player 1 to a point right of Player 3; character 668 refers to the Load State Tally Lights (which indicate each player's load state which is helpful when player objects may be loaded but concealed below the artificial horizon; and character 664 depicts the Speed Load Event Access button.

Continuing with FIG. 14A: Character 682 depicts the Media Player 1 Data Shade; character 536.71 refers to the Player 3 Ready Focus Border; character 504 refers to the Media Player 1 Object; character 520 refers to the Media Player 2 Object; character 536 refers to the Media Player 3 Object; character 546 refers to the Media Player 3 large Start (Play) button (it has “focus” and is visible above the horizon); and character 114.5 depicts the Artificial Horizon (shown as a horizontal dotted line near bottom of the screen) used in an embodiment to visually synchronize concurrent display of 6 large player objects. In this depiction the Artificial Horizon is visible at the bottom of the Field of View because the full scope of Media Player Object Group 1 (with Player 1, Player 2 and Player 3) is visible above the horizon line. In the next screen capture (FIG. 14B), the Artificial Horizon will be visible mid-screen to delineate the dividing line between Media Player Object Group 1 and Media Player Object Group 2 (with Player 4, Player 5 and Player 6).

In the screen capture depicted by FIG. 14A, the Master Container Object has used programming logic to determine the operational status (such as Loaded, Not Loaded, Ready To Play, etc.) of available media player objects, and automatically set program focus on Player 3. This caused the display within the Field of View to show only Media Player Object Group 1, because at the time the MCO logic executed, there was no activity in Players 4, 5 or 6.

Now referring to FIG. 14B, the character recitation is generally described from top to bottom and left to right: Character 110 refers to the Master Container Object Implemented as 6 Player Embodiment (and showing 6 discrete players with auto focus set on Player 4); key controls for 6 players are aligned by the programming logic in the MCO to be visible in equivalent proportions above and below the artificial horizon line (114.5) and therefore this screen capture depicts the results of the Auto-Adjusting Field of View (AAFOV) logic used to synchronize the visual display of two player object sets. Note that the vertical and horizontal boundaries for the player object Field of View have not changed—only the display of player object sets within the Field of View has changed from FIG. 14A to FIG. 14B. In the screen capture depicted by FIG. 14B, the Master Container Object has used programming logic to determine the operational status (such as Loaded, Not Loaded, Ready To Play, Currently Playing, etc.) of available media player objects, and automatically set program focus on Player 4.

This computation caused the display within the Field of View to change from showing only Media Player Object Group 1, to showing the key control and data message alignment for Media Player Object Groups 1 and 2. This occurred because the MCO was aware that the program was currently playing Player 3, and would next seek to cue the user to start Player 4; therefore key controls for both Media Player Object Groups were required to be visible in the Field of View.

Continuing with FIG. 14B: Character 114.5 depicts the Artificial Horizon (shown as dotted line near the middle of the display screen) used in an embodiment to visually synchronize concurrent display of 6 large player objects. In this depiction the Artificial Horizon is visible at horizontal mid-screen of the Field of View because the key data display and operational controls for Media Player Object Group 1 (with Player 1, Player 2 and Player 3) are visible above the horizon line, while the key data display and operational controls for Media Player Object Group 2 (with Player 4, Player 5 and Player 6) are also visible below the line. With this “inverted-order” design, the elements that comprise the Media Player Object Sets are assembled in equivalent proportions above and below the line. In this manner, the software user for this embodiment can easily evaluate his control options and message cues for 6 media player objects with one short glance in the Field of View. Since the situational awareness logic programming in the Master Container Object will evaluate the ready state condition of each player object, the MCO can auto-synchronize the Media Player Object Group alignment above and below the Artificial Horizon.

Continuing further with FIG. 14B: Character 552.52 depicts the Player 4 Proximity Border Light; character 114 depicts the Field of View with three player objects visible above the horizon, and three player objects visible below the Artificial Horizon; character 562 depicts the Media Player 4 large Start (Play) button which has “focus” and is visible below the Artificial Horizon; character 552 depicts the Media Player 4 Object; character 568 depicts the Media Player 5 Object; and character 586 depicts the Media Player 6 Object.

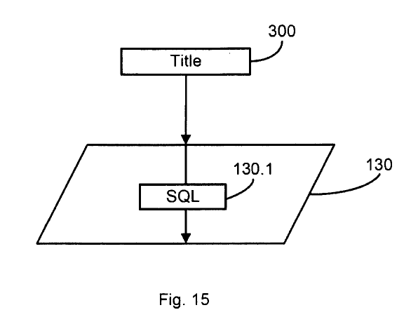

Now referring to FIG. 15 which illustrates an exemplary programming query instruction in one embodiment which can be attached to the click event of a Key Data Value Command Query Control (KDVCQC) where the queries are designed to execute in a default manner without user modification and thereby permit retrieval of a summary of records based on a propagated (sustained) anchor record used as a baseline for subsequent queries. (Note: the narrative for FIG. 15 uses the terms Text Input Box and Text Input Control interchangeably.)

In FIG. 15, the user has clicked the Title Key Data Value Command Query Control (300) which moves focus (and the cursor) to the Text Input Control (130) and sends the attached default KDVCQC SQL (structured query language) statement to the database and processor:

Me.cboSelectTextInputBox.RowSource=“SELECT [qryCPAQtitle].Title, [qryCPAQtitle].Artist, [qryCPAQtitle].MusicType, [qryCPAQtitle].MusicCode, [qryCPAQtitle].Tempo, [qryCPAQtitle].DanceRating, [qryCPAQtitle].Decade, [qryCPAQtitle].RecordID FROM [qryCPAQtitle];”

The SQL statement for the Title Key Data Value Command Query Control (KDVCQC) sets row source of Text Input Box to the programmed default CPAQtitle query (compound parallel attribute query) and determines key data value category (field) screen summary order, sorting data alphabetically by Title value as follows: ‘Title, Artist, Music Type, Music Code, Tempo, Dance Rating, Decade (and RecordID hidden in display summary).

This is an example embodiment of a program query instruction activated by the default (unmodified) search by Title KDVCQC—when user does not submit improvised instructions, and therefore uses SQL only process (130.1) in the Text Input Control. This example retrieves records sorted by title and maintains the default anchor record.

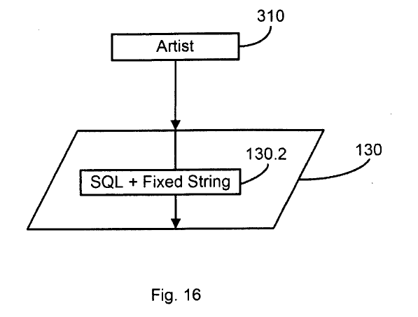

Now referring to FIG. 16 which illustrates an exemplary programming query instruction in one embodiment which can be attached to the click event of a Key Data Value Command Query Control where the queries are designed to execute first in a default manner without user modification, and then in a manner that accepts a user-improvised instruction, and thereby permits retrieval of a summary of records based on a propagated (sustained) anchor record, or a summary of records based on a new (migrated) anchor record which may consequently be used as a baseline for subsequent queries. (Note: the narrative for FIG. 16 uses the terms Text Input Box and Text Input Control interchangeably.)

In FIG. 16, the user has clicked the Artist Key Data Value Command Query Control (310) which moves focus (and the cursor) to the Text Input Control (130) and sends the attached default KDVCQC SQL (structured query language) statement to the database and processor:

Me.cboSelectTextInputBox.RowSource=“SELECT [qryCPAQartist].Artist, [qryCPAQartist].Title, [qryCPAQartist].MusicType, [qryCPAQartist].MusicCode, [qryCPAQartist].Tempo, [qryCPAQartist].DanceRating, [qryCPAQartist].Decade, [qryCPAQartist].RecordID FROM [qryCPAQartist];”

The SQL statement for the Artist Key Data Value Command Query Control (KDVCQC) sets row source of Text Input Box to the programmed default CPAQartist query (compound parallel attribute query) and determines key data value category (field) screen summary order, sorting data alphabetically by Artist value as follows: Artist, Title, Music Type, Music Code, Tempo, Dance Rating, Decade (and RecordID hidden in display summary).

However, in this case, with his cursor still in the Text Input Control (130) the user has decided to modify the query with an improvised character string instruction submitted in the master container object's text input box, and a Visual Basic® for Applications (VBA) statement is automatically added to the database command sent to the processor:

### Dim rs As Object

Set rs=Me.Recordset.Clone
rs.FindFirst “[RecordID]=” & Str(Me![cboSelectTextInputBox])

### If Not rs.EOF Then Me.Bookmark=rs.Bookmark

Because the default SQL instruction attached to the search by Artist KDVCQC has been modified with a VBA instruction in the Text Input Control process (130.2), the result causes the query to retrieve records with a combination of SQL, Microsoft® Visual Basic®, and Microsoft Access™ database programming.

As a result of the user's decision to use the “active mode” process (130.2), the records retrieved have been displayed with the database bookmark set to a new anchor record; a record with an artist attribute that matched the value submitted by the user in the Text Input Control.

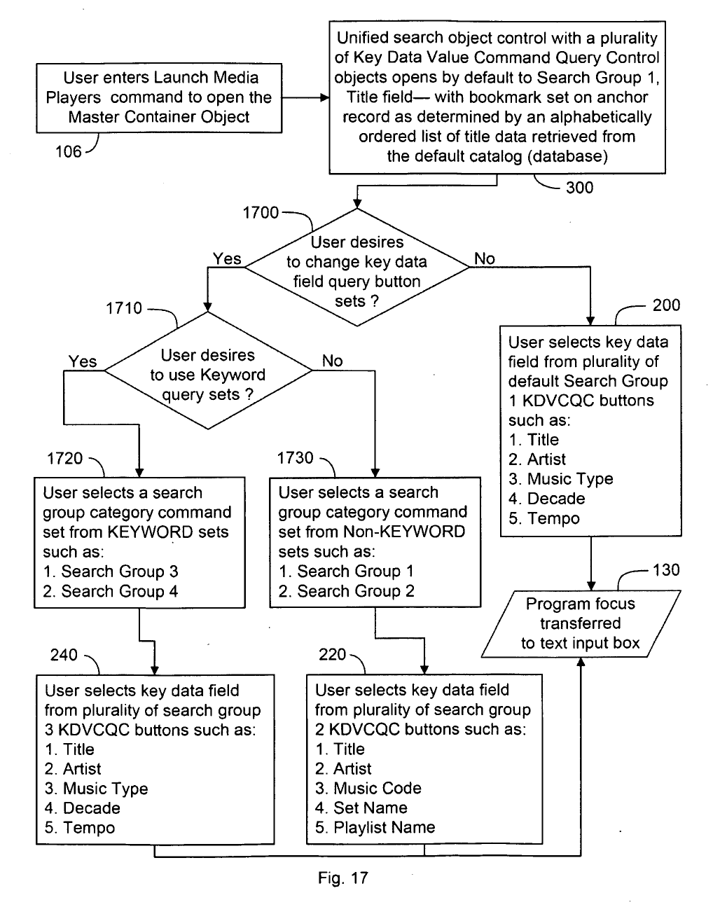

FIG. 17 is a flowchart depicting a method for choosing between various sets of complementary key data value command query category (field) controls, according to one embodiment of the present invention.

In FIG. 17, the user enters Launch Media Players command (106) to open the Master Container Object interface (see FIG. 1B, character 110 for a diagrammatic view of the Master container Object); then the unified search object control with a plurality of Key Data Value Command Query Control objects opens by default to Search Group 1, Title field (300)—with bookmark set on an anchor record as determined by an alphabetically ordered list of title data retrieved from the default catalog (database); next is depicted a decision process (1700), asking whether the user desires to change key data field query button sets.

If the user chooses no at the decision process (1700), he next selects key data field from plurality of default Search Group 1 KDVCQC buttons (200) such as: 1. Title, 2. Artist, 3. Music Type, 4. Decade, and 5. Tempo. Then program focus is transferred to text input control box (130).

Continuing with FIG. 17, if the user instead chooses yes at the decision process (1700), he moves to another decision process (1710), where the user determines whether to use Keyword query sets. If the user chooses no at the decision process (1710), he next selects a search group category command set from Non-KEYWORD sets (1730) such as: Search Group 1 or Search Group 2—where, in this example, the user selects Search Group 2 (220). Next, the user selects a key data field from a plurality of search group 2 KDVCQC buttons such as: 1. Title, 2. Artist, 3. Music Code, 4. Set Name, and 5. Playlist Name. Finally in this decision branch, program focus is transferred to the text input control box (130); and the user has successfully made a change in his choice of Search Groups.

Continuing with FIG. 17, if the user chooses yes at the decision process (1710), he next selects a search group category command set from KEYWORD sets (1720) such as: Search Group 3 or Search Group 4—where, in this example, the user selects Search Group 3 (240). Next, the user selects a key data field from a plurality of search group 3 KDVCQC buttons such as: 1. Title, 2. Artist, 3. Music Type, 4. Decade, and 5. Tempo. Finally in this decision branch, program focus is transferred to the text input control box (130); and the user has successfully made a change in his choice of Search Groups.

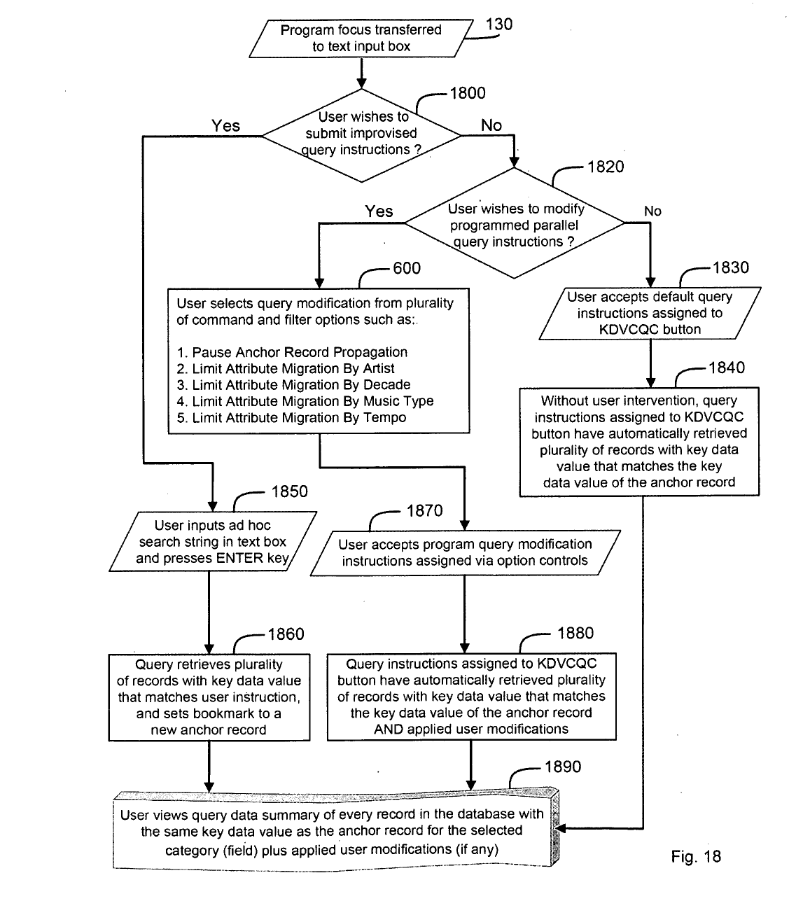

FIG. 18 is a flowchart depicting a method for choosing between three operational modes of one key data value command query category (field) control, according to one embodiment of the present invention.

FIG. 18 begins with program focus transferred to text input box (130); next, in a decision process (1800) the user decides whether to submit improvised query instructions; if the user chooses yes, he inputs an ad hoc search string in the text box and presses ENTER key (1850); then the query retrieves a plurality of records with a key data value that matches user instruction, and sets bookmark to a new anchor record (1860). Finally, in this branch step, the user views a query data summary of every record in the database with the same key data value as the anchor record for the selected category (field) plus applied user modifications (if any) (1890).

Continuing with FIG. 18, if at the first decision process (1800) the user selected no, he next moves to a new decision process (1820) in which he must determine if he wishes to modify the programmed parallel query instructions. If the user selects yes, he next must select a query modification from plurality of command and filter options (600) such as: 1. Pause Anchor Record Propagation, 2. Limit Attribute Migration By Artist, 3. Limit Attribute Migration By Decade, 4. Limit Attribute Migration By Music Type, 5. Limit Attribute Migration By Tempo. Next, the user accepts program query modification instructions assigned via option controls (1870); and next query instructions assigned to KDVCQC button have automatically retrieved plurality of records with key data value that matches the key data value of the anchor record AND applied user modifications (1880); finally, in this decision branch, the user views a query data summary of every record in the database with the same key data value as the anchor record for the selected category (field) plus applied user modifications (if any) (1890).

Back to the second decision process (1820) in FIG. 18, if the user selects no, he accepts the default query instructions assigned to KDVCQC button (1830); next, without user intervention, query instructions assigned to KDVCQC button have automatically retrieved plurality of records with key data value that matches the key data value of the anchor record (1840); and finally, the user views a query data summary of every record in the database with the same key data value as the anchor record for the selected category (field) plus applied user modifications (if any) (1890).

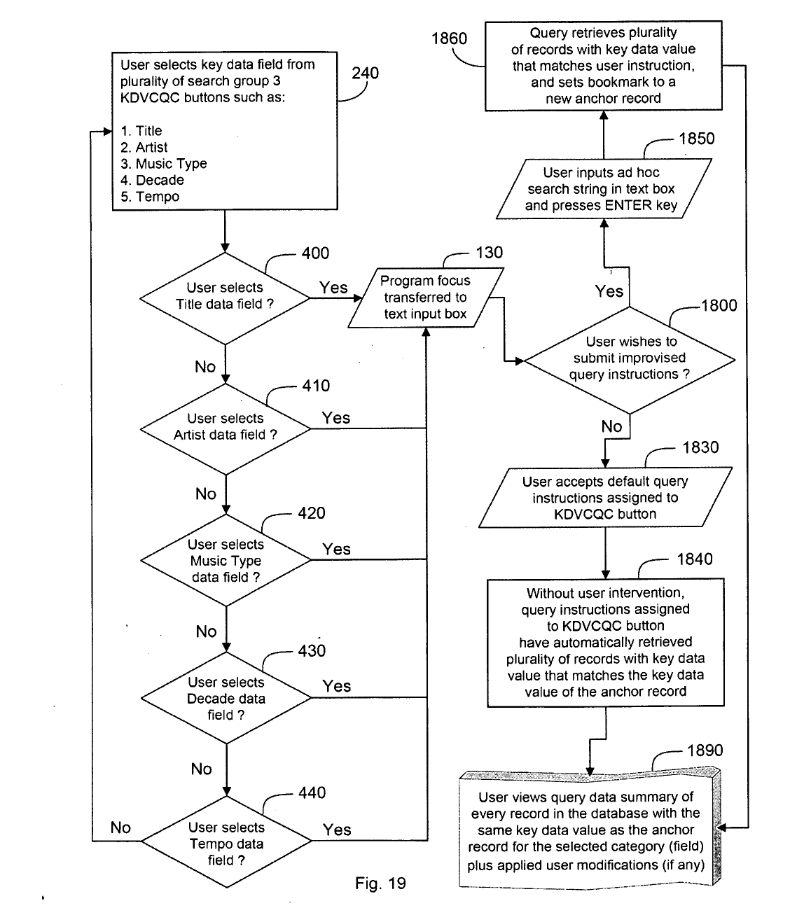

FIG. 19 is a flowchart depicting a method for selecting from a plurality of key data value command query category (field) controls and then choosing between two operational modes which can produce different summary views, according to one embodiment of the present invention.

FIG. 19 begins where the user selects a key data field from plurality of search group 3 KDVCQC buttons (240) such as: 1. Title, 2. Artist, 3. Music Type, 4. Decade, and 5. Tempo. Search Group 3 is keyword queries. No matter which KDVCQC the user selects here, the process going forward will be the same. Therefore, this specification will describe the selection of the Title KDVCQC (400), however the process flow path would be the same if a different KDVCQC were selected such as the Artist KDVCQC (410), the Music Type KDVCQC (420), the Decade KDVCQC (430), or the Tempo KDVCQC (440).

After selecting yes in the Title KDVCQC (400) a decision process, program focus is transferred to the text input control box (130); next, in a decision process (1800) the user decides whether to submit improvised query instructions; if the user chooses yes, he inputs an ad hoc search string in the text box and presses ENTER key (1850); then the query retrieves a plurality of records with a key data value that matches user instruction, and sets bookmark to a new anchor record (1860). Finally, in this branch step, the user views a query data summary of every record in the database with the same key data value as the anchor record for the selected category (field) plus applied user modifications (if any) (1890).

However, if in FIG. 19 at decision process 1800 the user selects no, he accepts the default query instructions assigned to KDVCQC button (1830); next, without user intervention, query instructions assigned to KDVCQC button have automatically retrieved plurality of records with key data value that matches the key data value of the anchor record (1840); and the user next views a query data summary of every record in the database with the same key data value as the anchor record for the selected category (field) plus applied user modifications (if any) (1890).

Continuing with FIG. 19; after selecting no in the Title KDVCQC (400) a decision process, (a decision which means the user has made no effort to advance the Title KDVCQV process) the user may then select yes or no in the Artist KDVCQC process (410), the Music Type KDVCQV process (420), the Decade KDVCQV process (430), or the Tempo KDVCQV process (440). At any point in this randomly accessible KDVCQC decision cycle, if the user has selected yes (by clicking the associated KDVCQC screen button, the data flow will execute with options as previously described for decision process 400; however if the user has selected no, the data process is free to move to an alternative KDVCQC decision option (or free to execute no further decision by remaining in the Search Group 3 KDVCQC button selector (240).

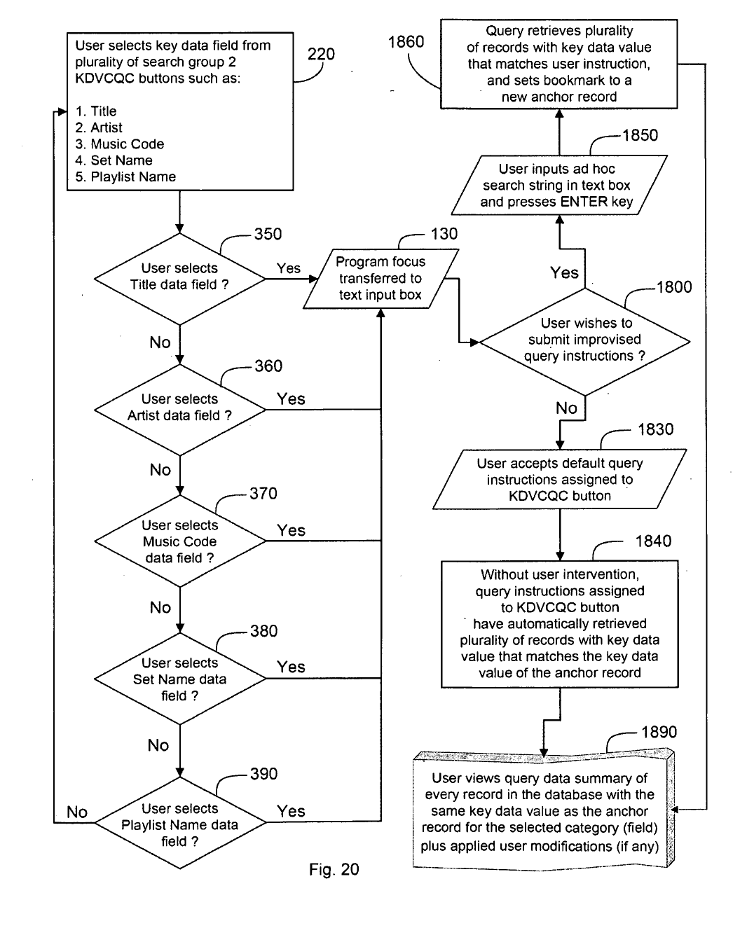

FIG. 20 is a flowchart depicting a method for selecting from a plurality of key data value command query category (field) controls and then choosing between two operational modes which can produce different summary views, according to one embodiment of the present invention.

FIG. 20 begins where the user selects a key data field from plurality of search group 2 KDVCQC buttons (220) such as: 1. Title, 2. Artist, 3. Music Code, 4. Set Name, and 5. Playlist Name. Search Group 2 is non-keyword queries. No matter which KDVCQC the user selects here, the process going forward will be the same. Therefore, this specification will describe the selection of the Title KDVCQC (350), however the process flow path would be the same if a different KDVCQC were selected such as the Artist KDVCQC (360), the Music Code KDVCQC (370), the Set Name KDVCQC (380), or the Playlist name KDVCQC (390).

After selecting yes in the Title KDVCQC (350) a decision process, program focus is transferred to the text input control box (130); next, in a decision process (1800) the user decides whether to submit improvised query instructions; if the user chooses yes, he inputs an ad hoc search string in the text box and presses ENTER key (1850); then the query retrieves a plurality of records with a key data value that matches user instruction, and sets bookmark to a new anchor record (1860). Finally, in this branch step, the user views a query data summary of every record in the database with the same key data value as the anchor record for the selected category (field) plus applied user modifications (if any) (1890).

However, if in FIG. 20 at decision process 1800 the user selects no, he accepts the default query instructions assigned to KDVCQC button (1830); next, without user intervention, query instructions assigned to KDVCQC button have automatically retrieved plurality of records with key data value that matches the key data value of the anchor record (1840); and the user next views a query data summary of every record in the database with the same key data value as the anchor record for the selected category (field) plus applied user modifications (if any) (1890).

Continuing with FIG. 20; after selecting no in the Title KDVCQC (350) a decision process, (a decision which means the user has made no effort to advance the Title KDVCQV process) the user may then select yes or no in the Artist KDVCQC process (360), the Music Code KDVCQV process (370), the Set Name KDVCQV process (380), or the Playlist Name KDVCQV process (390). At any point in this randomly accessible KDVCQC decision cycle, if the user has selected yes (by clicking the associated KDVCQC screen button, the data flow will execute with options as previously described for decision process 350; however if the user has selected no, the data process is free to move to an alternative KDVCQC decision option (or free to execute no further decision by remaining in the Search Group 2 KDVCQC button selector (220).

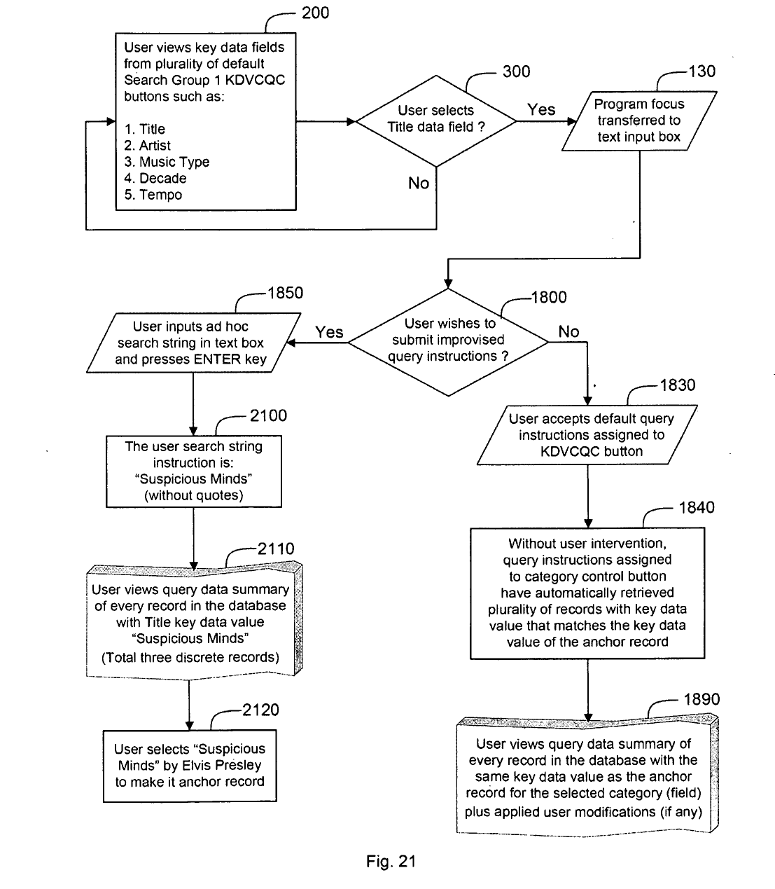

FIG. 21 is a flowchart (that begins a series of descendant queries) depicting a method for selecting from a plurality of key data value command query category (field) controls and then choosing between two operational modes which can produce different summary views, according to one embodiment of the present invention.

In FIG. 21, the user views key data field options from plurality of default Search Group 1 KDVCQC buttons (200) such as: 1. Title, 2. Artist, 3. Music Type, 4. Decade, and 5. Tempo. Next, if, in a decision process (300), the user does not select the Title data field, he returns to contemplate choosing a different KDVCQC field (200). However if he choose the Title KDVCQC data field (300), program focus is transferred to the text input control box (130). Next, in a decision process (1800) the user decides whether to submit improvised query instructions; if the user chooses yes, he inputs an ad hoc search string in the text box (1850) and the string is “Suspicious Minds” (2100).

Next in FIG. 21, the user views a query data summary of every record in the database with a Title key data value of “Suspicious Minds” (2110)—which equates to a total of three discrete records; the user then goes on to select “Suspicious Minds” by Elvis Presley to make it the anchor record (2120).

However, if at decision process 1800, the user selects no, he accepts the default query instructions assigned to KDVCQC button (1830); next, without user intervention, query instructions assigned to KDVCQC button have automatically retrieved plurality of records with key data value that matches the key data value of the anchor record (1840); and finally, the user views a query data summary of every record in the database with the same key data value as the anchor record for the selected category (field) plus applied user modifications (if any) (1890).

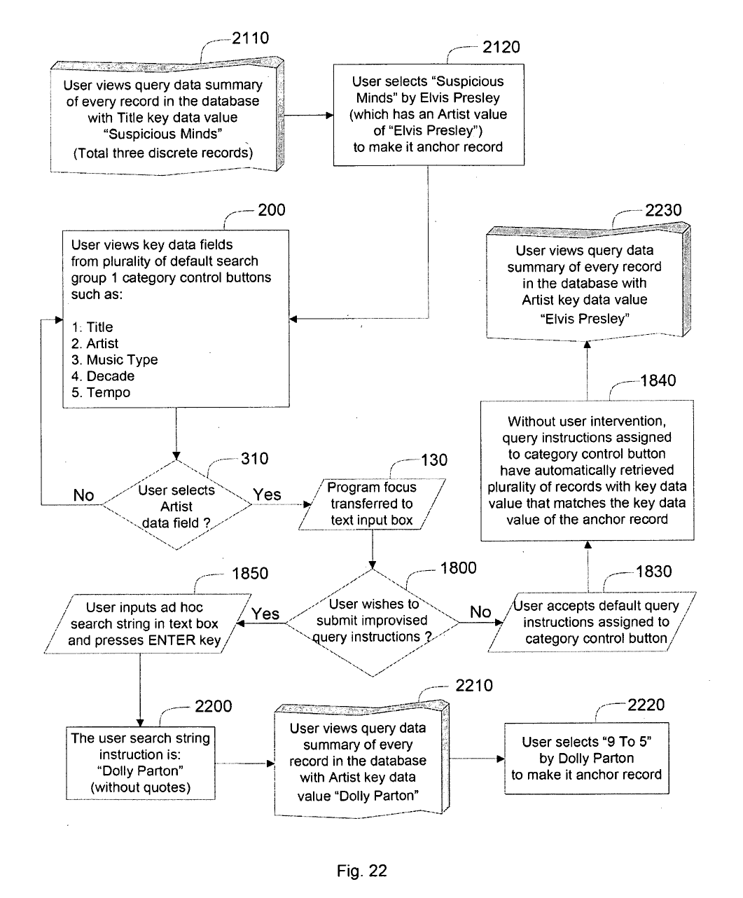

FIG. 22 is a flowchart depicting a method for selecting from a plurality of key data value command query category (field) controls and then choosing between two operational modes which can produce different summary views and different anchor records, according to one embodiment of the present invention.

FIG. 22 picks up with the end of a branch decision query from FIG. 21 where, in FIG. 22, the user views a query data summary of every record in the database with a Title key data value of “Suspicious Minds” (2110)—which equates to a total of three discrete records; the user then goes on to select “Suspicious Minds” by Elvis Presley—which has an artist value of “Elvis Presley”—to make it the anchor record (2120).

Next, the user views key data field options from plurality of default Search Group 1 KDVCQC buttons (200) such as: 1. Title, 2. Artist, 3. Music Type, 4. Decade, and 5. Tempo. Continuing, if in a decision process (310), the user does not select the Artist data field, he returns to contemplate choosing a different KDVCQC field (200). However if he chooses the Artist KDVCQC data field (310), program focus is transferred to the text input control box (130). Next, in a decision process (1800) the user decides whether to submit improvised query instructions; if the user chooses yes, he inputs an ad hoc search string in the text box (1850) and the string is “Dolly Parton” (2200). Continuing, in FIG. 22, the user views a query data summary of every record in the database with an Artist key data value of “Dolly Parton” (2210); the user then goes on to select “9 to 5” by Dolly Parton to make it the anchor record (2220).

However, if at decision process 1800, the user selects no, he accepts the default query instructions assigned to KDVCQC button (1830); next, without user intervention, query instructions assigned to KDVCQC button have automatically retrieved plurality of records with key data value that matches the key data value of the anchor record (1840); and finally, the user views a query data summary of every record in the database with an artist value of “Elvis Presley” (2230)—which matches the artist value of the original anchor record.

FIG. 22 illustrates how the KDVCQC system in the invention can allow the user to easily create new queries on the fly (by inputting new string instructions) or retain a link to the original anchor record while querying the database for a new record summary where all the records are related to the original anchor record.

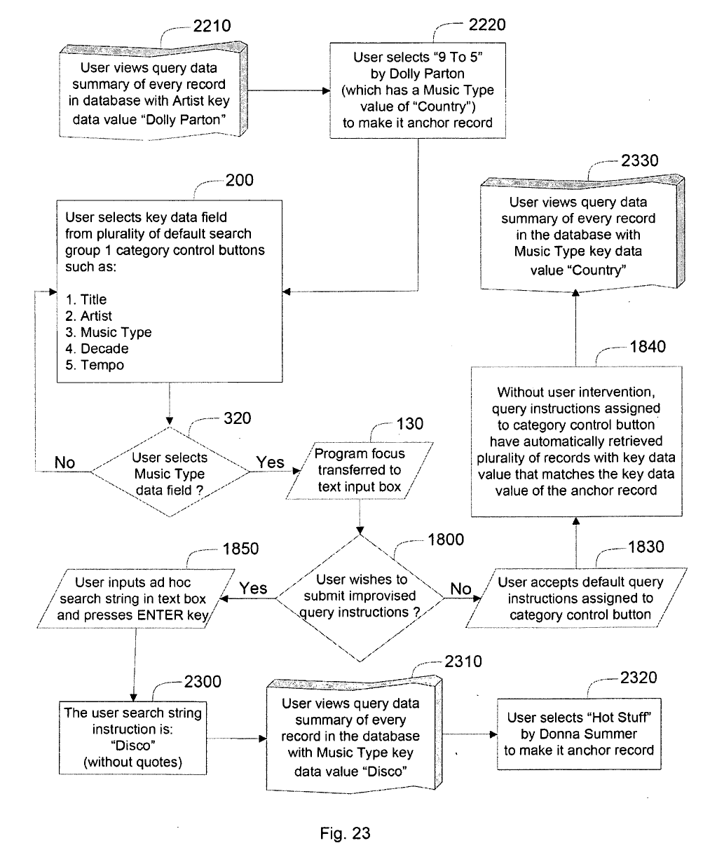

FIG. 23 is a flowchart (that begins at the point where FIG. 22 concluded) depicting a method for selecting from a plurality of key data value command query category (field) controls and then choosing between two operational modes which can produce different summary views and different anchor records, according to one embodiment of the present invention. The flow process in FIG. 23 is identical to FIG. 22, however FIG. 23 changes the KDVCQC to the Search Group 1 Music Type data field.

FIG. 23 picks up near the end of a branch decision query from FIG. 22 where, in FIG. 23, the user views a query data summary of every record in the database with an Artist key data value of “Dolly Parton” (2210); the user then goes on to select “9 To 5” by Dolly Parton (which has a Music Type value of “Country”) to make it the anchor record (2220).

Next, the user views key data field options from plurality of default Search Group 1 KDVCQC buttons (200) such as: 1. Title, 2. Artist, 3. Music Type, 4. Decade, and 5. Tempo. Continuing, if in a decision process (320), the user does not select the Music Type data field, he returns to contemplate choosing a different KDVCQC field (200). However if he chooses the Music Type KDVCQC data field (320), program focus is transferred to the text input control box (130). Next, in a decision process (1800) the user decides whether to submit improvised query instructions; if the user chooses yes, he inputs an ad hoc search string in the text box (1850) and the string is “Disco” (2300). Continuing, in FIG. 23, the user views a query data summary of every record in the database with a Music Type key data value of “Disco” (2310); the user then goes on to select “Hot Stuff” by Donna Summer to make it the anchor record (2320).

However, if at decision process 1800, the user selects no, he accepts the default query instructions assigned to KDVCQC button (1830); next, without user intervention, query instructions assigned to KDVCQC button have automatically retrieved plurality of records with key data value that matches the key data value of the anchor record (1840); and finally, the user views a query data summary of every record in the database with a Music Type value of “Country” (2330)—which matches the Music Type value of the original anchor record.

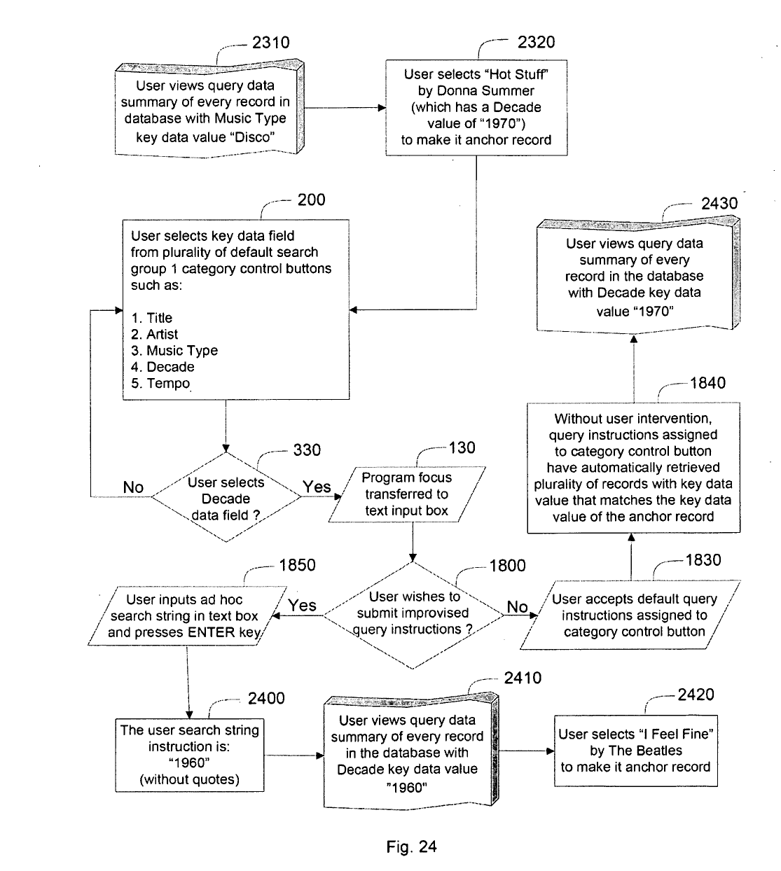

FIG. 24 is a flowchart (that begins at the point where FIG. 23 concluded) depicting a method for selecting from a plurality of key data value command query category (field) controls and then choosing between two operational modes which can produce different summary views and different anchor records, according to one embodiment of the present invention. The flow process in FIG. 24 is identical to FIG. 22, however FIG. 24 changes the KDVCQC to the Search Group 1 Decade data field.

FIG. 24 picks up near the end of a branch decision query from FIG. 23 where, in FIG. 24, the user views a query data summary of every record in the database with a Music Type key data value of “Disco” (2310); the user then goes on to select “Hot Stuff” by Donna Summer (which has a Decade value of “1970”) to make it the anchor record (2320).

Next, the user views key data field options from plurality of default Search Group 1 KDVCQC buttons (200) such as: 1. Title, 2. Artist, 3. Music Type, 4. Decade, and 5. Tempo. Continuing, if in a decision process (330), the user does not select the Decade data field, he returns to contemplate choosing a different KDVCQC field (200). However if he chooses the Decade KDVCQC data field (330), program focus is transferred to the text input control box (130). Next, in a decision process (1800) the user decides whether to submit improvised query instructions; if the user chooses yes, he inputs an ad hoc search string in the text box (1850) and the string is “1960” (2400). Continuing, in FIG. 24, the user views a query data summary of every record in the database with a Decade key data value of “1960” (2410); the user then goes on to select “I Feel Fine” by The Beatles to make it the anchor record (2420).

However, if at decision process 1800, the user selects no, he accepts the default query instructions assigned to KDVCQC button (1830); next, without user intervention, query instructions assigned to KDVCQC button have automatically retrieved plurality of records with key data value that matches the key data value of the anchor record (1840); and finally, the user views a query data summary of every record in the database with a Decade value of “1970” (2430)—which matches the Decade value of the original anchor record.

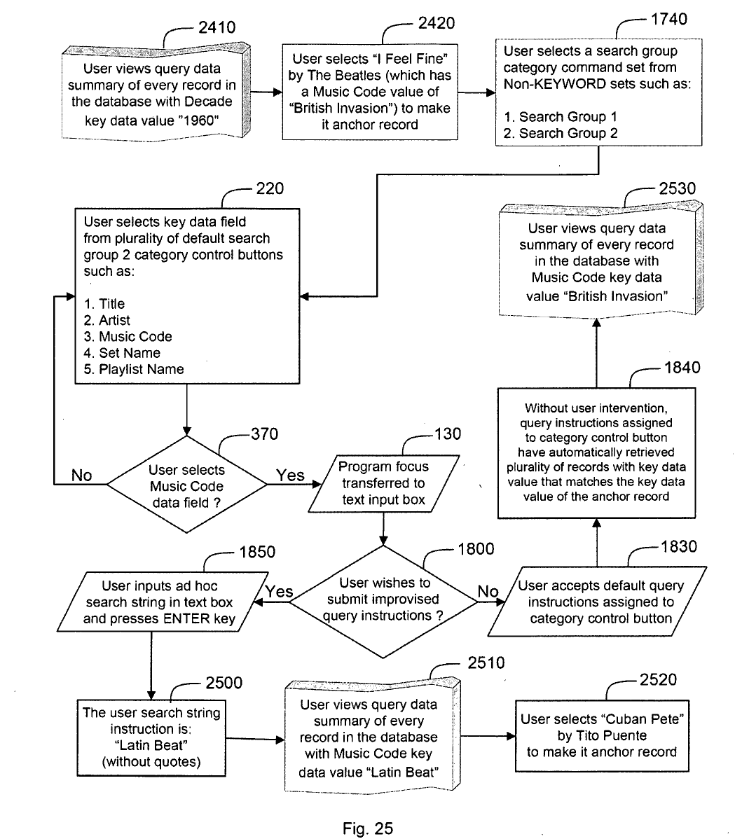

FIG. 25 is a flowchart (that begins at the point where FIG. 24 concluded) depicting a method for selecting from a plurality of key data value command query category (field) controls and then choosing between two operational modes which can produce different summary views and different anchor records, according to one embodiment of the present invention. The flow process in FIG. 25 is identical to FIG. 22, however FIG. 25 changes the KDVCQC to the Search Group 2 Music Code data field.

FIG. 25 picks up near the end of a branch decision query from FIG. 24 where, in FIG. 25, the user views a query data summary of every record in the database with a Decade key data value of “1960” (2410); the user then goes on to select “I Feel Fine” by The Beatles (which has a Music Code value of “British Invasion”) to make it the anchor record (2420).

At this point, the user wishes to change search group options, and selects Search Group 2 (1740). Next, the user views key data field options from plurality of default Search Group 2 KDVCQC buttons (220) such as: 1. Title, 2. Artist, 3. Music Code, 4. Set Name, and 5. Playlist Name. Continuing, if in a decision process (370), the user does not select the Music Code data field, he returns to contemplate choosing a different KDVCQC field (220). However if he chooses the Music Code KDVCQC data field (370), program focus is transferred to the text input control box (130). Next, in a decision process (1800) the user decides whether to submit improvised query instructions; if the user chooses yes, he inputs an ad hoc search string in the text box (1850) and the string is “Latin Beat” (2500). Continuing, in FIG. 25, the user views a query data summary of every record in the database with a Music Code key data value of “Latin Beat” (2510); the user then goes on to select “Cuban Pete” by Tito Puente to make it the anchor record (2520).

However, if at decision process 1800, the user selects no, he accepts the default query instructions assigned to KDVCQC button (1830); next, without user intervention, query instructions assigned to KDVCQC button have automatically retrieved plurality of records with key data value that matches the key data value of the anchor record (1840); and finally, the user views a query data summary of every record in the database with a Music Code value of “Latin Beat” (2530)—which matches the Decade value of the original anchor record.

FIG. 25 further illustrates how the KDVCQC system in the invention can allow the user to easily create new queries on the fly (by inputting new string instructions) or retain a link to the original anchor record while querying the database for a new record summary where all the records are related to the original anchor record.

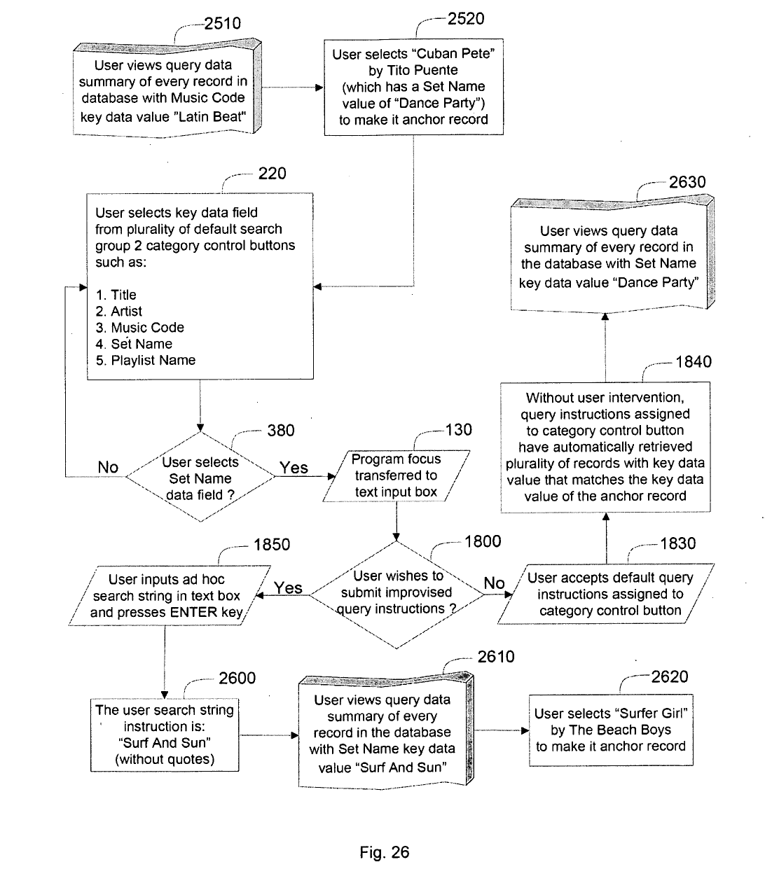

FIG. 26 is a flowchart (that begins at the point where FIG. 25 concluded) depicting a method for selecting from a plurality of key data value command query category (field) controls and then choosing between two operational modes which can produce different summary views and different anchor records, according to one embodiment of the present invention. The flow process in FIG. 26 is identical to FIG. 22, however FIG. 26 changes the KDVCQC to the Search Group 2 Set Name data field.

FIG. 26 picks up near the end of a branch decision query from FIG. 25 where, in FIG. 26, the user views a query data summary of every record in the database with a Music Code key data value of “Latin Beat” (2510); the user then goes on to select “Cuban Pete” by Tito Puente (which has a Set Name value of “Dance Party”) to make it the anchor record (2520).

Next, the user views key data field options from plurality of default Search Group 2 KDVCQC buttons (220) such as: 1. Title, 2. Artist, 3. Music Code, 4. Set Name, and 5. Playlist Name. Continuing, if in a decision process (380), the user does not select the Set Name data field, he returns to contemplate choosing a different KDVCQC field (220). However if he chooses the Set Name KDVCQC data field (380), program focus is transferred to the text input control box (130). Next, in FIG. 26, in a decision process (1800) the user decides whether to submit improvised query instructions; if the user chooses yes, he inputs an ad hoc search string in the text box (1850) and the string is “Surf And Sun” (2600). Continuing, in FIG. 26, the user views a query data summary of every record in the database with a Set Name key data value of “Surf And Sun” (2610); the user then goes on to select “Surfer Girl” by the Beach Boys to make it the anchor record (2620).

However, if at decision process 1800, the user selects no, he accepts the default query instructions assigned to KDVCQC button (1830); next, without user intervention, query instructions assigned to KDVCQC button have automatically retrieved plurality of records with key data value that matches the key data value of the anchor record (1840); and finally, the user views a query data summary of every record in the database with a Set Name value of “Dance Party” (2630)—which matches the Set Name value of the original anchor record.

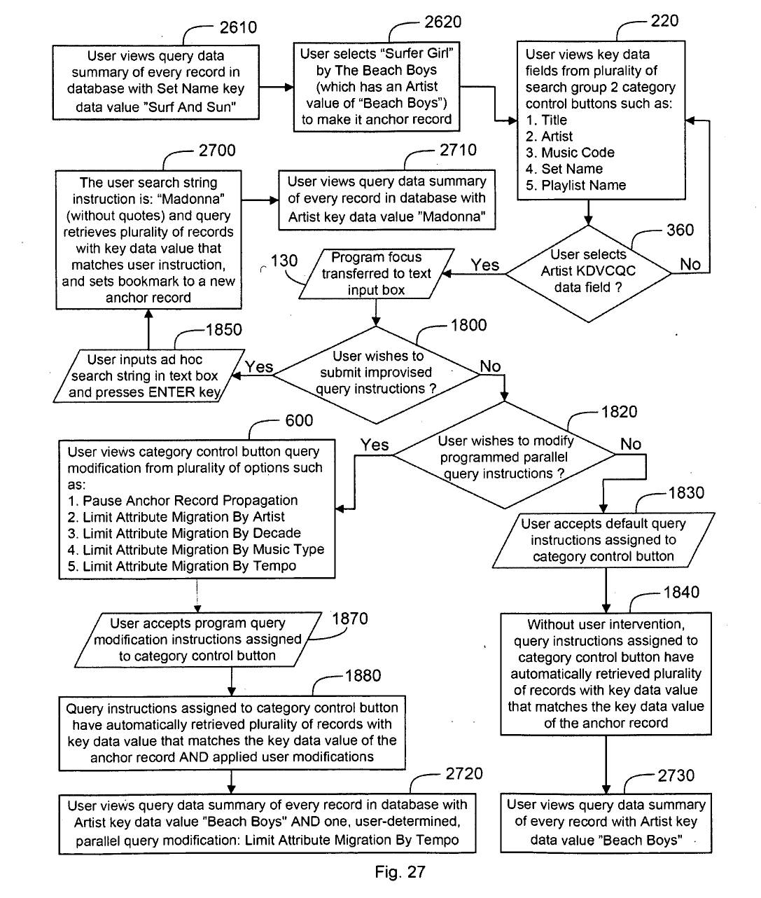

FIG. 27 is a flowchart (that begins at the point where FIG. 26 concluded) depicting a method for selecting from a plurality of key data value command query category (field) controls and then choosing between three operational modes which can produce different summary views and different anchor records, according to one embodiment of the present invention.

First in FIG. 27, the user views a query data summary of every record in database with Set Name key data value “Surf And Sun” (2610). This summary was calculated first in FIG. 26 and is taken as the starting point for FIG. 27 to demonstrate query association continuity. Next, the user selects “Surfer Girl” by The Beach Boys (which has an Artist value of “Beach Boys”) to make it anchor record (2620).

Continuing with FIG. 27, the user views key data fields from plurality of search group 2 category control buttons (220) such as: 1. Title, 2. Artist, 3. Music Code, 4. Set Name, and 5. Playlist Name (220). Then, in a decision process, the user may select the Artist KDVCQC (360). If he does not select the Artist data field query control, the user is redirected to choose a different KDVCQC from the Search group 2 set (220). If he does select the Artist KDVCQC, program focus is transferred to the text input control box (130).

At this point in FIG. 27, the user is presented with a second decision process (1800), where the user must decide whether to submit improvised query instructions. If the user chooses yes, he will input an ad hoc search string in text box (1850) and press the ENTER key. The user search string instruction was: “Madonna” (without quotes) and query retrieves plurality of records with key data value that matches user instruction, and sets bookmark to a new anchor record (2700). Then, the user views a summary of every record in the database with the key data value “Madonna” (2710).

Returning now to decision process 1800 where the user chooses no. A third decision process is then presented to the user, does he wish to modify the programmed parallel query instructions? (1820). Upon choosing yes, the user views category control button query modification restrictions from plurality of options (600) such as: 1. Pause Anchor Record Propagation, 2. Limit Attribute Migration By Artist, 3. Limit Attribute Migration By Decade, 4. Limit Attribute Migration By Music Type, and 5. Limit Attribute Migration By Tempo. Next, the user accepts program query modification instructions assigned to category control buttons of his choosing (1870). Continuing, query instructions assigned to category control button have automatically retrieved plurality of records with key data value that matches the key data value of the anchor record AND applied user modifications (1880). Next, the user views a query data summary of every record in the database with an Artist key data value “Beach Boys” AND one, user-determined, parallel query chose to apply one modification.

Continuing with FIG. 27, and returning now to decision process 1820 where the user chooses no. This decision means the user accepts the default query instructions assigned to category control button by the program instructions (1830). Next, without user intervention, query instructions assigned to category control button have automatically retrieved plurality of records with key data value that matches the key data value of the anchor record (2730). This flowchart demonstrates how the process in FIG. 27 can permit the user to develop three different record queries based on his decisions.

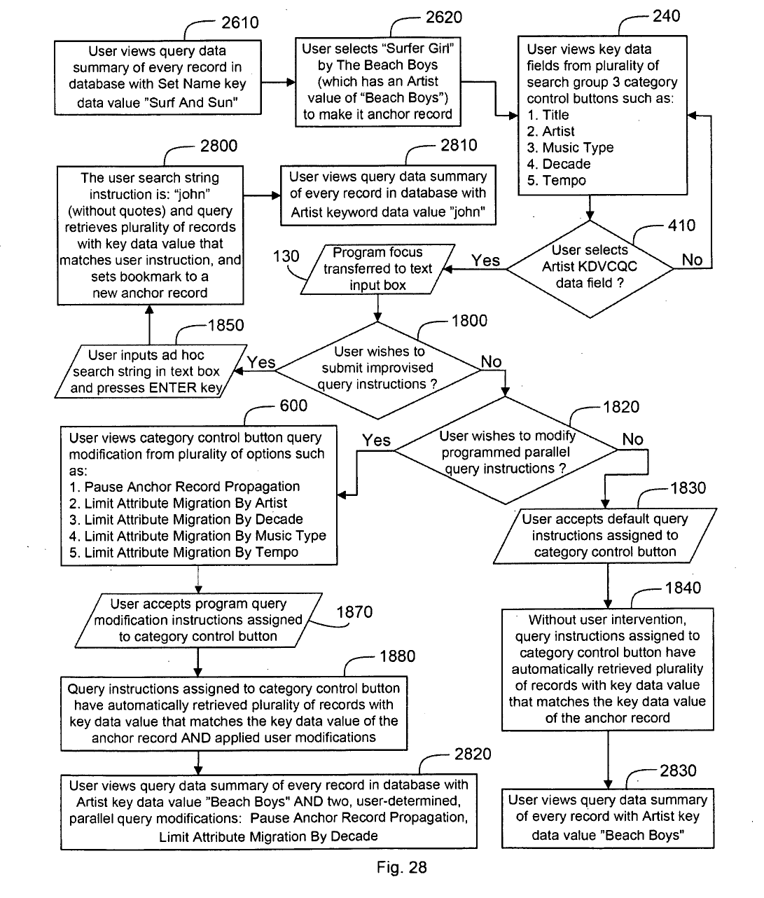

FIG. 28 is a flowchart (that begins at the point where FIG. 26 concluded) depicting a method for selecting from a plurality of key data value command query category (field) controls and then choosing between three operational modes which can produce different summary views and different anchor records, according to one embodiment of the present invention.

The flow process in FIG. 28 is identical to FIG. 27, however FIG. 28 changes the KDVCQC to the Search Group 3 Artist keyword data field, and the user has been able to view key data fields from plurality of Search Group 3 category control keyword buttons (240) such as: 1. Title, 2. Artist, 3. Music Type, 4. Decade, and 5. Tempo. This change will, of course, allow at least one query to deliver different results. Also in FIG. 28, the user applies two parallel query modifications (instead of one), and this too can produce different results.

First in FIG. 28, the user views a query data summary of every record in database with Set Name key data value “Surf And Sun” (2610). This summary was calculated first in FIG. 26 and is taken as the starting point for FIG. 28 to demonstrate query association continuity. Next, the user selects “Surfer Girl” by The Beach Boys (which has an Artist value of “Beach Boys”) to make it anchor record (2620).

Continuing with FIG. 28, the user views key data fields from plurality of search group 3 category control buttons (240) such as: 1. Title, 2. Artist, 3. Music Type, 4. Decade, and 5. Tempo. Then, in a decision process, the user may select the Artist KDVCQC (410). If he does not select the Artist data field query control, the user is redirected to choose a different KDVCQC from the Search group 3 set (240). If he does select the Artist KDVCQC (410), program focus is transferred to the text input control box (130).

At this point in FIG. 28, the user is presented with a second decision process (1800), where the user must decide whether to submit improvised query instructions. If the user chooses yes, he will input an ad hoc search string in text box (1850) and press the ENTER key. The user search string instruction was: “john” (without quotes) and query retrieves plurality of records with key data value that matches user instruction, and sets bookmark to a new anchor record (2800). Then, the user views a summary of every record in the database with the artist keyword data value “john” (2810).

Returning now to decision process 1800 where the user chooses no. A third decision process is then presented to the user, does he wish to modify the programmed parallel query instructions? (1820). Upon choosing yes, the user views category control button query modification restrictions from plurality of options (600) such as: 1. Pause Anchor Record Propagation, 2. Limit Attribute Migration By Artist, 3. Limit Attribute Migration By Decade, 4. Limit Attribute Migration By Music Type, and 5. Limit Attribute Migration By Tempo. Next, the user accepts program query modification instructions assigned to category control buttons of his choosing (1870). Continuing, query instructions assigned to category control button have automatically retrieved plurality of records with key data value that matches the key data value of the anchor record AND applied user modifications (1880). Next, the user views a query data summary of every record in the database with an Artist key data value “Beach Boys” AND two, user-determined, parallel query modifications (2820): Pause Anchor Record Propagation and Limit Attribute Migration By Decade because, in this example, the user chose to apply two modifications.

Continuing with FIG. 28, and returning now to decision process (1820) where the user chooses no. This decision means the user accepts the default query instructions assigned to category control button by the program instructions (1830). Next, without user intervention, query instructions assigned to category control button have automatically retrieved plurality of records with key data value that matches the key data value of the anchor record (1840). Finally, the user views a query data summary of every record in the database with an Artist key data value of “Beach Boys” (2830)—which is where the data flow process in FIG. 28 began. This flowchart demonstrates how the process in FIG. 28 can permit the user to develop three different record queries based on his or her decisions.

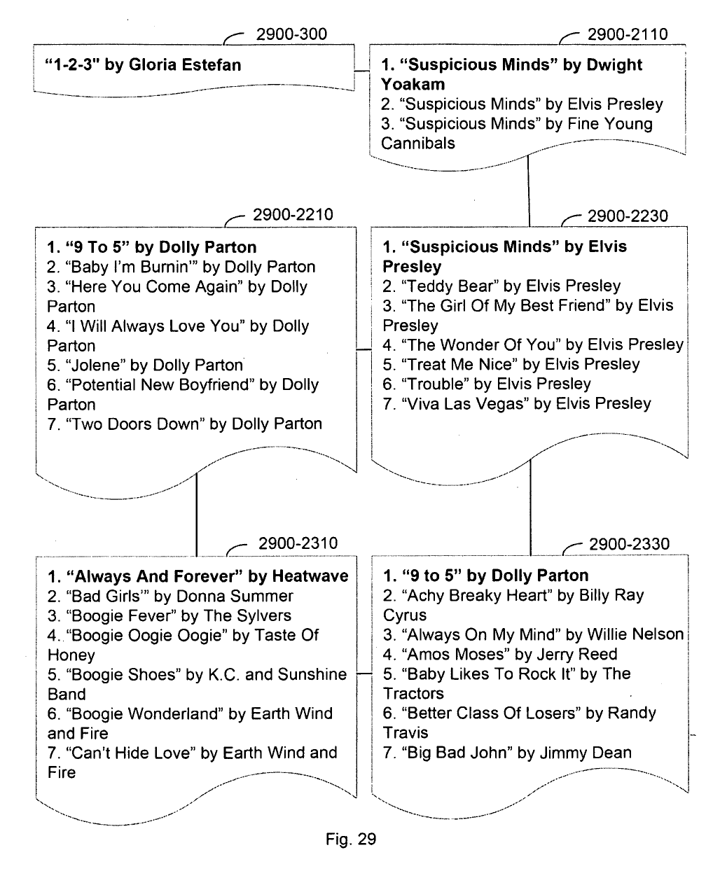

The next group of figures (FIG. 29-FIG. 33) presents query summary lists that include results listing, among other attributes, a song Title and its corresponding Artist. For readability, the figures here show listings such as “Little Surfer Girl” by the Beach Boys. However, in the software embodiments disclosed here, the media player data displays do not include the word “by” before the Artist name.

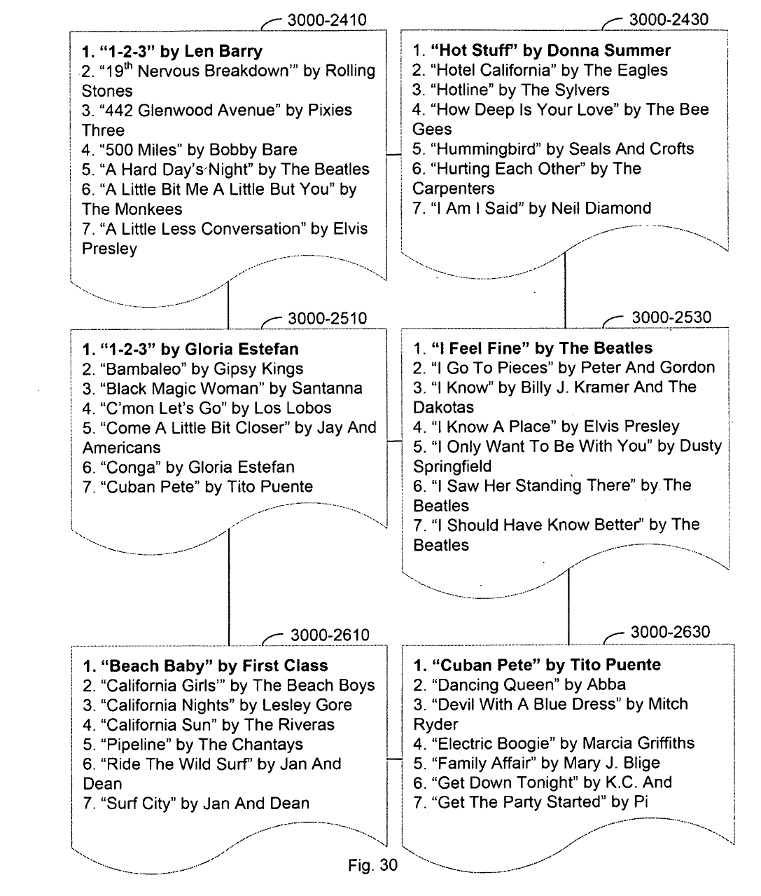

In FIGS. 29 through 33, the character labels use hyphenated numbers where the number that appears after the hyphen refers to the query results that are depicted in corresponding flowchart illustrations. For example, in FIG. 29, character number 2900-2110 shows query results that correspond with the process depicted in FIG. 21, character 2110; and in FIG. 30, character 3000-2430 shows query results that correspond with the process depicted in FIG. 24, character 2430. One exception is FIG. 29, character 2900-300 which depicts the first record appearing in a default Search Group 1 query attached to the “Title” KDVCQC (which first appears in the specification as character 300, in FIG. 3).

Now referring to FIG. 29, this drawing illustrates different views of summary lists (delineating specific record sets) that have been retrieved from the music catalog (database) as a result of using various combinations of default (pre-programmed) and user-improvised query instructions.

In FIG. 29, character 2900-300 depicts: Default Search Group 1, Opens to Title Category, with bookmark set on anchor record determined by an alphabetically ordered list of title data; character 2900-2110 depicts: Search Group 1, Title Category user ad hoc query has retrieved three discrete records on the instruction “Suspicious Minds”—with bookmark set on the new anchor record, “Suspicious Minds” by Dwight Yoakam, determined by an alphabetically ordered list of title data; character 2900-2210 depicts: Search Group 1, Artist Category user ad hoc query has retrieved a plurality of records on the instruction “Dolly Parton”—with bookmark set on the new anchor record, “9 To 5” by Dolly Parton, determined by an alphabetically ordered list of title data.

Continuing with FIG. 29, character 2900-2230 depicts: Search Group 1, Artist Category programmed parallel query has retrieved a plurality of records on the key data value “Elvis Presley”—with bookmark set on anchor record, “Suspicious Minds” by Elvis Presley, determined by propagation of the anchor record from the preceding query; the list is alphabetically ordered by title data, starting with the anchor record; character 2900-2310 depicts: Search Group 1, Music Type Category user ad hoc query has retrieved a plurality of records on the instruction “Disco”—with bookmark set on the new anchor record, “Always And Forever” by Heatwave, as determined by an alphabetically ordered list of title data.

And finally, in FIG. 29, character 2900-2330 depicts: Search Group 1, Music Type Category programmed parallel query has retrieved a plurality of records on the key data value “Country”—with bookmark set on anchor record, “9 to 5” by Dolly Parton, determined by propagation of the anchor record from the preceding query; the list is alphabetically ordered by title data, starting with the anchor record.

Now referring to FIG. 30, this drawing illustrates different views of summary lists (delineating specific record sets) that have been retrieved from the music catalog (database) as a result of using various combinations of default (pre-programmed) and user-improvised query instructions.

In FIG. 30, character 3000-2410 depicts: Search Group 1, Decade Category user ad hoc query has retrieved a plurality of records on the instruction “1960”—with bookmark set on the new anchor record, “1-2-3” by Len Barry, determined by an alphabetically ordered list of title data; character 3000-2430 depicts: Search Group 1, Decade Category programmed parallel query has retrieved a plurality of records on the key data value “1970”—with bookmark set on anchor record, “Hot Stuff” by Donna Summer, determined by propagation of the anchor record from the preceding query; the list is alphabetically ordered by title data, starting with the anchor record.

Also in FIG. 30, character 3000-2510 depicts: Search Group 2, Music Code Category user ad hoc query has retrieved a plurality of records on the instruction “Latin Beat”—with bookmark set on the new anchor record, “1-2-3” by Gloria Estefan, determined by an alphabetically ordered list of title data; character 3000-2530 depicts: Search Group 2, Music Code Category programmed parallel query has retrieved a plurality of records on the key data value “British Invasion”—with bookmark set on anchor record, “I Feel Fine” by The Beatles, determined by propagation of the anchor record from the preceding query; the list is alphabetically ordered by title data, starting with the anchor record.

Continuing with FIG. 30, character 3000-2610 depicts: Search Group 2, Set Name Category user ad hoc query has retrieved a plurality of records on the instruction “Surf And Sun”—with bookmark set on the new anchor record, “Beach Baby” by First Class, determined by an alphabetically ordered list of title data; and finally, character 3000-2630 depicts: Search Group 2, Set Name Category programmed parallel query has retrieved a plurality of records on the key data value “Dance Party”—with bookmark set on anchor record, “Cuban Pete” by Tito Puente, determined by propagation of the anchor record from the preceding query; the list is alphabetically ordered by title data, starting with the anchor record.

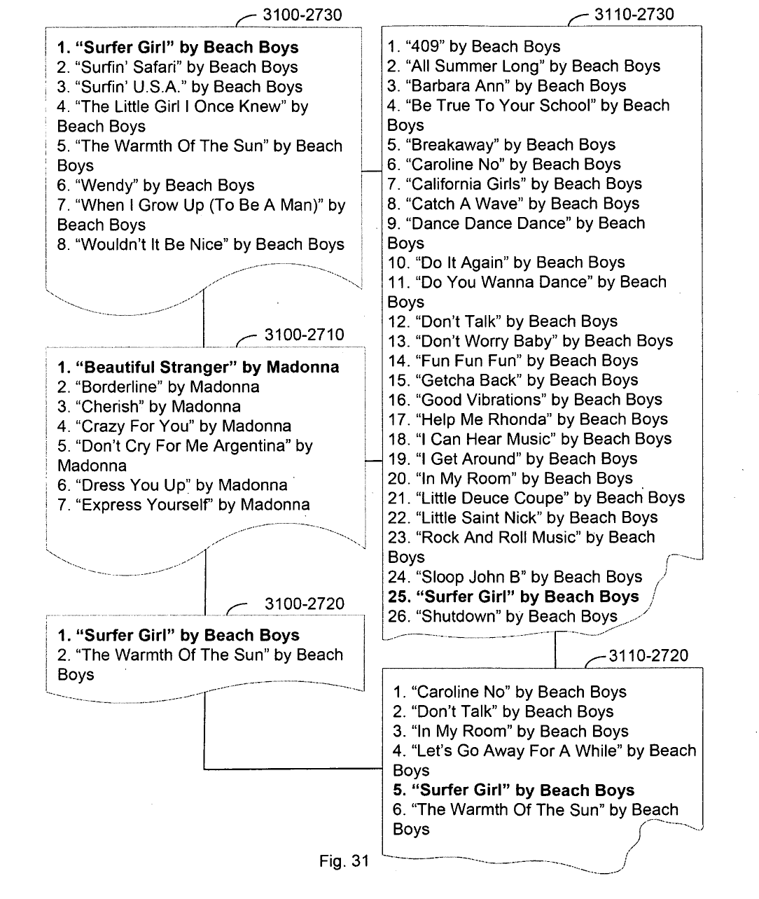

Now referring to FIG. 31, this drawing illustrates different views of summary lists (delineating specific record sets) that have been retrieved from the music catalog (database) as a result of using various combinations of default (pre-programmed), user-improvised, and filter modified query instructions.

In FIG. 31, character 3100-2730 depicts: Search Group 2, Artist Category programmed parallel query has retrieved a plurality of records on the key data value “Beach Boys”—with bookmark set on anchor record, “Surfer Girl” by Beach Boys, determined by propagation of the anchor record from the preceding query; the list is alphabetically ordered by title data, starting with the anchor record; character 3110-2730 depicts: Search Group 2, Artist Category programmed parallel query has retrieved a plurality of records on the key data value “Beach Boys”—with bookmark set on anchor record, “Surfer Girl” by Beach Boys, determined by propagation of the anchor record from the preceding query; the list is alphabetically ordered by title data, starting with the anchor record, however, in this view, the user has browsed to the top of the list.

Continuing with FIG. 31, character 3100-2710 depicts: Search Group 2, Artist Category user ad hoc query has retrieved a plurality of records on the instruction “Madonna”—with bookmark set on the new anchor record, “Beautiful Stranger” by Madonna, determined by an alphabetically ordered list of title data; character 3100-2720 depicts: Search Group 2, Artist Category programmed parallel query has retrieved a plurality of records on the key data value “Beach Boys”—with bookmark set on anchor record, “Surfer Girl” by Beach Boys, determined by propagation of the anchor record from the preceding query, using the Artist data value of the preceding query and filtering for slow tempo data values; the list is alphabetically ordered by title data, starting with the anchor record.

And finally, in FIG. 31, character 3110-2720 depicts: Search Group 2, Artist Category programmed parallel query has retrieved a plurality of records on the key data value “Beach Boys”—with bookmark set on anchor record, “Surfer Girl” by Beach Boys, determined by propagation of the anchor record from the preceding query, using the Artist data value of the preceding query and filtering for slow tempo data values; the list is alphabetically ordered by title data, starting with the anchor record, however, in this view, the user has browsed to the top of the list.

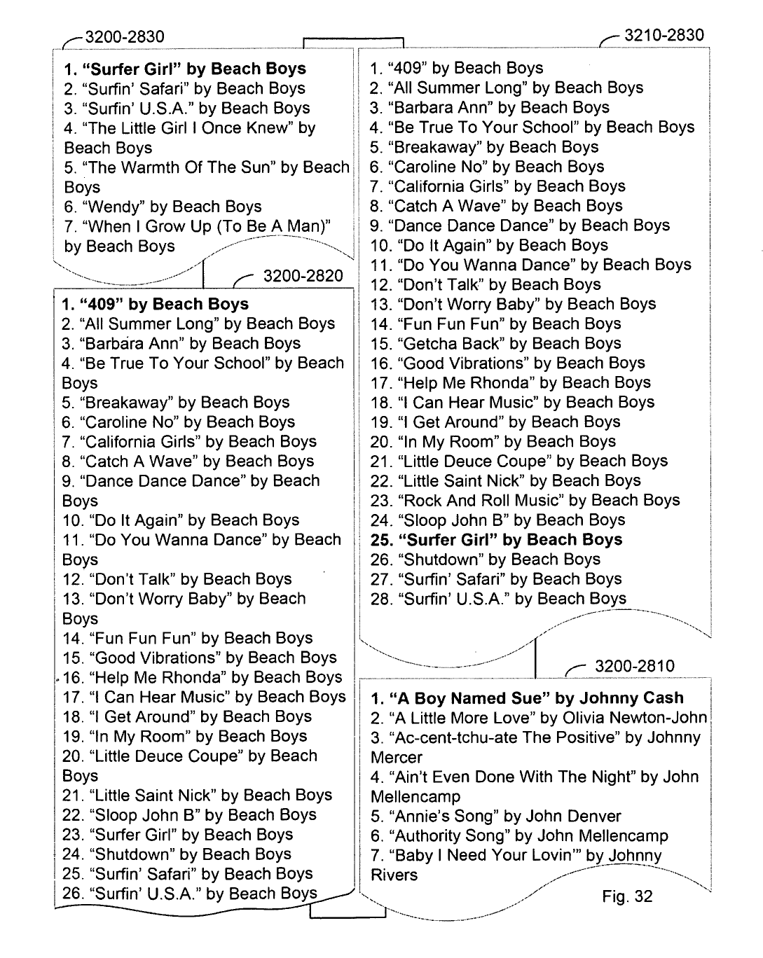

Now referring to FIG. 32, this drawing illustrates different views of summary lists (delineating specific record sets) that have been retrieved from the music catalog (database) as a result of using various combinations of default (pre-programmed), user-improvised, and filter modified query instructions.

In FIG. 32, character 3200-2830 depicts: Search Group 3, Artist Category programmed parallel query has retrieved a plurality of records on the key data value “Beach Boys”—with bookmark set on anchor record, “Surfer Girl” by Beach Boys, determined by propagation of the anchor record from the preceding query; the list is alphabetically ordered by title data, starting with the anchor record; character 3210-2830 depicts: Search Group 3, Artist Category programmed parallel query has retrieved a plurality of records on the key data value “Beach Boys”—with bookmark set on anchor record, “Surfer Girl” by Beach Boys, determined by propagation of the anchor record from the preceding query; the list is alphabetically ordered by title data, starting with the anchor record, however, in this view, the user has browsed to the top of the list.

Continuing with FIG. 32, character 3200-2820 depicts: Search Group 3, Artist Category programmed parallel query has retrieved a plurality of records on the key data value “Beach Boys”—with bookmark set on new anchor record, “409” by Beach Boys, determined by using the ARTIST data value of the preceding query, suspending propagation of the anchor record from the preceding query and filtering for 1960 decade data values; the list is alphabetically ordered by title data, starting with the anchor record; and finally, character 3200-2810 depicts: Search Group 3, Artist Category user ad hoc keyword query has retrieved a plurality of records on the instruction “john”—with bookmark set on the new anchor record, “A Boy Named Sue” by, Johnny Cash, determined by an alphabetically ordered list of title data.

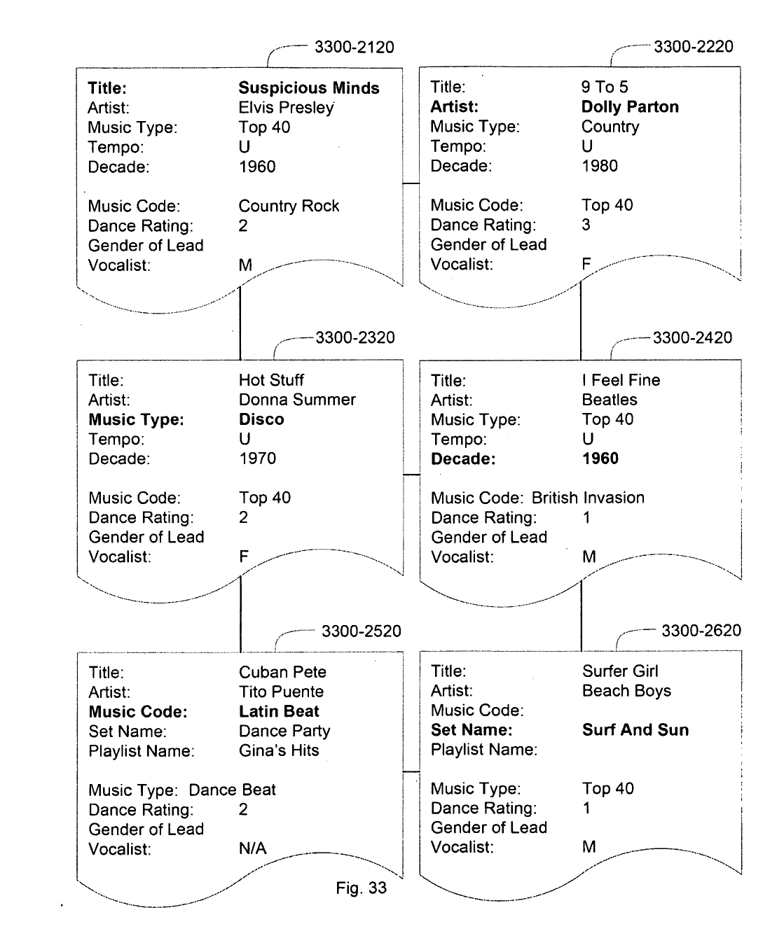

Now referring to FIG. 33, this drawing illustrates different views of key data values (associated with specific anchor records) that have been retrieved from the music catalog (database) as a result of using various combinations of default (pre-programmed based on command query control buttons), user-improvised, and filter modified query instructions.

In FIG. 33, character 3300-2120 depicts a scenario where the user selects “Suspicious Minds” by Elvis Presley to make it the anchor record. Query was based on the Title category control button. The key data fields for this recording in Search Group 1 contain the listed values; with additional values for associated data categories such as Music Code, Dance Rating, etc. as noted; character 3300-2220 depicts a scenario where the user selects “9 To 5” by Dolly Parton to make it the anchor record. Query was based on the Artist category control button. The key data fields for this recording in Search Group 1 contain the listed values; with additional values for associated data categories; character 3300-2320 depicts a scenario where the user selects “Hot Stuff” by Donna Summer to make it the anchor record. Query was based on the Music Type category control button. The key data fields for this recording in Search Group 1 contain the listed values; with additional values for associated data categories.

Continuing with FIG. 33, character 3300-2420 depicts a scenario where the user selects “I Feel Fine” by The Beatles to make it the anchor record. Query was based on the Decade category control button. The key data fields for this recording in Search Group 1 contain the listed values; with additional values for associated data categories; character 3300-2520 depicts a scenario where the user selects “Cuban Pete” by Tito Puente to make it the anchor record. Query was based on the Music Code category control button. The key data fields for this recording in Search Group 2 contain the listed values; with additional values for associated data categories.

And finally, in FIG. 33, character 3300-2620 depicts a scenario where the user selects “Surfer Girl” by The Beach Boys to make it the anchor record. Query was based on the Set Name category control button. The key data fields for this recording in Search Group 2 contain the listed values; with additional values for associated data categories.

The next two figures, 34A and 34B, illustrate a programming event state known as “focus”. Before detailing the individual depictions for these related figures, an explanation of focus, as used in this invention, will be described.

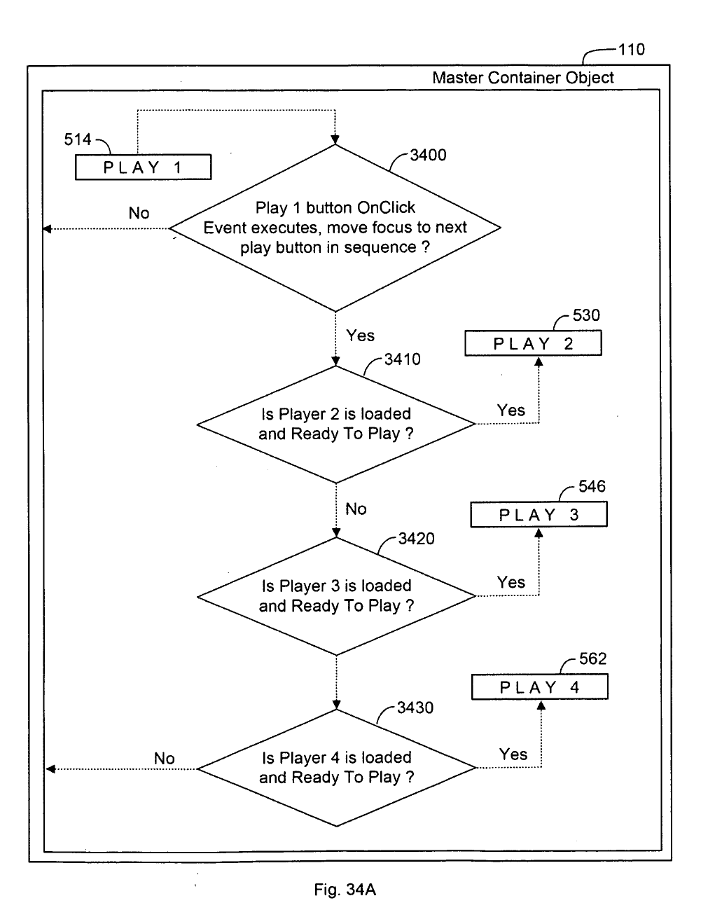

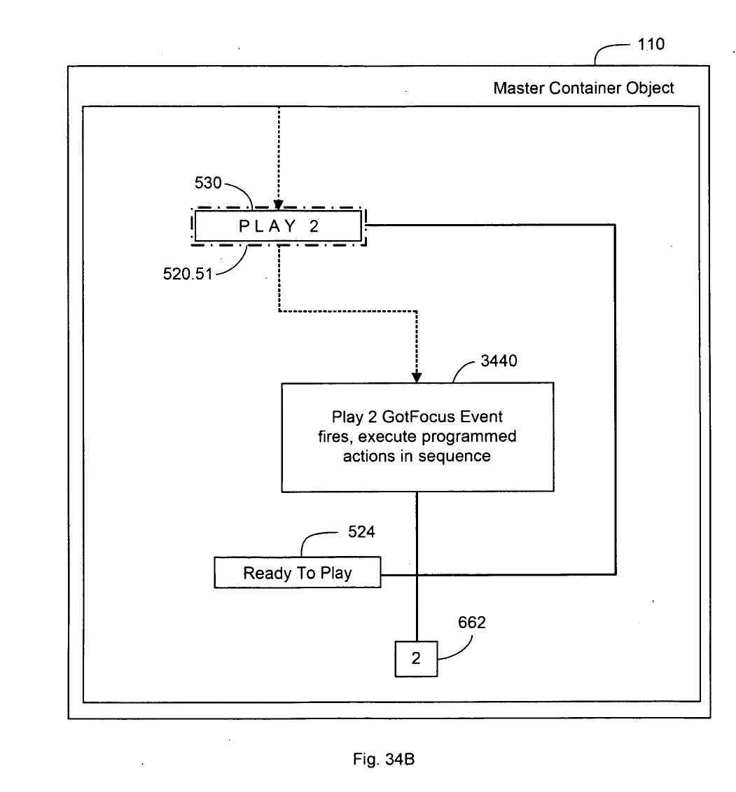

FOCUS (for one embodiment as depicted in FIG. 34A) is an object state or event state where the development environment such as found, for example, in the Microsoft® Access™ database product, will permit the computer programmer to construct software routines (programming statements) that can allow the user, or the application itself, to execute tasks specific to the programming object that is, or has been, or may yet be (and conversely, is not, or has not, or will not be)—the SUBJECT of program attention at any given point in time.

The invention described in this specification uses a system and method of object delineation, coordinated with focus events and other programming techniques, to create NEXT EVENT AUTO-FOCUS (which is part of the invention's situational awareness logic) to confer, in one embodiment, a programmed capability to evaluate the collective sum of all key object states in a MASTER CONTAINER OBJECT and calculate which media player object should properly become the next object of focus—and then to carry out a focus command, and a plurality of additional instructions as may be included, for the purpose of achieving desirable goals such as moving the player sequence forward according to a schedule or spontaneous user action.

A reader skilled in the art will likely recognize that the processor and systems described in at least one embodiment of this invention are controlled by a combination of Microsoft® Access™, Microsoft Visual Basic® for Applications (VBA) programming, industry-standard SQL (structured query language)—and the interaction of those programming environments with the Microsoft Windows® operating system.

One embodiment leverages measurable information pertaining to object states and properties as instantiated (created) in a Master Container Object design specifically for this invention. In one embodiment, the Master Container Object works with the operating system to control audio as reproduced through digital media players instantiated in the Master Container Object.

In particular, as noted, a Microsoft® Access™/VBA object event state known as “focus” can be used to help the programmer specifically identify an object that is currently, has been, or can be directed to be—the subject of program attention; e.g. the code can be designed to execute certain events, react to certain events or change specified object states in direct correlation with respect to various focus states or directives (such as GotFocus, LostFocus, SetFocus, etc.) of any other object in the master container, as that object might possess at any given time.

In visual terms, focus can be depicted to the user as an observable display modification corresponding with the state of screen objects. For example, with regard to a specific digital media player, focus can be depicted as a state where that media player is in a “selected condition”, as contrasted with other digital media players that may be concurrently presented on the visual display screen, but are in a “non-selected condition” and therefore do not demonstrate focus.

Receiving focus (for one embodiment as depicted in FIG. 34B) can be an object state that causes a plurality of other objects to change their properties.

In the world of Microsoft® Access™ and Microsoft® VBA, when a computer routine is programmed to quantify or adjust the focus state of any object, it can be compared to an NFL football team that has been trained (programmed) to react to the physical state of the football in play on the field, according to evaluated conditions and specified rules within a given timeframe. For example: How close is the football to the goal line of Team 1?, How much time remains on the clock?, If Player X has possession of the football, Player Y will tackle Player X and Player Z will assist Player Y, etc.

To continue the sports analogy, when a quarterback hands off the football to his running back, it might be said that the quarterback has Lost Focus and that the running back has Got Focus—and, like an executing computer instruction, this event can be observed unfolding in real-time on the gridiron, with demonstrable effects, as the all the players from both teams change position in order to focus on the football and execute maneuvers designed to achieve critical objectives like thwarting a field goal or scoring a touchdown.

Having described FOCUS, the skilled reader should be aware that this invention makes extensive use of various focus states through the creation of an elaborate series of programming objects and associated code instructions which, as previously noted, are collectively referred to as “NEXT EVENT AUTO-FOCUS”; and where the objective is to construct a logical system and method of manipulating master container objects so that each object might react in a predictable manner as if each object possessed an innate awareness of any other key object in the master container, even though, in the absence of the unique design depicted in such an embodiment, each object cannot be intrinsically aware of any other object, or the current property states of that other object.

Imagine the crowded football field again. Then visualize how the coach for one team could manipulate the game action if he knew what every player could see from that player's perspective. What if the coach could always know, to the millimeter, where each player was in relation to the football and the precise vector and speed of any offensive or evasive action each player might undertake at the moment the ball became airborne? What if the coach could control focus (possession) of the football? Much like one embodiment detailed in this specification, a coach with native “situational awareness” capabilities would have an immediate advantage.

In one embodiment of the present invention, the net effect of this “see all, know all” strategy has been to produce a Master Container Object (implemented in part by programming instructions attached to commands accessible in the user interface) with situational awareness logic, wherein certain objects are manipulated by rules-based programming so that they can behave in a predictable and beneficial manner with or without user intervention, and further, the Master Container Object can also concurrently manage and visually indicate a programmed event sequence (workflow pattern) to the user via a computer display and audio cues, while permitting the user to improvisationally alter the sequence.

A system and method will be disclosed for an embodiment that will demonstrate how the invention can assess its collective state (via cumulative analysis of a plurality of discrete object and event states), prepare itself for execution of the next logical event, and communicate to the user a series of program-initiated, program recommended, and user-modifiable actions, according to a prescribed time line, as they may collectively serve to advance the primary goal of the invention: to construct an advanced, integrated, digital media asset management and reproduction system.

Now referring to FIG. 34A which illustrates how an event state known as program focus (hereinafter “focus”) can be used to determine how a specific object can be directed to be the subject of attention during the execution of a programming procedure according to one embodiment. In FIG. 34A, the dashed line with arrow point indicates the flow of program focus between objects and object event processes and between object event processes and object events.

In FIG. 34A, the Master Container Object (110) controls the invention's customized logic-based rules which manage focus; and focus can be used to evaluate logic process execution and determine process direction in decision trees. This capability allows the invention to construct a consistent level of situational awareness logic.

When the user clicks the (Media Player 1 Object) Play 1 button (514), computer instructions attached to its OnClick event (3400) trigger a series of instructions controlled and evaluated by the Master Container Object (MCO). In this simple example, the Play 1 button OnClick event will start audio reproduction from Player 1, change the Player 1 status message label from “Ready To Play” to “Now Playing”, and it will also instruct the MCO to determine whether the next sequential player is loaded and ready to play.

If next event auto focus is turned off, focus will default to a designated holding object in the MCO. If next event auto focus is on, the sequential workflow instructions will evaluate each player's ready state in order beginning with the Is Player 2 Loaded and Ready To Play process (3410). If Player 2 is ready to play, the MCO will direct focus to the Play 2 button (530) where this action will trigger appropriate visual cues to the user and prepare Player 2 for immediate start.

However, if Player 2 is not ready to play, the MCO will evaluate moving focus to the next logic waypoint such as Player 3, continuing with the Is Player 3 Loaded and Ready To Play process (3420). If Player 3 is ready to play, the MCO will move focus to the Play 3 button (546).

However, if Player 3 is not ready to play, the MCO will evaluate moving focus to the next logic waypoint such as Player 4, continuing with the Is Player 4 Loaded and Ready To Play process (3430). If Player 4 is ready to play, the MCO will move focus to the Play 4 button (562).

In cases where no player is ready to play, the OnClick event can be instructed to move focus to a default object in the MCO.

In one embodiment, the MCO can determine if a digital media player, such as Player 2, is ready to play by issuing an instruction to evaluate the caption value of the message status label for Player 2. If the caption value of the Player 2 message status label were equal to “Not Loaded”, the MCO could calculate that Player 2 was not ready to play, and then attempt to move focus to Player 3. However, if the caption value of the Player 2 message status label were equal to “Ready To Play”, the MCO could calculate that Player 2 was ready to play, and therefore deduce that the Play 2 button should receive focus.

In the invention, status waypoints (or logic waypoints) are customized programming objects that have been created to provide a means for the MCO to evaluate the various states of each digital media player object. The MCO can measure or evaluate the condition of various logic waypoints such as: the caption value of individual message status labels which may correspond to a specific player, the color value of a visual border indicator which may correspond to a specific player, or the value of a program variable such as a song title which may correspond to a specific player.

The hierarchical system of rules-based logic in the MCO uses the collective assessment of a plurality of logic waypoints to instantiate, calibrate and operate a form of situational awareness (SA) logic within the invention. Since an embodiment can be designed to benefit operationally and visually from the SA logic, the MCO can effectively evaluate the various states of its instantiated digital media players and then control their physical operations (such as play, fade, mute) while also controlling corresponding visual cues (such as status labels, timing data, color border indicators) that may comprise optical flow cues that guide the user's audio event execution decisions.

Now referring to FIG. 34B which illustrates how an event state known as “focus” can be used to manipulate various object states and properties during the execution of a programming procedure. In FIG. 34B, the dashed line with arrow point indicates the flow of program focus between objects and object events, and the solid lines are used to illustrate objects or events that change in connection with a focus event.

In FIG. 34B, the Play 2 button (530) has been directed to receive focus by logic in the Master Container Object (110). As a result of receiving focus, the GotFocus event (3440) of the Play 2 button is triggered. Instructions attached to the Play 2 Gotfocus event cause a series of other objects to appear and change properties. These events include: to illuminate (make visible) a bright blue border (520.51) around the edges of the Play 2 button; to change the Player 2 status message (524) to Ready To Play (from Ready To Load), to change the status message font color to green (from orange); and to update the interface Player Ready Focus box (662), changing it to the number “2” representing the media player with current program focus (from that of “1” representing the number of the media player which previously had focus). In this manner, the MCO has evaluated the state of Player 2 and executed a series of programming instructions used to change visual cues that notify the user of the current player state.

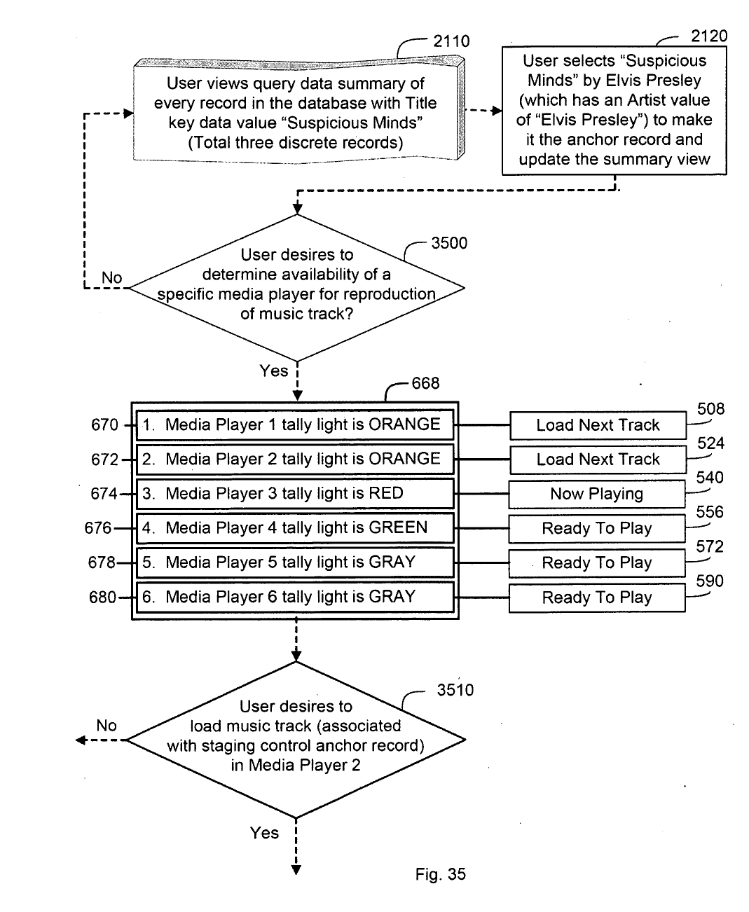

FIG. 35 is a flowchart depicting two visual methods the user may invoke to determine the availability of a plurality of media player objects (for purpose of loading a digital media file), according to one embodiment of the present invention.

Each object, event and process depicted in FIG. 35 is contained within the Master Container Object. Dashed lines with arrows indicate the direction of logic process (programming) workflow, and solid lines indicate a connected event or logic process.

At the top of FIG. 35, the user views a query data summary of every record in the database with the Title key data value of “Suspicious Minds”—a total of three discrete records (2110); then the user selects “Suspicious Minds” by Elvis Presley (2120) which has an Artist value of “Elvis Presley” to make it the anchor record and update the summary view.

Continuing with FIG. 35, if the user desires to determine availability of a specific media player for reproduction of a music track (3500) he continues with the process, otherwise he is routed back to the query summary. In one embodiment depicted in FIG. 35, the user may select from as many as six digital media players, numbered 1 through 6. In order to choose a target reproduction device from a plurality of available players, the user observes media player object states in the master container interface “field of view”, or discerns discrete player object load state via tally light display set (668).

In FIG. 35, the tally light for digital Media Player 1 (670) is orange, and its status message label (508) value reads “Load Next Track” in orange font indicating Player 1 is available because it is not currently active or “Now Playing”. The tally light for digital Media Player 2 (672) is orange, and its status message label (524) value reads “Load Next Track” in orange font indicating Player 2 is available. The tally light for digital Media Player 3 (674) is red, and its status message label (540) value reads “Now Playing” in red font indicating Player 3 is not available.

Continuing in FIG. 35, the tally light for digital Media Player 4 (676) is green, and its status message label (556) value reads “Ready To Play” in green font indicating Player 3 is not available for file insertion because it is loaded, ready to play, and is the subject of program focus. The tally light for digital Media Player 5 (678) is gray, and its status message label (572) value reads “Ready To Play” in gray font indicating Player 5 is not available because it is loaded, ready to play, and is not the subject of program focus. And the tally light for digital Media Player 6 (680) is gray, and its status message label (590) value reads “Ready To Play” in gray font indicating Player 6 is not available because it is loaded, ready to play, and is not the subject of program focus.

In the next character (3510) the user will choose whether to load the music track associated with the staging control anchor record into Media Player 2 which has been shown to be available. This completes the File Load Process Waypoint 1 step.

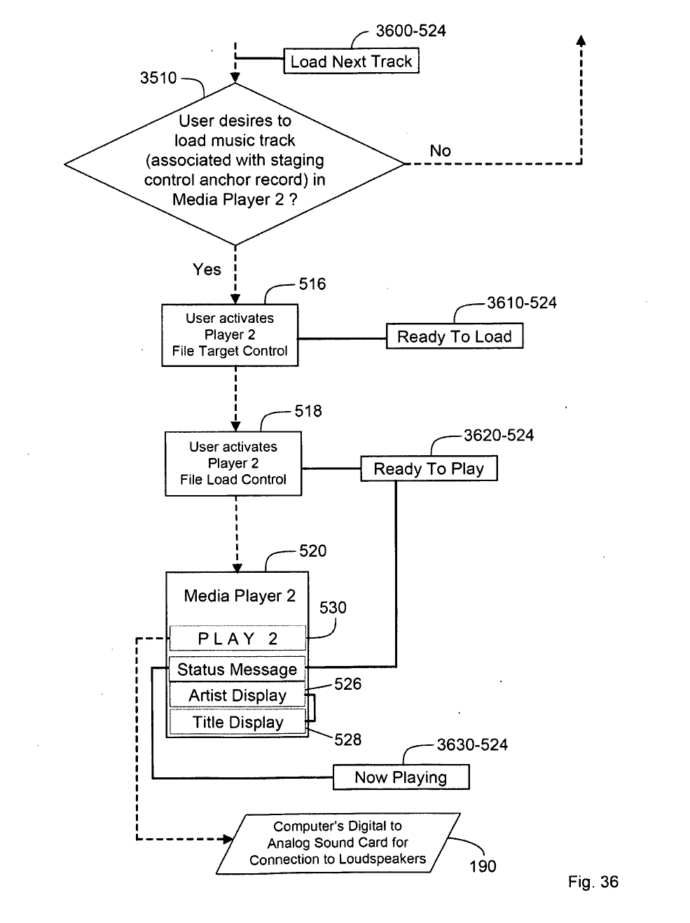

FIG. 36 is a flowchart (that begins at the point where FIG. 35 concluded) depicting the process of loading a digital file into a specific media player object when the user click-activates the requisite series of file load waypoint commands where, in turn, each command advances the process and changes the color and caption properties for associated objects.

Each object, event and process depicted in FIG. 36 is contained within the Master Container Object. Dashed lines with arrows indicate the direction of logic process (programming) workflow, and solid lines indicate a connected event or logic process.

At the top of FIG. 36, the Media Player 2 status message label (3600-524) is depicts its caption value as “Load Next Track” indicating to the user that Player 2 is not loaded and therefore not ready to play a music track (recording). In one embodiment, the Player 2 Status Message Display caption is rendered in orange font indicating that a previously loaded file has been played. The program code moves next to a decision process (3510) presented to the user: User desires to load music track (associated with staging control anchor record) in Media Player 2? If the user chooses No, the program flow returns to the Master Container Object to reevaluate the player availability options.

If the user chooses yes, he moves forward and will next elect to click the Player 2 File Target Control button (516) which tells the MCO the file in the Anchor Record Staging Control will be placed on standby for insertion into Player 2. This step will be File Load Process Waypoint 2. At the moment he clicks the Player 2 File Target Control button, the MCO changes the caption value in the Player 2 status message label (3610-524) to “Ready To Load” from “Load Next Track” and the font remains orange.

Continuing with FIG. 36, where the flowchart depicts the next step in the file reproduction process. The user will activate the Player 2 File Load Control (518) which also changes the caption value for the Player 2 status message label (3620-524) to “Ready To Play” from “Ready To Load” and the font color changes to green as focus defaults to the Player 2 Play button.

Next, there is a depiction of Media Player 2 (520) with its interface display objects including the Artist Display (526) and the Title Display (528). At the moment the new file was inserted (loaded) into Player 2, the Player 2 Artist and Title Display captions changed to indicate value of the currently loaded track which is “Suspicious Minds” by Elvis Presley.

Continuing in FIG. 36, the user clicks the Play 2 button (530) and the audio track begins playing. At the same moment, the Player 2 status message label (3630-524) caption value changes to “Now Playing” from “Ready To Play” and its font color changes to red.

Finally, we see the program flow depicting audio output to the computer's digital to analog sound card (190) which is in turn connected to loudspeakers.

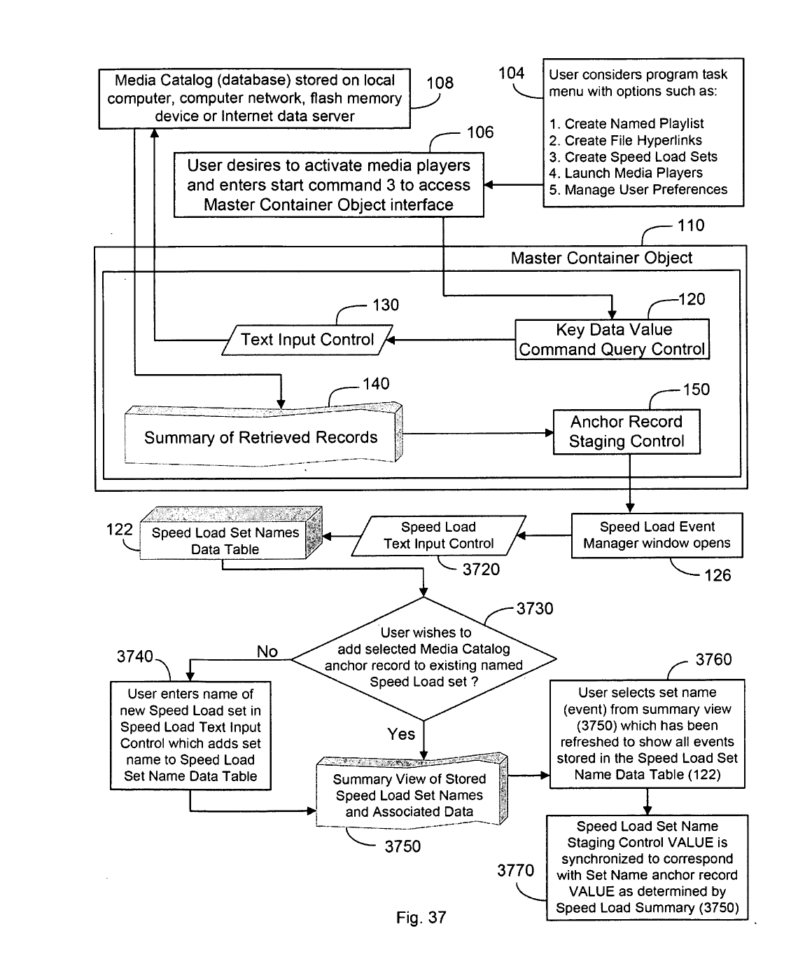

FIG. 37 is a flowchart depicting a method for querying and retrieving a specific database record from a media catalog (database) and passing its associated attribute information to the Speed Load Manager, and from there into a separate database table that catalogs named Speed Load sets; once a title is associated with a Speed Load Set Name (unique list), it can be readied for further transfer to a Speed Load Set Name staging control, which will next serve the title to the appropriate Speed Load Set Name variable position—which will eventually facilitate the transfer of the title (record) to a holding variable known as the Media Player Speed Load value.

The concept of a Speed Load Event (SLE) executed by a system of Speed Load Set Names associated with records in a Speed Load data table can be compared with so-called “speed loader” apparatus that a firearms owner might employ to rapidly load ammunition rounds into five or six cylinders of his revolver. In the way that a firearms speed loader can insert multiple ammunition cartridges into adjacent cylinders with one or two movements, an embodiment's SLE system can insert a plurality of digital media files into a plurality of digital media players with as little as one or two mouse clicks (steps).

The SLE as disclosed in this specification enables the user to conduct one query search (such as for a particular pre-designated Speed Load Event music list) and collectively insert (load) a plurality of digital media files on that list into a plurality of instantiated digital media players available in the Master Container Object (user interface). The files are not queued up for sequential playback into any one player; they are instead inserted for immediate reproduction capability in a plurality of discrete digital media players which may be used to reproduce digital audio from the files in any sequence desired by the user; with that sequence dependent on which digital media player the user (or alternatively, program automation) may choose to execute playback instructions.

This SLE method and system allows the user to collectively load 2, 3, 4, 5, or more files into corresponding digital media players with the query selection of one data set; as opposed to individually instigating multiple file query and load routines (which is how prior art functions today). The SLE is also different from media player Playlist functions in prior art which permit the user to select a pre-determined summary of digital media files and collectively load that Playlist into a single media player. (FIGS. 37 through 40 depict various flow process and system object designs for the SLE system.)

In FIG. 37 a user views a program task menu with options (104) such as: 1. Create Named Playlist, 2. Create File Hyperlinks, 3. Create Speed Load Sets, 4. Launch Media Players, and 5. Manage User Preferences. Next, a user desires to activate media players and therefore enters start command 3 to access Master Container Object interface (106). Program focus flows into the Master Container Object (110) and then to the default KDVCQC button (120). This in turn places focus in the Text Input Control box (130).

Continuing with FIG. 37, by default the Text Input Control (TIC) and a SQL database instruction attached to the KDVCQC run a query on the Media Catalog (database) stored on local computer, computer network, flash memory device or Internet data server (108). The results of the query are displayed in the Summary of Retrieved Records (140) with the first record in the list automatically propagated to the Anchor Record Staging Control (150). Next, the Speed Load Event Manager window opens (126) and focus is transferred to the Speed Load Text Input Control (3720).

At this junction in FIG. 37, the Speed Load Set Names Data Table (122) is automatically queried in default mode and a list of pre-designated Speed Load Event Set Names (each displaying a list of a plurality of digital music records associated with each Set Name) is observable by the user.

Next, the user enters a decision process; does he wish to add the currently selected Media Catalog default anchor record to an existing named Speed Load set? (3730). Note: the Media Catalog anchor record value is obtained from the Anchor Record Staging Control (150). If the answer is no, the user enters the name of new Speed Load set in Speed Load Text Input Control which adds the set name to Speed Load Set Name Data Table (3740) and places the title from the Anchor Record Staging Control on that set list. Program flow then advances to the Summary View of Stored Speed Load Set Names and Associated Data (3750). In an embodiment, Speed Load Set Names and associated data can be stored as discrete records in a relational table in the same database container as the Media Catalog.

Continuing with FIG. 37, the user next selects a Speed Load Set Name (3760) from summary view which has been refreshed to show all events stored in the Speed Load Set Name Data Table. Finally, the Speed Load Set Name Staging Control value is synchronized to correspond with the Set Name anchor record value (3770) as determined by Speed Load Summary.

Returning to decision process 3730 where if the user chooses yes, he bypasses character 3740 and moves directly to character 3750 because he does not intend to add the name of the current anchor record to a new Speed Load Set Name list and therefore can proceed with selecting a particular Speed Load Set Name from a Summary View of Stored Speed Load Set Names and Associated Data (3750).

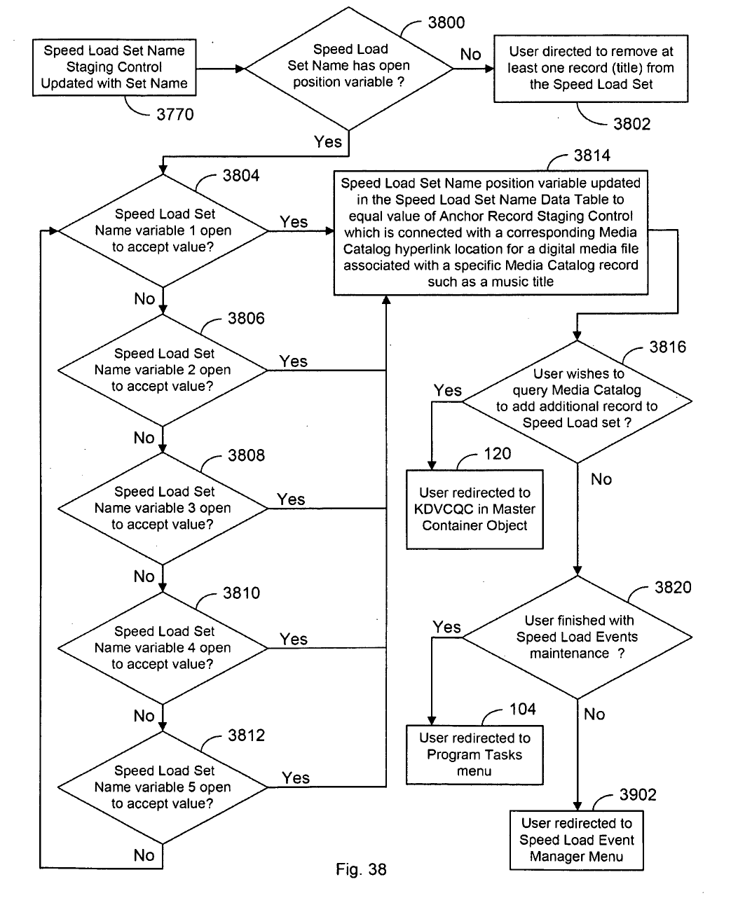

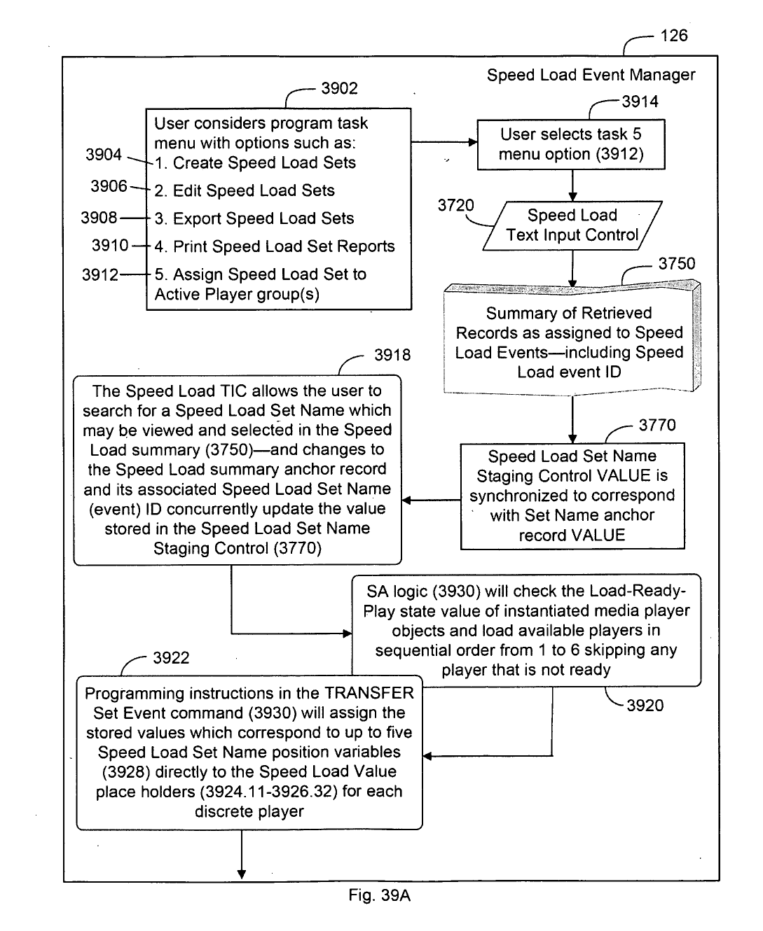

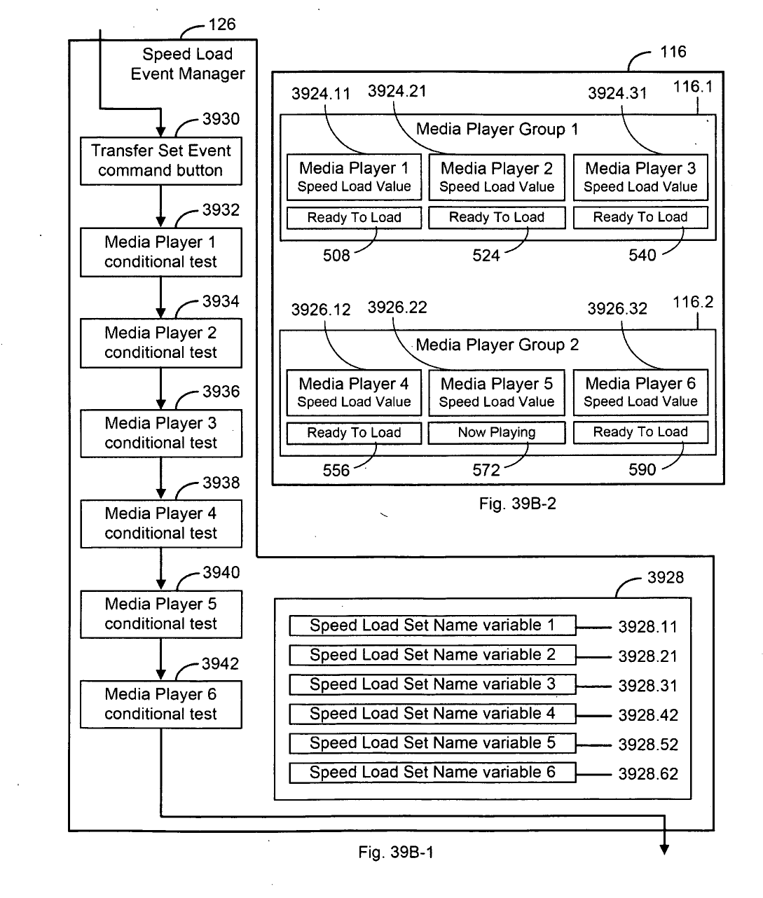

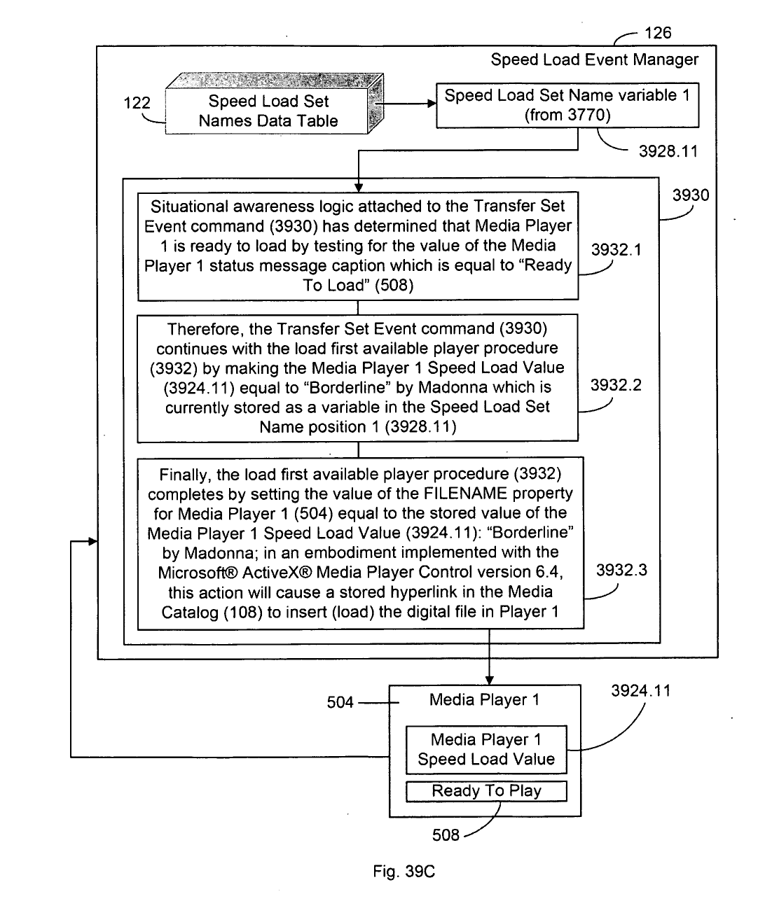

FIG. 38 is a flowchart that begins where FIG. 37 ended and follows the designated record (title) associated with the Speed Load Set Name staging control through a process that assigns the record to a specific Speed Load Set Name variable position.

FIG. 38 begins at a point where the Speed Load Set Name Staging Control is Updated with a Set Name (3770) and continues to a decision process (3800) where the system will determine whether the Speed Load Set Name has an open position variable. This is important because, for the embodiment envisioned here, a series of programming placeholders or memory “variables” will be created to temporarily store the names (titles) and associated physical (hard drive) addresses of digital media files as they exist on a Speed Load Set Name list. If an embodiment included five variables in the SLE system, it could accept the key identification data (such as song name and physical location) for five digital media files so that it may be stored in memory and subsequently transferred in one or two steps directly to the insertion instructions for a plurality of a corresponding five media players.

If the system did not have an open or available variable position, the user might be informed via a screen message and instructed to remove at least one record (title) from the current Speed Load Set (3802). However, if there was at least one variable position open, the system would then determine which position was open and proceed with its task of assigning key digital file information to an open variable.

Continuing with FIG. 38, the first available Speed Load Set Name variable position will be assigned. (For example, Speed Load Set Name variables 1 through 5 are illustrated as characters 3804, 3806, 3808, 3810 and 3812.) The evaluation process with the SLE is the same for all variables and once a variable position is assigned, the process (3814) ensures that the Speed Load Set Name position variable will updated in the Speed Load Set Name Data Table to equal value of Anchor Record Staging Control which is connected with a corresponding Media Catalog hyperlink location for a digital media file associated with a specific Media Catalog record such as a music title.

In the next decision process, the user must decide if he wishes to query the Media Catalog to add additional records to Speed Load set (3816). If yes, the user is redirected to KDVCQC in Master Container Object. If no, the user is directed to the next decision process where he must decide if he is finished with Speed Load Events maintenance (3820). If no at 3820, the user is redirected to Program Tasks menu (104); if yes, the user is redirected to Speed Load Event Manager Menu (3902).

Returning to decision process 3816 in FIG. 38: if the user chooses yes, indicating he does not wish to query the Media Catalog to add an additional record to the Speed Load set, he is directed to the generic KDVCQC (120).

FIG. 39A is a flowchart that begins a more detailed explanation of the process used to place a retrieved media catalog record (title) into the Speed Load Set Name staging control and through a process that assigns the record to a specific Speed Load Set Name variable position so that, eventually, the stored record can be loaded into a media player object as part of one batch load process command.

FIG. 39A begins where the user considers program task menu with options (3902) such as: 1. Create Speed Load Sets (3904), 2. Edit Speed Load Sets (3906), 3. Export Speed Load Sets (3908), 4. Print Speed Load Set Reports (3910), and 5. Assign Speed Load Set to Active Player group(s) (3912); the user selects the task 5 menu option (3914); program focus is transferred to the Speed Load Text Input Control (3720) and next the user will see the Summary of Retrieved Records as assigned to Speed Load Events—ordered first by Speed Load Set Name, then Title, Artist, etc. and including Speed Load event ID (3750).

Continuing with FIG. 39A, the Speed Load Set Name Staging Control value is synchronized to correspond with Set Name anchor record value (3770) as determined by Speed Load Summary; then the Speed Load Text Input Control allows the user to search for a Speed Load Set Name (3918) which may be viewed and selected in the Speed Load summary—and changes to the Speed Load summary anchor record and its associated Speed Load Set Name (event) ID concurrently update the value stored in the Speed Load Set Name Staging Control which will be used to transfer the Media Player object variable place holders (depicted in FIG. 39B-1, characters 3932 through 3942) which can help facilitate the auto-load process for a plurality of AVAILABLE media player objects with one approved command instruction.

At this point, in one embodiment, the situational awareness (SA) logic will check the Load-Ready-Play state value of instantiated media player objects and load available players in sequential order from 1 to 6 skipping any player that is not ready—up to a maximum of five players (3920). The next character (3922) describes a sequence of events that occur: the next group of programming instructions in the TRANSFER Set Event command (illustrated as character 3930 in FIG. 39B-1) will assign the stored values which correspond to up to five Speed Load Set Name position variables (depicted in FIG. 39B-1, character 3928) directly to the Speed Load Value place holders (depicted in FIG. 39B-2, characters 3924.11 through 3926.32) for each discrete player—which will then be converted to instructions that assign the associated hyperlink for selected records directly to each discrete player in the Media Player Object Group. Flow continues from 39A to the Media Player object variable place holder transactions which are illustrated in FIG. 39B-1.

FIG. 39B-1 is a flowchart that begins where FIG. 39A ends, and continues a detailed explanation of the process used to convert database information for a retrieved media catalog record (title), that is on a specific Speed Load Set Name event list, into a hyperlink value that can be identified by the system, loaded, and then made ready to play in a media player object, through the use of a system of variable data value placeholder exchanges that eventually culminate in a process that will concurrently load a plurality of digital files into a plurality of media player objects with one command.

FIG. 39B-1 starts at the point in the Speed Load Events Manger (126) where data flows from the Speed Load Set Name Staging Control to a User selection of the Transfer Set Event command button to accept Media Catalog records associated with the Speed Load Set Name—stored in the Speed Load Set Name Staging Control—and to process up to five file name values in one procedure (3930) in one embodiment.

In the next process (3932), a test is performed to determine the load-ready-play state of Media Player 1. The program uses these conditional tests: If Media Player 1 is ready to load, then make Media Player 1 Speed Load Value equal to Speed Load Set Name variable 1 (as stored in Speed Load Set Name data table); calculate by comparing the data point values represented by corresponding illustration numbers on this page:

If 508=“Ready To Load” then
3924.11=3928.11
MediaPlayer1.filename=3924.11
Else if 508 not=“Ready To Load” Then

### Go To Next Status Message Test

In order to understand the logic statement in context for character 3932, please review the characters depicted in FIG. 39B-1 and 39B-2, where, for example the number “508” in the statement above directly corresponds with FIG. 39B-2, character 508; and the number “3924.11” corresponds to FIG. 39B-2 character 3924.11; and the number “3928.11” corresponds to FIG. 39B-1 character 3928.11.

A successful test will cause the stored hyperlink for the associated Media Catalog record to load the player. This logic process is then repeated for each media player object (Media Player 2, 3, 4, 5, and 6) and the test conditions required for each variable assignment are represented by the depiction of FIG. 39B-1 characters 3934, 3936, 3938, 3940, and 3942—where each character corresponds with Media Players 2 through 6.

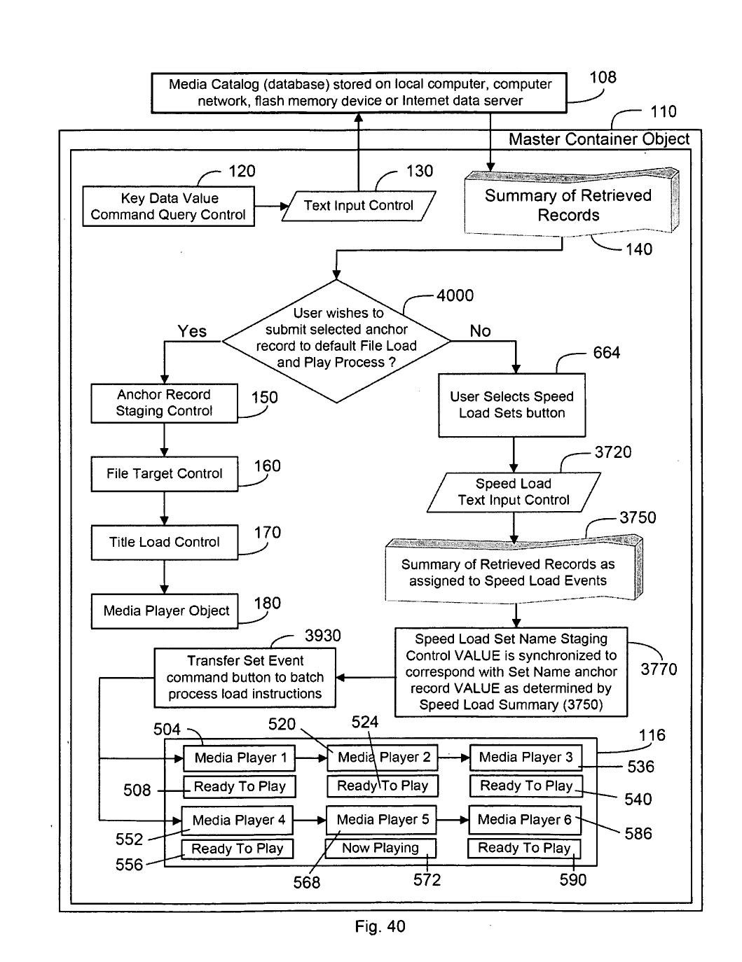

Programming instructions attached to the Transfer Set Event command button (3930) assign the stored values corresponding to up to five Speed Load Set Name position variables directly to the Speed Load Value place holders for each discrete player—in an embodiment example here in FIG. 39B-1, Player 5 is not available because it will be evaluated as “Now Playing” (see FIG. 39B-2, 572) and therefore the procedure will skip loading Player 5 and go on to load the next ready to load player object, Player 6 (see FIG. 40 for a high-level data flow depiction of this process).

Also depicted in FIG. 39B-1 are the Speed Load Set name Variables, listed in order with variable 1 (3928.11), variable 2 (3928.21), variable 3 (3928.31), variable 4 (3928.42), variable 5 (3928.52), and variable 6 (3928.62). Note: the equation depicted above for character 3932 uses the variable represented by character number 3928.11 as part of the calculation. This is also true for characters 3934 through 3942 which perform the same calculation depicted in FIG. 39B-1 character 3932, except that the equations for 3934 through 3942 substitute their corresponding variables and evaluate conclusions with their corresponding data values from FIG. 39B-2.

Moving to FIG. 39B-2, observe the Media Player Object Sets as used in the calculation for variable transfer programming (described in detail for FIG. 39B-1): Media Player Group 1 (116.1) and Media Player Group 2 (116.2) are shown in the Media Player Objects Group (116) with their respective digital media players; Media Player 1 status message (508), Media Player 2 status message (524), Media Player 3 status message (540), Media Player 4 status message (556), Media Player 5 status message (572), and Media Player 6 status message (590). Also, the corresponding Speed Load values used in the variable transfer calculation are depicted with media player objects:

Media Player 1 Speed Load Value (3924.11), Media Player 2 Speed Load Value (3924.21), Media Player 3 Speed Load Value (3924.31), Media Player 4 Speed Load Value (3926.12), Media Player 5 Speed Load Value (3926.22), and Media Player 6 Speed Load Value (3926.32).

FIG. 39C is a flowchart that illustrates in greater detail the (Speed Load) Transfer Set Event command depicted in FIGS. 39B-1 and 39B-2. FIG. 39C examines the step by step process in the first part of a nested procedure that converts a Media Catalog stored hyperlink file path to a load command for a specific media player object.

In FIG. 39C, programming event flow within the Speed Load Event Manager (126) is examined with special regard to the interaction between the Speed Load Set Names Data Table (122), the Speed Load Set Name variable 1 (3928.11) and the individual logic steps that transpire within the Transfer Set Event command (3930) as it first executes the conditional test for Media Player 1 (see FIG. 39B-1, character 3932 for an in-context diagram). Essentially, the Speed Load Set Name position variable 1 (3928.11) retrieved from the Speed Load Set Name Data Table (122) is associated with a specific Speed Load Set Name ID Number, and the first record stored on the corresponding Speed Load Set Name (event list) is “Borderline” by Madonna; and the digital media file associated with the “Borderline” title is stored in the following path: “D:\Audio\Decades\1980s\Borderline.mp3”.

FIG. 39C depicts, in three steps, the process that occurs when the Transfer Set Event command (3930) executes first as a conditional process (3932) for Media Player 1—where that process consists of determining that Media Player 1 is ready to load by testing for the value of the Media Player 1 status message caption (3932.1); then making the Media Player 1 Speed Load Value equal to stored variable (3932.2); and lastly setting the value of the filename property for Media Player 1 equal to the stored value of the Media Player 1 Speed Load Value (3932.3).

Finally, the product of one variable assignment via character 3930, is inserted into a digital media player, Media Player 1 (504) and made ready to play as seen in the Media Player 1 status message (508); this is accomplished through variables formulated, in part, with the Media Player 1 Speed Load Value (3924.11). At the end of FIG. 39C, “Borderline” has been loaded into Media Player 1. The process flow of FIG. 39C represents a more detailed explanation of process 3930 as seen in FIG. 39B-1, and as it applies to the conditional test for Media Player 1 (3932) which, for this diagram in FIG. 39C, has been delineated as characters 3932.1, 3932.2, and 3932.3. The depictions in FIG. 39C should be reviewed in connection with FIG. 39B-1 and 39B-2.

FIG. 40 is a flowchart depicting the process of concurrently loading a plurality of digital files into a plurality of media player objects with one command when the user elects to bypass the default file load process and choose from a summary of pre-defined “speed load” record sets; it also shows the resolution of the speed load process initiated in FIG. 37, which is further explained in FIGS. 38, 39A, 39B-1, 39B-2, and 39C.

In FIG. 40, the Master Container Object (110) is depicted with a plurality of characters that has appeared with like numbers many times in previous drawings for this specification. FIG. 40 begins with the Key Data Value Command Query Control (KDVCQC) (120), continues to the previously explained Text Input Control (130), and so on, repeating a flow pattern depicted often in this specification. FIG. 40 however, ends with a Speed Load Set Name list of digital media files loaded in five instantiated media players as seen in the combination of Media Player Object groups (116). FIG. 40 also depicts a simple decision process (4000) implemented in the user interface for an embodiment where a user can choose to use the Master Container Object to submit the selected anchor record to the default File Load and Play Process, or use it to engage the Select Show Speed Load Event Sets button. FIG. 40 should be viewed in context after studying FIGS. 37 through 39C.

Initially, in FIG. 40, the “Master Container Object” interface (110) is open with a default generic Key Data Value Command Query Control (120) visible near the top left of the diagram. The same action in the Master Container Object (MCO) that reveals the Key Data Value Command Query Control automatically directs program focus to the Text Input Control (130) where a default text string (such as the title of a hit-music recording) is visible having been retrieved from the Media Catalog (108) and presented in the Summary of Retrieved Records (140).

Continuation in the system depends on the user's actions as the result of a decision process (4000) for FIG. 40: Does the user wish to submit the selected anchor record to the default file load and play process? If the user selects yes, the system continues with the previously described file load and play process which is to make the Anchor Record Staging Control (150) equal to the record selected for the Summary of Retrieved Records (140). Next, the user selects the File Target Control (160) which will identify the digital media player the user intends for file insertion. Then, the user will select the File Load Control (170) which will insert (load) the selected file (digital media asset or so-called “track”) into the chosen Media Player object (180).

Returning to the decision process (4000) for FIG. 40: Does the user wish to submit the selected anchor record to the default file load and play process? If the user selects no, the system continues when the user selects the Speed Load Sets (sometimes called the Speed Load Access) button (664). (For a software embodiment depiction of the Speed Load Sets button, see FIG. 14A, character 664.) This action places the cursor in the Speed Load Text Input Control (3720) which functions like the Text Input Control (130) previously described in detail in this specification.

Continuing with FIG. 40, the user next observes the Summary of Retrieved Records as assigned to Speed Load Events (3750). The user will then choose a Speed Load Set Name from the summary. Next, the Transfer Set Event command button (3930) will batch process file load instructions for a plurality of digital media players, assigning digital media files from the Speed Load Set Name list to available media players.

Under the scenario depicted in FIG. 40, where digital Media Player 5 is currently in use (or “Now Playing”), the Transfer Set Event command button (3930) will automatically insert the stored digital files associated with the user designated Speed Load Event into the available media players as shown in the Media Player Object Groups (116).

In this case: Media Player 1 (504) is loaded with a file from the Speed Load Event list and its status message (508) is updated to read “Ready To Play”; Media Player 2 (520) is loaded with a file from the Speed Load Event list and its status message (524) is updated to read “Ready To Play”; Media Player 3 (536) is loaded with a file from the Speed Load Event list and its status message (540) is updated to read “Ready To Play”; Media Player 4 (552) is loaded with a file from the Speed Load Event list and its status message (556) is updated to read “Ready To Play”.

Continuing with the file load process in FIG. 40: Media Player 5 (568) is not loaded with a file from the Speed Load Event list and its status message (572) is not updated because Media Player 5 is in use (busy) and reads “Now Playing”; Media Player 6 (586) is loaded with a file from the Speed Load Event list and its status message (5590) is updated to read “Ready To Play”.

The batch process executed in FIG. 40 by the Transfer Set Event command button (3930) actually executes conditional tests for all six digital media players, and these actions are depicted in diagram form in FIG. 39B-1, characters 3932, 3934, 3936, 3938, 3940, and 3942. The batch process executed by 3930 concurrently loads a plurality of players with a pre-determined list in just one user step.

This completes a description of FIG. 40, a high-level flowchart which depicts a method that executes a compound digital media file insertion permitting the user to conduct one individualized query search, view a summary of retrieved records and proceed to concurrently load a plurality of digital media assets (associated with the summary of retrieved records) into a plurality of integrated media player objects with as few as one or two execution commands.

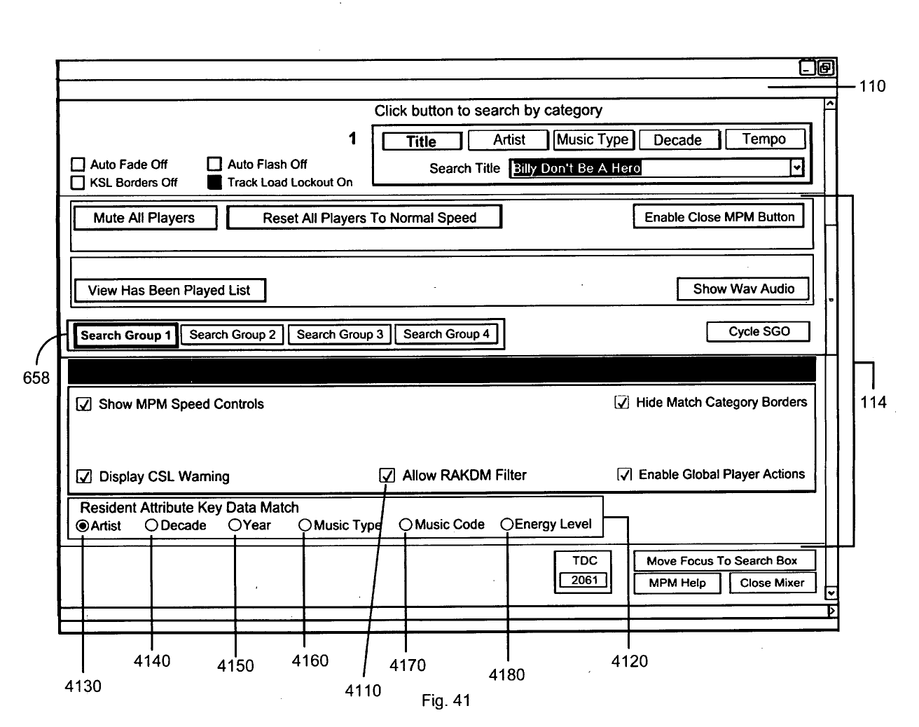

FIG. 41 is a software screen image depicting the Resident Attribute Key Data Match (RAKDM) control section accessible from the user interface in an embodiment. Character 110 depicts the Master Container Object (implemented as 3 Player embodiment); character 658 depicts the Key Data Value Command Query Control Switching System; character 114 depicts the Field of View Aligned with Media Player Mixer Control Buttons; and character 4110 depicts the Allow RAKDM (Resident Access Key Data Match) filter check box (used to turn on global player RAKDM features).

Continuing with FIG. 41, character 4120 depicts the Resident Attribute Key Data Match Category Selection Buttons; character 4130 refers to the RAKDM Artist filter attribute button; character 4140 refers to the RAKDM Decade filter attribute button; character 4150 refers to the RAKDM Year filter attribute button; character 4160 refers to the RAKDM Music Type filter attribute button; character 4170 refers to the RAKDM Music Code filter attribute button; and character 4180 refers to the RAKDM Energy Level filter attribute button.

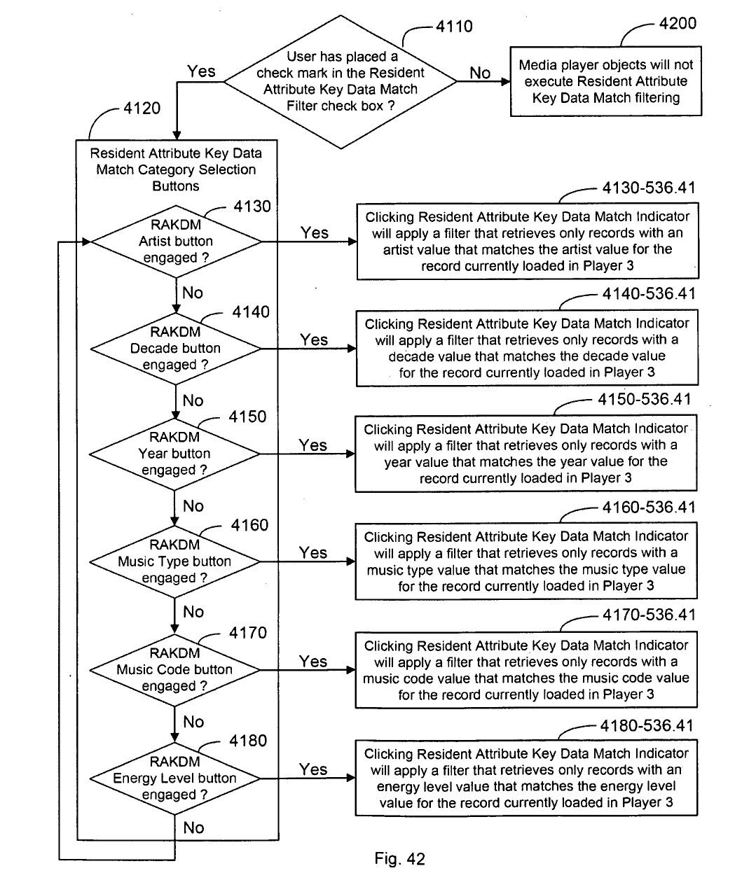

In FIG. 41, when a user selects the Allow RAKDM filter check box (4110) and then selects, for example, the RAKDM Decade filter attribute button (4140), and then clicks the artist label area in any loaded player, a filter will be applied that instantly shows all available music tracks for songs that share the same decade value as that of the track currently loaded in the clicked media player. (FIG. 42 explains this process in greater detail.)

FIG. 42 is a flowchart depicting the process of selecting a Resident Attribute Key Data Match filter button and its consequences. In FIG. 42, when the user enters the decision process (4110) known as the Allow RAKDM filter check box, and decides to remove a check mark from the box, he is deactivating the RAKDM system (4200). However, it the user elects to add a check mark to the box (4110), he is activating the RAKDM capability for one embodiment of the master container object and its digital media players.

Next, the user will move to the Resident Attribute Key Data Match Category Selection Buttons (4120) and decide which aspect of the RAKDM filter to apply. The user will choose one of six RAKDM filters: Artist, Decade, Year, Music Type, Music Code and Energy Level.

If the Artist button (4130) is engaged, the RAKDM filter, when activated in a media player, will apply a filter that limits the available music track selection to all records that contain an artist value (attribute) that matches the artist value of the music track loaded in the user click-designated player. Character 4130-536.41 represents the process of clicking the Media Player 3 artist label, which contains an embedded switch that applies the RAKDM filter that retrieves only records with an artist value that matches the artist value for the record currently loaded in Player 3.

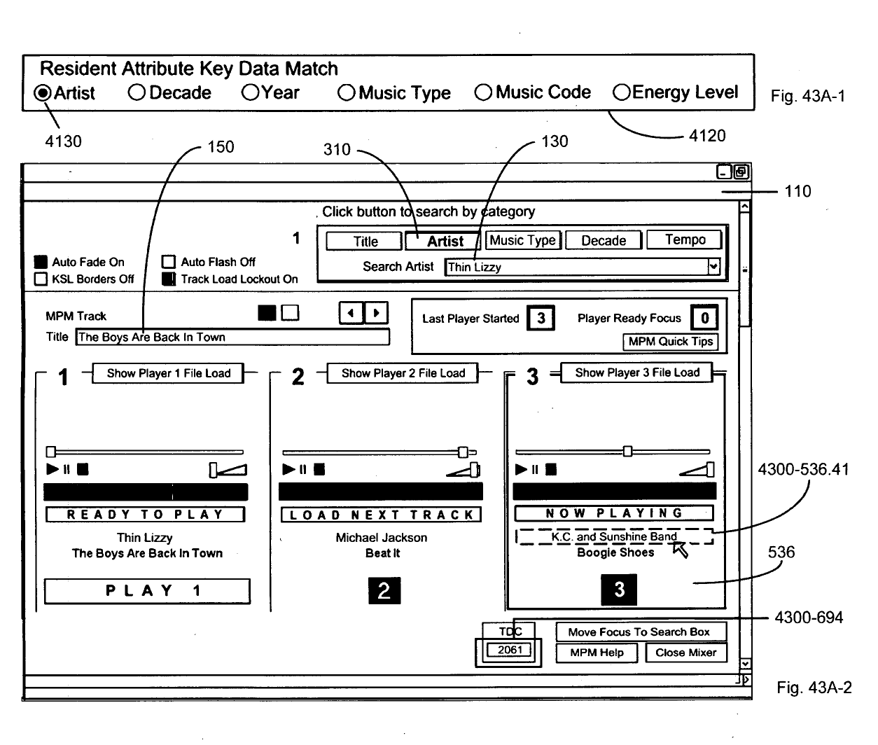

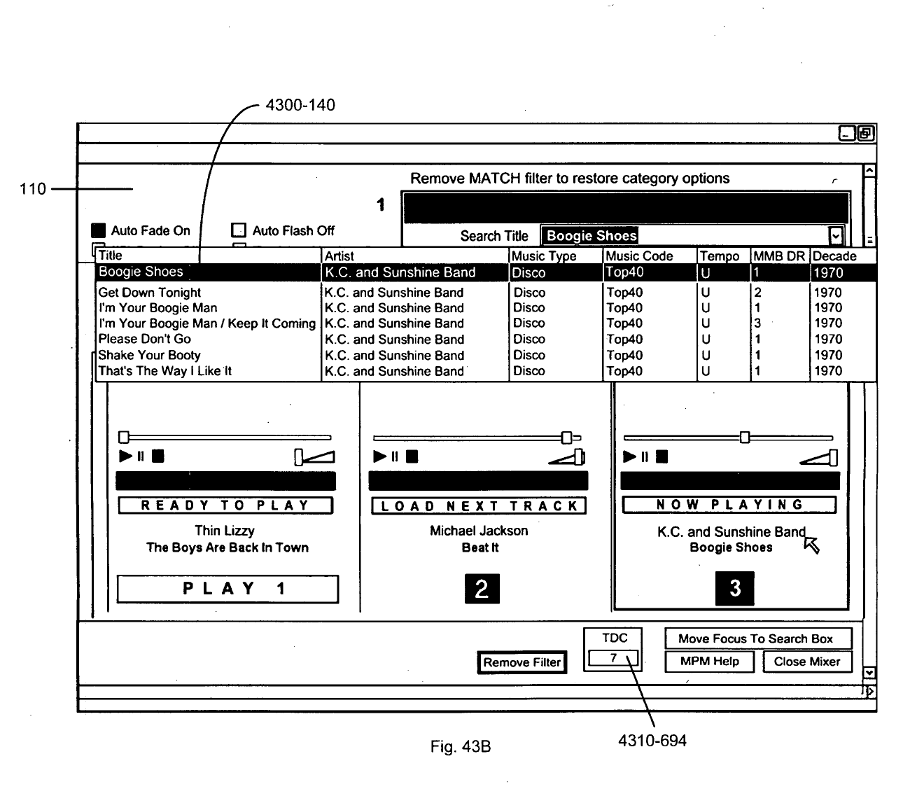

For example, in one embodiment, if the user has loaded a music track by the artist “K.C. and Sunshine Band” in digital Media Player 3, and the RAKDM filter system is allowed, and the RAKDM Artist button is engaged, double-clicking the artist label for Media Player 3 (see FIG. 5D, character 536.41 for an in context data flow diagram) will apply a query filter that retrieves only records with an artist value that matches the artist value for the record currently loaded in Player 3, and the results of that filter are displayed in the master container object interface. (See the Summary of Retrieved Records character 4300-140, in FIG. 43B for a software screen image depiction of an applied artist filter).

Continuing with FIG. 42, if the Decade button (4140) is engaged, the RAKDM filter, when activated in a media player, will apply a filter that limits the available music track selection to all records that contain a decade value (attribute) that matches the decade value of the music track loaded in the user click-designated player. Character 4140-536.41 represents the process of clicking the Media Player 3 artist label, which contains an embedded switch that applies the RAKDM filter that retrieves only records with a decade value that matches the decade value for the record currently loaded in Player 3.

In FIG. 42, if the Year button (4150) is engaged, the RAKDM filter, when activated in a media player, will apply a filter that limits the available music track selection to all records that contain a year of release value (attribute) that matches the year of release value of the music track loaded in the user click-designated player. Character 4150-536.41 represents the process of clicking the Media Player 3 artist label, which contains an embedded switch that applies the RAKDM filter that retrieves only records with a year of release value that matches the year of release value for the record currently loaded in Player 3.

Also in FIG. 42, if the Music Type button (4160) is engaged, the RAKDM filter, when activated in a media player, will apply a filter that limits the available music track selection to all records that contain a music type value (attribute) that matches the music type value of the music track loaded in the user click-designated player. Character 4160-536.41 represents the process of clicking the Media Player 3 artist label, which contains an embedded switch that applies the RAKDM filter that retrieves only records with a music type value that matches the music type value for the record currently loaded in Player 3.

Continuing with FIG. 42, if the Music Code button (4170) is engaged, the RAKDM filter, when activated in a media player, will apply a filter that limits the available music track selection to all records that contain a music code value (attribute) that matches the music code value of the music track loaded in the user click-designated player. Character 4170-536.41 represents the process of clicking the Media Player 3 artist label, which contains an embedded switch that applies the RAKDM filter that retrieves only records with a music code value that matches the music code value for the record currently loaded in Player 3.

Finally in FIG. 42, if the Energy Level button (4180) is engaged, the RAKDM filter, when activated in a media player, will apply a filter that limits the available music track selection to all records that contain an energy level rating value (attribute) that matches the energy level rating value of the music track loaded in the user click-designated player. Character 4180-536.41 represents the process of clicking the Media Player 3 artist label, which contains an embedded switch that applies the RAKDM filter that retrieves only records with an energy level rating value that matches the energy level rating value for the record currently loaded in Player 3.

Now referring to FIG. 43A-1 and FIG. 43A-2, a software screen images depicting the process of selecting the Resident Attribute Key Data Match filter Artist button in the interface and applying the filter by double-clicking the Resident Attribute Key Data Match indicator from within the media player object.

In FIG. 43A-1, the user will observe the Resident Attribute Key Data Match Category Selection Buttons (4120) and decide which aspect of the RAKDM filter to apply. Since the Artist button (4130) is engaged, the RAKDM filter, when activated in a media player, will apply a filter that limits the available music track selection to all records that contain an artist value (attribute) that matches the artist value of the music track loaded in the user click-designated player.

Now referring to FIG. 43A-2: Character 4300-536.41 represents the process of clicking the Media Player 3 artist label, which contains an embedded switch that applies the RAKDM filter that retrieves only records with an artist value that matches the artist value for the record currently loaded in Player 3 (and the artist is “K.C. and Sunshine Band”).

Clearly visible in FIG. 43A-2 are other components of the digital media players and the interface as implemented in one embodiment: the Master Container Object (110), which is presented to the user as the software interface, but actually is the programming environment container for hundreds of objects both visible and invisible. Many of these objects are used as logic waypoints when the MCO evaluates the load-ready-play states of various media players.

Continuing with FIG. 43A-2, character 310 depicts the Search by Artist KDVCQC; character 130 depicts the Text Input Control box (with the artist value of the current anchor record “Thin Lizzy” visible); character 150 depicts the Anchor Record Staging Control (also known as the MPM Track box); character 4300-694 depicts the Title Display Count (TDC) which is updated to reflect the depth of the active record summary (currently at 2061); and character 536 depicts the Media Player 3 object (a digital media player).

Now referring to FIG. 43B, which is related to FIG. 43A-2. FIG. 43B is a software screen image depicting the summary of retrieved records after the user has applied a specific Resident Attribute Key Data Match filter button by clicking the artist label in Player 3 (see FIG. 43A-2, character 4300-536.41).

In FIG. 43B, the Master Container Object (110) is visible and the Summary of Retrieved Records (4300-140) is extended to show the plurality of digital media files that have been queried by application of the RAKDM artist filter. By first selecting the RAKDM artist button and then clicking on the Player 3 artist label (activating the embedded filter query switch), the user has applied a mask that shows a TDC (4310-694) of 7 records (as opposed to the TDC value of 2061 before the filter).

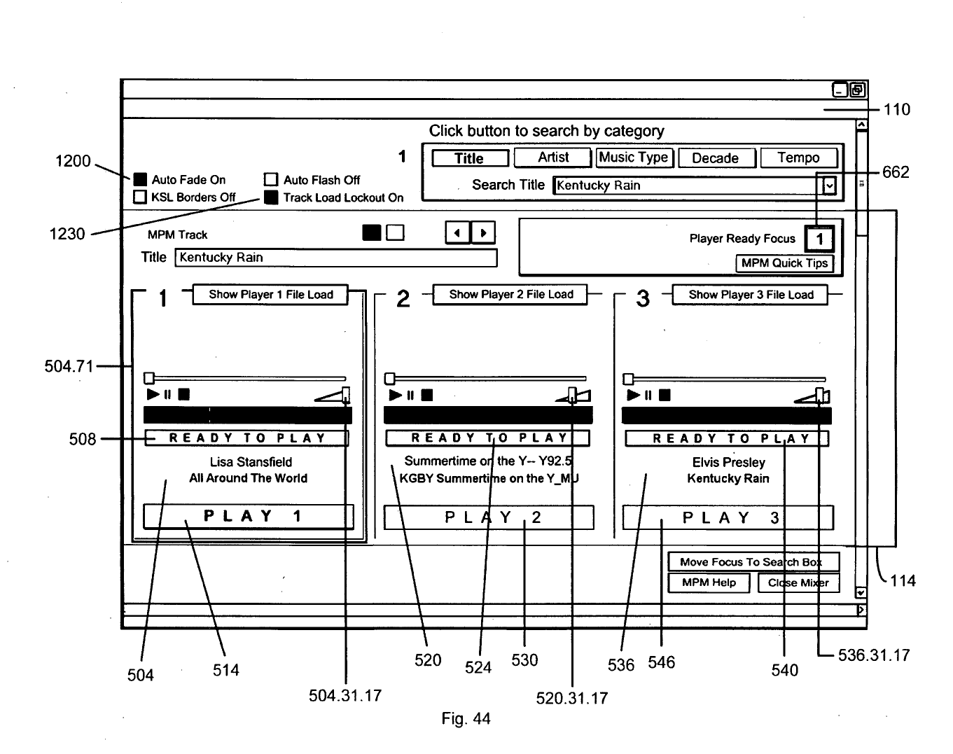

FIG. 44 uses computer program screen images to illustrate the interface display process of workflow management controlled by the Master Container Object (MCO). We begin FIG. 44 with the MCO (110) visible as a three-player object implementation of the invention. On the user interface the Auto Fade button (1200) is “on”. This means that when the user clicks a media player object play button, the program logic will check to assess the value of the Auto Fade button and if it is “on” (true) the MCO will execute Auto Fade and automatically fade the audio output level of a playing track the moment a new player is started.

The Track Load Lockout button (1230) is “on”. This means that when the user clicks a Title Load button for a media player object that is currently in use (busy), the program logic will check to assess the value of the Auto Fade button and if it is “on” (true) the MCO will block the new track from loading (Track Load Lockout) in the active player.

Continuing with FIG. 44, the value of the Player Ready Focus control (662) reads “1” and that means that the situational awareness logic in Master Container Object “knows” which player is “ready to play” and also the subject for program “focus” (and can be started therefore with the simple tap of the ENTER key or SPACEBAR).

Media Player 1 (504) which has focus displays a bright blue border (504.71) around its outer edges to cue the DJ and tell him Player 1 has focus. Also, the Player 1 status message (508) reads “Ready To Play”. This occurs for two reasons. First it is another clear sign for the user and secondly, this control (508) also acts as a data point for the MCO's situational awareness logic. For example, when a player objects status message caption has a value of “Ready To Play” the MCO is informed of that object's player state. If the message caption or Player 1 read “Load Next Track”, instead of “Ready To Play”, the Master Container Object would know that Player 1 was not ready to play and the workflow instructions would not attempt to set focus on Player 1 or direct the user to start Player 1.

Observe also in FIG. 44 that the value of the Player 1 audio level (504.31.17) is hard right and therefore has been automatically loaded at full volume. In an embodiment, this is possible because the Media Catalog stores a preferred volume level for the digital file that has been loaded in the player. When the user issues a load command, the MCO situational awareness (SA) logic checks the catalog to see if it contains a preferred volume level for the associated record (music track) and it the value is present that value is transferred to the audio level control (504.31.17). The audio level control can also be set to fade out when a new track starts if the Auto Fade button (1200) is on.

In FIG. 44, when the user presses the Play 1 button (514) a series of program logic instructions execute to assess a plurality of event and object states. For example, when Player 1 starts, program focus (a workflow feature) is normally set to rotate to the next ready player, in other words, if Player 2 (520) is loaded and “Ready To Play”, then shift focus to Player 2. Or if Player 2 is not loaded and not “Ready To Play”, shift focus to Player 3 (536) if Player 3 is loaded and “Ready To Play”.

The SA logic determines player states by reading the value of the status message light and play buttons associated with each specific player object. For example, if Player 2 status message (524) displays “Ready To Play” and if the Play 2 button (530) displays “Play 2”, then Player 2 has been identified by the Master Container Object as . . . “ready to play.”

Note also that the position of the Player 2 audio level control (520.31.17) which is set at about half-volume because the MCO has determined that the stored value for the track loaded in Player 2 requires that setting. The same is true for the Player 3 audio level control (536.31.17). And, the Player 3 message status light (540) displays “Ready to Play” and the caption for the Player 3 Play 3 button (546) is “Play 3”. The field of view (114) shows the full dimensions of all three media player objects. Each character in this illustration, with the exception of the player audio level controls (which are part of the Microsoft® ActiveX® Windows Media® player control) has been created as part of the media player object sets that facilitate the situational awareness logic in the MCO. Note: In FIG. 44, and in some other software image figures submitted with this specification, the lead lines for character 114 (the so-called Auto Adjusting Field of View or field of view) depict the point where the upper and lower field of view boundaries are positioned on the screen. Because placing a four-border box around the complete field of view would cause the field of view boundaries to cross or intersect with many other lead lines, a decision was taken not to interfere with other lead lines or screen objects. For a whole depiction of the field of view, please see character 114 in FIG. 1A-2.

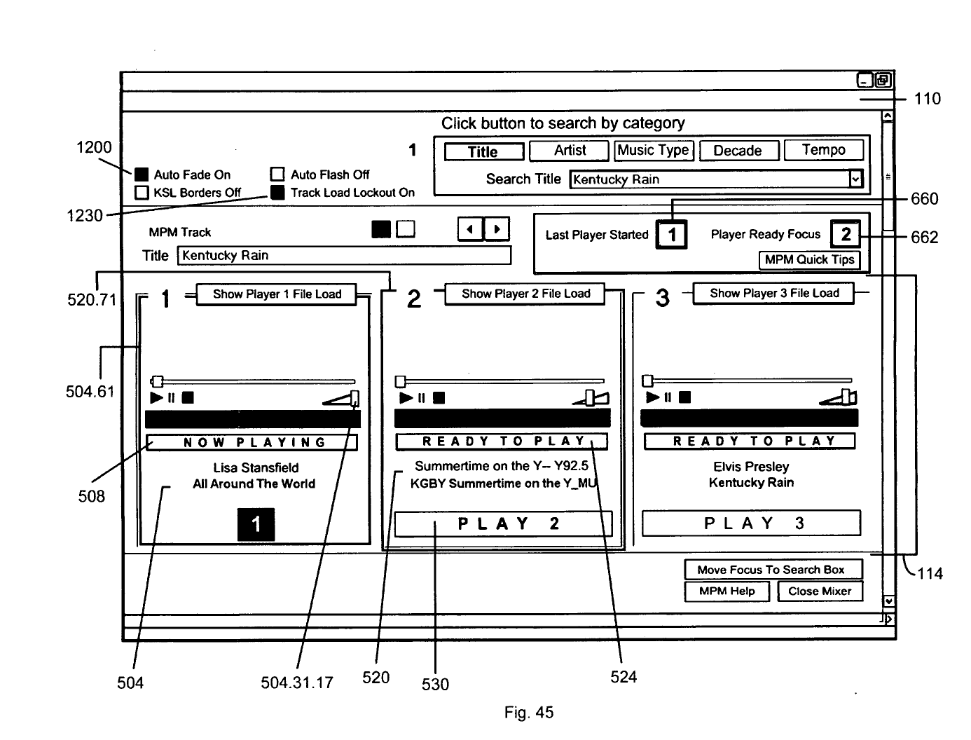

FIG. 45 is a software screen image depicting the step by step continuation of a situational awareness Master Container Object workflow sequence with “focus” set on Player 2.

FIG. 45 further illustrates the interface display process of workflow management controlled by the Master Container Object (MCO). We begin FIG. 45 with the MCO (110) visible as a three-player object implementation of the invention, and three players are visible in the screen display area known as the “field of view” (114). On the user interface the Auto Fade button (1200) is “on”. The Track Load Lockout button (1230) is “on”.

Continuing with FIG. 45, the value of the Player Ready Focus control (662) reads “2” and that means that the situational awareness logic in Master Container Object “knows” which player is “ready to play” and also the subject for program “focus” (and can be started therefore with the simple tap of the ENTER key or SPACEBAR).

Previously, in FIG. 44, all three players were loaded but none was playing. Now, in FIG. 45, Player 1 has been started and the SA automation in the MCO has automatically determined that the next player in sequence, Player 2, was loaded and Ready To Play. The MCO accomplished this evaluation with program instructions that checked the caption value of the Player 2 status message label (524) which displays “Ready To Play”. Since the MCO accepted Player 2 as ready to play next, it also updated the value of the Player Ready Focus control (662) to “2” because Player 2 is loaded and the subject of program focus. Since Media Player 2 (520) has focus, a bright blue border (520.71) is displayed around its outer edges to cue the DJ and tell him Player 2 has focus; the changing border “lights” are also a good way to guide workflow.

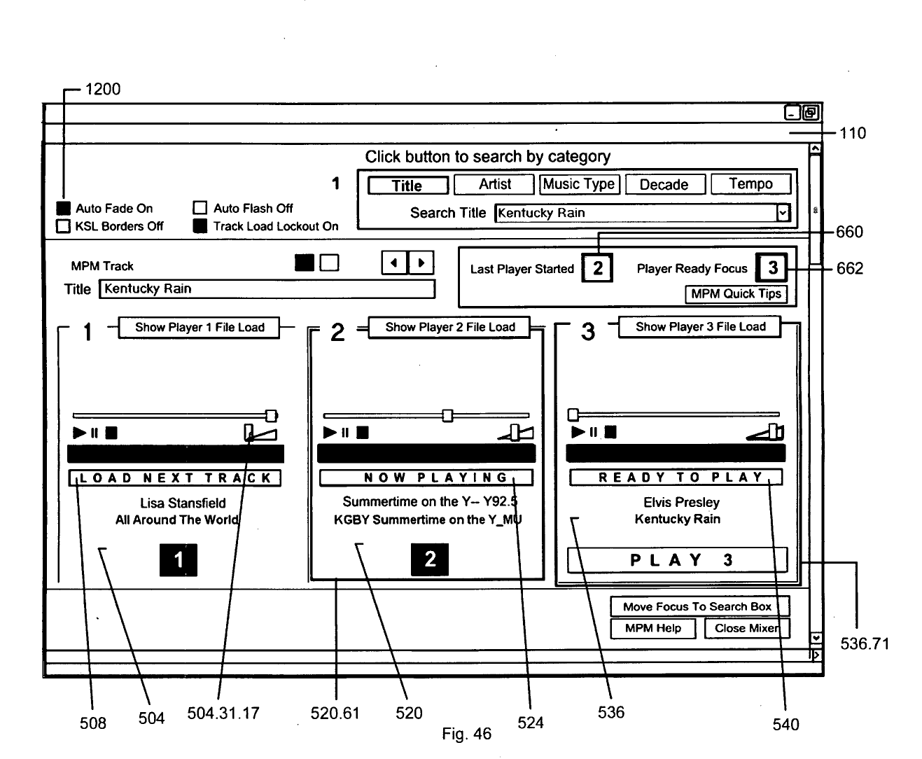

In FIG. 45, observe also that: the value of the Last Player Started control (660) displays “1” indicating to the user that the MCO has determined, and therefore displays, that Player 1 is the last player started; and the Player 1 status message light (508) reads “Now Playing”; and that the Now Playing Inside Border Light (504.61) is visible around the edges of Player 1 (504) because the MCO uses this cue to visually inform the operator which player is the last started (and currently active) player; and the Player 2 Play Button (530) is visible; and that the current position of the Player 1 audio control level (504.31.17) is hard right (at the extreme right position)-indicating full volume level for any audio reproduced by player 1. To better understand FIG. 45, it should be studied in context with FIGS. 44 through 49B. Now referring to FIG. 46, a software screen image depicting the step by step continuation of a situational awareness Master Container Object workflow sequence with “focus” set on Player 3. FIG. 46 continues the sequential media player focus pattern begun in FIGS. 44 and 45.

In FIG. 46, Player 1 (504) has completed playback and its status message display (508) reads “Load Next Track”. The Player 2 (520) status message (524) reads “Now Playing” and the Player 3 (536) status message (540) depicts “Ready To Play”. SA logic in the MCO (110) is responsible for changing the status messages for players 1 and 2. When the user initiated a start command for Player 2, a computer instruction attached to the Play 2 button (seen in FIG. 45, character 530) simultaneously started audio reproduction in Player 2 and changed its message label to “Now Playing” while it also changed the message label for Player 1 from “Now Playing” to “Load Next Track” (508). Since Player 3 accepted the auto event focus from the MCO, Player 3 is depicted with a bright blue border (536.71) around its outer edges. Also observe that the Player Ready Focus control (662) has been changed to display a value of “3”. The Player Ready Focus control is a logic waypoint maintained by the MCO. Since the caption value of the Ready Focus control is “3”, the Master Container Object has sensed that Player 3 is Ready To Play and is the subject of focus. This information is passed on as a visual display cue to guide workflow for the user. Observe also that the value of the Last Player Started control (660) has been updated from “1” (as depicted in FIG. 45) to a value of “2” because FIG. 46 depicts Player 2 as the last started and currently playing digital media player object.

The MCO (Master Container Object) logic initiated other actions when the user started Player 2. Instructions attached to the Play 2 start button performed a conditional test to evaluate the position of the Auto Fade switch (1200). Since Auto Fade is “on”, starting Player 2 automatically faded down the level of Player 1 and the Player 1 audio control (504.31.17) which was positioned hard right in the previous screen capture (FIG. 45), and now in FIG. 46 is visible hard left—at zero level. Also, the Now Playing Inside Border Light (520.61) is visible around the edges of Player 2 (520) because the MCO uses this cue to visually inform the operator which player is the last started (and the currently active player). At the same moment the MCO displayed the Player 2 Inside Border Light (520.61), it also made the Player 1 Inside Border Light (seen in FIG. 45 character 504.61) invisible.

In FIG. 46, changing visual indicators, revised screen messages and operational functions, such as controlling audio levels, are all managed by the situational awareness logic in the embodiment's MCO. To better understand FIG. 46, it should be studied in context with FIGS. 44 through 49B.

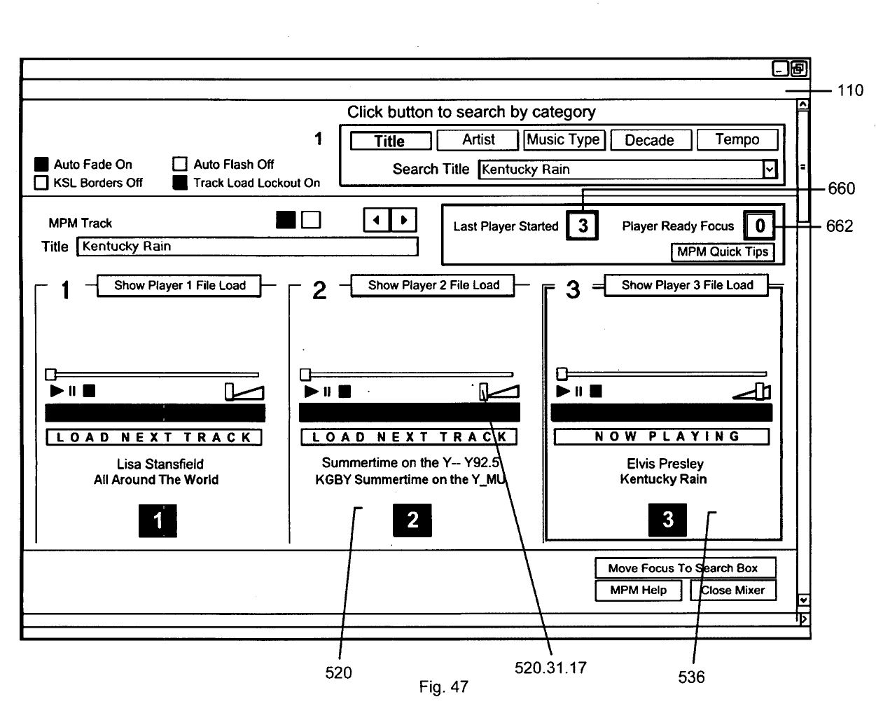

Now referring to FIG. 47, a software screen image depicting the step by step continuation of a situational awareness Master Container Object workflow sequence where Player 3 is playing and no other players are loaded.

FIG. 47 continues the next event auto focus sequence started in FIG. 45. In FIG. 47, Player 3 (536) has started playing, the Player 2 (520) audio control (520.31.17) has automatically faded to zero, and the Player Ready focus box (662) has been updated to “0” because in FIG. 47 no player is loaded and ready to play. Also notice another logic waypoint, the Last Player Started (660) control box. Since Player 3 was the last player started, a “3” is visible in the box. This logic waypoint is used to help the MCO understand which player to fade.

When a new player event is begun, the default behavior in the MCO (110) is to check the value of the Last Player Started control and assume that the player represented by the value is the player that should be faded to zero audio. Throughout the invention, a series of logic waypoints, both visible and hidden, act as part of a network supplying the MCO with situational awareness data; this information can then be used as part of a rules-based logic system to manage physical behaviors and visual cues in the interface.

In FIG. 47, changing visual indicators, revised screen messages and operational functions, such as controlling audio levels, are all managed by the situational awareness logic in the embodiment's MCO. To better understand FIG. 47, it should be studied in context with FIGS. 44 through 49B.

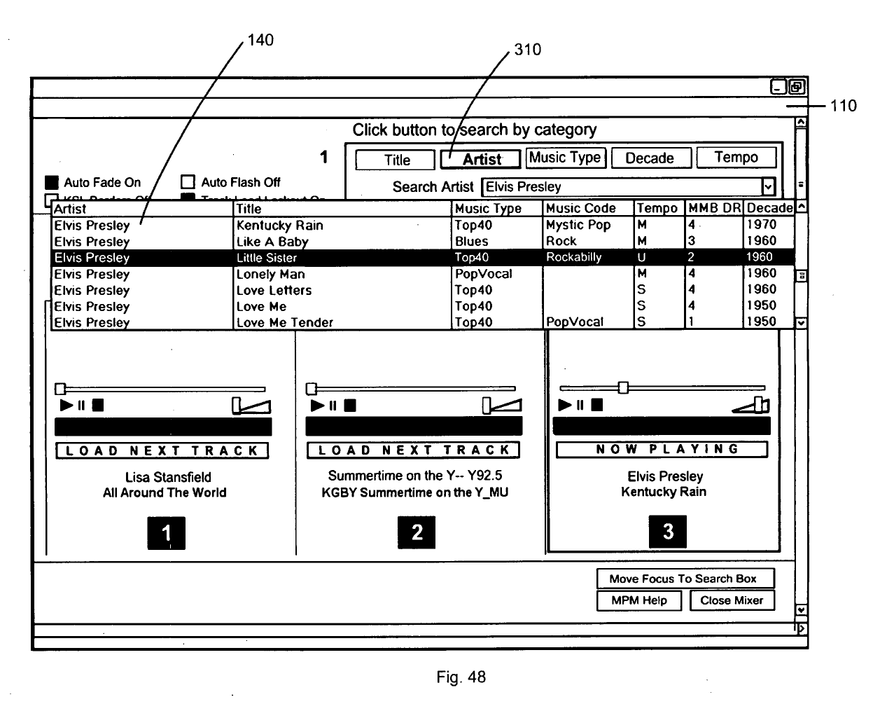

The next drawing is FIG. 48, a software screen image depicting the step by step continuation of a situational awareness Master Container Object (110) workflow sequence where the user has selected a different Key Data Value Command Query Control (KDVCQC) button and opened the summary of records.

In FIG. 48, when the user selected the Artist KDVCQC, a default SQL instruction attached to the Artist button (310) resorted the record summary and displayed all available digital files that share the same attribute as the anchor record (“Kentucky Rain” by Elvis Presley as depicted in FIG. 47); that common attribute for the Artist KDVCQC is the value of the artist name: “Elvis Presley”. Now, in FIG. 48, a plurality of Elvis tracks is visible in the Summary of Retrieved Records (140).

FIG. 48 is significant because it illustrates how the user can easily change the key data search field (from the Search Title category in the previous figure) to the Search Artist category within the MCO (110). To better understand FIG. 48, it should be studied in context with FIGS. 44 through 49B.

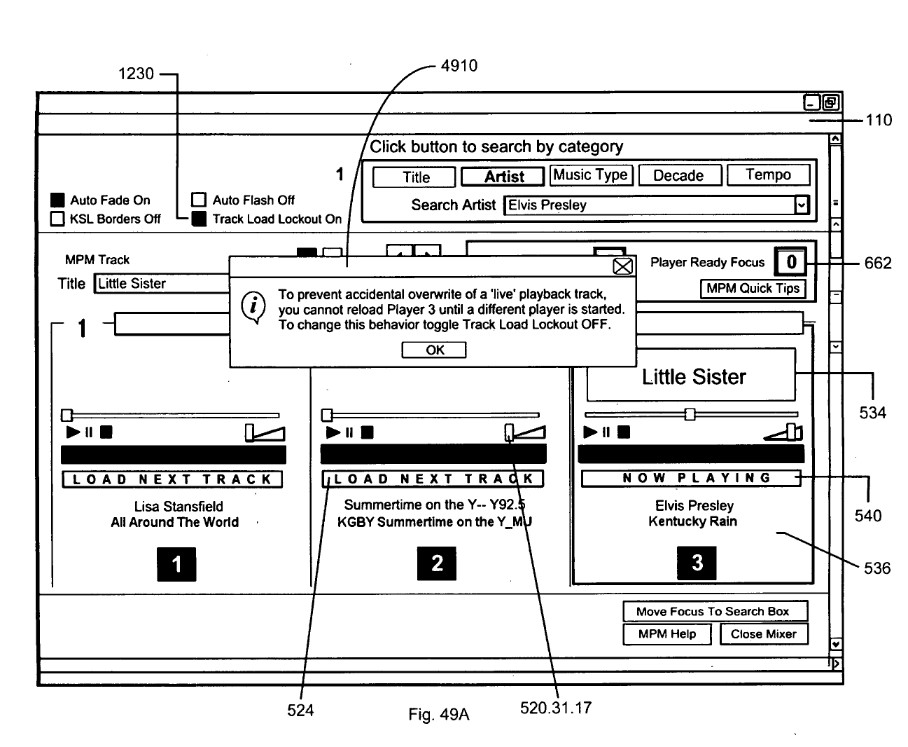

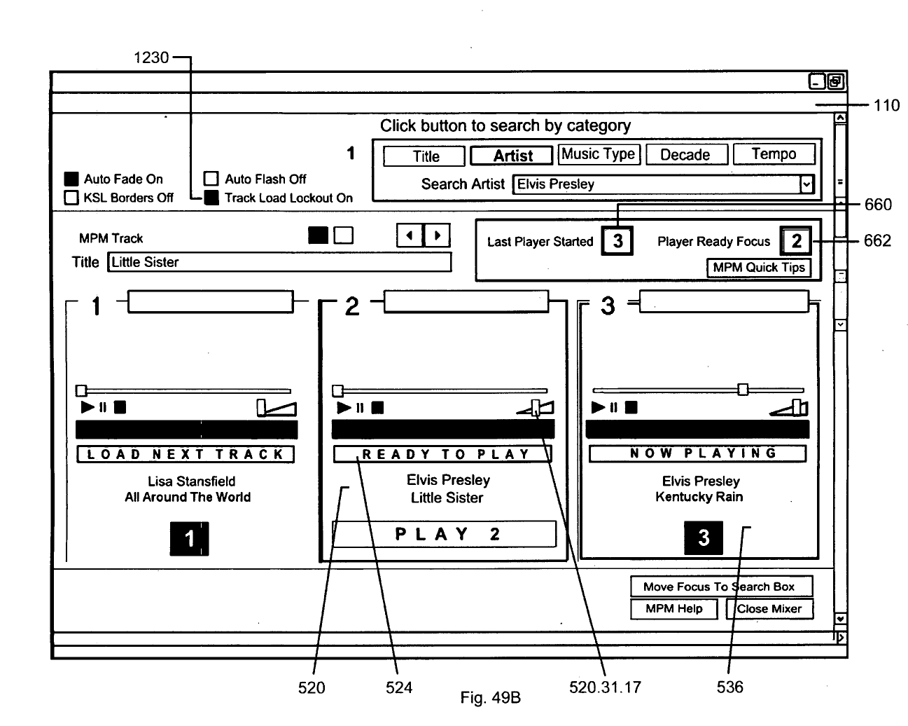

FIG. 49A is a software screen image depicting the step by step continuation of a situational awareness Master Container Object (MCO) workflow sequence where Player 3 is playing and the user has received an error message on a blocked attempt to overwrite a media file in Player 3.

In FIG. 49A, an error message dialog box (4910) has been generated by the situational awareness logic in the MCO (110). Because the Track Load Lockout switch (1230) is “on”, the MCO evaluated the state of Player 3 when the user attempted to load a track in Player 3 (536). The Elvis Presley song “Little Sister” is visible on the Player 3 Title Load button (534). Since the Player 3 status message (540) caption is equal to “Now Playing”, the MCO understood that Player 3 was busy and blocked the load command. With program focus on the error message dialog box (4910), focus is not on any of the media players, and therefore the Player Ready Focus control (662) displays “0” as a visual indicator to the user that no player is subject of program focus. Note also, in FIG. 49A, the position of the Player 2 audio level control (520.31.17) is depicted as hard left (or fully left) which indicates that the player's audio level is set a zero. Because it will be an important comparative value in the next figure, observe that in FIG. 49A the Player 2 status message (524) displays “Load Next Track”.

FIG. 49A is significant because it illustrates how the situational awareness logic in the MCO (110) can prevent undesirable operations such as overwriting a currently playing audio file in an active digital player. To better understand FIG. 49A, it should be studied in context with FIGS. 44 through 49B.

Now referring to FIG. 49B, a software screen image depicting the step by step continuation of a situational awareness Master Container Object (MCO) workflow sequence where Player 3 is playing and the user has successfully loaded a media file in Player 2.

In FIG. 49B, the user has selected an alternative player, Player 2 (520), and the Elvis Presley track insertion attempt that failed in FIG. 49A has now been successful. The MCO (110) evaluated the load-ready-play state of Player 2 when the user issued the load command. As depicted here in FIG. 49B, the MCO approved the load action because, even though the Track Load Lockout switch (1230) is “on”, the value of the Player 2 status message was “Load Next Track” (see FIG. 49A, character 524) when the user decided to load Player 2 with the Elvis track. After inserting the Elvis song “Little Sister” in Player 2, the value of the Player 2 status message (524) now reads “Ready To Play”. Since a new track has been loaded on Player 2 (520), the Player 2 audio control (520.31.17) level has been automatically set at a mid-position value because the MCO logic understands that the “Little Sister” track has a pre-programmed audio level (as stored in the media catalog) and set the level for Player 2 accordingly.

Note also that in FIG. 49B, because the MCO understands that the currently active player is Player 3 (536), the value of the Last Player Started control (660) displays “3”. Additionally, because the MCO understands that Player 2 (520) has program focus, the value of the Player Ready Focus control (662) displays “2”. FIG. 49B is significant because it illustrates how the situational awareness logic in the MCO (110) can allow a desirable operation such as inserting a new audio file in a user designated player because the MCO has deduced that the selected player (520) was not busy reproducing a track, and therefore it was freely available. To better understand FIG. 49B, it should be studied in context with FIGS. 44 through 49A.

In FIGS. 50A through 55, stated screen dimensions are accurate however the drawings are not to scale.

FIG. 50A is an illustration depicting the dimensions of a typical Master Container Object (MCO) interface implemented in a computer resolution of 1024×768. In FIG. 50A, the specific dimensions for one embodiment's “field of view” are disclosed. The field of view with its particular computer screen dimensions is a critical part of the Auto Adjusting Field Of View (AAFOV) system.

An important detail depicted in FIG. 50A is the measurement for the interface field of view (114), which has a vertical height dimension of 6 and ½ inches. The significance of this measurement will become clear in FIG. 50B, where the combined vertical height of two Media Player Object Groups (116.1 and 116.2 in FIG. 50B) is 10 and ¼ inches. Because the size of the field of view restricts full images of two Media Player Object Groups from concurrent display, the AAFOV system was created to manage an auto alignment that can evaluate which digital media players, in which Media Player Object Groups, are required to be visible by the user. When members of both groups must be presented at the same time on the screen display, the AAFOV system can arrange digital media player images so that the key operational elements (components) of each player in each Media Player Object Group is visible within the 6 and ½″ vertical height area occupied by the field of view in the user interface. In FIG. 50A, like numbers indicate like characters depicted earlier in the specification.

In FIG. 50A, the Master Container Object (110) in an embodiment is depicted as a representation of the physical dimensions of the user interface display area on a computer screen with a resolution of 1024×768 pixels on a 17″ diagonal monitor. In such an embodiment the viewable screen area is 13¼″ wide (5010) by 10⅝″ high (5004) with a diagonal measurement of approx. 17″. The Master Container Object (MCO) has an upper vertical boundary (110.1), a left horizontal boundary (110.2), a lower vertical boundary (110.3), and a right horizontal boundary (110.4).

Continuing with FIG. 50A, the Auto-Adjusting Field Of View (AAFOV) (114) is depicted within the MCO. The AAFOV has four boundaries: an upper vertical boundary (114.1), a left horizontal boundary (114.2), a lower vertical boundary (114.3), and a right horizontal boundary (114.4). Within the AAFOV, there is a program alterable line of demarcation (or “artificial horizon”) which is fundamentally a media player object group divider line (114.5). In the 1024×768 pixel 17″ diagonal embodiment depicted in FIG. 50A, the AAFOV has a width of 13″ (5008), a height of 6½″ (5002), and a diagonal measurement of approx. 15″ (5006).

Now referring to FIG. 50B which is an illustration depicting the dimensions of two Media Player Object Groups provided to indicate their size in relation to the field of view in the MCO. In FIG. 50B, the specific dimensions for one embodiment's Media Player Object Sets (MPOS) are disclosed. The MPOS with its particular computer screen dimensions is a critical part of the Auto Adjusting Field Of View (AAFOV) system.

The AAFOV in one embodiment can compute and automatically align each media player object group to show its full size (not just the key operational elements) and hide the other media player object group if it is not required; or the system can show the key operational controls for both sets in appropriate situations such as when a digital media file is loaded and/or playing in a player from each of the top and bottom sets, and the workflow guidance sequence logically requires that the user view data from both sets concurrently.

Since the MCO monitors the state of all its instantiated digital media players, it can automatically animate the vertical synchronization of the player images within the field of view so as to always manage display of the appropriate key operational controls (such as Play button, Title and Artist display, etc.) for any active player.

In FIG. 50B, like numbers indicate like characters depicted earlier in the specification. An improved understanding of the combined vertical dimensions of Media Player Object Sets (116.1 and 116.2) in FIG. 50B can be gained from the reviewing the description of the connected FIG. 50A.

An important detail depicted in FIG. 50B is the vertical measurement for the Media Player Object Group 1 (116.1), which has a vertical height dimension of 4 and ⅞ inches (5016). Each individual member of Media Player Object Group 1 has a vertical height of 4 and ⅞ inches, and the members of Media Player Object Group 1 include: Media Player Object Set 1 (MPOS 1) (504); Media Player Object Set 2 (MPOS 2) (520); and Media Player Object Set 3 (MPOS 3) (536). Each individual member of Media Player Object Group 2 (116.2) also has a vertical height of 4 and ⅞ inches, and the members of Media Player Object Group 2 include: Media Player Object Set 4 (MPOS 4) (552); Media Player Object Set 5 (MPOS 5) (568); and Media Player Object Set 6 (MPOS 6) (586).

The significance of this vertical measurement will become clear in when it is realized that the combination vertical height measurements of both Media Player Object Groups is 10 and ¼ inches (5018); this measurement is made by adding the vertical height of Media Player Object Group 1 and Media Player Object Group 2, plus the one-half inch vertical height of the screen space (5012) separating groups 1 and 2.

Because the 6½ inch vertical size of the “field of view” (see FIG. 50A, character 5002) is less than 10¼ inches vertical height of Media Player Object Groups 1 and 2 (5018), full images of two Media Player Object Groups cannot be concurrently displayed in the available field of view screen space. However, with alignment manipulation by the AAFOV system, the key operational elements (controls and display messages) from both Media Player Object Groups can be proportionately synchronized and concurrently displayed. This is possible when Media Player Object Group 1 is comprised of Media Player Object Sets designed with “standard-order” construction, and Media Player Object Group 2 is comprised of Media Player Object Sets designed with “inverted-order” construction. (Refer to FIG. 5B-1 for a depiction of Media Player Object Set standard-order construction, and FIG. 5C-1 for a depiction of Media Player Object Set inverted-order construction.)

The AAFOV system was created to manage auto alignment technology that can evaluate which digital media players in which Media Player Object Groups are required to be visible by the user. In cases where members of both groups should be visible at the same time on the screen display, the AAFOV system can arrange digital media player images so that the key operational elements of each player in each Media Player Object Group is visible within the 6 and ½ inch field of view vertical height area. The user benefit gained from such an AAFOV design is to provide a system for creating a plurality of media player objects that can be rendered in “over-size” (larger than common) dimensions, and yet automatically self-align in player object groups above and below an “artificial horizon” (line of demarcation) so that the user can enjoy the benefits of large display characteristics in a screen field of view that allows the key operational controls and data for six players, for example, to fit into the space normally reserved for three players of those dimensions.

It can also be observed in a 1024×768 pixel resolution embodiment, as depicted in FIG. 50B, that while the horizontal width for a single digital media player, for example MPOS 6 (586), is 4 inches (5020), the horizontal width for three adjacent media player objects (such as MPOS 4 and MPOS 5 and MPOS 6) is 12½ inches (5014).

Now the discussion moves to FIG. 51A which is an illustration depicting the dimensions of one media player object group as aligned within the Master Container Object “field of view” where the full vertical dimensions of Media Player Object Group 1 (116.1) is shown above the “artificial horizon” line (114.5) and the full vertical dimensions of Media Player Object Group 2 (116.2) are out of view below the “artificial horizon” line. In FIG. 51A, like numbers indicate like characters depicted earlier in the specification.

In FIG. 51A the Master Container Object (110) is depicted with its four boundaries: the upper vertical boundary (110.1), the left horizontal boundary (110.2), the lower vertical boundary (110.3), and the right horizontal boundary (110.4). Also illustrated in FIG. 51A is the field of view (114) outlined by its four boundaries: the upper vertical boundary (114.1), the left horizontal boundary (114.2), the lower vertical boundary (114.3), and the right horizontal boundary (114.4). Media Player Object Group 1 (116.1)—comprised of Media Player Object Set 1 (504), Media Player Object Set 2 (520), and Media Player Object Set 3 (536)—is visible and aligned to depict the full vertical images of MPOS 1, MPOS 2 and MPOS 3 within the boundaries of the field of view.

AT1 (Alignment Tab 1) (5110) is a hidden programming object which is used by the MCO to control the automatic alignment of respective Media Player Object Groups. Since Media Player Object Group 1 (116.1) is the only group displayed visible in the field of view for FIG. 51A, the AT1 is positioned near the bottom of the field of view. This causes the members of the Media Player Object Group 1 to align as depicted. AT2 (5120) is illustrated near the vertical center of the players that comprise Media Player Object Group 2 (116.2): Media Player Object Set 4 (552), Media Player Object Set 5 (568), and Media Player Object Set 6 (586). In the next drawing (FIG. 51B), AT2 will be positioned where AT1 is located in FIG. 51A.

Now referring to FIG. 51B which is an illustration depicting the dimensions of two media player object groups as aligned within the Master Container Object (MCO) “field of view” where part of Media Player Object Group 1 (116.1) is shown above the “artificial horizon” line and part of Media Player Object Group 2 (116.2) is shown below the “artificial horizon” line. The combined full vertical height of Media Player Object Groups 1 and 2, plus the one-half inch vertical height of the screen space separating groups 1 and 2 is indicated as 10 and ⅝ inches (5004).

In FIG. 51B, the vertical area of the field of view (114) is shared equally by the bottom portion of players that comprise of Media Player Object Group 1 (116.1): Media Player Object Set 1 (504), Media Player Object Set 2 (520), and Media Player Object Set 3 (536); and by the top portion of players that comprise of Media Player Object Group 2 (116.2): Media Player Object Set 4 (552), Media Player Object Set 5 (568), and Media Player Object Set 6 (586). The field of view artificial horizon line (114.5) is shown between the depictions of each Media Player Object Group. It can be observed that the MCO (110) has four boundaries: the upper vertical boundary (110.1), the left horizontal boundary (110.2), the lower vertical boundary (110.3), and the right horizontal boundary (110.4). Additionally, the AAFOV or field of view also has four boundaries depicted in FIG. 51B: the upper vertical boundary (114.1), the left horizontal boundary (114.2), the lower vertical boundary (114.3), and the right horizontal boundary (114.4).

As previously described, AT1 (5110) and AT2 (5120) are hidden programming objects which are used by the MCO to control the automatic alignment of respective Media Player Object Groups. In FIG. 51B, the MCO has automatically aligned AT2 (5120) with the bottom edge of the field of view (114.3). This action has caused the key operational elements of Media Player Object Group 1 and Media Player Object Group 2 to be visible within the four boundaries of the field of view. Therefore the operator has the ability to see and access display messages and control buttons for six digital media players (members of a Media Player Object Set) in the screen area which had been previously (see FIG. 51A) exclusively devoted to members of Media Player Object Group 1. (FIG. 14B is a related software screen capture which depicts a six-player embodiment where the key operational elements of Media Player Object Group 1 and Media Player Object Group 2 are visible within the four boundaries of the field of view.)

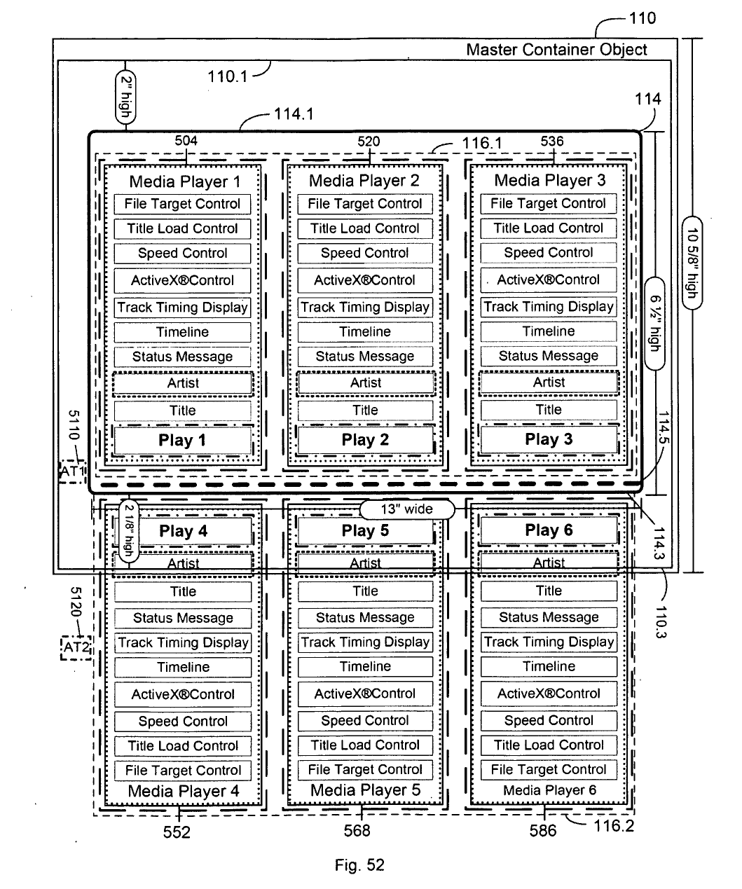

FIG. 52 is a companion illustration to FIG. 51A. FIG. 52 depicts the dimensions of two Media Player Object Groups within the Master Container Object “field of view” where Media Player Object Group 1 is shown above the “artificial horizon” line and parts of Media Player Object Group 2 are shown below the “artificial horizon” line and continue in a background layer view below the outside dimensions of the MCO.

In FIG. 52, a more detailed rendering of each media player object (1 through 6) is depicted with the individual components that are part of the media player object set for each digital media player in the MCO. Because images for Media Player Object Group 1 (which includes Player 1, 2 and 3) can be seen to be aligned in a manner as to be fully visible in the field of view (114), the program's situational awareness logic has played an important role. In the MCO, when the user has loaded a digital media file into Player 1, 2 or 3, Media Player Object Group 1 is said to be active. If the user has also loaded a file, or is playing a file, from Media Player 4, 5 or 6—Media Player Object Group 2 is said to be active. In cases where only one group is active, the SA logic in the MCO will use the alignment tabs (5110 and 5120) as focus points and automatically align the group so that a full image of the player is displayed in the field of view.

However, when elements of both sets are active, the alignment tabs can be used to animate the movement of each Media Player Object Group so that the key operational elements of each group are visible to the user and accessible from within the field of view. Key operational elements for each player include objects such as the Play button, the Title and Artist display, the status message and the timeline.

FIG. 52 depicts the Master Container Object (110) with its four outer boundaries; however only the upper vertical boundary (110.1) and the lower vertical boundary (110.3) are labeled in the drawing. (The reader is presumed to understand the four boundaries of the MCO from previous descriptions in the disclosure.) Also present in FIG. 52 is the dark bold rectangular object with curved edges that represents the field of view (114) or the so-called Auto-Adjusting Field of View (AAFOV). The field of view has four outer boundaries; however only the upper vertical boundary (114.1) and the lower vertical boundary (114.3) are labeled in the drawing. (The reader is presumed to understand the four boundaries of the field of view from previous descriptions in the disclosure.)

Continuing with FIG. 52, the Media Player Object Group 1 (116.1) comprised of three Media Player Object Sets, is visible within the field of view. The Media Player Object Sets which comprise Media Player Object Group 1 include: Media Player Object Set 1 (504), Media Player Object Set 2 (520), and Media Player Object Set 3 (536). Each Media Player Object Set includes its corresponding instantiation of a digital media player. Observe that in FIG. 52, the players included in Media Player Object Group 1 (116.1) are wholly depicted within the field of view and the field of view “artificial horizon” (Media Player Object Group dividing line) (114.5) is visible directly below players 1, 2 and 3. Note that the programming Alignment Tab 1 (5110) is depicted to the left of Player 1 where it is positioned just above the artificial horizon which—at that moment—is positioned just above the field of view lower vertical boundary (114.3) indicating the tab has been used by programming instructions to align Media Player Object Group 1 in such a manner as to permit the user to see the key operational elements (controls and display messages) of only Media Player Object Group 1.

Continuing with FIG. 52, the Media Player Object Group 2 (116.2) comprised of three Media Player Object Sets, is visible below the field of view. The Media Player Object Sets which comprise Media Player Object Group 2 include: Media Player Object Set 4 (552), Media Player Object Set 5 (568), and Media Player Object Set 6 (586). Each Media Player Object Set includes its corresponding instantiation of a digital media player. Observe that in FIG. 52, the players included in Media Player Object Group 2 (116.2) are depicted wholly below the field of view, and the field of view “artificial horizon” (Media Player Object Group dividing line) (114.5) is visible directly above players 4, 5 and 6. Note that the programming Alignment Tab 2 (5120) is depicted to the left of Player 4 where it is positioned significantly below the artificial horizon.

In the depiction for FIG. 52, the MCO has determined that only members of Media Player Object Group 1 (Player 1, 2 or 3) are active, therefore AT1 (5110) is illustrated near the bottom of the field of view. AT1 is the hidden alignment tab used by program instructions to present Media Player Object Group 1 in its full height configuration. In FIG. 52, like numbers indicate like characters depicted earlier in the specification.

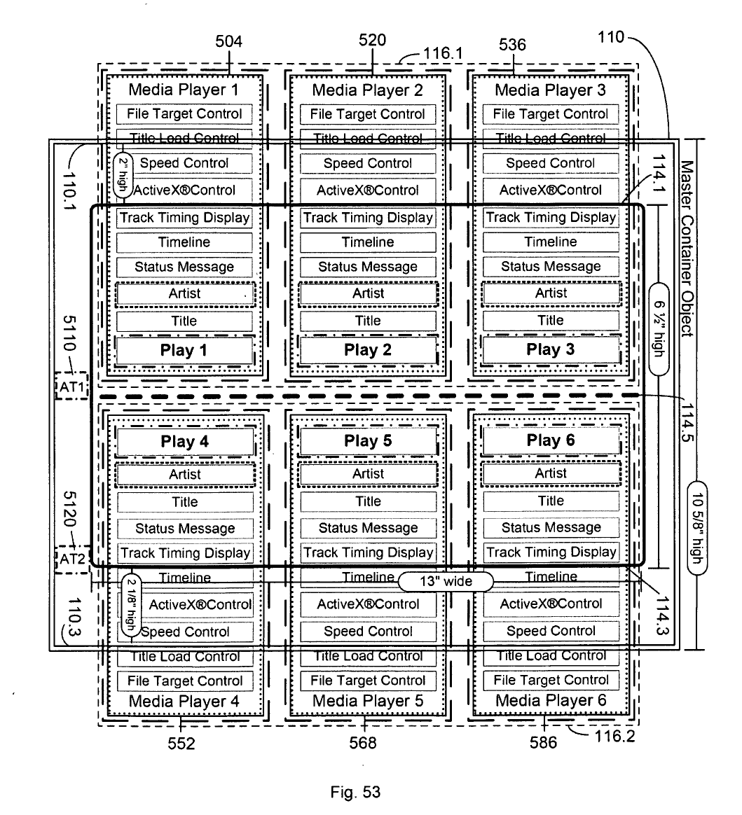

Now referring to FIG. 53 which is a companion illustration to FIG. 51B. FIG. 53 depicts the dimensions of two media player object groups within the Master Container Object “field of view” where parts of Media Player Object Group 1 are shown above the “artificial horizon” line and parts of Media Player Object Group 2 (as aligned by the hidden Alignment Tab 2 program object) are shown below the “artificial horizon” line.

As with FIG. 52, the SA logic in the Master Container Object as depicted in FIG. 53 has determined which player object groups have active members (e.g., digital media players that are loaded, ready to play or currently playing). Since FIG. 53 illustrates the alignment (via AT2) of both Media Player Object Groups within the field of view, the reader can conclude that this depiction includes at least one active digital media player from both groups. Note that AT2 (5120) is positioned near the bottom edge of the field of view, and this has caused the equal alignment for the area that encompasses the key operation elements for both groups within the field of view. (See FIGS. 5B-1, 5C-1 and 5D for depictions of the standard order and inverted order Media Player Object Groups and the key operational elements assigned to each digital media player.) In FIG. 53, like numbers indicate like characters depicted earlier in the specification.

FIG. 53 depicts the Master Container Object (110) with its four outer boundaries; however only the upper vertical boundary (110.1) and the lower vertical boundary (110.3) are labeled in the drawing. (The reader is presumed to understand the four boundaries of the MCO from previous descriptions in the disclosure.) Also present in FIG. 53 is the dark rectangular object with curved edges that represents the field of view or the so-called Auto-Adjusting Field of View (AAFOV). The field of view has four outer boundaries; however only the upper vertical boundary (114.1) and the lower vertical boundary (114.3) are labeled in the drawing. (The reader is presumed to understand the four boundaries of the field of view from previous descriptions in the disclosure.)

Continuing with FIG. 53, the Media Player Object Group 1 (116.1) comprised of three Media Player Object Sets, is partially visible within the field of view. The Media Player Object Sets which comprise Media Player Object Group 1 include: Media Player Object Set 1 (504), Media Player Object Set 2 (520), and Media Player Object Set 3 (536). Each Media Player Object Set includes its corresponding instantiation of a digital media player. Observe that in FIG. 53, the players included in Media Player Object Group 1 (116.1) are depicted in part within the field of view, and in part above the upper vertical boundary of the field of view; and the field of view “artificial horizon” (Media Player Object Group dividing line) (114.5) is visible directly below players 1, 2 and 3. Note that the programming Alignment Tab 1 (5110) is depicted to the left of Player 1 where it is positioned just above the artificial horizon which—at that moment—is positioned at the vertical mid-point of the field of view. (The artificial horizon has moved up, when compared with its placement in FIG. 52, because in FIG. 53 the field of view includes visual depictions of active members of two media player object sets.)

Continuing with FIG. 53, the Media Player Object Group 2 (116.2) comprised of three Media Player Object Sets, is partially visible within the field of view. The Media Player Object Sets which comprise Media Player Object Group 2 include: Media Player Object Set 4 (552), Media Player Object Set 5 (568), and Media Player Object Set 6 (586). Each Media Player Object Set includes its corresponding instantiation of a digital media player. Observe that in FIG. 53, the players included in Media Player Object Group 2 (116.2) are depicted in part within the field of view, and in part below the lower vertical boundary of the field of view; and the field of view “artificial horizon” (Media Player Object Group dividing line) (114.5) is visible directly above players 4, 5 and 6. Note that the programming Alignment Tab 2 (5120) is depicted to the left of Player 4 where it is positioned significantly below the artificial horizon; however AT2 (5120) is depicted near the field of view the lower vertical boundary (114.3) indicating the tab has been used by programming instructions to align Media Player Object Group 2 in such a manner as to permit the user to see the key operational elements (controls and display messages) of both Media Player Object Group 1 and Media Player Object Group 2 within the usable screen area of the field of view.

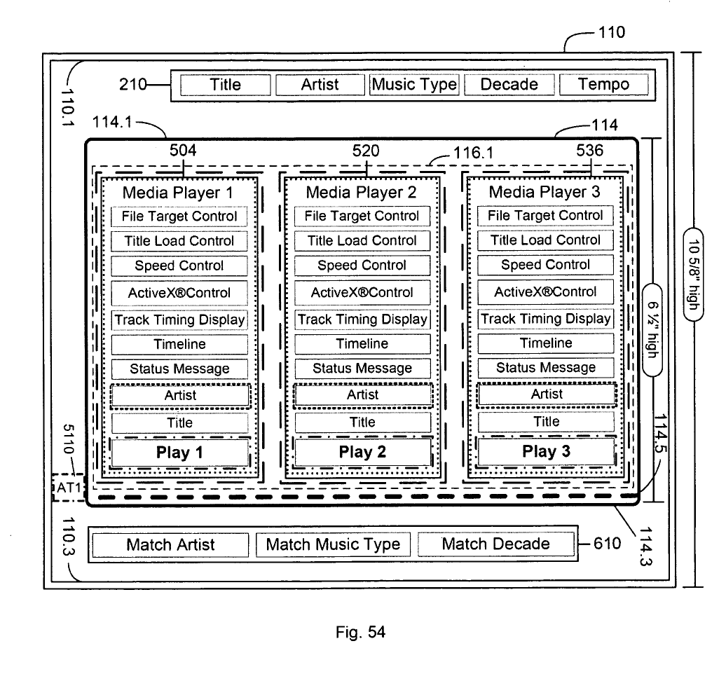

Now referring to FIG. 54 which is a companion illustration to FIG. 52. FIG. 54 depicts the dimensions of one media player object group (as aligned by the hidden Alignment Tab 1 program object) within the Master Container Object “field of view” where media player object group 1 is shown above the “artificial horizon” line and other command elements of the MCO such as the KDVCQC switches and the match attribute filter buttons are visible above and below the field of view. FIG. 54 depicts the full image of each player in Media Player Object Group 1, and the display in the field of view includes all the components of each player's object set. In FIG. 54, like numbers indicate like characters depicted earlier in the specification.

FIG. 54 depicts the Master Container Object (MCO) (110) with its four outer boundaries; however only the upper vertical boundary (110.1) and the lower vertical boundary (110.3) are labeled in the drawing. (The reader is presumed to understand the four boundaries of the MCO from previous descriptions in the disclosure.) Also present in FIG. 54 is the dark bold rectangular object with curved edges that represents the field of view (114) or the so-called Auto-Adjusting Field of View (AAFOV). The field of view has four outer boundaries; however only the upper vertical boundary (114.1) and the lower vertical boundary (114.3) are labeled in the drawing. (The reader is presumed to understand the four boundaries of the field of view from previous descriptions in the disclosure.)

Continuing with FIG. 54, the Media Player Object Group 1 (116.1) comprised of three Media Player Object Sets, is visible within the field of view. The Media Player Object Sets which comprise Media Player Object Group 1 include: Media Player Object Set 1 (504), Media Player Object Set 2 (520), and Media Player Object Set 3 (536). Each Media Player Object Set includes its corresponding instantiation of a digital media player. Observe that in FIG. 54, the players included in Media Player Object Group 1 (116.1) are wholly depicted within the field of view and the field of view “artificial horizon” (Media Player Object Group dividing line) (114.5) is visible directly below players 1, 2 and 3. Note that the programming Alignment Tab 1 (5110) is depicted to the left of Player 1 where it is positioned just above the artificial horizon which—at that moment—is positioned just above the field of view lower vertical boundary (114.3) indicating the tab has been used by programming instructions to align Media Player Object Group 1 in such a manner as to permit the user to see the key operational elements (controls and display messages) of only Media Player Object Group 1.

In FIG. 54, there additional are two screen display areas. One is visible above the field of view upper vertical boundary (114.1) and below the Master Container Object upper vertical boundary (110.1). The other area is visible below the field of view lower vertical boundary (114.3) and above the Master Container Object lower vertical boundary (110.3). These interface display areas are within the vertical and horizontal boundaries of the Master Container Object (110) where the MCO is depicted with an upper vertical boundary (110.1) and a lower vertical boundary (110.3).

Occupying these screen areas are sets of command buttons. In an embodiment depicted in FIG. 54, a set of Search Group 1 Key Data Value Command Query Controls (210) is illustrated within the MCO and positioned above the field of view upper vertical boundary (114.1) and below the Master Container Object upper vertical boundary (110.1). Also present in FIG. 54 is a plurality of query filter controls (610) that may be present within the Master Container Object. These filter controls are depicted below the field of view lower vertical boundary (114.3) and above the Master Container Object lower vertical boundary (110.3).

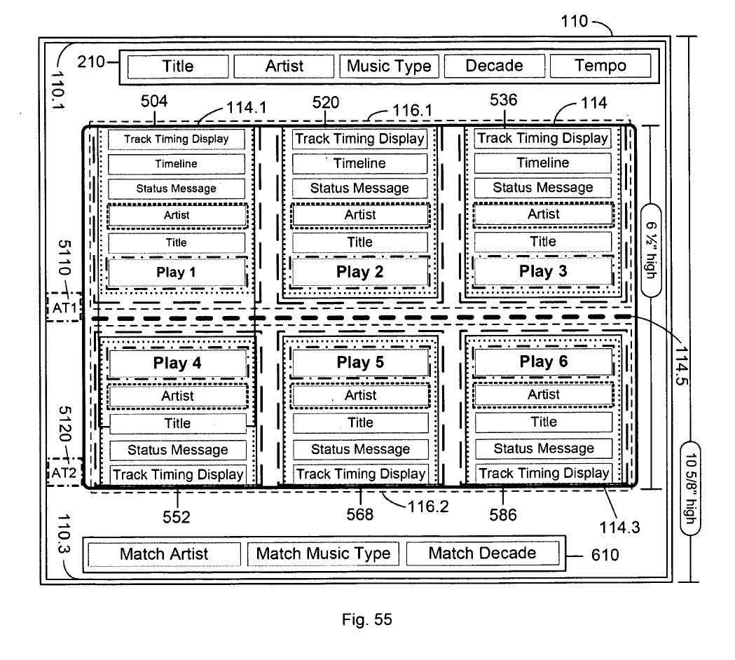

Now referring to FIG. 55 which is a companion illustration to FIG. 53. FIG. 55 depicts the dimensions of two media player object groups within the Master Container Object “field of view” where parts of Media Player Object Group 1 are shown above the “artificial horizon” line and parts of Media Player Object Group 2 are shown below the “artificial horizon” line while at the same time other command elements of the MCO (such as the KDVCQC switches and the match attribute filter buttons) are visible above and below the field of view. FIG. 55 depicts the partial image of each player in Media Player Object Group 1 and Media Player Object Group 2. The alignment for FIG. 55 has been automatically programmed so as to equally display in the field of view only the key operational controls and displays for each player's object set. In FIG. 55, like numbers indicate like characters depicted earlier in the specification.

FIG. 55 depicts the Master Container Object (MCO) (110) with its four outer boundaries; however only the upper vertical boundary (110.1) and the lower vertical boundary (110.3) are labeled in the drawing. (The reader is presumed to understand the four boundaries of the MCO from previous descriptions in the disclosure.) Also present in FIG. 55 is the dark bold rectangular object with curved edges that represents the field of view (114) or the so-called Auto-Adjusting Field of View (AAFOV). The field of view has four outer boundaries; however only the upper vertical boundary (114.1) and the lower vertical boundary (114.3) are labeled in the drawing. (The reader is presumed to understand the four boundaries of the field of view from previous descriptions in the disclosure.)

Continuing with FIG. 55, the Media Player Object Group 1 (116.1) comprised of three Media Player Object Sets, is visible in part within the field of view. The Media Player Object Sets which comprise Media Player Object Group 1 include: Media Player Object Set 1 (504), Media Player Object Set 2 (520), and Media Player Object Set 3 (536). Each Media Player Object Set includes its corresponding instantiation of a digital media player. Observe that in FIG. 55, the players included in Media Player Object Group 1 (116.1) are partially depicted within the field of view and the field of view “artificial horizon” (Media Player Object Group dividing line) (114.5) is visible directly below players 1, 2 and 3. Note that the programming Alignment Tab 1 (5110) is depicted to the left of Player 1 where it is positioned just above the artificial horizon which—at that moment—is positioned at the vertical mid-point of the field of view (114.3).

FIG. 55 depicts the alignment of an additional Media Player Object Group because, in this drawing, there are concurrently active digital player members of Media Player Object Group 1 and Media Player Object Group 2. Media Player Object Group 2 (116.2) comprised of three Media Player Object Sets, is visible in part within the field of view. The Media Player Object Sets which comprise Media Player Object Group 2 include: Media Player Object Set 4 (552), Media Player Object Set 5 (568), and Media Player Object Set 6 (586). Each Media Player Object Set includes its corresponding instantiation of a digital media player. Observe that in FIG. 55, the players included in Media Player Object Group 2 (116.2) are partially depicted within the field of view and the field of view “artificial horizon” (Media Player Object Group dividing line) (114.5) is visible directly above players 4, 5 and 6. Note that the programming Alignment Tab 2 (5120) is depicted to the left of Player 4 where it is positioned significantly below the artificial horizon which—at that moment—is positioned at the vertical mid-point of the field of view. The position of AT2 (5120) is significantly below the artificial horizon, and at a screen position level with the field of view lower vertical boundary (114.3). This indicates the tab has been used by programming instructions to align Media Player Object Group 2 in such a manner as to permit the user to see the key operational elements (controls and display messages) of both Media Player Object Group 1 and Media Player Object Group 2 within the usable screen area of the field of view.

In FIG. 55, there additional are two screen display areas. One is visible above the field of view upper vertical boundary (114.1) and below the Master Container Object upper vertical boundary (110.1). The other area is visible below the field of view lower vertical boundary (114.3) and above the Master Container Object lower vertical boundary (110.3). These interface display areas are within the vertical and horizontal boundaries of the Master Container Object (110) where the MCO is depicted with an upper vertical boundary (110.1) and a lower vertical boundary (110.3).

Occupying these screen areas are sets of command buttons. In an embodiment depicted in FIG. 55, a set of Search Group 1 Key Data Value Command Query Controls (210) is illustrated within the MCO and positioned above the field of view upper vertical boundary (114.1) and below the Master Container Object upper vertical boundary (110.1). Also present in FIG. 55 is a plurality of query filter controls (610) that may be present within the Master Container Object. These filter controls are depicted below the field of view lower vertical boundary (114.3) and above the Master Container Object lower vertical boundary (110.3).

While illustrated embodiments of the present invention have been described and illustrated in the appended drawings, the present invention is not limited thereto but only by the scope and spirit of the appended claims.

I claim:

1. A digital media management and reproduction system, comprising:
a computer-readable storage medium having a plurality of digital media files;
a processor programmed to execute a plurality of program instructions to instantiate a master container object and a plurality of digital media players each controlled by the master container object;
at least one output controlled by the master container object and at least one digital media player to play at least one selected digital media file;
a display coupled to the processor for displaying visual representations of ones of the digital media players to a user;
a graphical user interface coupled to the processor for inputting instructions from the user;
each digital media player operable to retrieve and play at least one digital media file, each visual representation of a digital media player displaying to the user at least one of a plurality of states of the digital media player, the states including LOADED, NOT LOADED, READY TO PLAY, and CURRENTLY PLAYING;
the master container object sensing the state of each digital media player and operable to change said state, the master container object operable by the user to simultaneously control the state and operations of each digital media player, said operations including the retrieval and playing of digital media files;
the master container object focusing the attention of the user on a selected one of the digital media players by altering the visual representation of the selected one of the digital media players from a first condition indicating nonselection to a second condition indicating selection.

2. The system of claim 1, wherein each digital media player is incapable of sensing the state of the other digital media players.

3. A method for searching a catalog of digital media files to retrieve lists of digital media files, wherein each media file in a retrieved list has at least one shared attribute with all others in the retrieved list, the method comprising the steps of:
storing, in an electronic relational database, a plurality of digital media file records, each record having a plurality of fields which each store a respective attribute of the digital media file;
creating, by a processor coupled to the electronic relational database, at least first and second command query control sets each to include a plurality of queries, each query searching on a respective attribute of the digital media file records, at least some of the queries in the first command query control set being different from the queries in the second command query control set;
on a display coupled to the processor, imaging each kind of query in the first command query control set;
selecting, using a graphical user interface coupled to the processor, one of the imaged queries in the first command query control set;
using the graphical user interface, entering text which is to be used by the selected query to search a respective field in each of the digital media file records;
responsive to entering the text, searching the database and retrieving a list of digital media file records having an attribute in the last said field which best matches the user-entered text;
displaying, for each listed digital media file, all of the attributes of the digital media file which are searchable by respective queries of the first command query control set;
assigning, to a first record of the retrieved list of records, the status of anchor record;
using the graphical user interface to select the second command query control set;
responsive to selecting the second query control set, displaying the different queries in the second query control set; and
using the graphical user interface to select one of the queries of the second query control set; and
responsive to the last said step of selecting, retrieving a plurality of digital media file records which best match the value of the attribute appearing in the anchor record.

4. The method of claim 3, and further comprising the steps of
selecting one of the records in the second list of digital media file records; and
responsive to said step of selecting, retrieving, from a computer-readable medium, the digital media file corresponding to the selected digital media file record for play in a digital media player.

5. A method for retrieving a plurality of digital media file records from a database of digital media file records, comprising the steps of:
storing, in an electronic relational database coupled to a processor, a plurality of digital media file records, each record having a plurality of fields which each store a respective attribute of the digital media file;
storing, in an electronic memory coupled to the processor, a plurality of command query control sets, each command query control set having a plurality of queries, each query searching on a respective field of the digital media file records, at least some of the queries in any one of the command query control sets searching on respective fields which are different than the fields searched by the queries in the other command query control sets;
displaying, on a display coupled to the processor, respective images of each of the command query control sets;
using a graphical user interface coupled to the processor to select one of the command query control sets;
responsive to the last set step of using the graphical user interface, deleting the images of those command query control sets which have not been selected by the user;
responsive to the last said step of using the graphical user interface, listing on the display each of the queries contained in the selected query control set;
using the graphical user interface to select one of the last said queries; and
using the selected query to search the database for digital media file records having an attribute which best matches an attribute entered into the selected query.

6. A method for displaying a plurality of media player images in a display, comprising the steps of:
controlling each of a plurality of digital media players each capable of playing a digital media file, by a master container object, the digital media players and master container object instantiated by a processor programmed with a plurality of computer program instructions;
rendering an image of each digital media player to have a height which is more than one-half a height of an active area of the display;
establishing a horizontal dividing line on the display;
arranging ones of the digital media player images above the dividing line so that only a lower portion of each of the last said images is visible in the display, the lower portion of each of the last said images including images of a plurality of key operational elements, the key operational elements including a play command button, a title of the digital media file presently associated with the digital media player, and the name of an artist authoring the digital media file presently associated with the digital media player; and
arranging others of the digital media player images below the dividing line so that only an upper portion of each of the last said images is visible in the display, the upper portion of the last said images including the same key operational elements as are visible in each of lower portions of the media player images appearing above the horizontal dividing line.

7. The method of claim 6, wherein during a period other than the period in which said steps of establishing a horizontal dividing line, arranging ones of the digital media players, and arranging others of the digital players, the processor controls the display to display a number of full images of a plurality of digital media players, the number of displayed full images being less than the sum of said ones and said others.

8. The method of claim 6, wherein the key operational elements visible in the lower portions of the upper digital media player images and in the upper portions of the lower digital media player images further include a status message, a track timing display, and a time line.

9. The method of claim 6, wherein the digital media player images above the dividing line each have therein a plurality of operational elements, including the key operational elements, in a vertical stack conforming to a predetermined order, the digital media player images arranged below the dividing line displaying the operational elements in a vertical stack conforming to a second order different from the predetermined order, such that the key operational elements in each digital media player are visible regardless of the position of the digital media player above or below the horizontal dividing line.

10. A method of loading each of a plurality of digital media players with multiple digital media files to be played by the digital media players, comprising the steps of:
creating a database containing a plurality of digital media file records;
providing at least one machine-readable storage medium storing digital media files corresponding to ones of the digital media file records in the database;
for each of a plurality of speed load data sets, using a processor coupled to the database and the storage medium to retrieve a plurality of digital media file records, such that each speed load data set includes a plurality of digital media file records;
displaying, on a display coupled to the processor, visual representations of each of the digital media players;
displaying, on the display, visual representations of a plurality of the speed load data sets;
using a graphical user interface coupled to the processor to select one of the speed load data sets for loading into all of the digital media players; and
responsive to the last said step, loading all of the digital media files identified in the selected speed load data set into all of the digital media players.

11. A method for searching a database of digital media file records having attributes similar to a selected attribute of a currently loaded digital media file, each record corresponding to a digital media file stored on a storage medium, the method comprising the steps of:
storing in the database, for each digital media file record, a plurality of fields;
controlling a digital media player instantiated by a processor to retrieve from the storage medium and load into the player a selected digital media file;
displaying, on a display coupled to the processor, a plurality of different key data filters, each key data filter corresponding to a respective field of the digital media file records;
selecting, by a user using a graphical user interface coupled to the processor, a resident attribute key data filter from the displayed plurality of different key data filters;
storing the selected resident attribute key data filter;
at a time subsequent to the last said step of storing, and using the graphical user interface, activating the resident attribute key data filter;
responsive to said step of activating, fetching the value of the record field of the currently loaded digital media file corresponding to the key data filter;
after said step of fetching, searching the same field in all digital media file records in the database to retrieve digital media file records having a value in said field which best matches the fetched value; and
displaying on the display those digital media file records having the best match of the value in their corresponding fields to the fetched value.
